(19) United States
(12) Patent Application Publication
(10) Pub. No.: US 2025/0215019 A1
(43) Pub. Date: Jul. 3, 2025

(54) ORTHOGONAL FUNCTIONALIZATION OF BRIDGE-SUBSTITUTED BCPS

(71) Applicant: The Board of Regents of The University of Texas System, Austin, TX (US)

(72) Inventors: Yangyang YANG, Dallas, TX (US); Jet TSIEN, Dallas, TX (US); Tian QIN, Dallas, TX (US)

(73) Assignee: The Board of Regents of The University of Texas System, Austin, TX (US)

(21) Appl. No.: 18/848,342

(22) PCT Filed: Mar. 17, 2023
(86) PCT No.: PCT/US2023/064626

§ 371 Date: Sep. 18, 2024

Related U.S. Application Data
(60) Provisional application No. 63/321,700, filed on Mar. 19, 2022.

(51) Int. Cl. C07F 5/02; B01J 23/46; B01J 23/755; B01J 27/16; B01J 35/39

(52) U.S. Cl. CPC C07F 5/025; B01J 23/468; B01J 23/755; B01J 27/16; B01J 35/39

(57) ABSTRACT

Disclosed herein are methods of synthesizing compounds of the formula wherein the variables are defined herein. Also provided are compounds produced using these methods. In some aspects, the methods provided herein may be used to create di- and tri-substituted BCPs.

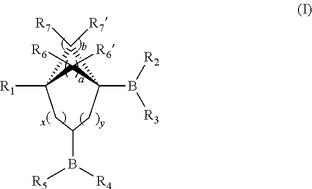

This application claims the benefit of priority to U.S. Provisional Application No. 63/321,700, filed on Mar. 19, 2022, the entire contents of which are hereby incorporated by reference.

This invention was made with government support under grant no. R01GM141088 awarded by the National Institutes of Health. The government has certain rights in the invention.

### BACKGROUND

### I. Field

The present disclosure relates generally to the fields of chemistry and synthesis. More particularly, it concerns methods of synthesis and compounds produced via the methods disclosed herein. The present disclosure also relates to starting materials for use in those synthetic methods.

### II. Description of Related Art

Caged bicyclic molecules that exhibit considerable ring strain have long been the subject of intense study due to their unusual geometries, physical properties, and theoretical interest (Levin et al., 2000). Recent developments in medicinal chemistry shine a new light on the potential utility of these C(sp³)-rich hydrocarbons (Lovering et al., 2009). Owing to their unique physical and chemical properties, bicyclic hydrocarbons exhibit the ability to modulate the pharmacokinetic and physiochemical properties of drug candidates (Pellicciari et al., 1996; Mikhailiuk et al., 2006; Stepan et al., 2012; Westphal et al., 2015; Costantino et al., 2001; Nicolaou et al., 2016; Measom et al., 2017; Auberson et al., 2017). Bicyclo[1.1.1]pentanes (BCPs) containing substitutions at bridgehead positions (C1, C3) are now widely recognized as saturated bioisosteres for para-substituted benzenes (Talele, 2020; Bauer et al., 2021). Analogously, related caged scaffolds with differentiated substitutions (FIG. 1A) are expected to be ideal bioisosteres of ortho- or meta-substituted benzenes (Mykhailiuk, 2019; Denisenko et al., 2020). Currently BCPs are synthesized from the highly strained [1.1.1]propellane (6) (the strain energy of the C—C bond=˜59-65 kcal/mol [Jackson et al., 1984; Feller and Davidson, 1987; Wiberg and Walker, 1982; Wu et al., 2009]), using methodologies pioneered by Wiberg (Wiberg et al., 1982; Wiberg et al., 1986), Michl (Kaszynki and Michl, 1988), Baran (Gianatassio et al., 2016; Lopchuk et al., 2017), and others (Ma et al., 2020; Kanazawa and Uchiyama, 2019; Makarov et al., 2017; Kanazawa et al. 2017; Kondo et al., 2020; Caputo et al., 2018; Nugent et al., 2019; Zhang et al., 2020; Trongsiriwat et al., 2019; Hughes et al., 2019; Shelp et al., 2018; Yu et al., 2020; Kim et al., 2020; Shin et al., 2021; Toriyama et al., 2016; VanHeyst et al., 2020; Garlets et al., 2020; Zarate et al., 2021), wherein 6 is transformed to symmetric and asymmetric BCPs using either single- or two-electron transfer pathways (FIG. 1B). These efforts have primarily focused on accessing C1 and/or C3-substituted BCPs until two recent reports (Ma et al., 2020; Zhao et al., 2020) disclosed strategies for the systematic functionalization of the backbone (C2) of BCPs. In addition to strain-release, Wurtz coupling (Wiberg et al., 1964; Rifi, 1969), Norrish-Yang cyclization (Padwa and Alexander, 1967; Padwa et al., 1969), [2+2] photo-cycloaddition (Srinivasan and Carlough, 1967), ring expansion (Ma et al., 2019; Applequist et al., 1982), and ring contraction (Meinwald et al., 1967; Della et al., 1981; Della and Pigou, 1984) represent other means to access BCPs. However, these methods are often plagued by low yields or limited substrate scope. In light of the aforementioned issues, practical and efficient methodologies to construct multi-substituted (C1/C2/C3) BCPs 8 are highly desirable as they represent elusive bioisosteres of ortho-/meta-substituted benzene rings and would enable access to novel chemical space.

### SUMMARY

The present disclosure provides synthetic methods of synthesizing organic compounds having bicyclic substructures, such as bicyclo[1.1.1]pentane. The present disclosure also provides compounds prepared by said methods.

In some aspects, the present disclosure provides methods of preparing a compound comprising reacting a compound of the formula:

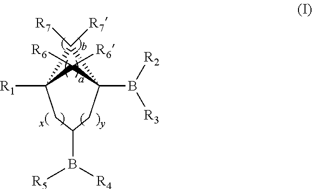

wherein:
a and b are each independently selected from 0, 1, 2, or 3;
x and y are each independently selected from 0, 1, 2, or 3;
R₁ is an organic moiety; R₂, R₃, R₄, and R₅ are each hydroxy or R₂ and R₃ are taken together to form a B-containing heterocycloalkyl_{(C≤12)} or substituted B-containing heterocycloalkyl_{(C≤12)}; and
R₆, R₆′, R₇, and R₇′ are each independently hydrogen, alkyl_{(C≤12)}, or substituted alkyl_{(C≤12)};
   with a reactive compound to form a monoboronated compound of the formula:

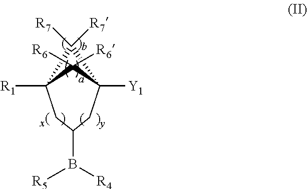

wherein:
a and b are each independently selected from 0, 1, 2, or 3;
x and y are each independently selected from 0, 1, 2, or 3;
R₁ is an organic moiety;
R₂, R₃, R₄, and R₅ are each hydroxy or R₂ and R₃ are taken together to form a B-containing heterocycloalkyl_{(C≤12)} or substituted B-containing heterocycloalkyl_{(C≤12)};
R₆, R₆′, R₇, and R₇′ are each independently hydrogen, alkyl_{(C≤12)}, or substituted alkyl_{(C≤12)}; and
Y₁ is hydrogen or an organic moiety.

In some embodiments, the methods further comprise reacting the monoboronated compound of formula II with a second reactive compound to form a compound of the formula:

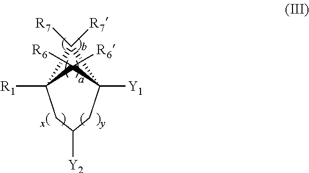

wherein:
a and b are each independently selected from 0, 1, 2, or 3;
x and y are each independently selected from 0, 1, 2, or 3;
R₁ is an organic moiety;
R₂, R₃, R₄, and R₅ are each hydroxy or R₂ and R₃ are taken together to form a B-containing heterocycloalkyl_{(C≤12)} or substituted B-containing heterocycloalkyl_{(C≤12)};
R₆, R₆′, R₇, and R₇′ are each independently hydrogen, alkyl_{(C≤12)}, or substituted alkyl_{(C≤12)}; and
Y₁ and Y₂ are each independently hydrogen or an organic moiety.

In some embodiments, the reactive compound is a catechol such as tert-butylcatechol. In some embodiments, Y₁ is hydrogen. In some embodiments, the methods further comprise a coupling partner. In some embodiments, the coupling partner is a cyanide source such as tosyl cyanide. In other embodiments, the coupling partner is a sulfur source. In some embodiments, the sulfur source comprises a S—S bond. In some embodiments, the sulfur source is a sulfonothioic acid such as an S-phenyl ester of benzenesulfonothioic acid. In other embodiments, the coupling partner is a nitrogen source. In some embodiments, the nitrogen source comprises an azodicarboxylate group such as di-tert-butyl azodicarboxylate or di-isopropyl azodicarboxylate. In some embodiments, the reactive compound is a hydrazone.

In some embodiments, the hydrazone further comprises an alkylsulfonyl_{(C≤12)}, arylsulfonyl_{(C≤12)}, or a substituted version of either group. In some embodiments, the hydrazone further comprises a group of the formula:

CRₐRₐ′═

wherein:
Rₐ and Rₐ′ are each hydrogen, alkyl_{(C≤12)}, cycloalkyl_{(C≤12)}, alkenyl_{(C≤12)}, cycloalkenyl_{(C≤12)}, alkynyl_{(C≤12)}, cycloalkynyl_{(C≤12)}, aryl_{(C≤12)}, heteroaryl_{(C≤12)}, heterocycloalkyl_{(C≤12)}, alkoxy_{(C≤12)}, aryloxy_{(C≤12)}, aralkoxy_{(C≤12)}, acyl_{(C≤12)}, alkylamino_{(C≤12)}, dialkylamino_{(C≤12)}, alkylsulfonyl_{(C≤12)}, arylsulfonyl_{(C≤12)}, or a substituted version of any of these groups.

In some embodiments, the hydrazone is further defined as:

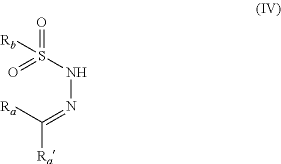

wherein:
Rₐ and Rₐ′ are each hydrogen, alkyl_{(C≤12)}, cycloalkyl_{(C≤12)}, alkenyl_{(C≤12)}, cycloalkenyl_{(C≤12)}, alkynyl_{(C≤12)}, cycloalkynyl_{(C≤12)}, aryl_{(C≤12)}, heteroaryl_{(C≤12)}, heterocycloalkyl_{(C≤12)}, alkoxy_{(C≤12)}, aryloxy_{(C≤12)}, aralkoxy_{(C≤12)}, acyl_{(C≤12)}, alkylamino_{(C≤12)}, dialkylamino_{(C≤12)}, alkylsulfonyl_{(C≤12)}, arylsulfonyl_{(C≤12)}, or a substituted version of any of these groups; and
R_{b} is alkyl_{(C≤12)}, aryl_{(C≤12)}, or a substituted version thereof.

In some embodiments, the reactive compound is a Michael acceptor. In some embodiments, the Michael acceptor comprises a double bond such as when the double bond is attached to an electron withdrawing group. In some embodiments, the electron withdrawing group is an oxo group, an ester group, an amide group, or a cyano group.

In some embodiments, the methods further comprise a metal catalyst. In some embodiments, the metal catalyst is iridium catalyst. In some embodiments, the method further comprises exposing the compound to an energy source. In some embodiments, the energy source is a radiation source such as UV light.

In other embodiments, the reactive compound is an organic halide. In some embodiments, the organic halide is an organic bromide such as an aromatic bromide. In some embodiments, the aromatic bromide is further defined as: R_{d}Br, wherein: aryl_{(C≤18)}, heteroaryl_{(C≤18)}, or a substituted version of either group. In other embodiments, the organic bromide is an aliphatic bromide. In some embodiments, the aliphatic bromide is further defined as: R_{d}Br, wherein: alkyl_{(C≤18)}, alkenyl_{(C≤18)}, alkynyl_{(C≤18)}, or a substituted version of any of these group.

In some embodiments, the methods further comprise a metal catalyst such a nickel metal catalyst. In some embodiments, the methods further comprise a Lewis acid. In some embodiments, the Lewis acid is a metal salt. In some embodiments, the metal salt is a zinc salt such as zinc triflate. In some embodiments, the methods further comprise a photocatalyst. In some embodiments, the photocatalyst is capable of generating a radical. In some embodiments, the photocatalyst is an organic compound. In some embodiments, the photocatalyst is a photoredox catalyst such as an isophthalonitrile. In some embodiments, the isophthalonitrile is 2,4,5,6-tetra(9H-carbazol-9-yl)isophthalonitrile.

In some embodiments, the methods further comprise exposing the compound to an energy source. In some embodiments, the energy source is a radiation source such as ultraviolet radiation. In some embodiments, the reactive compound is a heteroarene_{(C≤18)} or a substituted heteroarene_{(C≤18)}. In some embodiments, the methods further comprise a metal salt. In some embodiments, the metal salt is a manganese salt. In some embodiments, the metal salt is a manganese(III) salt such as Mn(OAc)₃.

In some embodiments, the method further comprises an acid. In some embodiments, the acid has a pKₐ of less than 5 such as a pKₐ of less than 0. In some embodiments, the acid is an alkylcarboxylate_{(C≤8)} or a substituted alkylcarboxylate_{(C≤8)}. In some embodiments, the acid is a substituted alkylcarboxylate_{(C≤8)} such as trifluoroacetic acid.

In some embodiments, the second reactive compound is a peroxide. In other embodiments, the second reactive compound is a base. In some embodiments, the base is an organolithium compound. In some embodiments, the organolithium compound is an alkyl lithium such as nbutyllithium. In other embodiments, the organolithium compound is an aromatic lithium. In some embodiments, the aromatic lithium is an aryl lithium or a heteroaryl lithium such as phenyl lithium. In other embodiments, the base is a metal carbonate. In some embodiments, the base is an alkali metal carbonate such as CsCO₃.

In some embodiments, the second reactive compound is a carbon atom source. In some embodiments, the carbon source is a dihaloalkane_{(C≤12)} or a substituted dihaloalkane_{(C≤12)}. In some embodiments, the halogen atoms in the dihaloalkane_{(C≤12)} or the substituted dihaloalkane_{(C≤12)} are different. In some embodiments, the dihaloalkane_{(C≤12)} is bromoiodomethane.

In some embodiments, the second reactive compound is a cyanide source such as tosyl cyanide. In some embodiments, the second reactive compound is a Michael acceptor. In some embodiments, the Michael acceptor comprises a double bond. In some embodiments, the double bond is attached to an electron withdrawing group. In some embodiments, the electron withdrawing group is an oxo group, an ester group, an amide group, or a cyano group.

In some embodiments, the second reactive compound is a hydrazone. In some embodiments, the hydrazone further comprises an alkylsulfonyl_{(C≤12)}, arylsulfonyl_{(C≤12)}, or a substituted version of either group. In some embodiments, the hydrazone further comprises a group of the formula:

CRₐRₐ′═

wherein:
Rₐ and Rₐ′ are each hydrogen, alkyl_{(C≤12)}, cycloalkyl_{(C≤12)}, alkenyl_{(C≤12)}, cycloalkenyl_{(C≤12)}, alkynyl_{(C≤12)}, cycloalkynyl_{(C≤12)}, aryl_{(C≤12)}, heteroaryl_{(C≤12)}, heterocycloalkyl_{(C≤12)}, alkoxy_{(C≤12)}, aryloxy_{(C≤12)}, aralkoxy_{(C≤12)}, acyl_{(C≤12)}, alkylamino_{(C≤12)}, dialkylamino_{(C≤12)}, alkylsulfonyl_{(C≤12)}, arylsulfonyl_{(C≤12)}, or a substituted version of any of these groups.

In some embodiments, the hydrazone is further defined as:

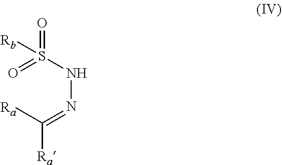

wherein:
Rₐ and Rₐ′ are each hydrogen, alkyl_{(C≤12)}, cycloalkyl_{(C≤12)}, alkenyl_{(C≤12)}, cycloalkenyl_{(C≤12)}, alkynyl_{(C≤12)}, cycloalkynyl_{(C≤12)}, aryl_{(C≤12)}, heteroaryl_{(C≤12)}, heterocycloalkyl_{(C≤12)}, alkoxy_{(C≤12)}, aryloxy_{(C≤12)}, aralkoxy_{(C≤12)}, acyl_{(C≤12)}, alkylamino_{(C≤12)}, dialkylamino_{(C≤12)}, alkylsulfonyl_{(C≤12)}, arylsulfonyl_{(C≤12)}, or a substituted version of any of these groups; and
R_{b} is alkyl_{(C≤12)}, aryl_{(C≤12)}, or a substituted version thereof.

In other embodiments, the second reactive compound is a nitroaromatic compound. In some embodiments, the nitroaromatic compound is RₑNO₂, wherein Rₑ is aryl_{(C≤18)}, heteroaryl_{(C≤18)}, or a substituted version thereof. In other embodiments, the second reactive compound is a nitrogen source. In some embodiments, the nitrogen source comprises an azodicarboxylate group such as di-tert-butyl azodicarboxylate or di-isopropyl azodicarboxylate.

In other embodiments, the second reactive compound is a heteroarene_{(C≤18)} or a substituted heteroarene_{(C≤18)}. In other embodiments, the second reactive compound is an organic halide. In some embodiments, the organic halide is an organic bromide. In some embodiments, the organic halide is an aromatic bromide. In some embodiments, the aromatic bromide is further defined as: R_{d}Br, wherein: aryl_{(C≤18)}, heteroaryl_{(C≤18)}, or a substituted version of either group. In other embodiments, the organic bromide is an aliphatic bromide. In some embodiments, the aliphatic bromide is further defined as: R_{d}Br, wherein: alkyl_{(C≤18)}, alkenyl_{(C≤18)}, alkynyl_{(C≤18)}, or a substituted version of any of these group.

In some embodiments, the second reactive compound is a sulfur source. In some embodiments, the sulfur source comprises a S—S bond. In some embodiments, the sulfur source is a sulfonothioic acid such as an S-phenyl ester of benzenesulfonothioic acid.

In some embodiments, the methods further comprise exposing the monoboronated compound to an energy source. In some embodiments, the energy source is a radiation source such as ultraviolet radiation. In some embodiments, the methods further comprise a diol. In some embodiments, the diol is pinacol. In other embodiments, the diol is a catechol such as tert-butylcatechol.

In some embodiments, the methods further comprise a phosphorus catalyst. In some embodiments, the phosphorus catalyst is a phosphorus oxide compound. In some embodiments, the methods further comprise a metal catalyst. In some embodiments, the metal catalyst is an iridium catalyst. In other embodiments, the metal catalyst is a nickel catalyst. In other embodiments, the metal salt is a manganese salt. In some embodiments, the metal salt is a manganese(III) salt such as Mn(OAc)₃.

In some embodiments, the methods further comprise an energy source. In some embodiments, the energy source is a radiation source such as ultraviolet radiation. In some embodiments, the methods further comprise a redox catalyst. In some embodiments, the redox catalyst is a dimethylhydantoin such as a dibromodimethylhydantoin. In other embodiments, the redox catalyst is a boron compound such as MeOB(catechol).

In some embodiments, R₁ is hydrogen, alkyl_{(C≤24)}, cycloalkyl_{(C≤24)}, alkenyl_{(C≤24)}, cycloalkenyl_{(C≤24)}, alkynyl_{(C≤24)}, cycloalkynyl_{(C≤24)}, aryl_{(C≤24)}, heteroaryl_{(C≤24)}, heterocycloalkyl_{(C≤24)}, alkoxy_{(C≤24)}, aryloxy_{(C≤24)}, aralkoxy_{(C≤24)}, acyl_{(C≤24)}, alkylamino_{(C≤24)}, dialkylamino_{(C≤24)}, alkylthio_{(C≤24)}, arylthio_{(C≤24)}, alkylsulfonyl_{(C≤24)}, arylsulfonyl_{(C≤24)}, or a substituted version of any of these groups; or a group of the formula: —C(O)R₈, wherein R₈ is alkoxy_{(C≤12)}, alkylamino_{(C≤12)}, dialkylamino_{(C≤12)}, or a substituted version of any of these groups; a monovalent protected amine group, a divalent protected amine group, a protected hydroxy group, or a protected thio group; or —X₁—R₉, wherein X₁ is substituted alkanediyl_{(C≤12)}, cycloalkanediyl_{(C≤12)}, alkenediyl_{(C≤12)}, arenediyl_{(C≤12)}, heteroarenediyl_{(C≤12)}, heterocycloalkanediyl_{(C≤12)}, or a substituted version thereof; and R₉ is alkyl_{(C≤24)}, cycloalkyl_{(C≤24)}, alkenyl_{(C≤24)}, cycloalkenyl_{(C≤24)}, alkynyl_{(C≤24)}, cycloalkynyl_{(C≤24)}, aryl_{(C≤24)}, heteroaryl_{(C≤24)}, heterocycloalkyl_{(C≤24)}, alkoxy_{(C≤24)}, aryloxy_{(C≤24)}, aralkoxy_{(C≤24)}, acyl_{(C≤24)}, alkylamino_{(C≤24)}, dialkylamino_{(C≤24)}, alkylthio_{(C≤24)}, arylthio_{(C≤24)}, alkylsulfonyl_{(C≤24)}, arylsulfonyl_{(C≤24)}, or a substituted version of any of these groups; or a group of the formula: —C(O)R₈, wherein R₈ is alkoxy_{(C≤12)}, alkylamino_{(C≤12)}, dialkylamino_{(C≤12)}, or a substituted version of any of these groups; a monovalent protected amine group, a divalent protected amine group, a protected hydroxy group, or a protected thio group. In some embodiments, R₁ is hydrogen, alkyl_{(C≤24)}, cycloalkyl_{(C≤24)}, alkenyl_{(C≤24)}, cycloalkenyl_{(C≤24)}, alkynyl_{(C≤24)}, cycloalkynyl_{(C≤24)}, aryl_{(C≤24)}, heteroaryl_{(C≤24)}, heterocycloalkyl_{(C≤24)}, alkoxy_{(C≤24)}, aryloxy_{(C≤24)}, aralkoxy_{(C≤24)}, acyl_{(C≤24)}, alkylamino_{(C≤24)}, dialkylamino_{(C≤24)}, alkylthio_{(C≤24)}, arylthio_{(C≤24)}, alkylsulfonyl_{(C≤24)}, arylsulfonyl_{(C≤24)}, or a substituted version of any of these groups. In some embodiments, R₁ is or a group of the formula: —C(O)R₈, wherein R₈ is alkoxy_{(C≤12)}, alkylamino_{(C≤12)}, dialkylamino_{(C≤12)}, or a substituted version of any of these groups. In other embodiments, R₁ is a monovalent protected amine group, a divalent protected amine group, a protected hydroxy group, or a protected thio group. In some embodiments, R₁ is —X₁—R₉, wherein X₁ is substituted alkanediyl_{(C≤12)}, cycloalkanediyl_{(C≤12)}, alkenediyl_{(C≤12)}, arenediyl_{(C≤12)}, heteroarenediyl_{(C≤12)}, heterocycloalkanediyl_{(C≤12)}, or a substituted version thereof; and R₉ is alkyl_{(C≤24)}, cycloalkyl_{(C≤24)}, alkenyl_{(C≤24)}, cycloalkenyl_{(C≤24)}, alkynyl_{(C≤24)}, cycloalkynyl_{(C≤24)}, aryl_{(C≤24)}, heteroaryl_{(C≤24)}, heterocycloalkyl_{(C≤24)}, alkoxy_{(C≤24)}, aryloxy_{(C≤24)}, aralkoxy_{(C≤24)}, acyl_{(C≤24)}, alkylamino_{(C≤24)}, dialkylamino_{(C≤24)}, alkylthio_{(C≤24)}, arylthio_{(C≤24)}, alkylsulfonyl_{(C≤24)}, arylsulfonyl_{(C≤24)}, or a substituted version of any of these groups; or a group of the formula: —C(O)R₈, wherein R₈ is alkoxy_{(C≤12)}, alkylamino_{(C≤12)}, dialkylamino_{(C≤12)}, or a substituted version of any of these groups; a monovalent protected amine group, a divalent protected amine group, a protected hydroxy group, or a protected thio group. In some embodiments, R₁ is alkyl_{(C≤24)}, cycloalkyl_{(C≤24)}, aryl_{(C≤24)}, heteroaryl_{(C≤24)}, heterocycloalkyl_{(C≤24)}, a group of the formula: —C(O)R₈, wherein R₈ is alkoxy_{(C≤12)}, a monovalent protected amine group, a divalent protected amine group, a protected hydroxy group, a protected thio group, R₁ is —X₁—R₉, wherein X₁ is substituted alkanediyl_{(C≤12)} or a substituted version thereof; and R₉ is cycloalkyl_{(C≤24)}, aryl_{(C≤24)}, heteroaryl_{(C≤24)}, heterocycloalkyl_{(C≤24)}, alkoxy_{(C≤24)}, aryloxy_{(C≤24)}, aralkoxy_{(C≤24)}, acyl_{(C≤24)}, alkylamino_{(C≤24)}, dialkylamino_{(C≤24)}, alkylthio_{(C≤24)}, arylthio_{(C≤24)}, alkylsulfonyl_{(C≤24)}, arylsulfonyl_{(C≤24)}, or a substituted version of any of these groups; or a group of the formula: —C(O)R₈, wherein R₈ is alkoxy_{(C≤12)}, alkylamino_{(C≤12)}, dialkylamino_{(C≤12)}, or a substituted version of any of these groups; a monovalent protected amine group, a divalent protected amine group, a protected hydroxy group, or a protected thio group.

In still another aspect, the present disclosure provides compounds of the formula:

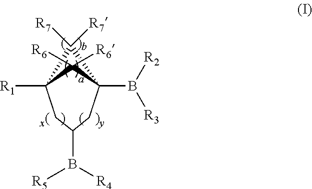

wherein:
a and b are each independently selected from 0, 1, 2, or 3;
x and y are each independently selected from 0, 1, 2, or 3;
R₁ is an organic moiety;
R₂, R₃, R₄, and R₅ are each hydroxy or R₂ and R₃ are taken together to form a B-containing heterocycloalkyl_{(C≤12)} or substituted B-containing heterocycloalkyl_{(C≤12)}; and
R₆, R₆′, R₇, and R₇′ are each independently hydrogen, alkyl_{(C≤12)}, or substituted alkyl_{(C≤12)}.

In some embodiments, the compound is not a compound of the formula:

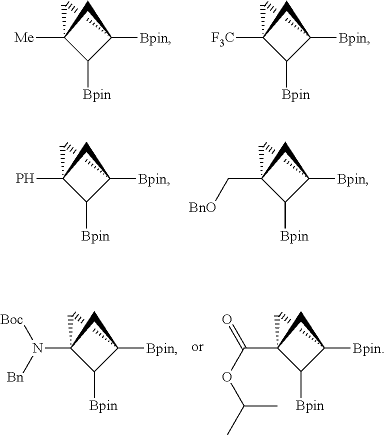

In some embodiments, R₁ is aralkoxy_{(C≤24)}, acyl_{(C≤24)}, alkylamino_{(C≤24)}, dialkylamino_{(C≤24)}, alkylthio_{(C≤24)}, arylthio_{(C≤24)}, alkylsulfonyl_{(C≤24)}, arylsulfonyl_{(C≤24)}, or a substituted version of any of these groups; or a group of the formula: —C(O)R₈, wherein R₈ is alkoxy_{(C≤12)}, alkylamino_{(C≤12)}, dialkylamino_{(C≤12)}, or a substituted version of any of these groups; a monovalent protected amine group, a divalent protected amine group, a protected hydroxy group, or a protected thio group; or —X₁—R₉, wherein X₁ is substituted alkanediyl_{(C≤12)}, cycloalkanediyl_{(C≤12)}, alkenediyl_{(C≤12)}, arenediyl_{(C≤12)}, heteroarenediyl_{(C≤12)}, heterocycloalkanediyl_{(C≤12)}, or a substituted version thereof; and R₉ is alkyl_{(C≤24)}, cycloalkyl_{(C≤24)}, alkenyl_{(C≤24)}, cycloalkenyl_{(C≤24)}, alkynyl_{(C≤24)}, cycloalkynyl_{(C≤24)}, aryl_{(C≤24)}, heteroaryl_{(C≤24)}, heterocycloalkyl_{(C≤24)}, alkoxy_{(C≤24)}, aryloxy_{(C≤24)}, aralkoxy_{(C≤24)}, acyl_{(C≤24)}, alkylamino_{(C≤24)}, dialkylamino_{(C≤24)}, alkylthio_{(C≤24)}, arylthio_{(C≤24)}, alkylsulfonyl_{(C≤24)}, arylsulfonyl_{(C≤24)}, or a substituted version of any of these groups; or a group of the formula: —C(O)R₈, wherein R₈ is alkoxy_{(C≤12)}, alkylamino_{(C≤12)}, dialkylamino_{(C≤12)}, or a substituted version of any of these groups; a monovalent protected amine group, a divalent protected amine group, a protected hydroxy group, or a protected thio group.

In some embodiments, R₁ is hydrogen, alkyl_{(C≤24)}, cycloalkyl_{(C≤24)}, alkenyl_{(C≤24)}, cycloalkenyl_{(C≤24)}, alkynyl_{(C≤24)}, cycloalkynyl_{(C≤24)}, aryl_{(C≤24)}, heteroaryl_{(C≤24)}, heterocycloalkyl_{(C≤24)}, alkoxy_{(C≤24)}, aryloxy_{(C≤24)}, aralkoxy_{(C≤24)}, acyl_{(C≤24)}, alkylamino_{(C≤24)}, dialkylamino_{(C≤24)}, alkylthio_{(C≤24)}, arylthio_{(C≤24)}, alkylsulfonyl_{(C≤24)}, arylsulfonyl_{(C≤24)}, or a substituted version of any of these groups.

In some embodiments, R₁ is a group of the formula: —C(O)R₈, wherein R₈ is alkoxy_{(C≤12)}, alkylamino_{(C≤12)}, dialkylamino_{(C≤12)}, or a substituted version of any of these groups. In other embodiments, R₁ is a monovalent protected amine group, a divalent protected amine group, a protected hydroxy group, or a protected thio group. In other embodiments, R₁ is —X₁—R₉, wherein X₁ is substituted alkanediyl_{(C≤12)}, cycloalkanediyl_{(C≤12)}, alkenediyl_{(C≤12)}, arenediyl_{(C≤12)}, heteroarenediyl_{(C≤12)}, heterocycloalkanediyl_{(C≤12)}, or a substituted version thereof; and R₉ is alkyl_{(C≤24)}, cycloalkyl_{(C≤24)}, alkenyl_{(C≤24)}, cycloalkenyl_{(C≤24)}, alkynyl_{(C≤24)}, cycloalkynyl_{(C≤24)}, aryl_{(C≤24)}, heteroaryl_{(C≤24)}, heterocycloalkyl_{(C≤24)}, alkoxy_{(C≤24)}, aryloxy_{(C≤24)}, aralkoxy_{(C≤24)}, acyl_{(C≤24)}, alkylamino_{(C≤24)}, dialkylamino_{(C≤24)}, alkylthio_{(C≤24)}, arylthio_{(C≤24)}, alkylsulfonyl_{(C≤24)}, arylsulfonyl_{(C≤24)}, or a substituted version of any of these groups; or a group of the formula: —C(O)R₈, wherein R₈ is alkoxy_{(C≤12)}, alkylamino_{(C≤12)}, dialkylamino_{(C≤12)}, or a substituted version of any of these groups; a monovalent protected amine group, a divalent protected amine group, a protected hydroxy group, or a protected thio group.

In some embodiments, R₁ is alkyl_{(C≤24)}, cycloalkyl_{(C≤24)}, aryl_{(C≤24)}, heteroaryl_{(C≤24)}, heterocycloalkyl_{(C≤24)}, a group of the formula: —C(O)R₈, wherein R₈ is alkoxy_{(C≤12)}, a monovalent protected amine group, a divalent protected amine group, a protected hydroxy group, a protected thio group, R₁ is —X₁—R₉, wherein X₁ is substituted alkanediyl_{(C≤12)} or a substituted version thereof; and R₉ is cycloalkyl_{(C≤24)}, aryl_{(C≤24)}, heteroaryl_{(C≤24)}, heterocycloalkyl_{(C≤24)}, alkoxy_{(C≤24)}, aryloxy_{(C≤24)}, aralkoxy_{(C≤24)}, acyl_{(C≤24)}, alkylamino_{(C≤24)}, dialkylamino_{(C≤24)}, alkylthio_{(C≤24)}, arylthio_{(C≤24)}, alkylsulfonyl_{(C≤24)}, arylsulfonyl_{(C≤24)}, or a substituted version of any of these groups; or a group of the formula: —C(O)R₈, wherein R₈ is alkoxy_{(C≤12)}, alkylamino_{(C≤12)}, dialkylamino_{(C≤12)}, or a substituted version of any of these groups; a monovalent protected amine group, a divalent protected amine group, a protected hydroxy group, or a protected thio group.

In some embodiments, R₂ and R₃ are a B-containing heterocycloalkyl_{(C≤12)} such as a pinacol boronic ester. In some embodiments, R₄ and R₅ are a B-containing heterocycloalkyl_{(C≤12)} such as a pinacol boronic ester. In some embodiments, R₆ is hydrogen. In some embodiments, R₆′ is hydrogen. In some embodiments, R₇ is hydrogen. In some embodiments, R₇′ is hydrogen. In some embodiments, the compounds are further defined as:

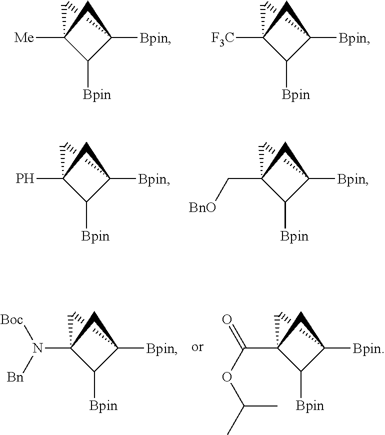

Other objects, features and advantages of the present disclosure will become apparent from the following detailed description. It should be understood, however, that the detailed description and the specific examples, while indicating specific embodiments of the disclosure, are given by way of illustration only, since various changes and modifications within the spirit and scope of the disclosure will become apparent to those skilled in the art from this detailed description. Note that simply because a particular compound is ascribed to one particular generic formula doesn't mean that it cannot also belong to another generic formula.

### BRIEF DESCRIPTION OF THE DRAWINGS

For a more complete understanding of the features and advantages of the present disclosure, reference is now made to the detailed description of the disclosure along with the accompanying figures and in which:

FIGS. 1A-1C show the introduction of BCP Bis-functionalization strategy. (FIG. 1A) Bicyclo[1.1.1]pentanes as benzene bioisosteric 3D-surrogates in drug discovery; (FIG. 1B) Structure-activity relationships (SARs) analysis with BCP scaffold; (FIG. 1C) Programmable and orthogonal functionalization of bridge-substituted BCPs.

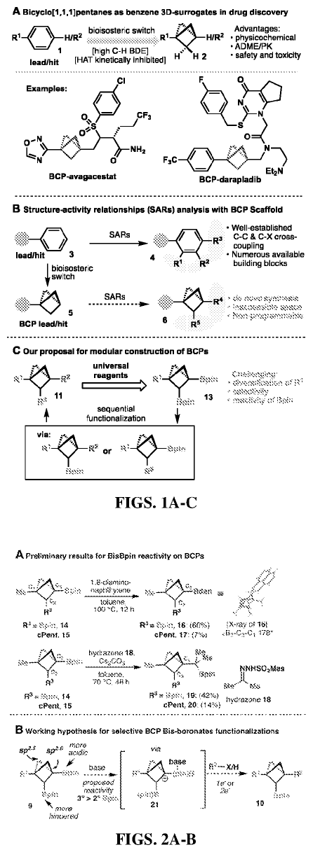

FIGS. 2A-2B show the preliminary Chemoselectivity of BCP bis-boronates and Theoretical Explanation. (FIG. 2A) Preliminary results for BCP bis-boronates reactivities. (FIG. 2B) Working hypothesis for selective BCP bis-boronates functionalizations.

FIG. 3 shows the representative synthesis route towards BCP 23 and BisBpin-substituted BCPs.

FIG. 4 shows the 1^{st} functionalization of BCP Bis-boronates. Reaction conditions: a) BCP BisBpin (1.0 equiv.), sulfonyl hydrazone (2.0 equiv.), Cs₂CO₃ (3.0 equiv.), toluene (0.2 M), 70° C., 18-48 h; b) BCP BisBpin (1.0 equiv.), TBC (2.5 equiv.), toluene (0.2 M), Ar or air atmosphere, 100° C., 2-12 h; c) BCP BisBpin (1.0 equiv.), 4-CzlPn (5 mol %), MeOBcat (30 mol %), acetone/MeOH (1:1, 0.1 M), blue LED, r.t., 2 h; d) BCP BisBpin (1.0 equiv.), TsCN (2.0 equiv.), TBC (20 mol %), toluene (0.2 M), 18 h; e) BCP BisBpin (1.0 equiv.), PhSO₂SPh or DBAD (2.0 equiv.), TBC (20 mol %), toluene (0.2 M), 70° C., 18-24 h; f) BCP BisBpin (1.0 equiv.), [Ir](5 mol %), DMAP (30 mol %), Michael acceptor (2.0 equiv.), acetone/MeOH (1:1, 0.1 M), blue LED, r.t., 24 h; g) BCP BisBpin (1.0 equiv.), 4-CzlPn (2-5 mol %), [Ni](10-20 mol %), ArBr (3.0 equiv.), Zn(OTf)₂ (2.0 equiv.), DMAP (4.0 equiv.), DMA (0.2 M), blue LED, r.t., 24-60 h; h) BCP BisBpin (1.0 equiv.), heteroarene (3.0 equiv.), Mn(OAc)₃ (2.5 equiv.), TFA (2.5 equiv.), AcOH/H₂O (1:1, 0.1 M), 50° C., 18 h. i. dr value is not determined; ii. 10 mmol scale; iii. 2.0 mmol scale; iv. 1.0 mmol scale; [Ir], (Ir[dF(CF₃)ppy]₂(dtbbpy))PF₆, [Ni], Ni(dtbbpy)Cl₂ or Ni(cod)₂+dtbbpy.

FIG. 5 shows the 2^{nd} functionalization of BCP Bis-boronates. Reaction conditions: A) BCP C2-Bpin (1.0 equiv.), PhLi (1.2 equiv.) THF (0.2 M), −78° C. to r.t., 1 h; then 4-CzlPn (5 mol %), tert-butyl acrylate (2.0 equiv.), THF/MeCN (0.1 M), blue LED, 15 h; B) BCP C2-Bpin (1.0 equiv.), PhLi (1.2 equiv.) THF (0.2 M), −78° C. to r.t., 1 h; then 4-CzlPn (5 mol %), Ni(dtbbpy)Cl₂ (10 mol %), ArBr (3.0 equiv.), THF/DMA (0.1 M), blue LED, 15 h; C) BCP C2-B(OH)₂ (1.0 equiv.), ArNO₂ (1.0 equiv.), 1,2,2,3,4,4-hexamethyl-phosphetane 1-oxide (15 mol %), PhSiH₃ (2.0 equiv.), m-xylene (0.5 M), 120° C., 8 h; D) BCP C2-BF₃K (1.0 equiv.), [Ir](5 mol %), Ni(dtbbpy)Cl2 (20 mol %), ArBr (5.0 equiv.), Cs₂CO₃ (6.0 equiv.), dioxane or THF (0.1 M), blue LED, 24 h; E) BCP C2-BF₃K (1.0 equiv.), heteroarene (3.0 equiv.), Mn(OAc)₃ (2.5 equiv.), TFA (2.5 equiv.), AcOH/H₂O (1:1, 0.1 M), 50° C., 18 h; See Experimental Procedures and Characterization Data of Substrates.

FIGS. 6A-6E shows the ball and stick X-ray diffraction structures.

### DESCRIPTION OF ILLUSTRATIVE EMBODIMENTS

In some aspects, the present disclosure provides methods of preparing sequential reaction of BCPs to obtain a BCPs substituted with 2 or 3 groups that have been orthogonally added to the BCP. These groups may be added starting from a bis-boronate that allows for the sequential reaction of the boronate at the tertiary position followed by a sequential reaction at a secondary position of the boronate there. These compounds allow higher yielding access to BCP derivatives than could be obtained through traditional methods. Furthermore, these methods provide simplified access to a wider array of compounds. Compounds for use in these method are also provided.

### I. COMPOUNDS OF THE PRESENT DISCLOSURE

The compounds of the present disclosure are shown, for example, above, in the summary of the invention section, and in the claims below. They may be made using the synthetic methods outlined in the Examples section. These methods can be further modified and optimized using the principles and techniques of organic chemistry as applied by a person skilled in the art. Such principles and techniques are taught, for example, in Smith, March's Advanced Organic Chemistry: Reactions, Mechanisms, and Structure, (2013), which is incorporated by reference herein. In addition, the synthetic methods may be further modified and optimized for preparative, pilot- or large-scale production, either batch or continuous, using the principles and techniques of process chemistry as applied by a person skilled in the art. Such principles and techniques are taught, for example, in Anderson, Practical Process Research & Development—A Guide for Organic Chemists (2012), which is incorporated by reference herein.

Compounds of the present disclosure may contain one or more asymmetrically-substituted carbon, sulfur, or phosphorus atom and may be isolated in optically active or racemic form. Thus, all chiral, diastereomeric, racemic form, epimeric form, and all geometric isomeric forms of a chemical formula are intended, unless the specific stereochemistry or isomeric form is specifically indicated. Compounds may occur as racemates and racemic mixtures, single enantiomers, diastereomeric mixtures and individual diastereomers. In some embodiments, a single diastereomer is obtained. The chiral centers of the compounds of the present disclosure can have the S or the R configuration. In some embodiments, the present compounds may contain two or more atoms which have a defined stereochemical orientation.

Chemical formulas used to represent compounds of the present disclosure will typically only show one of possibly several different tautomers. For example, many types of ketone groups are known to exist in equilibrium with corresponding enol groups. Similarly, many types of imine groups exist in equilibrium with enamine groups. Regardless of which tautomer is depicted for a given compound, and regardless of which one is most prevalent, all tautomers of a given chemical formula are intended.

In addition, atoms making up the compounds of the present disclosure are intended to include all isotopic forms of such atoms. Isotopes, as used herein, include those atoms having the same atomic number but different mass numbers. By way of general example and without limitation, isotopes of hydrogen include tritium and deuterium, and isotopes of carbon include ¹³C and ¹⁴C.

In some embodiments, compounds of the present disclosure exist in salt or non-salt form. With regard to the salt form(s), in some embodiments the particular anion or cation forming a part of any salt form of a compound provided herein is not critical, so long as the salt, as a whole, is pharmacologically acceptable. Additional examples of pharmaceutically acceptable salts and their methods of preparation and use are presented in Handbook of Pharmaceutical Salts: Properties, and Use (2002), which is incorporated herein by reference.

It will be appreciated that many organic compounds can form complexes with solvents in which they are reacted or from which they are precipitated or crystallized. These complexes are known as “solvates.” Where the solvent is water, the complex is known as a “hydrate.” It will also be appreciated that many organic compounds can exist in more than one solid form, including crystalline and amorphous forms. All solid forms of the compounds provided herein, including any solvates thereof are within the scope of the present disclosure.

### II. METHODS OF USE

The present disclosure relates to the use of the bis-BCPs to create di- and tri-substituted BCPs through traditional boronic acid based reaction techniques. These methods include a reduction to a hydrogen atom, oxidation to obtain a hydroxyl group or other oxygen containing groups, thiolation to install thio or mercapto containing groups, replacement of the boronic acid or ester with a halogen, an amination reaction to install an amine group, or a cross coupling reaction that forms one or more carbon-carbon bonds. A wide array of different carbon carbon bonding forming cross couplings are known including Suzuki, Chan-Lam, conjugate additions, a Giese alkylation, or a cross coupling with an heteroarene using the Minisci reaction. Many of these methods are catalyzed by one or more transition metal catalysts such as a Pd, Mn, Ni, Zn, or Ir catalyst. The compounds described herein may be transformed into a differentially modified BCP using these techniques in a sequential fashion with highly selectivity for each of the separate positions on the BCP.

### III. DEFINITIONS

When used in the context of a chemical group: “hydrogen” means —H; “hydroxy” means —OH; “oxo” means ═O; “carbonyl” means —C(═O)—; “carboxy” means —C(═O)OH (also written as —COOH or —CO₂H); “halo” means independently —F, —Cl, —Br or —I; “amino” means —NH₂; “hydroxyamino” means —NHOH; “nitro” means —NO₂; imino means=NH; “cyano” means —CN; “isocyanyl” means —N═C═O; “azido” means —N₃; in a monovalent context “phosphate” means —OP(O)(OH)₂ or a deprotonated form thereof; in a divalent context “phosphate” means —OP(O)(OH)O— or a deprotonated form thereof; “mercapto” means —SH; and “thio” means=S; “thiocarbonyl” means —C(═S)—; “sulfonyl” means —S(O)₂—; and “sulfinyl” means —S(O)—.

In the context of chemical formulas, the symbol “—” means a single bond, “═” means a double bond, and “≡” means triple bond. The symbol “----” represents an optional bond, which if present is either single or double. The symbol “ [symbol] ” represents a single bond or a double bond. Thus, the formula

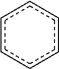

covers, for example,

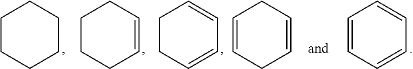

And it is understood that no one such ring atom forms part of more than one double bond. Furthermore, it is noted that the covalent bond symbol “—”, when connecting one or two stereogenic atoms, does not indicate any preferred stereochemistry. Instead, it covers all stereoisomers as well as mixtures thereof. The symbol “ [symbol] ”, when drawn perpendicularly across a bond (e.g.,

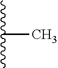

for methyl) indicates a point of attachment of the group. It is noted that the point of attachment is typically only identified in this manner for larger groups in order to assist the reader in unambiguously identifying a point of attachment. The symbol “ [symbol] ” means a single bond where the group attached to the thick end of the wedge is “out of the page.” The symbol “ [symbol] ” means a single bond where the group attached to the thick end of the wedge is “into the page”. The symbol “ [symbol] ” means a single bond where the geometry around a double bond (e.g., either E or Z) is undefined. Both options, as well as combinations thereof are therefore intended. Any undefined valency on an atom of a structure shown in this application implicitly represents a hydrogen atom bonded to that atom. A bold dot on a carbon atom indicates that the hydrogen attached to that carbon is oriented out of the plane of the paper.

When a variable is depicted as a “floating group” on a ring system, for example, the group “R” in the formula:

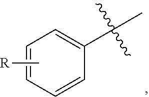

then the variable may replace any hydrogen atom attached to any of the ring atoms, including a depicted, implied, or expressly defined hydrogen, so long as a stable structure is formed. When a variable is depicted as a “floating group” on a fused ring system, as for example the group “R” in the formula:

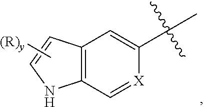

then the variable may replace any hydrogen attached to any of the ring atoms of either of the fused rings unless specified otherwise. Replaceable hydrogens include depicted hydrogens (e.g., the hydrogen attached to the nitrogen in the formula above), implied hydrogens (e.g., a hydrogen of the formula above that is not shown but understood to be present), expressly defined hydrogens, and optional hydrogens whose presence depends on the identity of a ring atom (e.g., a hydrogen attached to group X, when X equals —CH—), so long as a stable structure is formed. In the example depicted, R may reside on either the 5-membered or the 6-membered ring of the fused ring system. In the formula above, the subscript letter “y” immediately following the R enclosed in parentheses, represents a numeric variable. Unless specified otherwise, this variable can be 0, 1, 2, or any integer greater than 2, only limited by the maximum number of replaceable hydrogen atoms of the ring or ring system.

For the chemical groups and compound classes, the number of carbon atoms in the group or class is as indicated as follows: “Cn” or “C=n” defines the exact number (n) of carbon atoms in the group/class. “C≤n” defines the maximum number (n) of carbon atoms that can be in the group/class, with the minimum number as small as possible for the group/class in question. For example, it is understood that the minimum number of carbon atoms in the groups “alkyl_{(C≤8)}”, “alkanediyl_{(C≤8)}”, “heteroaryl_{(C≤8)}”, and “acyl_{(C≤8)}” is one, the minimum number of carbon atoms in the groups “alkenyl_{(C≤8)}”, “alkynyl_{(C≤8)}”, and “heterocycloalkyl_{(C≤8)}” is two, the minimum number of carbon atoms in the group “cycloalkyl_{(C≤8)}” is three, and the minimum number of carbon atoms in the groups “aryl_{(C≤8)}” and “arenediyl_{(C≤8)}” is six. “Cn-n′” defines both the minimum (n) and maximum number (n′) of carbon atoms in the group. Thus, “alkyl_{(C2-10)}” designates those alkyl groups having from 2 to 10 carbon atoms. These carbon number indicators may precede or follow the chemical groups or class it modifies and it may or may not be enclosed in parenthesis, without signifying any change in meaning. Thus, the terms “C₁₋₄-alkyl”, “C1-4-alkyl”, “alkyl_{(C1-4)}”, and “alkyl_{(C≤4)}” are all synonymous. Except as noted below, every carbon atom is counted to determine whether the group or compound falls with the specified number of carbon atoms. For example, the group dihexylamino is an example of a dialkylamino_{(C12)} group; however, it is not an example of a dialkylamino_{(C6)} group. Likewise, phenylethyl is an example of an aralkyl_{(C=8)} group. When any of the chemical groups or compound classes defined herein is modified by the term “substituted”, any carbon atom in the moiety replacing the hydrogen atom is not counted. Thus methoxyhexyl, which has a total of seven carbon atoms, is an example of a substituted alkyl_{(C1-6)}. Unless specified otherwise, any chemical group or compound class listed in a claim set without a carbon atom limit has a carbon atom limit of less than or equal to twelve.

The term “saturated” when used to modify a compound or chemical group means the compound or chemical group has no carbon-carbon double and no carbon-carbon triple bonds, except as noted below. When the term is used to modify an atom, it means that the atom is not part of any double or triple bond. In the case of substituted versions of saturated groups, one or more carbon oxygen double bond or a carbon nitrogen double bond may be present. And when such a bond is present, then carbon-carbon double bonds that may occur as part of keto-enol tautomerism or imine/enamine tautomerism are not precluded. When the term “saturated” is used to modify a solution of a substance, it means that no more of that substance can dissolve in that solution.

The term “aliphatic” signifies that the compound or chemical group so modified is an acyclic or cyclic, but non-aromatic compound or group. In aliphatic compounds/groups, the carbon atoms can be joined together in straight chains, branched chains, or non-aromatic rings (alicyclic). Aliphatic compounds/groups can be saturated, that is joined by single carbon-carbon bonds (alkanes/alkyl), or unsaturated, with one or more carbon-carbon double bonds (alkenes/alkenyl) or with one or more carbon-carbon triple bonds (alkynes/alkynyl).

The term “aromatic” signifies that the compound or chemical group so modified has a planar unsaturated ring of atoms with 4n+2 electrons in a fully conjugated cyclic π system. An aromatic compound or chemical group may be depicted as a single resonance structure; however, depiction of one resonance structure is taken to also refer to any other resonance structure. For example:

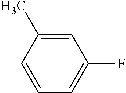

is also taken to refer to

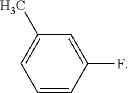

Aromatic compounds may also be depicted using a circle to represent the delocalized nature of the electrons in the fully conjugated cyclic π system, two non-limiting examples of which are shown below:

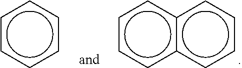

The term “alkyl” refers to a monovalent saturated aliphatic group with a carbon atom as the point of attachment, a linear or branched acyclic structure, and no atoms other than carbon and hydrogen. The groups —CH₃ (Me), —CH₂CH₃ (Et), —CH₂CH₂CH₃ (n-Pr or propyl), —CH(CH₃)₂ (i-Pr, ⁱPr or isopropyl), —CH₂CH₂CH₂CH₃ (n-Bu), —CH(CH₃)CH₂CH₃ (sec-butyl), —CH₂CH(CH₃)₂ (isobutyl), —C(CH₃)₃ (tert-butyl, t-butyl, t-Bu or ^{t}Bu), and —CH₂C(CH₃)₃ (neo-pentyl) are non-limiting examples of alkyl groups. The term “alkanediyl” refers to a divalent saturated aliphatic group, with one or two saturated carbon atom(s) as the point(s) of attachment, a linear or branched acyclic structure, no carbon-carbon double or triple bonds, and no atoms other than carbon and hydrogen. The groups —CH₂— (methylene), —CH₂CH₂—, —CH₂C(CH₃)₂CH₂—, and —CH₂CH₂CH₂— are non-limiting examples of alkanediyl groups. The term “alkylidene” refers to the divalent group ═CRR′ in which R and R′ are independently hydrogen or alkyl. Non-limiting examples of alkylidene groups include: ═CH₂, ═CH(CH₂CH₃), and ═C(CH₃)₂. An “alkane” refers to the class of compounds having the formula H—R, wherein R is alkyl as this term is defined above.

The term “cycloalkyl” refers to a monovalent saturated aliphatic group with a carbon atom as the point of attachment, said carbon atom forming part of one or more non-aromatic ring structures, no carbon-carbon double or triple bonds, and no atoms other than carbon and hydrogen. Non-limiting examples include: —CH(CH₂)₂ (cyclopropyl), cyclobutyl, cyclopentyl, or cyclohexyl (Cy). As used herein, the term does not preclude the presence of one or more alkyl groups (carbon number limitation permitting) attached to a carbon atom of the non-aromatic ring structure. The term “cycloalkanediyl” refers to a divalent saturated aliphatic group with two carbon atoms as points of attachment, no carbon-carbon double or triple bonds, and no atoms other than carbon and hydrogen. The group

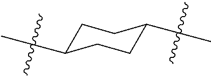 [SMILES: *C1CCC(*)CC1]

is a non-limiting example of cycloalkanediyl group. A “cycloalkane” refers to the class of compounds having the formula H—R, wherein R is cycloalkyl as this term is defined above.

The term “alkenyl” refers to a monovalent unsaturated aliphatic group with a carbon atom as the point of attachment, a linear or branched, acyclic structure, at least one nonaromatic carbon-carbon double bond, no carbon-carbon triple bonds, and no atoms other than carbon and hydrogen. Non-limiting examples include: —CH═CH₂ (vinyl), —CH═CHCH₃, —CH═CHCH₂CH₃, —CH₂CH═CH₂ (allyl), —CH₂CH═CHCH₃, and —CH═CHCH═CH₂. The term “alkenediyl” refers to a divalent unsaturated aliphatic group, with two carbon atoms as points of attachment, a linear or branched acyclic structure, at least one nonaromatic carbon-carbon double bond, no carbon-carbon triple bonds, and no atoms other than carbon and hydrogen. The groups —CH═CH—, —CH═C(CH₃)CH₂—, —CH═CHCH₂—, and —CH₂CH═CHCH₂— are non-limiting examples of alkenediyl groups. It is noted that while the alkenediyl group is aliphatic, once connected at both ends, this group is not precluded from forming part of an aromatic structure. The terms “alkene” and “olefin” are synonymous and refer to the class of compounds having the formula H—R, wherein R is alkenyl as this term is defined above. Similarly, the terms “terminal alkene” and “α-olefin” are synonymous and refer to an alkene having just one carbon-carbon double bond, wherein that bond is part of a vinyl group at an end of the molecule.

The term “alkynyl” refers to a monovalent unsaturated aliphatic group with a carbon atom as the point of attachment, a linear or branched acyclic structure, at least one carbon-carbon triple bond, and no atoms other than carbon and hydrogen. As used herein, the term alkynyl does not preclude the presence of one or more non-aromatic carbon-carbon double bonds. The groups —C≡CH, —C≡CCH₃, and —CH₂C≡CCH₃ are non-limiting examples of alkynyl groups. An “alkyne” refers to the class of compounds having the formula H—R, wherein R is alkynyl.

The term “aryl” refers to a monovalent unsaturated aromatic group with an aromatic carbon atom as the point of attachment, said carbon atom forming part of a one or more aromatic ring structures, each with six ring atoms that are all carbon, and wherein the group consists of no atoms other than carbon and hydrogen. If more than one ring is present, the rings may be fused or unfused. Unfused rings are connected with a covalent bond. As used herein, the term aryl does not preclude the presence of one or more alkyl groups (carbon number limitation permitting) attached to the first aromatic ring or any additional aromatic ring present. Non-limiting examples of aryl groups include phenyl (Ph), methylphenyl, (dimethyl)phenyl, —C₆H₄CH₂CH₃ (ethylphenyl), naphthyl, and a monovalent group derived from biphenyl (e.g., 4-phenylphenyl). The term “arenediyl” refers to a divalent aromatic group with two aromatic carbon atoms as points of attachment, said carbon atoms forming part of one or more six-membered aromatic ring structures, each with six ring atoms that are all carbon, and wherein the divalent group consists of no atoms other than carbon and hydrogen. As used herein, the term arenediyl does not preclude the presence of one or more alkyl groups (carbon number limitation permitting) attached to the first aromatic ring or any additional aromatic ring present. If more than one ring is present, the rings may be fused or unfused. Unfused rings are connected with a covalent bond. Non-limiting examples of arenediyl groups include:

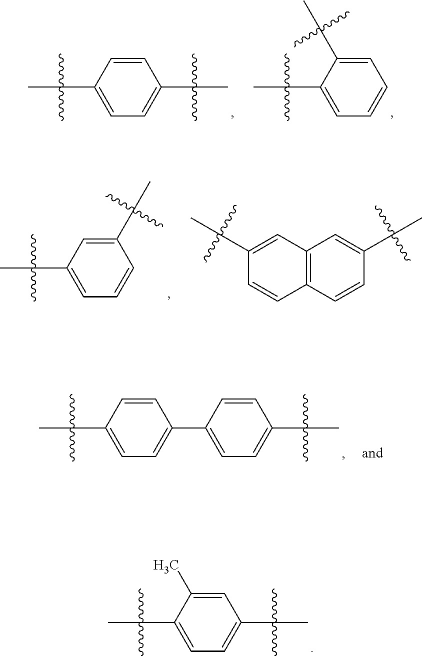

An “arene” refers to the class of compounds having the formula H—R, wherein R is aryl as that term is defined above. Benzene and toluene are non-limiting examples of arenes.

The term “aralkyl” refers to the monovalent group -alkanediyl-aryl, in which the terms alkanediyl and aryl are each used in a manner consistent with the definitions provided above. Non-limiting examples are: phenylmethyl (benzyl, Bn) and 2-phenyl-ethyl.

The term “heteroaryl” refers to a monovalent aromatic group with an aromatic carbon atom or nitrogen atom as the point of attachment, said carbon atom or nitrogen atom forming part of one or more aromatic ring structures, each with three to eight ring atoms, wherein at least one of the ring atoms of the aromatic ring structure(s) is nitrogen, oxygen or sulfur, and wherein the heteroaryl group consists of no atoms other than carbon, hydrogen, aromatic nitrogen, aromatic oxygen and aromatic sulfur. If more than one ring is present, the rings are fused; however, the term heteroaryl does not preclude the presence of one or more alkyl or aryl groups (carbon number limitation permitting) attached to one or more ring atoms. Non-limiting examples of heteroaryl groups include benzoxazolyl, benzimidazolyl, furanyl, imidazolyl (Im), indolyl, indazolyl, isoxazolyl, methylpyridinyl, oxazolyl, oxadiazolyl, phenylpyridinyl, pyridinyl (pyridyl), pyrrolyl, pyrimidinyl, pyrazinyl, quinolyl, quinazolyl, quinoxalinyl, triazinyl, tetrazolyl, thiazolyl, thienyl, and triazolyl. The term “N-heteroaryl” refers to a heteroaryl group with a nitrogen atom as the point of attachment. A “heteroarene” refers to the class of compounds having the formula H—R, wherein R is heteroaryl. Pyridine and quinoline are non-limiting examples of heteroarenes.

The term “heteroaralkyl” refers to the monovalent group -alkanediyl-heteroaryl, in which the terms alkanediyl and heteroaryl are each used in a manner consistent with the definitions provided above. Non-limiting examples are: pyridinylmethyl and 2-quinolinyl-ethyl.

The term “heterocycloalkyl” refers to a monovalent non-aromatic group with a carbon, nitrogen, or boron atom as the point of attachment, said carbon, nitrogen, or boron atom forming part of one or more non-aromatic ring structures, each with three to eight ring atoms, wherein at least one of the ring atoms of the non-aromatic ring structure(s) is nitrogen, oxygen, sulfur, or boron and wherein the heterocycloalkyl group consists of no atoms other than carbon, hydrogen, nitrogen, oxygen, sulfur, and boron. If more than one ring is present, the rings are fused. As used herein, the term does not preclude the presence of one or more alkyl groups (carbon number limitation permitting) attached to one or more ring atoms. Also, the term does not preclude the presence of one or more double bonds in the ring or ring system, provided that the resulting group remains non-aromatic. Non-limiting examples of heterocycloalkyl groups include aziridinyl, azetidinyl, pyrrolidinyl, piperidinyl, piperazinyl, morpholinyl, thiomorpholinyl, tetrahydrofuranyl, tetrahydrothiofuranyl, tetrahydropyranyl, pyranyl, oxiranyl, oxetanyl, 1,3,2-dioxaborolanyl, and 4,4,5,5-tetramethyl-1,3,2-dioxaborolanyl. The term “N-heterocycloalkyl” refers to a heterocycloalkyl group with a nitrogen atom as the point of attachment. N-pyrrolidinyl is an example of such a group. The term “B-heterocycloalkyl” refers to a heterocycloalkyl group with a boron atom as the point of attachment. 1,3,2-dioxaborolanyl and 4,4,5,5-tetramethyl-1,3,2-dioxaborolanyl are examples of such a group.

The term “acyl” refers to the group —C(O)R, in which R is a hydrogen, alkyl, cycloalkyl, or aryl as those terms are defined above. The groups, —CHO, —C(O)CH₃ (acetyl, Ac), —C(O)CH₂CH₃, —C(O)CH(CH₃)₂, —C(O)CH(CH₂)₂, —C(O)C₆H₅, and —C(O)C₆H₄CH₃ are non-limiting examples of acyl groups. A “thioacyl” is defined in an analogous manner, except that the oxygen atom of the group —C(O)R has been replaced with a sulfur atom, —C(S)R. The term “aldehyde” corresponds to an alkyl group, as defined above, attached to a —CHO group.

The term “alkoxy” refers to the group —OR, in which R is an alkyl, as that term is defined above. Non-limiting examples include: —OCH₃ (methoxy), —OCH₂CH₃ (ethoxy), —OCH₂CH₂CH₃, —OCH(CH₃)₂ (isopropoxy), or —OC(CH₃)₃ (tert-butoxy). The terms “cycloalkoxy”, “alkenyloxy”, “alkynyloxy”, “aryloxy”, “aralkoxy”, “heteroaryloxy”, “heterocycloalkoxy”, and “acyloxy”, when used without the “substituted” modifier, refers to groups, defined as —OR, in which R is cycloalkyl, alkenyl, alkynyl, aryl, aralkyl, heteroaryl, heterocycloalkyl, and acyl, respectively. The term “alkylthio” and “acylthio” refers to the group —SR, in which R is an alkyl and acyl, respectively. The term “alcohol” corresponds to an alkane, as defined above, wherein at least one of the hydrogen atoms has been replaced with a hydroxy group. The term “ether” corresponds to an alkane, as defined above, wherein at least one of the hydrogen atoms has been replaced with an alkoxy group.

The term “alkylamino” refers to the group —NHR, in which R is an alkyl, as that term is defined above. Non-limiting examples include: —NHCH₃ and —NHCH₂CH₃. The term “dialkylamino” refers to the group —NRR′, in which R and R′ can be the same or different alkyl groups. Non-limiting examples of dialkylamino groups include: —N(CH₃)₂ and —N(CH₃)(CH₂CH₃). The term “amido” (acylamino), when used without the “substituted” modifier, refers to the group —NHR, in which R is acyl, as that term is defined above. A non-limiting example of an amido group is —NHC(O)CH₃.

The term “alkylsilyl” refers to the group —Si(R)₃, in which R, R′, and R″ are alkyl, as that term is defined above, and R, R′, and R″ can be the same or different alkyl groups. Non-limiting examples include: —Si(CH₃)₃ and —Si(CH₃)₂C(CH₃)₃.

An “amine protecting group” or “amino protecting group” is well understood in the art. An amine protecting group is a group which modulates the reactivity of the amine group during a reaction which modifies some other portion of the molecule. Amine protecting groups can be found at least in Greene and Wuts, 1999, which is incorporated herein by reference. Some non-limiting examples of amino protecting groups include formyl, acetyl, propionyl, pivaloyl, t-butylacetyl, 2-chloroacetyl, 2-bromoacetyl, trifluoroacetyl, trichloroacetyl, o-nitrophenoxyacetyl, α-chlorobutyryl, benzoyl, 4-chlorobenzoyl, 4-bromobenzoyl, 4-nitrobenzoyl, and the like; sulfonyl groups such as benzenesulfonyl, p-toluenesulfonyl and the like; alkoxy- or aryloxycarbonyl groups (which form urethanes with the protected amine) such as benzyloxycarbonyl (Cbz), p-chlorobenzyloxycarbonyl, p-methoxybenzyloxycarbonyl, p-nitrobenzyloxycarbonyl, 2-nitrobenzyloxycarbonyl, p-bromobenzyloxycarbonyl, 3,4-dimethoxybenzyloxycarbonyl, 3,5-dimethoxybenzyloxycarbonyl, 2,4-dimethoxybenzyloxycarbonyl, 4-methoxybenzyloxycarbonyl, 2-nitro-4,5-dimethoxybenzyloxycarbonyl, 3,4,5-trimethoxybenzyloxycarbonyl, 1-(p-biphenylyl)-1-methylethoxycarbonyl, α,α-dimethyl-3,5-dimethoxybenzyloxycarbonyl, benzhydryloxycarbonyl, t-butyloxycarbonyl (Boc), diisopropylmethoxycarbonyl, isopropyloxycarbonyl, ethoxycarbonyl, methoxycarbonyl, allyloxycarbonyl (Alloc), 2,2,2-trichloroethoxycarbonyl, 2-trimethylsilylethyloxycarbonyl (Teoc), phenoxycarbonyl, 4-nitrophenoxycarbonyl, fluorenyl-9-methoxycarbonyl (Fmoc), cyclopentyloxycarbonyl, adamantyloxycarbonyl, cyclohexyloxycarbonyl, phenylthiocarbonyl and the like; alkylaminocarbonyl groups (which form ureas with the protect amine) such as ethylaminocarbonyl and the like; aralkyl groups such as benzyl, triphenylmethyl, benzyloxymethyl and the like; and silyl groups such as trimethylsilyl and the like. Additionally, the “amine protecting group” can be a divalent protecting group such that both hydrogen atoms on a primary amine are replaced with a single protecting group. In such a situation the amine protecting group can be phthalimide (phth) or a substituted derivative thereof wherein the term “substituted” is as defined above. In some embodiments, the halogenated phthalimide derivative may be tetrachlorophthalimide (TCphth). When used herein, a “protected amino group”, is a group of the formula PG_{MA}NH— or PG_{DA}N— wherein PG_{MA} is a monovalent amine protecting group, which may also be described as a “monovalently protected amino group” and PG_{DA} is a divalent amine protecting group as described above, which may also be described as a “divalently protected amino group”.

As used herein, a “chiral auxiliary” refers to a removable chiral group that is capable of influencing the stereoselectivity of a reaction. Persons of skill in the art are familiar with such compounds, and many are commercially available.

When a chemical group is used with the “substituted” modifier, one or more hydrogen atom has been replaced, independently at each instance, by —OH, —F, —Cl, —Br, —I, —NH₂, —NO₂, —CO₂H, —CO₂CH₃, —CO₂CH₂CH₃, —CN, —SH, —OCH₃, —OCH₂CH₃, —C(O)CH₃, —NHCH₃, —NHCH₂CH₃, —N(CH₃)₂, —C(O)NH₂, —C(O)NHCH₃, —C(O)N(CH₃)₂, —OC(O)CH₃, —NHC(O)CH₃, —S(O)₂OH, or —S(O)₂NH₂. For example, the following groups are non-limiting examples of substituted alkyl groups: —CH₂OH, —CH₂Cl, —CF₃, —CH₂CN, —CH₂C(O)OH, —CH₂C(O)OCH₃, —CH₂C(O)NH₂, —CH₂C(O)CH₃, —CH₂OCH₃, —CH₂OC(O)CH₃, —CH₂NH₂, —CH₂N(CH₃)₂, and —CH₂CH₂C1. The term “haloalkyl” is a subset of substituted alkyl, in which the hydrogen atom replacement is limited to halo (i.e. —F, —Cl, —Br, or —I) such that no other atoms aside from carbon, hydrogen and halogen are present. The group, —CH₂Cl is a non-limiting example of a haloalkyl. The term “fluoroalkyl” is a subset of substituted alkyl, in which the hydrogen atom replacement is limited to fluoro such that no other atoms aside from carbon, hydrogen and fluorine are present. The groups —CH₂F, —CF₃, and —CH₂CF₃ are non-limiting examples of fluoroalkyl groups. Non-limiting examples of substituted aralkyls are: (3-chlorophenyl)-methyl, and 2-chloro-2-phenyl-eth-1-yl. The groups, —C(O)CH₂CF₃, —CO₂H (carboxyl), —CO₂CH₃ (methylcarboxyl), —CO₂CH₂CH₃, —C(O)NH₂ (carbamoyl), and —CON(CH₃)₂, are non-limiting examples of substituted acyl groups. The groups —NHC(O)OCH₃ and —NHC(O)NHCH₃ are non-limiting examples of substituted amido groups.

The use of the word “a” or “an,” when used in conjunction with the term “comprising” in the claims and/or the specification may mean “one,” but it is also consistent with the meaning of “one or more,” “at least one,” and “one or more than one.”

Throughout this application, the term “about” is used to indicate that a value includes the inherent variation of error for the device, the method being employed to determine the value, or the variation that exists among the study subjects or patients. When used in the context of X-ray powder diffraction, the term “about” is used to indicate a value of ±0.2°2θ from the reported value, preferably a value of ±0.1°2θ from the reported value. When used in the context of differential scanning calorimetry or glass transition temperatures, the term “about” is used to indicate a value of ±10° C. relative to the maximum of the peak, preferably a value of ±2° C. relative to the maximum of the peak. When used in other contexts, the term “about” is used to indicate a value of ±10% of the reported value, preferably a value of ±5% of the reported value. It is to be understood that, whenever the term “about” is used, a specific reference to the exact numerical value indicated is also included.”

The terms “comprise,” “have” and “include” are open-ended linking verbs. Any forms or tenses of one or more of these verbs, such as “comprises,” “comprising,” “has,” “having,” “includes” and “including,” are also open-ended. For example, any method that “comprises,” “has” or “includes” one or more steps is not limited to possessing only those one or more steps and also covers other unlisted steps.

The terms “comprise,” “have” and “include” are open-ended linking verbs. Any forms or tenses of one or more of these verbs, such as “comprises,” “comprising,” “has,” “having,” “includes” and “including,” are also open-ended. For example, any method that “comprises,” “has” or “includes” one or more steps is not limited to possessing only those one or more steps and also covers other unlisted steps.

The term “effective,” as that term is used in the specification and/or claims, means adequate to accomplish a desired, expected, or intended result. The above definitions supersede any conflicting definition in any reference that is incorporated by reference herein. The fact that certain terms are defined, however, should not be considered as indicative that any term that is undefined is indefinite. Rather, all terms used are believed to describe the invention in terms such that one of ordinary skill can appreciate the scope and practice the present invention.

The term “hydrate” when used as a modifier to a compound means that the compound has less than one (e.g., hemihydrate), one (e.g., monohydrate), or more than one (e.g., dihydrate) water molecules associated with each compound molecule, such as in solid forms of the compound.

An “isomer” of a first compound is a separate compound in which each molecule contains the same constituent atoms as the first compound, but where the configuration of those atoms in three dimensions differs.

“Pharmaceutically acceptable salts” means salts of compounds disclosed herein which are pharmaceutically acceptable, as defined above, and which possess the desired pharmacological activity. Such salts include acid addition salts formed with inorganic acids such as hydrochloric acid, hydrobromic acid, sulfuric acid, nitric acid, phosphoric acid, and the like; or with organic acids such as 1,2-ethanedisulfonic acid, 2-hydroxyethanesulfonic acid, 2-naphthalenesulfonic acid, 3-phenylpropionic acid, 4,4′-methylenebis(3-hydroxy-2-ene-1-carboxylic acid), 4-methylbicyclo[2.2.2]oct-2-ene-1-carboxylic acid, acetic acid, aliphatic mono- and dicarboxylic acids, aliphatic sulfuric acids, aromatic sulfuric acids, benzenesulfonic acid, benzoic acid, camphorsulfonic acid, carbonic acid, cinnamic acid, citric acid, cyclopentanepropionic acid, ethanesulfonic acid, fumaric acid, glucoheptonic acid, gluconic acid, glutamic acid, glycolic acid, heptanoic acid, hexanoic acid, hydroxynaphthoic acid, lactic acid, laurylsulfuric acid, maleic acid, malic acid, malonic acid, mandelic acid, methanesulfonic acid, muconic acid, o-(4-hydroxybenzoyl)benzoic acid, oxalic acid, p-chlorobenzenesulfonic acid, phenyl-substituted alkanoic acids, propionic acid, p-toluenesulfonic acid, pyruvic acid, salicylic acid, stearic acid, succinic acid, tartaric acid, tertiarybutylacetic acid, trimethylacetic acid, and the like. Pharmaceutically acceptable salts also include base addition salts which may be formed when acidic protons present are capable of reacting with inorganic or organic bases. Acceptable inorganic bases include sodium hydroxide, sodium carbonate, potassium hydroxide, aluminum hydroxide and calcium hydroxide. Acceptable organic bases include ethanolamine, diethanolamine, triethanolamine, tromethamine, N-methylglucamine and the like. It should be recognized that the particular anion or cation forming a part of any salt of this invention is not critical, so long as the salt, as a whole, is pharmacologically acceptable. Additional examples of pharmaceutically acceptable salts and their methods of preparation and use are presented in Handbook of Pharmaceutical Salts: Properties, and Use (P. H. Stahl & C. G. Wermuth eds., Verlag Helvetica Chimica Acta, 2002).

A “stereoisomer” or “optical isomer” is an isomer of a given compound in which the same atoms are bonded to the same other atoms, but where the configuration of those atoms in three dimensions differs. “Enantiomers” are stereoisomers of a given compound that are mirror images of each other, like left and right hands. “Diastereomers” are stereoisomers of a given compound that are not enantiomers. Chiral molecules contain a chiral center, also referred to as a stereocenter or stereogenic center, which is any point, though not necessarily an atom, in a molecule bearing groups such that an interchanging of any two groups leads to a stereoisomer. In organic compounds, the chiral center is typically a carbon, phosphorus or sulfur atom, though it is also possible for other atoms to be stereocenters in organic and inorganic compounds. A molecule can have multiple stereocenters, giving it many stereoisomers. In compounds whose stereoisomerism is due to tetrahedral stereogenic centers (e.g., tetrahedral carbon), the total number of hypothetically possible stereoisomers will not exceed 2ⁿ, where n is the number of tetrahedral stereocenters. Molecules with symmetry frequently have fewer than the maximum possible number of stereoisomers. A 50:50 mixture of enantiomers is referred to as a racemic mixture. Alternatively, a mixture of enantiomers can be enantiomerically enriched so that one enantiomer is present in an amount greater than 50%. Typically, enantiomers and/or diastereomers can be resolved or separated using techniques known in the art. It is contemplated that that for any stereocenter or axis of chirality for which stereochemistry has not been defined, that stereocenter or axis of chirality can be present in its R form, S form, or as a mixture of the R and S forms, including racemic and non-racemic mixtures. As used herein, the phrase “substantially free from other stereoisomers” means that the composition contains ≤15%, more preferably ≤10%, even more preferably ≤5%, or most preferably ≤1% of another stereoisomer(s).

The above definitions supersede any conflicting definition in any reference that is incorporated by reference herein. The fact that certain terms are defined, however, should not be considered as indicative that any term that is undefined is indefinite. Rather, all terms used are believed to describe the invention in terms such that one of ordinary skill can appreciate the scope and practice the present invention.

### IV. EXAMPLES

The following examples are included to demonstrate preferred embodiments of the disclosure. It should be appreciated by those of skill in the art that the techniques disclosed in the examples which follow represent techniques discovered by the inventor to function well in the practice of the disclosure, and thus can be considered to constitute preferred modes for its practice. However, those of skill in the art should, in light of the present disclosure, appreciate that many changes can be made in the specific embodiments which are disclosed and still obtain a like or similar result without departing from the spirit and scope of the disclosure.

### Example 1: Boronate Ligand Exchange Reaction

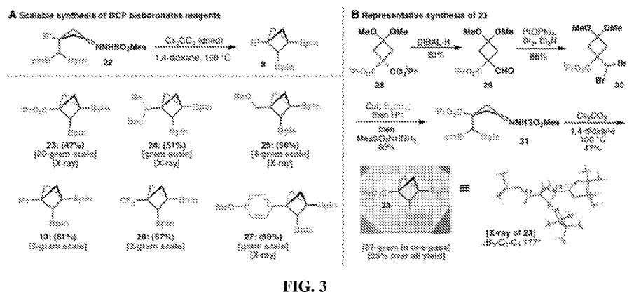

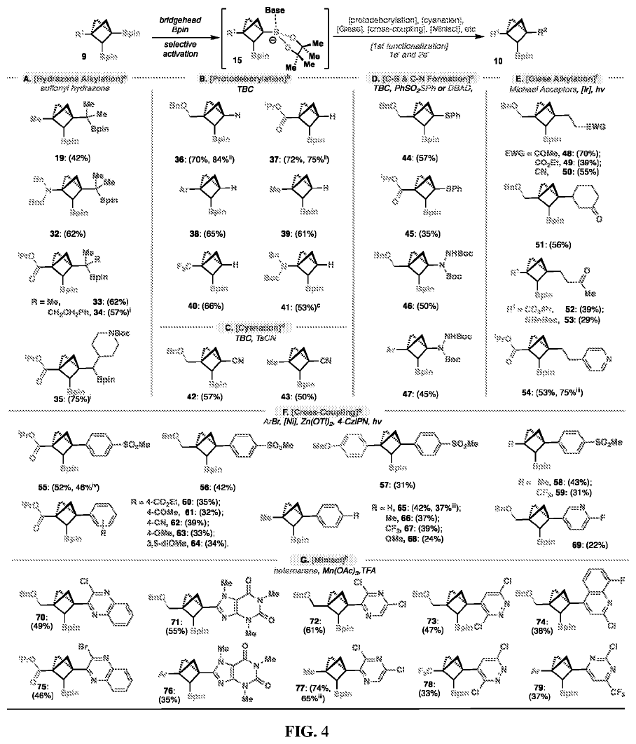

The striking reactivity difference between these two Bpin units of BCP 14 was initially observed in the boronate ligand exchange reaction (FIG. 2A). Under treatment of naphthalene-1,8-diamine in toluene, selective formation of bridgehead Bdan-substituted product 16 was initially identified by NMR analysis and then later confirmed by X-ray diffraction. In comparison, the C2 cyclopentyl-substituted BCP 15 provided the corresponding product in significantly lower-yield (17, 7%). Without being bound by theory, this chemoselectivity was also observed in the hydrazone coupling (Yang et al., 2021a). The bridgehead C₃-Bpin in bis-boronates presented an activated reactivity and underwent coupling with sulfonyl hydrazone while C₂-Bpin in bis-boronates and BCP 15 was mostly retained (FIG. 2A). Without being bound by theory, it was initially hypothesized that, as noted by Morken (Mlynarski et al., 2014) and others (Nóvoa et al., 2021; Kaiser et al., 2019; Fawcett et al., 2016), that selective activation at the C₃ position in this bis-boronate system is likely due to intramolecular coordination (e.g., oxygen lone pair-boron interaction) of the Bpin at the C₂ position. However, careful analysis of B₃—C₃-C₁ angles of these BCPs X-ray structures (vide infra; see FIG. 3), revealed no obvious initial interaction between the two adjacent Bpin groups in the BCP scaffolds, presumably, though without being bound by theory, a consequence of this strained bicyclic scaffold which restricts the relative spatial positioning of these groups (FIG. 2A).

### Example 2: Synthesis and Reactions of BCP Bis-Boronates

The advantages of the strategy disclosed herein to access bridge-substituted BCPs not only draws from its modularity, but also is reinforced by the synthetic efficacy and practicality with which various BCP bis-boronates can be prepared. In a previous study (Yang et al., 2021b), the alkyl substituted BCP bis-boronate (14) was synthesized from readily accessible starting materials on gram scale and in moderate yield (FIG. 3A). However, during present attempts to synthesize the carboxylate ester, trifluoromethyl and aryl substituted BCP bis-boronates, this synthetic pathway was found to be is plagued by the challenging access to geminal bisBpin precursors (yield <5%) and diminished yield in intramolecular cyclization. Gratifyingly, these BCPs were successfully accessed (23, 24, 25) through crucial modifications including the diborylation of geminal dibromo compounds (Yang et al., 2011) (instead of sulfonylhydrazone)(Li et al., 2012), and intramolecular cyclization under “dry” conditions (pre-preparation of sulfonylhydrazone, dry solvent and base). As an example, synthesis of ester C₁-substituted BCP 23 (FIG. 3B) started from an affordable cyclobutyl diester 28. The cyclobutyl sulfonylhydrazone 31 was generated in high yields through a sequence of DIBAL-H reduction, debromination and diborylation. The following dried-Cs₂CO₃-mediated cyclization robustly afforded 23 on 40-gram scale in a single pass without deterioration of yield. Notably, all the synthesized BCP bis-boronates were stable crystalline solids and were able to be stored without any noticeable degradation for several months at −20° C.

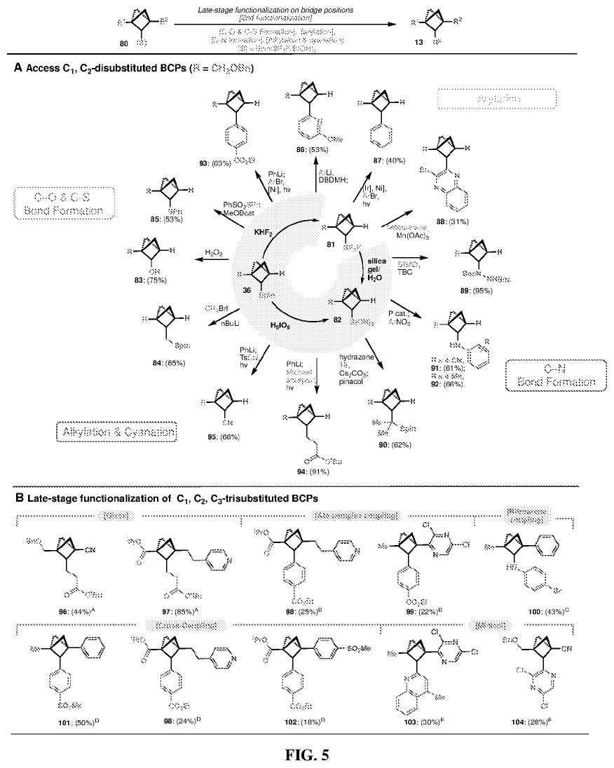

With a variety of BCP bis-boronates in hand, the selective deborylative alkylation, protonation and (hetero)arylation of the bridgehead C₃ Bpin (FIG. 4) was investigated. Consistent with theoretical assessment of the model reaction (vide supra), the increased reactivity of the bridgehead (C₃) Bpin was found to be compatible for the coupling between BCP bis-boronates and sulfonylhydrazone (Yang et al., 2021b) (FIG. 4A, 19, 32-35). It is worth noting that conventional alkyl Bpins were incompatible with this hydrazone coupling (Yang et al., 2021a). Further, since ortho- and meta-disubstituted benzenes are some of the most prevalent structural units in small molecule drugs/drug candidates, their bioisosteric 1,2-disubstituted BCPs are highly desired motifs by medicinal chemists. A selective C₁-protodeborylation of BCP bis-boronates, thereby affording C₂-Bpin substituted BCPs and providing a modular tool to enable efficient access a library of diverse disubstituted BCPs via late-stage functionalization, an essential feature of productive SAR campaigns (FIG. 4B), was sought. A selective protodeborylation at the C₁ position of BCP bis-boronates was pursued. (Pozzi et al., 2005; Renaud et al., 2020) Similar to the boronate ligand exchange (vide supra), selective protodeborylation could be achieved by simply heating a solution of the BCP bis-boronates and tert-butyl catechol (TBC) in toluene under an argon atmosphere to afford C₁, C₂-disubstituted BCPs (36, 38, 39) in good yields. Radical initiators such as Et³B and Lewis acids were found to be detrimental to the reaction (Renaud et al., 2020). For the BCP bisboronates containing electron-withdrawing group at C₁ position such as 37 and 40, protodeborylation proceeded smoothly in air to motivate initialization. However, despite efforts otherwise, the protodeborylation method with TBC was not compatible with nitrogen substituted BCP (41), where only decomposition of stating material was observed. Alternatively, a photosensitized protodeborylation approach was developed to access the C₂-Bpin substituted BCP with amine at bridgehead position (Kim et al., 2020). Besides abstracting hydrogen from TBC, the selectively-generated BCP-bridgehead radicals could also be trapped with other coupling reagents such as tosyl cyanide (TsCN), PhSO₂SPh, and di-tert-butyl azodicarboxylate (DBAD), which afforded nitrile- (42, 43), thioether- (44, 45) and hydrazide- (46, 47) containing BCPs in moderate yields (FIGS. 4C & 4D). Selective Giese reactions (48-54) were also productive using conditions established by Ley's and co-workers (Lima et al., 2017; Lima et al., 2018), where an ate complex was formed with DMAP and underwent a photoinduced oxidation to generate a bridgehead carbon-centered radical (FIG. 4E). Radical capture with a Ni(II) complex followed by Ni-catalyzed cross coupling reactions with aryl bromide (Mousseau et al., 2022; Denisenko et al., 2020; Joseph et al., 2021; Zhao et al., 2021; Ma et al., 2020) was then attempted. However, desired products were not observed with all the previously reported conditions of Ni-catalyzed cross coupling (Lima et al., 2016; Tellis et al., 2014; Gutierrez et al., 2015; Primer & Molander, 2017; Yuan et al., 2020). Through screening efforts, a photosensitized method was developed with 4-CzlPn as the photosensitizer and Zn(OTf)₂ was identified as a key Lewis acid additive to observe the proposed reactivity, where arylbromoides with diverse electronic properties were well tolerated, producing bridgehead-coupled aryl BCPs in moderate yields. (55-69, FIG. 4F). Minisci reactivities (Molander et al., 2011) could also be achieved with selective introduction of a series of heteroarenes including quinoxaline (70, 75), caffeine (71, 76), pyrazine (72, 77), pyridazine (73, 78), quinoline (74) and pyrimidine (79) and moderate to good yields of the products were afforded (FIG. 4G).

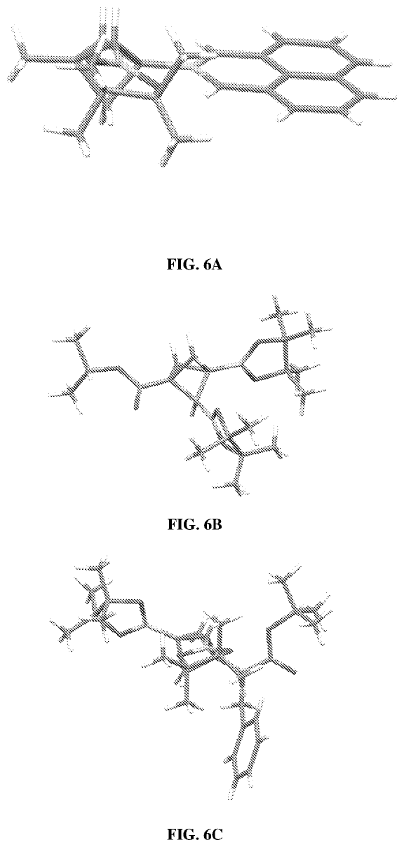

The derivatization of BCP C₂-Bpins was explored to demonstrate broad applications of a sequential functionalization strategy for the late-stage synthesis of C₁, C₂-di-(FIG. 5A) and C₁, C₂, C₃-tri-substituted BCPs (FIG. 5B). In comparison with conventional secondary boronic esters, BCP C₂-boronates were found to exhibit inferior reactivity owing to a combination of specific hybridization (Jarret & Cusumano, 1990) changing C—H bond energy at the C₂ bridge position and steric hinderance (Wiberg & Williams, 1970). Such challenges were also observed by unsuccessful efforts in Pd-catalyzed Suzuki-Miyaura cross-coupling and Chan-Lam reaction at C₂ position. Fortunately, attempts to leverage BCP 36 in C—O and C—S formation proved successful, as demonstrated in oxidation (83) and Renaud's radical trapping (Renaud et al., 2020) (84), Aggarwal's arylation (86) (Odachowski et al., 2016) and Ni-catalyzed ‘ate’complex coupling (93) (Kaiser et al., 2019) with PhLi from boronate 36, Molander's photo-induced cross-coupling (87) (Tellis et al., 2014; Gutierrez et al., 2015; Primer & Molander, 2017; Yuan et al., 2020), and Minisci-type heteroarylation (88) (Molander et al., 2011) from trifluorobororate salt 81 that enabled the installation of aryl and heteroaryl groups at the bridge (C₂) position. TBC-mediated C—N formation afforded hydrazine (89) (Renaud et al., 2020) in 95% yield and amination with nitroarene using Radosevich's protocol afforded anilines (91, 92) (Nykaza et al., 2018) in moderate yields. Matteson homologation (85) (Sadhu et al., 1985), Giese-type alkylation (94) and cyanation (95) via ‘ate’ complex (Kaiser et al., 2019) using PhLi from boronate 36 and sulfonyl hydrazone coupling (90) (Yang et al., 2021a) of boronic acid (82) afforded CH₂ insertion, alkylation and cyanation product on the BCP motif in moderate to high yields. To further demonstrate the potential of BCP bis-boronates as a versatile building block, a series of structurally diverse trisubstituted BCPs were accessed through a C₃-C₂ functionalization sequence. Representatives of bridgehead disubstituted BCP C₂-Bpin (42, 54, 55, 65, 77) enabled employment of Bpin functionalization strategies, including Giese-type alkylation (96, 97), arylation (98, 99, 101, 102), amination (100) and heteroarylation (103, 104), furnishing low to moderate yields of desired product, emphasizing, without being bound by theory, the effect that steric hinderance from substituents at C₃-position has on the efficiency of these transformations.

### Example 3: Synthesis and Characterization

### A. General Experimental

Tetrahydrofuran (THF), diethyl ether (Et₂O), toluene and dichloromethane (CH₂Cl₂) were obtained by passing the previously degassed solvents through an activated alumina column. Dioxane and reagents were purchased at the highest commercial quality and used without further purification. All of the rest of the reagents were purchased from BLD Pharmatech Co., Sigma-Aldrich, TCI, Synthonix and/or Combi-Blocks and used without further purification. Yields refer to chromatographically and spectroscopically (¹H NMR) homogeneous material. Reactions were monitored by GC-MS (Rtx-5MS, 30 m, 0.25 mm ID, 0.25 μm), GC-FID (SH-Rxi-5Sil MS, 30 m, 0.25 mm ID, 0.25 m), LC/MS, and thin layer chromatography (TLC). TLC was performed using 0.25 mm E. Merck silica plates (60F-254), using short-wave UV light as the visualizing agent, and phosphomolybdic acid and CAM (H₂SO₄, ammonium molybdate and ceric ammonium sulfate), or KMnO₄ and heat as developing agents. NMR spectra were recorded on Bruker Ascend-600 spectrometers, Varian Inova-400 spectrometers and Bruker Ascend-400 spectrometers instruments and are calibrated using residual undeuterated solvent (CHCl₃ at 7.26 ppm ¹H NMR, 77.16 ppm ¹³C NMR; acetone at 2.05 ppm ¹H NMR, 29.84, 206.26 ppm ¹³C NMR; DMSO at 2.50 ppm ¹H NMR, 39.52 ppm ¹³C NMR; methanol at 3.31 ppm ¹H NMR, 49.00 ppm ¹³C NMR). The following abbreviations were used to explain multiplicities: s=singlet, d=doublet, t=triplet, q=quartet, m=multiplet, br=broad. ¹³C signals adjacent to boron are generally not observed due to quadrupolar relaxation. Column chromatography was performed using E. Merck silica (60, particle size 0.043-0.063 mm), and preparative TLC was performed on Merck silica plates (60F-254). Melting points were recorded on a Fisher Scientific™ melting point apparatus (12-144) and are uncorrected. Optical rotation data was recorded on a JAS DIP-360 digital polarimeter. Multi-gram Scale Preparation of BCP BisBoronates

Decagram-Scale Synthesis of BCP BisBoronates 23 (R¹═C₂ⁱPr)

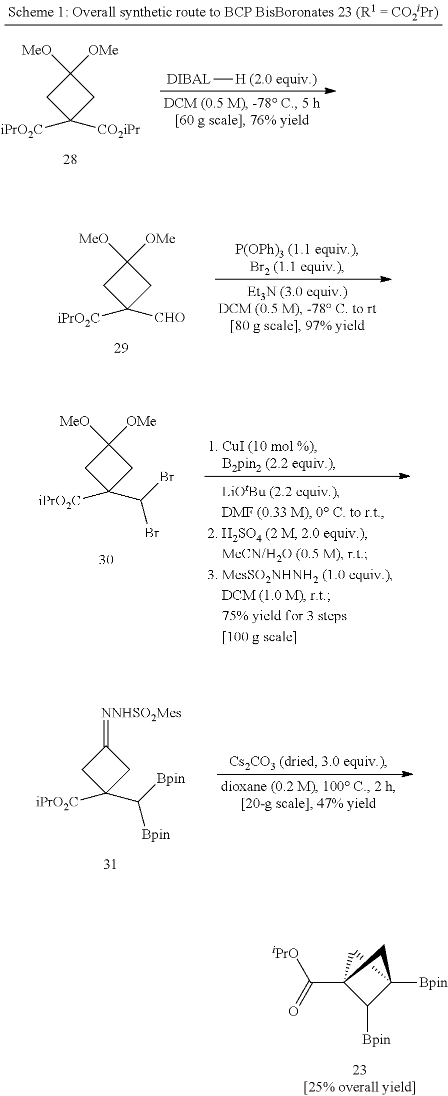

### Step 1: Synthesis of Compound 29

A 2-L three-necked (24/40 joint) round-bottomed flask, equipped with a 6.4 cm Teflon-coated magnetic stir bar, was flame-dried under vacuum, and then cooled to 23° C. under an atmosphere of argon. Then the flask was charged with diisopropyl 3,3-dimethoxycyclobutane-1,1-dicarboxylate, compound 28, (103.8 g, 360 mmol, 1.0 equiv.). Methylene chloride (720 mL) was added into the flask and the mixture was cooled in a dried ice-acetone bath (−78° C.) and stirred for 15 minutes. Next a solution of DIBAL-H (720 mL, 1 M in hexanes, 2.0 equiv., pre-cooled at −78° C.) was added dropwise into the flask through a dropping funnel at −78° C. in 2 hours and the mixture was allowed to stir at −78° C. for another 3 hours. After it was confirmed that the starting material, 28, was consumed through TLC analysis, the reaction was quenched at −78° C. with methanol (24 mL, 720 mmol, 2.0 equiv.). After the reaction was slowly warmed to room temperature, water (29 mL), 20% NaOH (29 mL) and water (72 mL) was slowly added into the reaction mixture in sequence and the mixture was allowed to stir for another 30 minutes. Next, excess Na₂SO₄ was added to dry the reaction mixture and the suspension was filtered through Celite. Solvents was removed under vacuum and the crude product was purified through flash chromatography (hexanes:ethyl acetate, 5:1) on silica gel to afford 63 g (76%) of the title compound 29 (Yang et al., 2021b). Spectroscopic data of the product 29 matches that reported in the literature. (Yang et al., 2021b).

### Step 2: Synthesis of Compound 30

A 2-L three-necked (24/40 joint) round-bottomed flask, equipped with a 6.4 cm Teflon-coated magnetic stir bar, was flame-dried under vacuum, and then cooled to 23° C. under an atmosphere of argon. Then the flask was charged with triphenyl phosphite (78 mL, 300 mmol, 1.1 equiv.). Methylene chloride (340 mL) was added into the flask and the mixture was cooled to −78° C. Then bromine (15 mL, 300 mmol, 1.1 equiv.) was added slowly into the flask, followed by addition of triethyl amine (140 mL, 1.0 mol, 3.3 equiv.). (Note: a suspension of the mixture was formed.) Next, the solution of 29 (63 g, 270 mmol, 1.0 equiv.) in 160 mL methylene chloride was added into the mixture and the reaction was warmed up to room temperature. After it was confirmed that the starting material, 29, was consumed through TLC analysis, solvent was removed by rotary evaporator and the crude product was purified through flash chromatography (hexanes:ethyl acetate, 20:1) on silica gel to afford 87 g (97%) of the title compound 30 (Hazrati & Oestreich, 2018).

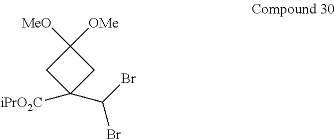

### isopropyl 1-(dibromomethyl)-3,3-dimethoxycyclobutane-1-carboxylate (30)

Physical State: colorless oil. ¹H NMR (600 MHz, CDCl₃): δ 6.03 (s, 1H), 5.10 (hept, J=6.3 Hz, 1H), 3.16 (s, 3H), 3.15 (s, 3H), 2.72-2.66 (m, 2H), 2.48-2.42 (m, 2H), 1.28 (d, J=6.3 Hz, 6H) ppm. ¹³C NMR (151 MHz, CDCl₃) δ 170.41, 96.85, 69.77, 49.87, 48.79, 48.75, 48.57, 40.13, 21.74. ppm. MS (GCMS, EI): m/z=345 (1.5%), 343 (3%), 341 (1.5%), 255 (8%), 201 (29%), 88 (100%). TLC: R_{f}=0.32 (10:1 hexanes:ethyl acetate).

### Step 3: Synthesis of Compound 31

A 2-L one-necked (24/40 joint) round-bottomed flask, equipped with a 6.4 cm Teflon-coated magnetic stir bar, was flame-dried under vacuum, and then cooled to 23° C. under an atmosphere of argon. Then the flask was charged with copper(I) iodide (4.88 g, 25.6 mmol, 0.1 equiv.), B₂pin₂ (140 g, 550 mmol, 2.2 equiv.), and lithium tert-butoxide (44.0 g, 550 mmol, 2.2 equiv.). After being evacuated and backfilled with argon from a balloon 3 times, DMF (500 mL) was added into the flask at 0° C. Then a solution of compound 30 (256 mmol, 95.6 g, 1.0 equiv.) in DMF (250 mL) was added slowly into the mixture at 0° C. in 15 minutes and the reaction mixture was allowed to slowly warm to room temperature and stir for another 1 hour. After it was confirmed that the starting material, 30, was consumed through TLC analysis, the reaction was filtered through Celite, washed with diethyl ether (200 mL) and quenched at 0° C. with water (500 mL) (Caution: the quenching process is exothermic). The mixture was transferred into a 6-L flask and diluted with water (1.5 L) and diethyl ether (300 mL). After the mixture was stirred for 30 minutes at room temperature, the two-phase solution was transferred into a 3-L separation funnel. The aqueous phase was separated and extracted with two 200-mL portions of diethyl ether. The combined organic layers were washed with the mixture of 200 mL water and 200 mL saturated NaCl solution twice, dried over Na₂SO₄, and filtered through Celite. (Yang et al., 2011).

After solvent was removed by rotary evaporator, the crude product was redissolved in 250 mL acetonitrile in a 1-L flask. 2M H₂SO₄ (256 mL, 2.0 equiv.) was added into the mixture at room temperature and the reaction was allowed to stir for another 1.5 hours. After it was confirmed that the ketal intermediate was consumed through TLC analysis, the crude reaction was concentrated to remove excess acetonitrile. Then diethyl ether (400 mL) and saturated brine (150 mL) was added to the reaction mixture and the mixture was transferred to a 1-L separatory funnel. The aqueous layer was separated and further extracted with diethyl ether (3×150 mL). The combined organic layers were dried over Na₂SO₄, filtered through Celite. Excess solvent was removed by rotary evaporator.

The crude product was redissolved in 250 mL methylene chloride in a 500 mL-flask and mesitylene sulfonyl hydrazide (54.9 g, 256 mmol, 1.0 equiv.) was added. The mixture was allowed to stir at room temperature for another 2 hours. After it was confirmed that the ketone intermediate was consumed through TLC analysis, the crude reaction was concentrated to remove excess solvent. The crude product was purified through flash chromatography (hexanes:ethyl acetate, 4:1 to 2:1) on silica gel to afford 116 g (73%) of the title compound 31. (Yang et al., 2021b).

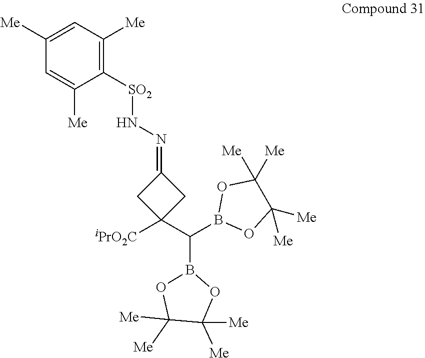

### Isopropyl 1-(bis(4,4,5,5-tetramethyl-1,3,2-dioxaborolan-2-yl)methyl)-3-(2-(mesitylsulfonyl)-hydrazineylidene)cyclobutane-1-carboxylate (31)

Physical State: white solid. m.p.: 85-87° C. ¹H NMR (600 MHz, Acetone-d₆) δ 9.17 (s, 1H), 7.02 (s, 2H), 4.90 (hept, J=6.2 Hz, 1H), 3.23 (ddd, J=17.6, 3.3, 1.7 Hz, 1H), 3.12 (dt, J=17.0, 2.5 Hz, 1H), 3.05-2.98 (m, 1H), 2.94 (ddd, J=17.1, 3.4, 1.5 Hz, 1H), 2.65 (s, 6H), 2.28 (s, 3H), 1.22 (s, 1H), 1.19 (d, J=6.3 Hz, 3H), 1.18 (d, J=6.6 Hz, 3H), 1.17 (s, 6H), 1.16 (s, 6H), 1.13 (s, 12H) ppm. ¹³C NMR (151 MHz, Acetone-d₆) δ 176.43, 154.40, 143.07, 140.75, 134.85, 132.46, 83.83, 83.78, 68.79, 45.17, 43.93, 40.62, 25.18, 25.06, 24.74, 23.44, 21.80, 21.76, 20.85 ppm.

¹¹B NMR (128 MHz, CDCl₃): δ 32.98 ppm. HRMS (ESI-TOF): calc'd for C₃₀H₄₈B₂N₂O₈S [M+H]⁺: 619.3390, found: 619.3402. TLC: R_{f}=0.30 (3:1 hexanes:ethyl acetate).

### Step 4: Synthesis of 23

A 1-L one-necked (24/40 joint) round-bottomed flask, equipped with a 6.4 cm Teflon-coated magnetic stir bar, was flame-dried under vacuum, and then cooled to 23° C. under an atmosphere of argon. Then the flask was charged with 31 (61.8 g, 100 mmol, 1.0 equiv.) and dried cesium carbonate (100 g, 300 mmol, 3.0 equiv.). (Note: Cesium carbonate was dried at 120° C. under vacuum for 18 hours.) After being evacuated and backfilled with argon from a balloon 3 times, dioxane (500 mL) was added into the flask and the reaction mixture was allowed to stir at 100° C. for 40 minutes. After it was confirmed that the starting material, 31, was consumed through TLC analysis, the reaction was cooled to room temperature, filtered through Celite, washed with hexanes (500 mL), and concentrated to remove excess solvents. The crude reaction was purified through flash chromatography (hexanes:ethyl acetate, 10:1) on silica gel to afford the title compound 23, which was further purified through trituration in hexanes at −40° C. affording 19.0 g product (47% yield) with >99% purity as white solids. (Yang et al., 2021b).

Trituration procedure: The product (around 21 g) after chromatography was dissolved in hexanes (10 mL) at room temperature and then cooled to −40° C. After the solution of the product was slowly stirred at −40° C. for 1 h, the suspension was filtered and the white solid was washed with cooled hexanes (5 mL) quickly and dried under vacuum for 1 hour.

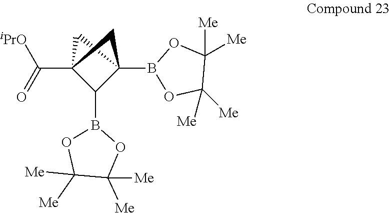 [SMILES: CC(C)OC(=O)[C@]12C[C@](B3OC(C)(C)C(C)(C)O3)(C1)C2B1OC(C)(C)C(C)(C)O1]

### isopropyl 2,3-bis(4,4,5,5-tetramethyl-1,3,2-dioxaborolan-2-yl)bicyclo[1.1.1]pentane-1-carboxylate (23)

Physical State: white solid. m.p.: 41-43° C. ¹H NMR (600 MHz, CDCl₃): δ 4.93 (hept, J=6.3 Hz, 1H), 2.71 (dd, J=9.4, 2.3 Hz, 1H), 2.14-2.08 (m, 2H), 2.03 (dd, J=8.1, 2.2 Hz, 1H), 1.88 (dd, J=8.2, 0.9 Hz, 1H), 1.22 (s, 12H), 1.21 (s, 6H), 1.20 (s, 6H), 1.19 (d, J=2.9 Hz, 3H), 1.18 (d, J=3.0 Hz, 3H) ppm. ¹³C NMR (151 MHz, CDCl₃) δ 169.49, 83.55, 83.10, 67.44, 55.81, 50.75, 44.87, 24.89, 24.87, 24.84, 24.79, 21.93 ppm. ¹¹B NMR (128 MHz, CDCl₃): δ 31.18 ppm. MS (GCMS, EI): m/z=391 (0.2%), 363 (0.3%), 348 (1%), 305 (1%), 164 (30%), 83 (100%). TLC: R_{f}=0.32 (5:1 hexanes:ethyl acetate).

### Gram-Scale Synthesis of BCP BisBoronates 24 (R¹=NBnBoc)

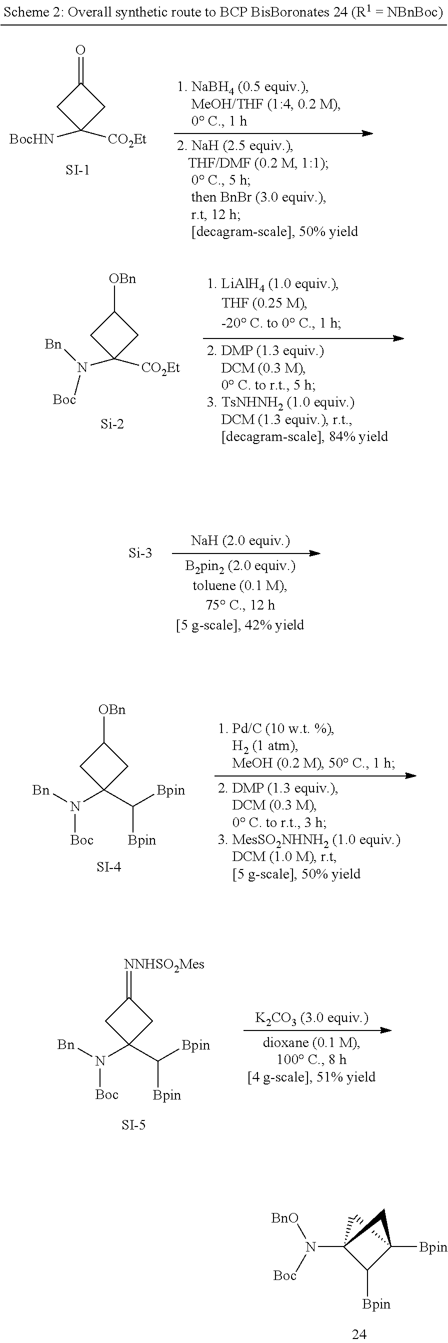

### Step 1: Synthesis of SI-2.

A flame-dried round-bottom flask charged with ethyl 1-([(tert-butoxy)carbonyl]amino)-3-oxocyclobutane-1-carboxylate, SI-1 (25 g, 100 mmol, 1.0 equiv.) dissolved in THF/methanol (500 mL, 4:1) was cooled to 0° C. Then NaBH₄ (1.9 g, 50 mmol, 0.5 equiv.) was added slowly to the mixture at 0° C. and the reaction was allowed to stir at the same temperature for 1 h. After it was confirmed that the starting material, SI-1, was consumed totally, the reaction was quenched by water (1.0 mL). After excess solvent was removed, the mixture was diluted with ethyl acetate (200 mL) and water (200 mL) and transferred into a 1-L separatory funnel. The aqueous layer was separated and further extracted with ethyl acetate (3×100 mL). The combined organic layers were dried over Na₂SO₄, filtered through Celite. Excess solvent was removed by rotary evaporator. The crude alcohol was used without further purification.

The crude alcohol was dissolved in THF/DMF (500 mL, 1:1) and the mixture was cooled to 0° C. NaH (10.0 g, 250 mmol, 2.5 equiv.) was added slowly to the reaction at 0° C. and the mixture was warmed to room temperature and stirred for 3 hours. After there were no bubbles being released, benzyl bromide (36 mL, 300 mmol, 3.0 equiv.) was added to the reaction at 0° C. and the mixture was allowed to stir at room temperature for around 12 hours. After it was confirmed that the alcohol intermediate was consumed totally, water (5.4 mL) was added to quench the reaction. Excess solvent was removed by rotary evaporator and the mixture was diluted with water (500 mL) and diethyl ether (200 mL) and then transferred into a 1-L separation funnel. The aqueous phase was separated and extracted with two 100-mL portions of diethyl ether. The combined organic layers were washed with the mixture of 100 mL water and 100 mL saturated NaCl solution twice, dried over Na₂SO₄, and filtered through Celite. The crude product was purified through flash chromatography (hexanes:ethyl acetate, 4:1) on silica gel to afford 21.9 g (50%) of the title compound SI-2.

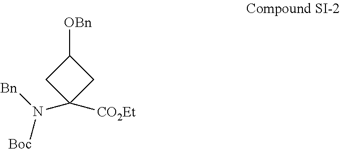 [SMILES: CCOC(=O)C1(N(Cc2ccccc2)C(=O)OC(C)(C)C)CC(OCc2ccccc2)C1]

### ethyl 1-(benzyl(tert-butoxycarbonyl)amino)-3-(benzyloxy)cyclobutane-1-carboxylate (SI-2)

Note: 1H NMR showed the presence of diastereoisomers and rotamers.

Physical State: yellow oil. ¹H NMR (600 MHz, CDCl₃): δ 7.31-7.14 (m, 10H), 4.49 (brs, 2H), 4.17 (brs, 2H), 4.12-4.06 (m, 2H), 3.65 (brs, 1H), 2.52 (brs, 4H), 1.35 (s, 9H). 1.24-1.13 (m, 3H) ppm. Note: The complexity of the 1H NMR is attributed to the diastereomerism and rotating isomerism. HRMS (ESI-TOF): calc'd for C₂₆H₃₃NO₅ [M+H]⁺: 440.2432, found: 440.2428.

TLC: R_{f}=0.68 (3:1 hexanes:ethyl acetate).

### Step 2: Synthesis of SI-3.

A flame-dried round-bottom flask charged with SI-2 (11.5 g, 25 mmol, 1.0 equiv.) dissolved in THF (100 mL) was cooled to −20° C. LiAlH₄ (1.0 g, 26 mmol, 1.05 equiv.) was added slowly to the solution at −20° C. and the reaction was allowed to warm to room temperature and stir at 0° C. for 1 hour. After it was confirmed that SI-2 was consumed totally, the reaction was quenched at 0° C. with water (1.0 mL), followed by 20% NaOH (1.0 mL) and water (3.0 mL) and the mixture was stirred at 0° C. for 30 min. Then excess Na₂SO₄ was added, and the suspended solution was stirred at room temperature for another 1 hour. The mixture was filtered through Celite, and the solvent was removed under high vacuum. The crude alcohol was used without further purification.

The crude alcohol was redissolved in methylene chloride (75 mL) and Dess-Martin periodinane (13.8 g, 32.5 mmol, 1.3 equiv.) was added to mixture at 0° C. The reaction was allowed to warm to room temperature and stir for 2 hours. After it was confirmed that the alcohol intermediate was consumed totally, the reaction was quenched by excess saturated NaHCO₃ solution and Na₂S₂O₃ solution and extracted with methylene chloride (100 mL) three times. The organic phase was separated, washed with brine, dried over Na₂SO₄ and evaporated. The crude aldehyde was used without further purification.

The aldehyde was dissolved in 25 ml methylene chloride and then p-toluenesulfonyl hydrazide (5.2 g, 27.5 mmol, 1.1 equiv.) was added. The mixture was allowed to stir at room temperature for another 1 hours. After it was confirmed that the aldehyde was consumed through TLC analysis, the crude reaction was concentrated to remove excess solvent. The crude product was purified through flash chromatography (hexanes:ethyl acetate, 3:1) on silica gel to afford 12.0 g (85%) of the title compound SI-3.

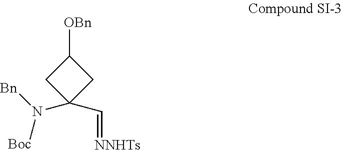

### tert-butylbenzyl(3-(benzyloxy)-1-((2-tosylhydrazineylidene)methyl)cyclobutyl)carbamate

(SI-3) Note: 1H NMR showed the presence of diastereoisomers (1/0.4) and trans/cis isomers. The 1H NMR of the main isomer is given.

Physical State: yellow oil. ¹H NMR (600 MHz, Acetone-d⁶): δ 9.81 (s, 1H), 7.76 (d, J=8.3 Hz, 2H), 7.58 (s, 1H), 7.38-7.14 (m, 12H), 4.25 (s, 2H), 4.15 (s, 2H), 3.87 (tt, J=7.0, 4.2 Hz, 1H), 2.58 (dd, J=13.7, 6.9 Hz, 2H), 2.34 (s, 3H), 2.29 (dd, J=13.8, 4.1 Hz, 2H), 1.31 (s, 9H) ppm.

HRMS (ESI-TOF): calc'd for C₃₁H₃₇N₃O₅S [M+Na]⁺: 586.2346, found: 586.2344. TLC: R_{f}=0.32 (3:1 hexanes:ethyl acetate).

### Step 3: Synthesis of SI-4

A dry round-bottom flask charged with SI-3 (12.0 g, 21 mmol, 1.0 equiv.), 60% NaH (1.68 g, 42 mmol, 2.0 equiv.) and B₂pin₂ (10.6 g, 42 mmol, 2.0 equiv.) was degassed and filled with argon three times. Toluene (210 mL) was added, and the mixture was heated at 75° C. for 5 h. After it was confirmed that the starting material SI-3 was consumed totally, the reaction was cooled to room temperature and the suspension was filtered by Celite and washed by diethyl ether (200 mL). After solvent was removed by rotary evaporator from the filtrate, the crude product was purified by flash chromatography (hexanes:ethyl acetate, 4:1) on silica gel to afford 5.3 g (42%) of the title compound SI-4. (Li et al., 2012)

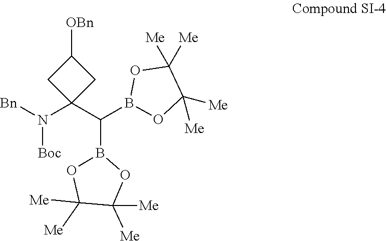 [SMILES: CC(C)(C)OC(=O)N(Cc1ccccc1)C1(C(B2OC(C)(C)C(C)(C)O2)B2OC(C)(C)C(C)(C)O2)CC(OCc2ccccc2)C1]

### tert-butyl benzyl(3-(benzyloxy)-1-(bis(4,4,5,5-tetramethyl-1,3,2-dioxaborolan-2-yl)methyl)cyclo butyl)carbamate (SI-4)

Note: the main isomer was isolated and characterized.

Physical State: white solid. m.p.: 99-101° C. ¹H NMR (600 MHz, CDCl₃): δ 7.25-7.04 (m, 10H), 4.59 (s, 2H), 4.07 (s, 2H), 3.48-3.33 (m, 1H), 2.69-2.63 (m, 2H), 2.36-2.28 (m, 2H), 2.09 (s, 1H), 1.38 (s, 9H), 1.17 (s, 12H), 1.17 (s, 12H) ppm. ¹³C NMR (151 MHz, CDCl₃) δ 140.90, 138.80, 128.37, 128.22, 127.92, 127.81, 127.29, 126.44, 126.40, 83.18, 69.66, 68.77, 49.84, 28.64, 25.05, 24.88 ppm. Note: BC, NC, NCH₂ and Me₃C were not observed. ¹¹B NMR (128 MHz, CDCl₃): δ 30.66 ppm. HRMS (ESI-TOF): calc'd for C₃₆H₅₃B₂NO₇ [M+H]⁺: 634.4081, found: 634.4096. TLC: R_{f}=0.68 (3:1 hexanes:ethyl acetate).

### Step 4: Synthesis of SI-5

A dry round-bottom flask was charged with SI-4 (7 g, 11 mmol, 1.0 equiv.) and Pd/C (10 w.t. %, 350 mg) and methanol (70 mL) was added then. The flask was then degassed and refilled with hydrogen three times. The reaction mixture was heated at 50° C. for 2 h. After it was confirmed that the starting material, SI-4, was consumed totally, the mixture was cooled to room temperature, filtered through Celite and concentrated. The crude alcohol was used without further purification.

The crude alcohol was redissolved in methylene chloride (40 mL) and Dess-Martin periodinane (6.4 g, 15 mmol, 1.3 equiv.) was added to mixture at 0° C. The reaction was allowed to warm to room temperature and stir for 2 hours. After it was confirmed that the alcohol intermediate was consumed totally, the reaction was quenched by excess saturated Na₂CO₃ solution and Na₂S₂O₃ solution and extracted with methylene chloride (50 mL) three times. The organic phase was separated, washed with brine, dried over Na₂SO₄ and evaporated. The crude ketone was used without further purification.

The ketone was dissolved in 25 mL methylene chloride and then mesitylsulfonyl hydrazide (2.6 g, 12 mmol, 1.1 equiv.) was added. The mixture was allowed to stir at room temperature for another 3-5 hours. After it was confirmed that the aldehyde was consumed through TLC analysis, the crude reaction is concentrated to remove excess solvent. The crude product was purified through flash chromatography (hexanes:ethyl acetate, 3:1) on silica gel to afford 4.48 g (55%) of the title compound SI-5.

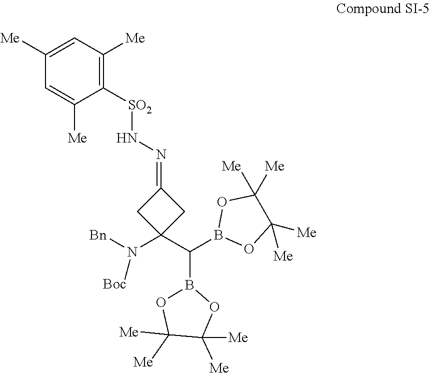 [SMILES: Cc1cc(C)c(S(=O)(=O)NN=C2CC(C(B3OC(C)(C)C(C)(C)O3)B3OC(C)(C)C(C)(C)O3)(N(Cc3ccccc3)C(=O)OC(C)(C)C)C2)c(C)c1]

### tert-butyl benzyl(1-(bis(4,4,5,5-tetramethyl-1,3,2-dioxaborolan-2-yl)methyl)-3-(2-(mesityl sulfonyl)hydrazineylidene)cyclobutyl)carbamate (SI-5)

Physical State: white solid. m.p.: 161-163° C. ¹H NMR (600 MHz, Acetone-d₆): δ 9.08 (s, 1H), 7.27 (t, J=7.6 Hz, 2H), 7.22-7.15 (m, 3H), 6.98 (s, 2H), 4.71-4.52 (m, 2H), 3.28-3.01 (m, 4H), 2.57 (s, 6H), 2.28 (s, 3H), 2.10 (s, 1H), 1.55-1.29 (m, 9H), 1.25-1.12 (m, 24H) ppm.

¹³C NMR (151 MHz, Acetone-d₆): δ 142.98, 141.79, 140.73, 140.71, 135.00, 134.96, 132.44, 129.24, 127.21, 126.32, 84.09, 84.03, 50.70, 28.53, 25.21, 25.04, 25.01, 24.96, 23.43, 20.85 ppm. Note: BC, NC, NCH₂ and Me₃C were not observed. ¹¹B NMR (128 MHz, CDCl₃): δ 37.71 ppm. HRMS (ESI-TOF): calc'd for C₃₈H₅₇B₂N₃O₈S [M+H]⁺: 738.4125, found: 738.4148.

TLC: R_{f}=0.40 (3:1 hexanes:ethyl acetate).

### Step 5: Synthesis of 24

A 250-mL one-necked (24/40 joint) round-bottomed flask, equipped with a Teflon-coated magnetic stir bar, was flame-dried under vacuum, and then cooled to 23° C. under an atmosphere of argon. Then the flask was charged with SI-5 (4.48 g, 6 mmol, 1.0 equiv.) and dried potassium carbonate (2.76 g, 20 mmol, 3.3 equiv.). (Note: Potassium carbonate was ground and dried at 120° C. under vacuum for 18 hours.) After being evacuated and backfilled with argon from a balloon 3 times, dioxane (60 mL) was added into the flask and the reaction mixture was allowed to stir at 105° C. for 8 hours. After it was confirmed that the starting material, SI-5, was consumed through TLC analysis, the reaction was cooled to room temperature, filtered through Celite, washed with diethyl ether (200 mL), and concentrated to remove excess solvents. The crude reaction was purified through flash chromatography (hexanes:ethyl acetate, 6:1) on silica gel to afford the title compound 24, which was further purified through trituration in hexanes at −40° C. affording 1.8 g product (57% yield) with >99% purity as white solids. (Yang et al., 2021b) Trituration procedure: The product (around 2.5 g) after chromatography was dissolved in hexanes (2.0 mL) at room temperature and then cooled to −40° C. After the solution of the product was slowly stirred at −40° C. for 40 minutes, the suspension was filtered and the white solid was washed with cooled hexanes (1.0 mL) quickly and dried under vacuum for 1 hour.

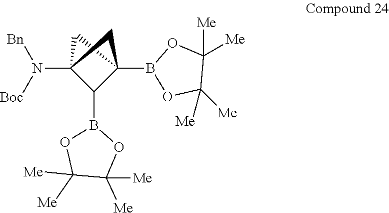 [SMILES: CC(C)(C)OC(=O)N(Cc1ccccc1)[C@]12C[C@](B3OC(C)(C)C(C)(C)O3)(C1)C2B1OC(C)(C)C(C)(C)O1]

### tert-butyl benzyl(2,3-bis(4,4,5,5-tetramethyl-1,3,2-dioxaborolan-2-yl)bicyclo[1.1.1]pentan-1-yl)carbamate (24)

Physical State: white solid. m.p.: 89-91° C. ¹H NMR (600 MHz, CDCl₃): δ 7.29-7.12 (m, 5H), 4.47 (brs, 2H), 2.56 (s, 1H), 2.12 (dd, J=9.5, 1.4 Hz, 1H), 2.06-1.97 (m, 3H), 1.47 (s, 9H), 1.21 (s, 12H), 1.20 (s, 12H) ppm. ¹³C NMR (151 MHz, CDCl₃) δ 140.12, 128.26, 126.92, 126.51, 83.48, 83.07, 52.68, 48.28, 28.69, 25.00, 24.95, 24.84, 24.81 ppm. Note: NC(O), NC, NCH2, Me3C and BC were not observed. ¹¹B NMR (128 MHz, CDCl₃): δ 30.94 ppm. HRMS (ESI-TOF): calc'd for C₂₉H₄₆B₂NO₆ [M+H]⁺: 526.3506, found: 526.3518. TLC: R_{f}=0.68 (3:1 hexanes:ethyl acetate).

Gram-Scale Synthesis of BCP BisBoronates 25 (R¹=CH₂OBn)

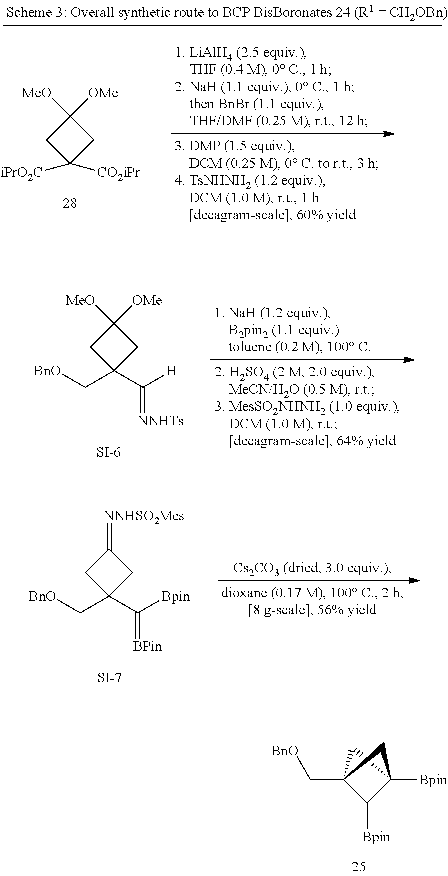

### Step 1: Synthesis of SI-6

To a solution of diisopropyl 3,3-dimethoxycyclobutane-1,1-dicarboxylate, 28, (115.2 g, 400 mmol, 1.0 equiv.) in dried THF (1.0 L) was added LiAlH₄ (38 g, 1.0 mmol, 2.5 equiv.) at 0° C. The mixture was allowed to warm up to room temperature and stirred for 3 hours. After it was confirmed that the start material, SI-6, was totally consumed, water (38 mL) was slowly added at 0° C., followed by 20% w.t. NaOH (38 mL) and water (95 mL), and the mixture was stirred at 0° C. for 30 min. Then excess Na₂SO₄ was added, and the suspended solution was stirred at room temperature for another 1 hour. The mixture was filtered through Celite and the solvent was removed under high vacuum. The crude alcohol was used without further purification. The crude yield (90% from 28) was calculated by ¹H NMR with dibromomethane as inner standard.

To a solution of the crude alcohol in THE/DMF (800 mL, 1:1) was added NaH (16.0 g, 400 mmol, 1.0 equiv.) slowly at 0° C. (Caution: Hydrogen was released.) After the reaction was stirred for 1 hour at room temperature, benzyl bromide (52 mL, 440 mmol, 1.1 equiv.) was added and the mixture was allowed to stir for 12 hours at room temperature. After it was confirmed that the diol intermediate was totally consumed, the reaction was quenched with water (10 mL) at 0′° C. Excess solvent was removed by rotary evaporator and the mixture was diluted with water (500 mL) and diethyl ether (200 mL) and then transferred into a 1-L separation funnel. The aqueous phase was separated and extracted with two 200-mL portions of diethyl ether. The combined organic layers were washed with the mixture of 200 mL water and 200 mL saturated NaCl solution twice, dried over Na₂SO₄, and filtered through Celite. The crude yield (75% from 28) was calculated by ¹H NMR with dibromomethane as inner standard.

After solvent was removed by rotary evaporator, the crude product was redissolved in methylene chloride (1.0 L) and Dess-Martin periodinane (153.5 g, 360 mmol, 0.9 equiv.) was added to mixture at 0° C. The reaction was allowed to warm to room temperature and stir for 2 hours. After it was confirmed that the alcohol intermediate was consumed totally, the reaction was quenched by excess saturated Na₂CO₃ solution and Na₂S₂O₃ solution and extracted with methylene chloride (200 mL) three times. The organic phase was separated, washed with brine, dried over Na₂SO₄ and evaporated. The crude aldehyde was used without further purification. The crude yield (62.5% from 28 was calculated by 1H NMR with dibromomethane as inner standard.

The aldehyde was dissolved in 100 mL methylene chloride and then p-toluenesulfonyl hydrazide (56 g, 300 mmol, 0.75 equiv.) was added. The mixture was allowed to stir at room temperature for another 1 hours. After it was confirmed that the aldehyde was consumed through TLC analysis, the crude reaction was concentrated to remove excess solvent. The crude product was purified through flash chromatography (hexanes:ethyl acetate, 3:1) on silica gel to afford 103.0 g (60% from 28) of the title compound SI-6. Cis/trans-isomerism (1/1.8) was observed. The 1H NMR characterization of main isomer was provided.

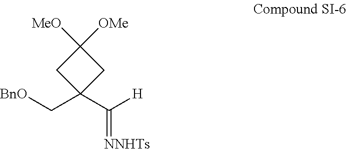

### N′-((1-((benzyloxy)methyl)-3,3-dimethoxycyclobutyl)methylene)-4-methylbenzenesulfono-hydrazide (SI-6)

Physical State: yellow oil. H NMR (600 MHz, CDCl₃): δ 7.93 (s, 1H), 7.78 (d, J=8.3 Hz, 2H), 7.36-7.09 (m, 8H), 4.43 (s, 2H), 3.52 (s, 2H), 3.06 (s, 3H), 3.02 (s, 3H), 2.37 (s, 3H), 2.24 (d, J=9.0 Hz, 2H), 2.11 (d, J=13.3 Hz, 2H) ppm. HRMS (ESI-TOF): calc'd for C₂₂H₂₈N₂O₅S [M+H]⁺: 433.1792, found: 433.1786. TLC: R_{f}=0.23 (2:1 hexanes:ethyl acetate).

### Step 2: Synthesis of SI-7

A dry round-bottom flask charged with SI-6 (103.0 g, 238 mmol, 1.0 equiv.) was degassed and filled with argon for three times. Toluene (1.0 L) was added, then 60% NaH (10.5 g, 262 mmol, 1.1 equiv.) was added in small portions and the mixture was stirred at room temperature for 1 h. A solution of B₂pin₂ (90 g, 357 mmol, 1.5 equiv.) was added. Then the reaction mixture was heated at 100° C. for 1 h. (Li et al., 2012). After cooling to room temperature, the suspension was filtered by Celite, and washed by diethyl ether (500 mL). After solvent was removed by rotary evaporator from the filtrate, the crude product was redissolved in 250 mL acetonitrile in a 1-L flask. 2 M H₂SO₄ (250 mL, 2.0 equiv.) was added into the mixture at room temperature and the reaction was allowed to stir for another 2 hours. After it was confirmed that the ketal intermediate was totally consumed, the crude reaction was concentrated to remove excess acetonitrile. Then diethyl ether (600 mL) and saturated brine (500 mL) were added to the reaction mixture and the mixture was transferred to a separatory funnel. The aqueous layer was separated and further extracted with diethyl ether (3×250 mL). The combined organic layers were dried over Na₂SO₄, filtered through Celite. Excess solvent was removed by rotary evaporator.

The crude ketone was redissolved in 250 mL methylene chloride in a 500 mL-flask and mesitylene sulfonyl hydrazide (55 g, 262 mmol, 1.1 equiv.) was added. The mixture was allowed to stir at room temperature for another 3-5 hours. After it was confirmed that the ketone intermediate was consumed through TLC analysis, the crude reaction was concentrated to remove excess solvent. The crude product was purified through flash chromatography (hexanes:ethyl acetate, 4:1) on silica gel to afford 100 g (64%) of the title compound SI-7.

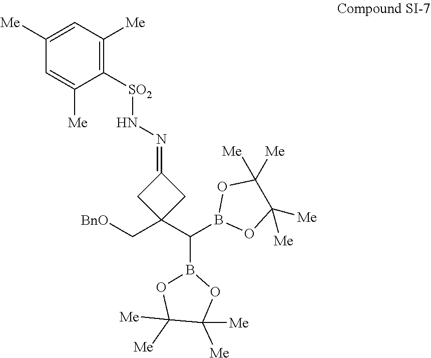 [SMILES: Cc1cc(C)c(S(=O)(=O)NN=C2CC(COCc3ccccc3)(C(B3OC(C)(C)C(C)(C)O3)B3OC(C)(C)C(C)(C)O3)C2)c(C)c1]

### N′-(3-((benzyloxy)methyl)-3-(bis(4,4,5,5-tetramethyl-1,3,2-dioxaborolan-2-yl)methyl)cyclo-butylidene)-2,4,6-trimethylbenzenesulfonohydrazide (SI-7)

Physical State: white solid. m.p.: 198-200° C. ¹H NMR (600 MHz, Acetone-d₆) δ 9.02 (s, 1H), 7.36-7.30 (m, 4H), 7.29-7.23 (m, 1H), 7.00 (s, 2H), 4.50 (s, 2H), 3.35 (d, J=8.9 Hz, 1H), 3.33 (d, J=8.9 Hz, 1H), 2.88-2.81 (m, 1H), 2.81-2.77 (m, 1H), 2.74 (ddd, J=17.3, 3.1, 2.1 Hz, 1H), 2.66 (ddd, J=17.3, 3.1, 2.1 Hz, 1H), 2.63 (s, 6H), 2.27 (s, 3H), 1.15 (s, 6H), 1.15 (s, 6H), 1.14 (s, 1H), 1.12 (s, 6H), 1.11 (s, 6H) ppm. ¹³C NMR (151 MHz, Acetone-d₆) δ 156.62, 142.96, 140.67, 139.71, 134.90, 132.41, 129.07, 128.36, 128.17, 83.67, 83.65, 78.27, 73.50, 43.34, 42.10, 36.28, 25.20, 25.08, 24.74, 23.39, 20.84 ppm. ¹¹B NMR (128 MHz, Acetone-d₆): δ 33.11 ppm. HRMS (ESI-TOF): calc'd for C₃₄H₅₀B₂N₂O₇S [M+H]⁺: 653.3598, found: 653.3602.

TLC: R_{f}=0.37 (3:1 hexanes:ethyl acetate).

### Step 3: Synthesis of 25

A 500-mL one-necked (24/40 joint) round-bottomed flask, equipped with a Teflon-coated magnetic stir bar, was flame-dried under vacuum, and then cooled to 23° C. under an atmosphere of argon. Then the flask was charged with SI-7 (22 g, 33 mmol, 1.0 equiv.) and dried cesium carbonate (33 g, 100 mmol, 3.0 equiv.). (Note: Cesium carbonate was dried at 120° C. under vacuum for 18 hours.) After being evacuated and backfilled with argon from a balloon 3 times, dioxane (200 mL) was added into the flask and the reaction mixture was allowed to stir at 100° C. for 2 hours. After it was confirmed that the starting material, SI-7, was consumed through TLC analysis, the reaction was cooled to room temperature, filtered through Celite, washed with hexanes (500 mL), and concentrated to remove excess solvents. The crude reaction was purified through flash chromatography (hexanes:ethyl acetate, 10:1) on silica gel to afford the title compound 25, which was further purified through trituration in hexanes at −40° C. affording 8.3 g product (56% yield) with >99% purity as white solids. (Yang et al., 2021b). Trituration procedure: The product (around 10 g) after chromatography was dissolved in hexanes (6 mL) at room temperature and then cooled to −40° C. After the solution of the product was slowly stirred at −40° C. for 30 minutes, the suspension was filtered and the white solid was washed with cooled hexanes (4 mL) quickly and dried under vacuum for 1 hour.

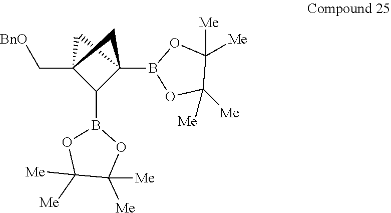 [SMILES: CC1(C)OB(C2[C@]3(COCc4ccccc4)C[C@@]2(B2OC(C)(C)C(C)(C)O2)C3)OC1(C)C]

### 2,2′-(3-((benzyloxy)methyl)bicyclo[1.1.1]pentane-1,2-diyl)bis(4,4,5,5-tetramethyl-1,3,2-dioxa-borolane) (25)

Physical State: colorless crystal. m.p.: 65-67° C. H NMR (600 MHz, CDCl₃): δ 7.36-7.28 (m, 4H), 7.24 (dd, J=8.2, 5.9 Hz, 1H), 4.52 (s, 2H), 3.38 (d, J=11.0, 1H), 3.36 (d, J=11.0, 1H), 2.38 (dd, J=9.7, 2.3 Hz, 1H), 1.93 (dd, J=9.7, 1.5 Hz, 1H), 1.88 (s, 1H), 1.82 (dd, J=8.3, 2.3 Hz, 1H), 1.67 (d, J=8.2 Hz, 1H), 1.23 (s, 12H), 1.20 (s, 6H), 1.19 (s, 6H) ppm. ¹³C NMR (151 MHz, CDCl₃) δ 139.14, 128.32, 127.55, 127.37, 83.35, 82.91, 72.88, 71.28, 54.69, 49.02, 46.50, 24.99, 24.90, 24.87, 24.84 ppm. ¹¹B NMR (128 MHz, CDCl₃): δ 31.92 ppm. MS (GCMS, EI): m/z=425 (0.1%), 349 (0.2%), 325 (0.2%), 249 (5%), 91 (100%). TLC: R_{f}=0.54 (5:1 hexanes:ethyl acetate).

### Gram-Scale Synthesis of BCP BisBoronates 14 (R¹=Me)

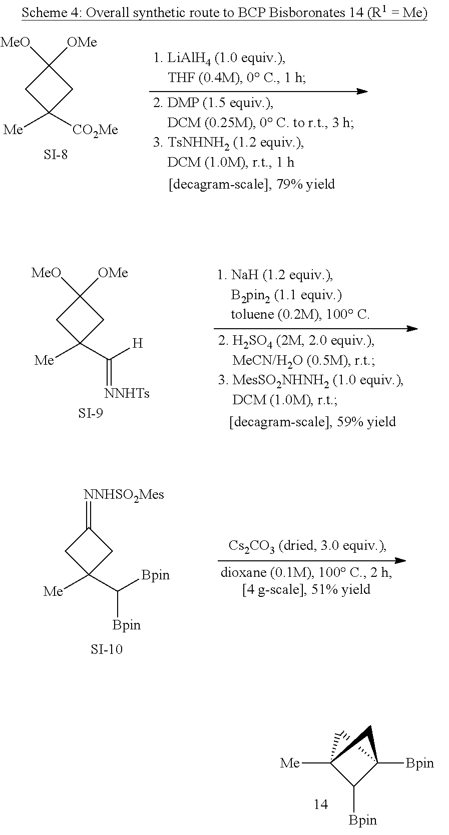

### Step 1: Synthesis of SI-9

To a solution of methyl 3,3-dimethoxy-1-methyl-cyclobutanecarboxylate, SI-8, (10.8 g, 57 mmol, 1.0 equiv.) in diethyl ether (160 mL) was added LiAlH₄ (3.3 g, 85.5 mmol, 1.5 equiv.) at 0° C. The mixture was allowed to warm up to room temperature. After it was confirmed that the start material, SI-8, was totally consumed, water (3.3 mL) was slowly added at 0° C., followed by 20% w.t. NaOH (3.3 mL) and water (10 mL), and the mixture was stirred at 0° C. for 30 min. Then excess Na₂SO₄ was added, and the suspended solution was stirred at room temperature for another 1 hour. The mixture was filtered through Celite, and the solvent was removed under high vacuum. The crude alcohol was used without further purification.

To a solution of the crude alcohol in methylene chloride (250 mL) was added Dess-Martin periodinane (25 g, 60 mmol, 1.05 equiv.) at 0° C. and the reaction mixture was allowed to warm to room temperature and stir for 2 hours. Then the reaction was quenched by excess saturated Na₂CO₃ solution and Na₂S₂O₃ solution and extracted with methylene chloride (100 mL) three times. The organic phase was separated, washed with brine, dried over Na₂SO₄ and evaporated. The crude aldehyde was used without further purification.

The aldehyde was dissolved in methylene chloride (60 mL) and then p-toluenesulfonyl hydrazide (11.2 g, 60 mmol, 1.05 equiv.) was added. The mixture was allowed to stir at room temperature for another 1 hour. After it was confirmed that the aldehyde was consumed through TLC analysis, the crude reaction was concentrated to remove excess solvent. The crude product was purified through flash chromatography (hexanes:ethyl acetate, 3:1) on silica gel to afford 14.7 g (79%) of the title compound SI-9. Spectroscopic data of the product SI-9 matches that reported in the literature. (Yang et al., 2021b).

### Step 2: Synthesis of SI-10

A dry round-bottom flask charged with SI-9 (14.7 g, 45 mmol, 1.0 equiv.), 60% NaH (2.2 g, 54 mmol, 1.2 equiv.) was degassed and filled with argon three times. Toluene (200 mL) was added, and the mixture was stirred at room temperature for 1 h. A solution of B₂pin₂ (17.0 g, 67 mmol, 1.5 equiv.) in toluene (50 mL) was added via syringe. Then the tube was sealed and heated at 100° C. for 1 h.⁴ After cooling to room temperature, the suspension was filtered by Celite, and washed by diethyl ether (200 mL). After solvent was removed by rotary evaporator from the filtrate, the crude product was redissolved in 45 mL acetonitrile in a 100-mL flask. 2M H₂SO₄ (45 mL, 2.0 equiv.) was added into the mixture at room temperature and the reaction was allowed to stir for another 2 hours. After it was confirmed that the ketal intermediate was totally consumed, the crude reaction was concentrated to remove excess acetonitrile. Then diethyl ether (150 mL) and saturated brine (150 mL) were added to the reaction mixture and the mixture was transferred to a separatory funnel. The aqueous layer was separated and further extracted with diethyl ether (3×50 mL). The combined organic layers were dried over Na₂SO₄, filtered through Celite. Excess solvent was removed by rotary evaporator.

The crude ketone was redissolved in 50 mL methylene chloride in a 100 mL-flask and mesitylene sulfonyl hydrazide (10.7 g, 50 mmol, 1.1 equiv.) was added. The mixture was allowed to stir at room temperature for another 3-5 hours. After it was confirmed that the ketone intermediate was consumed through TLC analysis, the crude reaction was concentrated to remove excess solvent. The crude product was purified through flash chromatography (hexanes:ethyl acetate, 4:1) on silica gel to afford 14.5 g (59%) of the title compound SI-10.

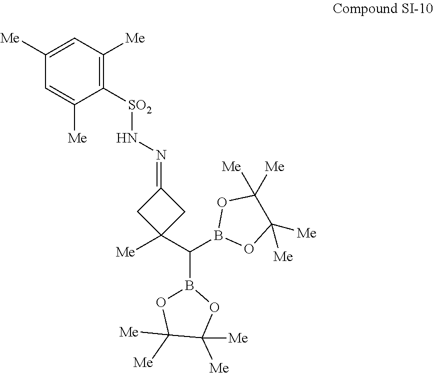 [SMILES: Cc1cc(C)c(S(=O)(=O)NN=C2CC(C)(C(B3OC(C)(C)C(C)(C)O3)B3OC(C)(C)C(C)(C)O3)C2)c(C)c1]

### N′-(3-(bis(4,4,5,5-tetramethyl-1,3,2-dioxaborolan-2-yl)methyl)-3-methylcyclobutylidene)-2,4,6-trimethylbenzenesulfonohydrazide (SI-10)

Physical State: white solid. m.p.: 111-113° C. ¹H NMR (600 MHz, Acetone-d⁶): δ 8.93 (s, 1H), 7.01 (s, 2H), 2.85 (dd, J=18.1, 3.3 Hz, 1H), 2.80 (dd, J=16.5, 2.2 Hz, 1H), 2.63 (s, 6H), 2.53 (dt, J=17.1, 2.9 Hz, 1H), 2.43 (dt, J=16.5, 3.0 Hz, 1H), 2.28 (s, 3H), 1.23 (s, 3H), 1.18 (s, 6H), 1.18 (s, 6H), 1.16 (s, 6H), 1.16 (s, 6H), 0.93 (s, 1H) ppm. ¹³C NMR (151 MHz, Acetone-d⁶): δ 156.80, 143.01, 140.69, 134.87, 132.42, 83.62, 83.61, 48.06, 46.69, 32.54, 30.04, 25.20, 25.12, 24.80, 24.79, 23.38, 20.86 ppm. ¹¹B NMR (128 MHz, Acetone-d⁶): S 32.87 ppm. HRMS (ESI-TOF): calc'd for C₂₇H₄₄B₂N₂O₆S [M+H]⁺: 547.3179, found: 547.3177. TLC: R_{f}=0.40 (3:1 hexanes:ethyl acetate).

### Step 3: Synthesis of 14

A 500-mL one-necked (24/40 joint) round-bottomed flask, equipped with a Teflon-coated magnetic stir bar, was flame-dried under vacuum, and then cooled to 23° C. under an atmosphere of argon. Then the flask was charged with SI-10 (14.5 g, 26.5 mmol, 1.0 equiv.) and dried cesium carbonate (25.4 g, 78 mmol, 3.0 equiv.). (Note: Cesium carbonate was dried at 120° C. under vacuum for 18 hours.) After being evacuated and backfilled with argon from a balloon 3 times, dioxane (250 mL) was added into the flask and the reaction mixture was allowed to stir at 100° C. for 2 hours. After it was confirmed that the starting material, SI-10, was consumed through TLC analysis, the reaction was cooled to room temperature, filtered through Celite, washed with hexanes (500 mL), and concentrated to remove excess solvents. The crude reaction was purified through flash chromatography (hexanes:ethyl acetate, 30:1) on silica gel to afford the title compound 14, which was further purified through trituration in hexanes at −40° C. affording 4.5 g product (51% yield) with >99% purity as white solids. (Yang et al., 2021b) Trituration procedure: The product (around 6 g) after chromatography was dissolved in hexanes (5 mL) at room temperature and then cooled to −40° C. After the solution of the product was slowly stirred at −40° C. for 40 minutes, the suspension was filtered and the white solid was washed with cooled hexanes (3 mL) quickly and dried under vacuum for 1 hour. Spectroscopic data of the product 14 matches that reported in the literature. (Yang et al., 2021b)

Gram-Scale Synthesis of BCP BisBoronates 26 (R¹═CF₃)

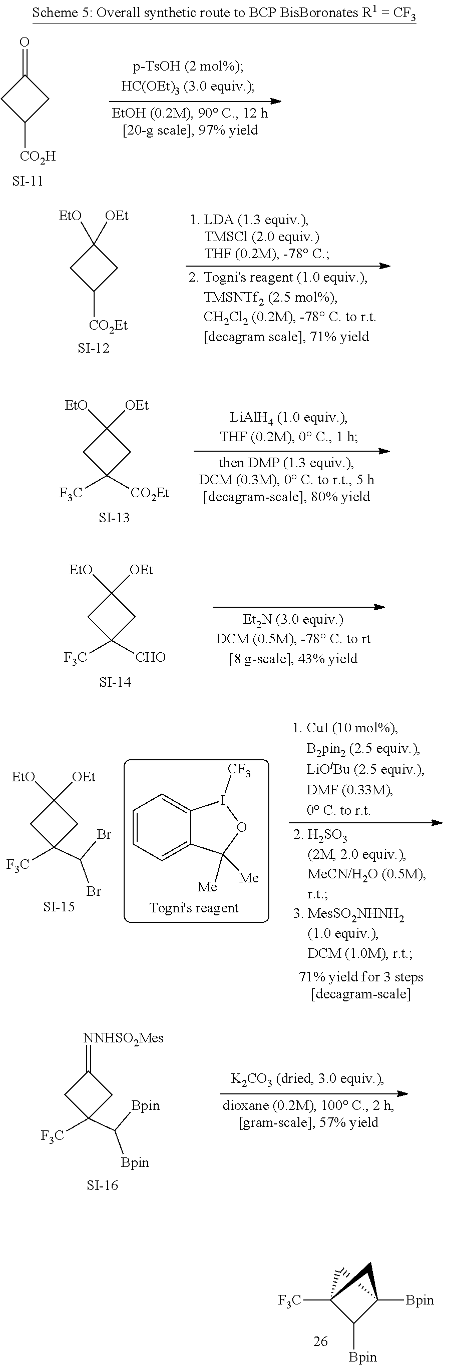

### Step 1: Synthesis of SI-12

A 500-mL round-bottomed flask, equipped with a Teflon-coated magnetic stir bar, was added SI-11 (22.8 g, 200 mmol, 1.0 equiv.) and TsOH·H₂O (760 mg, 4.0 mmol, 0.02 equiv.). Then EtOH (600 mL) and HC(OEt)₃ (67 mL, 400 mmol, 2.0 equiv.) were added, and the reaction mixture was refluxed at 90° C. for 12 h. The reaction was cooled to room temperature and concentrated under vacuum. The residue was purified through flash chromatography (hexanes:ethyl acetate, 10:1) on silica gel to afford 41.9 g (97%) of the title compound SI-12.

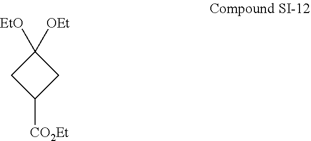 [SMILES: CCOC(=O)C1CC(OCC)(OCC)C1]

### ethyl 3,3-diethoxycyclobutane-1-carboxylate (SI-12)

Physical State: colorless oil. ¹H NMR (600 MHz, CDCl₃): δ 4.14 (q, J=7.2 Hz, 2H), 3.46-3.37 (m, 4H), 2.88 (p, J=8.6 Hz, 1H), 2.48-2.35 (m, 4H), 1.24 (d, J=7.3 Hz, 3H), 1.20-1.16 (m, 6H) ppm. ¹³C NMR (151 MHz, CDCl₃) δ 175.06, 99.29, 60.75, 56.87, 56.59, 36.49, 29.40, 15.48, 15.30, 14.35 ppm. MS (GCMS, EI): m/z=205 (6%), 176 (8%), 131 (8%), 91 (100%), 65 (14%). TLC: R_{f}=0.28 (10:1 hexanes:ethyl acetate).

### Step 2: Synthesis of SI-13

A flame-dried 1-L flask equipped with rubber septum and magnetic stirring bar was charged under Ar atmosphere subsequently with diisopropylamine (27.7 mL, 198 mmol, 1.1 equiv.) and anhydrous THF (500 mL). To this well-stirred solution held at −78° C. was added within 20 minutes via a dropping funnel a solution of n-BuLi (86.4 mL, 2.5M in hexanes, 1.2 equiv.). The resulting solution was stirred at this temperature for 30 minutes. A solution of the SI-12 (38.9 g, 180 mmol, 1.0 equiv.) in anhydrous THF (100 mL) was slowly introduced dropwise via a dropping funnel within 20 minutes. After stirring at −78° C. for 2 h, neat trimethylchlorosilane (39 mL; 306 mmol; 1.7 equiv.) was introduced at once. The resultant reaction mixture was allowed to gradually warm up to room temperature and stir overnight. The turbid solution was concentrated in vacuo in the reaction flask. To the remaining white slurry hexane (200 mL) was introduced and the mixture was cooled to 0° C. The resulting suspension was poured into ice water and hexanes, and extracted with hexanes. The combined organic solution was dried with Na₂SO₄, filtered and concentrated. The residue was purified by distillation to afford the desired trimethylsilylketene acetal 43 g (83%) as colorless oil.

In a flame-dried 2-L flask equipped with rubber septum and magnetic stirring bar, trimethylsilyl ketene acetal (34.6 g, 120 mmol, 1.0 equiv.) was added under Ar. Then anhydrous methylene chloride (1.3 L) was added, and the reaction mixture was cooled to −78° C. (dry ice/acetone bath). TMSNTf₂ (424 mg; 1.2 mmol; 0.01 equiv) was added via a syringe at once. To the resulting well-stirred solution was added solid 1-trifluoromethyl-1,3-dihydro-3,3-dimethyl-1,2-benziodoxole (39.6 g, 120 mmol, 1.0 equiv). The mixture was allowed to reach room temperature with stirring for 4 h. NaHCO₃ (50 mL) aqueous solution was added. The organic phase was separated and dried by Na₂SO₄. The solvent was concentrated, and the residue was purified through flash chromatography (hexanes:ethyl acetate, 10:1) on silica gel to afford 24.2 g (71%) of the title compound SI-13. (Katayev et al., 2015)

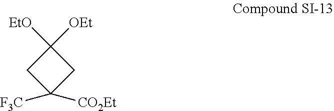 [SMILES: CCOC(=O)C1(C(F)(F)F)CC(OCC)(OCC)C1]

### ethyl 3,3-diethoxy-1-(trifluoromethyl)cyclobutane-1-carboxylate (SI-13)

Physical State: colorless oil. ¹H NMR (600 MHz, CDCl₃): δ 4.26 (q, J=7.1 Hz, 2H), 3.40 (q, J=7.1 Hz, 2H), 3.40 (q, J=7.1 Hz, 2H), 2.83-2.72 (m, 2H), 2.61-2.52 (m, 2H), 1.30 (t, J=7.1 Hz, 3H), 1.19 (t, J=7.1 Hz, 3H), 1.15 (t, J=7.1 Hz, 3H) ppm. ¹³C NMR (151 MHz, CDCl₃) δ 168.86, 125.22 (q, J=279.5 Hz), 97.02, 62.26, 56.91, 56.82, 44.13 (q, J=30.1 Hz), 38.07, 15.11, 15.06, 13.96 ppm. ¹⁹F NMR (565 MHz, CDCl₃): δ −73.10 ppm. MS (GCMS, EI): m/z=239 (30%), 211 (30%), 183 (48%), 116 (65%), 89 (100%). TLC: R_{f}=0.59 (10:1 hexanes:ethyl acetate).

### Step 3: Synthesis of SI-14

A 1-L one-necked (24/40 joint) round-bottomed flask, equipped with a 6.4 cm Teflon-coated magnetic stir bar, was flame-dried under vacuum, and then cooled to 23° C. under an atmosphere of argon. Then the flask was charged with SI-13 (20.2 g, 71 mmol, 1.0 equiv.). Dried THF (400 mL) was added into the flask and the mixture was cooled to 0° C. Then LiAlH₄ (2.7 g, 71 mmol, 1.0 equiv.) was added into the flask slowly at 0° C. and the reaction mixture was allowed to stir at 0° C. for 1 hour. After it was confirmed that the start material, SI-13, was totally consumed, water (2.7 mL) was slowly added at 0° C., followed by 20% w.t. NaOH (2.7 ml) and water (8.0 mL), and the mixture was stirred at 0° C. for 30 min. Then excess Na₂SO₄ was added, and the suspended solution was stirred at room temperature for another 1 hour. The mixture was filtered through Celite, and the solvent was removed under high vacuum. The crude alcohol was used without further purification.

To a solution of the crude alcohol in methylene chloride (280 mL) was added Dess-Martin periodinane (42.4 g, 100 mmol, 1.4 equiv.) at 0° C. and the reaction mixture was allowed to warm to room temperature and stir for 2 hours. Then the reaction was quenched by excess saturated NaHCO₃ solution and Na₂S₂O₃ solution and extracted with methylene chloride (100 mL) three times. The organic phase was separated, washed with brine, dried over Na₂SO₄ and evaporated. The crude product was purified through flash chromatography (hexanes:ethyl acetate, 10:1) on silica gel to afford 13.0 g (80%) of the title compound SI-14.

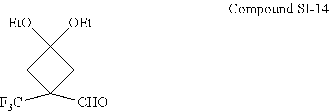 [SMILES: CCOC1(OCC)CC(C=O)(C(F)(F)F)C1]

### 3,3-diethoxy-1-(trifluoromethyl)cyclobutane-1-carbaldehyde (SI-14)

Physical State: colorless oil. ¹H NMR (600 MHz, CDCl₃): δ 9.73 (s, 1H), 3.44-3.39 (m, 2H), 3.40-3.36 (m, 2H), 2.67-2.62 (m, 2H), 2.50 (dt, J=11.5, 1.6 Hz, 2H), 1.19 (tt, J=7.1, 1.1 Hz, 3H), 1.15 (tt, J=7.1, 1.2 Hz, 3H) ppm. ¹³C NMR (151 MHz, CDCl₃) δ 193.87, 125.64 (q, J=279.3 Hz), 96.55, 56.95, 56.86, 47.30 (q, J=27.8 Hz), 34.98, 15.13 ppm. ¹⁹F NMR (565 MHz, CDCl₃): δ −72.10 ppm. MS (GCMS, EI): m/z=211 (48%), 195 (51%), 167 (40%), 135 (80%), 115 (100%). TLC: R_{f}=0.53 (10:1 hexanes:ethyl acetate).

### Step 4: Synthesis of SI-15

A 250-mL one-necked (24/40 joint) round-bottomed flask, equipped with a Teflon-coated magnetic stir bar, was flame-dried under vacuum, and then cooled to 23° C. under an atmosphere of argon. Then the flask was charged with triphenyl phosphite (21 mL, 80 mmol, 1.5 equiv.). Methylene chloride (50 mL) was added into the flask and the mixture was cooled to −78° C. Then bromine (4 mL, 78 mmol, 1.4 equiv.) was added slowly into the flask, followed by addition of triethyl amine (23 mL, 162 mmol, 3.0 equiv.). Next, the solution of SI-14 (13.0 g, 54 mmol, 1.0 equiv.) in 40 mL methylene chloride was added into the mixture and the reaction was warmed up to room temperature. After it was confirmed that the starting material, SI-14, was consumed through TLC analysis, solvent was removed by rotary evaporator and the crude product was purified through flash chromatography (hexanes:ethyl acetate, 20:1) on silica gel to afford 8.6 g (43%) of the title compound SI-15. (Hazrati & Oestreich, 2018)

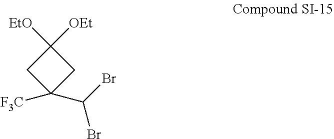 [SMILES: CCOC1(OCC)CC(C(Br)Br)(C(F)(F)F)C1]

### 1-(dibromomethyl)-3,3-diethoxy-1-(trifluoromethyl)cyclobutane (SI-15)

Physical State: colorless oil. ¹H NMR (600 MHz, CDCl₃): δ 5.96 (s, 1H), 3.43 (q, J=7.1 Hz, 2H), 3.40 (q, J=7.1 Hz, 2H), 2.66-2.59 (m, 2H), 2.42-2.36 (m, 2H), 1.22 (t, J=7.1 Hz, 3H), 1.19 (t, J=7.1 Hz, 3H) ppm. ¹³C NMR (151 MHz, CDCl₃) δ 126.09 (q, J=281.8 Hz), 95.57, 57.10, 56.88, 45.76, 45.48 (q, J=27.8 Hz), 39.60 (q, J=2.3 Hz), 15.40, 15.17 ppm. ¹⁹F NMR (565 MHz, CDCl₃): δ −68.99 ppm. MS (GCMS, EI): m/z=341 (5%), 339 (10%), 337 (5%), 311 (9%), 211 (30%), 116 (100%). TLC: R_{f}=0.69 (10:1 hexanes:ethyl acetate).

### Step 5: Synthesis of SI-16

A 250-mL one-necked (24/40 joint) round-bottomed flask, equipped with a Teflon-coated magnetic stir bar, was flame-dried under vacuum, and then cooled to 23° C. under an atmosphere of argon. Then the flask was charged with copper(I) iodide (437 mg, 2.3 mmol, 0.1 equiv.), B₂pin₂ (12.9 g, 51 mmol, 2.2 equiv.), and lithium tert-butoxide (4.4 g, 55 mmol, 2.4 equiv.). After being evacuated and backfilled with argon from a balloon 3 times, DMF (23 mL) was added into the flask at 0° C. Then a solution of SI-15 (23 mmol, 8.6 g, 1.0 equiv.) in DMF (46 mL) was added slowly into the mixture at 0° C. and the reaction mixture was allowed to slowly warm to room temperature and stir for another 1 hour. After it was confirmed that the starting material, SI-15, was consumed through TLC analysis, the reaction was filtered through Celite, washed with diethyl ether (100 mL) and quenched at 0° C. with water (300 mL) (Caution: the quenching process is exothermic). The mixture was then transferred into a 1-L separation funnel. The aqueous phase was separated and extracted with two 100-mL portions of diethyl ether. The combined organic layers were washed with the mixture of 100 mL water and 100 mL saturated NaCl solution twice, dried over Na₂SO₄, and filtered through Celite. (Yang et al., 2011)

After solvent was removed by rotary evaporator, the crude product was redissolved in 23 mL acetonitrile in a 100-mL flask. 2M H₂SO₄ (23 mL, 2.0 equiv.) was added into the mixture at room temperature and the reaction was allowed to stir for another 1.5 hours. After it was confirmed that the ketal intermediate was consumed through TLC analysis, the crude reaction is concentrated to remove excess acetonitrile. Then diethyl ether (100 mL) and saturated brine (50 mL) were added to the reaction mixture and the mixture was transferred to a 125-mL separatory funnel. The aqueous layer was separated and further extracted with diethyl ether (3×50 mL). The combined organic layers are dried over Na₂SO₄, filtered through Celite. Excess solvent was removed by rotary evaporator.

The crude product was redissolved in 20 mL methylene chloride in a 100 mL-flask and mesitylene sulfonyl hydrazide (4.93 g, 23 mmol, 1.0 equiv.) was added. The mixture was allowed to stir at room temperature for another 2 hours. After it was confirmed that the ketone intermediate was consumed through TLC analysis, the crude reaction was concentrated to remove excess solvent. The crude product was purified through flash chromatography (hexanes:ethyl acetate, 4:1) on silica gel to afford 9.8 g (71%) of the title compound SI-16.

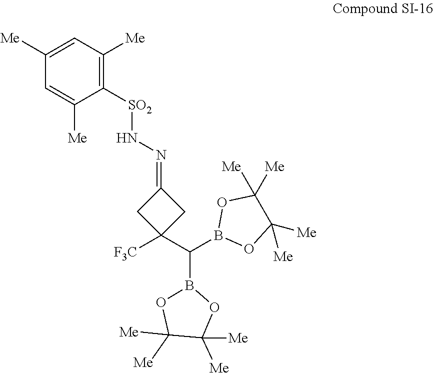 [SMILES: Cc1cc(C)c(S(=O)(=O)NN=C2CC(C(B3OC(C)(C)C(C)(C)O3)B3OC(C)(C)C(C)(C)O3)(C(F)(F)F)C2)c(C)c1]

### N′-(3-(bis(4,4,5,5-tetramethyl-1,3,2-dioxaborolan-2-yl)methyl)-3-(trifluoromethyl)cyclobutyl idene)-2,4,6-trimethylbenzenesulfonohydrazide (SI-16)

Physical State: white solid. m.p.: 186-188° C. ¹H NMR (600 MHz, Acetone-d₆): δ 9.34 (s, 1H), 7.03 (s, 2H), 3.22 (dd, J=18.1, 3.3 Hz, 1H), 3.11 (dd, J=17.6, 3.2 Hz, 1H), 3.06 (ddd, J=18.2, 3.3, 1.9 Hz, 1H), 3.00 (ddd, J=17.7, 3.3, 1.9 Hz, 1H), 2.64 (s, 6H), 2.29 (s, 3H), 1.28 (s, 1H), 1.19 (s, 6H), 1.18 (s, 6H), 1.17 (s, 6H), 1.14 (s, 6H) ppm. ¹³C NMR (151 MHz, Acetone-d₆) δ 151.49, 143.20, 140.78, 134.71, 132.49, 130.17 (q, J=279.7 Hz), 84.32, 84.28, 41.54 (q, J=2.8 Hz), 40.49 (q, J=2.7 Hz), 39.96 (q, J=27.4 Hz), 25.17, 24.98, 24.66, 24.64, 23.40, 20.85 ppm. ¹⁹F NMR (565 MHz, Acetone-d₆): δ−78.92 ppm. ¹¹B NMR (128 MHz, Acetone-d₆): δ 32.51 ppm. HRMS (ESI-TOF): calc'd for C₂₇H₄₁B₂F₃N₂O₆S [M+H]⁺: 601.2896, found: 601.2903. TLC: R_{f}=0.47 (10:1 hexanes:ethyl acetate).

### Step 6: Synthesis of 26

A 250-mL one-necked (24/40 joint) round-bottomed flask, equipped with a Teflon-coated magnetic stir bar, was flame-dried under vacuum, and then cooled to 23° C. under an atmosphere of argon. Then the flask was charged with SI-16 (6.0 g, 10 mmol, 1.0 equiv.) and dried potassium carbonate (4.14 g, 30 mmol, 3.0 equiv.). (Note: Potassium carbonate was dried at 120° C. under vacuum for 18 hours.) After being evacuated and backfilled with argon from a balloon 3 times, dioxane (60 mL) was added into the flask and the reaction mixture was allowed to stir at 105° C. for 2 hours. After it was confirmed that the starting material, SI-16, was consumed through TLC analysis, the reaction was cooled to room temperature, filtered through Celite, washed with hexanes (200 mL), and concentrated to remove excess solvents. The crude reaction was purified through flash chromatography (hexanes:ethyl acetate, 20:1) on silica gel to afford the title compound 26, which was further purified through trituration in hexanes at −40° C. affording 2.2 g product (57% yield) with >99% purity as white solids. (Yang et al., 2021b) Trituration procedure: The product (around 3 g) after chromatography was dissolved in hexanes (2.0 mL) at room temperature and then cooled to −40° C. After the solution of the product was slowly stirred at −40° C. for 40 minutes, the suspension was filtered and the white solid was washed with cooled hexanes (1.0 mL) quickly and dried under vacuum for 1 hour.

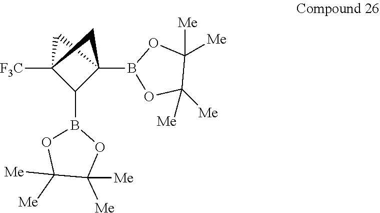 [SMILES: CC1(C)OB(C2[C@]3(B4OC(C)(C)C(C)(C)O4)C[C@@]2(C(F)(F)F)C3)OC1(C)C]

### 2,2′-(3-(trifluoromethyl)bicyclo[1.1.1]pentane-1,2-diyl)bis(4,4,5,5-tetramethyl-1,3,2-dioxa-borolane) (26)

Physical State: white solid. m.p.: 49-51° C. ¹H NMR (600 MHz, CDCl₃): δ 2.68 (dd, J=9.6, 2.3 Hz, 1H), 2.07 (dd, J=9.6, 1.7 Hz, 1H), 2.02 (d, J=1.7 Hz, 1H), 1.96 (dd, J=8.2, 2.3 Hz, 1H), 1.84 (d, J=8.1 Hz, 1H), 1.25-1.18 (m, 24H) ppm. ¹³C NMR (151 MHz, CDCl₃) δ 121.70 (q, J=278.4 Hz), 83.82, 83.44, 53.05 (q, J=2.7 Hz), 47.47 (q, J=2.4 Hz), 43.37 (q, J=36.9 Hz), 24.88, 24.85, 24.81, 24.73 ppm. ¹⁹F NMR (376 MHz, CDCl₃): δ −74.97 ppm. ¹¹B NMR (128 MHz, CDCl₃): δ 30.96 ppm. MS (GCMS, EI): m/z=387 (0.1%), 373 (0.4%), 288 (1%), 231 (5%), 131 (15%), 83 (100%). TLC: R_{f}=0.28 (15:1 hexanes:ethyl acetate).

### Gram-Scale Synthesis of BCP BisBoronates 27 (R¹=4-MeOPh)

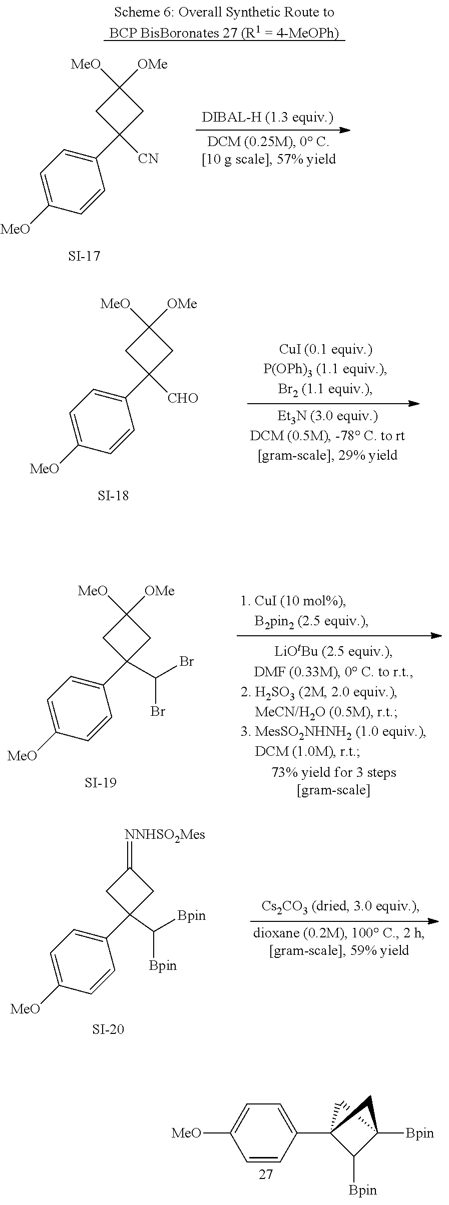

Compound SI-17 was prepared according to previous literate. (JosienJohn et al., 2010)

### Step 1: Synthesis of SI-18

A 500-mL round-bottomed flask, equipped with a Teflon-coated magnetic stir bar, was flame-dried under vacuum, and then cooled to 23° C. under an atmosphere of argon. Then the flask was charged with compound SI-17 (12.5 g, 50 mmol, 1.0 equiv.). Then methylene chloride (200 mL) was added and the reaction mixture was cooled to 0° C. Next, DIBAL-H (65 mL, 1.0 M, 1.3 equiv.) was added at 0° C. and the mixture was stirred at 0° C. for 3 hours. The cool mixture was added under vigorous stirring to saturated Rochelle salt solution at 0° C. and stirred overnight. The organic phase was separated, washed with brine, dried over Na₂SO₄ and evaporated. The crude product was purified through flash chromatography (hexanes:ethyl acetate, 4:1) on silica gel to afford 7.1 g (57%) of the title compound SI-18.

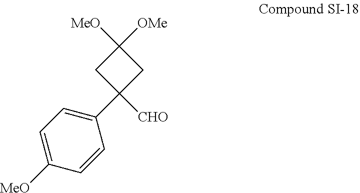 [SMILES: COc1ccc(C2(C=O)CC(OC)(OC)C2)cc1]

3,3-dimethoxy-1-(4-methoxyphenyl)cyclobutane-1-carbaldehyde (SI-18)

Physical State: white solid. m.p.: 56-58° C. ¹H NMR (600 MHz, CDCl₃): δ 9.49 (s, 1H), 7.11-7.06 (m, 2H), 6.94-6.87 (m, 2H), 3.80 (s, 3H), 3.17 (s, 3H), 3.14 (s, 3H), 3.02-2.96 (m, 2H), 2.48-2.42 (m, 2H) ppm. ¹³C NMR (151 MHz, CDCl₃) δ 198.24, 158.95, 131.30, 128.25, 114.49, 98.60, 55.45, 48.77, 48.68, 48.21, 38.95 ppm. HRMS (ESI-TOF): calc'd for C₁₄H₁₈O₄ [M+H]⁺: 251.1278, found: 251.1278. TLC: R_{f}=0.17 (10:1 hexanes:ethyl acetate).

### Step 2: Synthesis of SI-19

A 250-mL one-necked (24/40 joint) round-bottomed flask, equipped with a Teflon-coated magnetic stir bar, was flame-dried under vacuum, and then cooled to 23° C. under an atmosphere of argon. Then the flask was charged with triphenyl phosphite (5.8 mL, 22 mmol, 1.1 equiv.). Methylene chloride (25 mL) was added into the flask and the mixture was cooled to −78° C. Then bromine (1.1 mL, 22 mmol, 1.1 equiv.) was added slowly into the flask, followed by addition of triethyl amine (8.4 mL, 60 mmol, 3.0 equiv.). Next, the solution of SI-18 (5.0 g, 20 mmol, 1.0 equiv.) in 25 mL methylene chloride was added into the mixture and the reaction was warmed up to room temperature. After it was confirmed that the starting material, SI-18, was consumed through TLC analysis, solvent was removed by rotary evaporator and the crude product was purified through flash chromatography (hexanes:ethyl acetate, 20:1) on silica gel to afford 2.31 g (29%) of the title compound SI-19. (Hazrati & Oestreich, 2018).

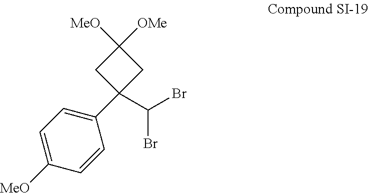 [SMILES: COc1ccc(C2(C(Br)Br)CC(OC)(OC)C2)cc1]

1-(1-(dibromomethyl)-3,3-dimethoxycyclobutyl)-4-methoxybenzene (SI-19)

Physical State: white solid. m.p.: 59-61° C. ¹H NMR (600 MHz, CDCl₃): δ 7.33-7.26 (m, 2H), 6.92-6.86 (m, 2H), 6.22 (s, 1H), 3.82 (s, 3H), 3.22 (s, 3H), 3.10 (s, 3H), 2.71-2.60 (m, 4H) ppm. ¹³C NMR (151 MHz, CDCl₃) δ 158.79, 133.80, 130.48, 112.67, 97.64, 58.64, 55.36, 48.81, 48.65, 45.40, 43.67 ppm. HRMS (ESI-TOF): calc'd for C₁₄H₁₈Br₂O₃[M+Na]⁺: 414.9515, found: 414.9508. TLC: R_{f}=0.45 (10:1 hexanes:ethyl acetate).

### Step 3: Synthesis of SI-20

A 100-mL one-necked (24/40 joint) round-bottomed flask, equipped with a Teflon-coated magnetic stir bar, was flame-dried under vacuum, and then cooled to 23° C. under an atmosphere of argon. Then the flask was charged with copper(I) iodide (114 mg, 0.6 mmol, 0.1 equiv.), B₂pin₂ (3.7 g, 14.5 mmol, 2.5 equiv.), and lithium tert-butoxide (1.16 g, 14.5 mmol, 2.5 equiv.). After being evacuated and backfilled with argon from a balloon 3 times, DMF (5 mL) was added into the flask at 0° C. Then a solution of ST-19 (5.8 mmol, 2.3 g, 1.0 equiv.) in DMF (10 mL) was added slowly into the mixture at 0° C. and the reaction mixture was allowed to slowly warm to room temperature and stir for another 1 hour. After it was confirmed that the starting material, SI-19, was consumed through TLC analysis, the reaction was filtered through Celite, washed with diethyl ether (50 mL) and quenched at 0° C. with water (100 mL) (Caution: the quenching process is exothermic). The mixture was then transferred into a 3-L separation funnel. The aqueous phase was separated and extracted with two 50-mL portions of diethyl ether. The combined organic layers were washed with the mixture of 50 mL water and 50 mL saturated NaCl solution twice, dried over Na₂SO₄, and filtered through Celite. (Yang et al., 2011)

After solvent was removed by rotary evaporator, the crude product was redissolved in 10 mL acetonitrile in a 50-mL flask. 2M H₂SO₄ (6 mL, 2.0 equiv.) was added into the mixture at room temperature and the reaction was allowed to stir for another 1.5 hours. After it was confirmed that the ketal intermediate was consumed through TLC analysis, the crude reaction was concentrated to remove excess acetonitrile. Then diethyl ether (40 mL) and saturated brine (15 mL) were added to the reaction mixture and the mixture was transferred to a 125-mL separatory funnel. The aqueous layer was separated and further extracted with diethyl ether (3×30 mL). The combined organic layers are dried over Na₂SO₄, filtered through Celite. Excess solvent was removed by rotary evaporator.

The crude product was redissolved in 20 mL methylene chloride in a 50 mL-flask and mesitylene sulfonyl hydrazide (1.24 g, 5.8 mmol, 1.0 equiv.) was added. The mixture was allowed to stir at room temperature for another 2 hours. After it was confirmed that the ketone intermediate was consumed through TLC analysis, the crude reaction was concentrated to remove excess solvent. The crude product was purified through flash chromatography (hexanes:ethyl acetate, 4:1 to 2:1) on silica gel to afford 2.72 g (73%) of the title compound SI-20.

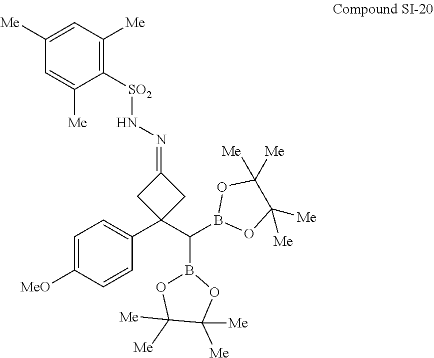 [SMILES: COc1ccc(C2(C(B3OC(C)(C)C(C)(C)O3)B3OC(C)(C)C(C)(C)O3)CC(=NNS(=O)(=O)c3c(C)cc(C)cc3C)C2)cc1]

### N′-(3-(bis(4,4,5,5-tetramethyl-1,3,2-dioxaborolan-2-yl)methyl)-3-(4-methoxyphenyl)cyclo-butylidene)-2,4,6-trimethylbenzenesulfonohydrazide (SI-20)

Physical State: white solid. m.p.: 155-157° C. ¹H NMR (600 MHz, Acetone-d₆) δ 9.04 (s, 1H), 7.24 (d, J=8.8 Hz, 2H), 6.98 (s, 2H), 6.89-6.64 (m, 2H), 3.74 (s, 3H), 3.40 (ddd, J=17.8, 3.4, 1.9 Hz, 1H), 3.32 (ddd, J=17.1, 3.4, 1.9 Hz, 1H), 3.16 (ddd, J=17.7, 3.5, 1.6 Hz, 1H), 3.09 (ddd, J=17.0, 3.5, 1.6 Hz, 1H), 2.63 (s, 6H), 2.26 (s, 3H), 1.31 (s, 1H), 1.11 (s, 12H), 1.10 (s, 12H) ppm. ¹³C NMR (151 MHz, Acetone-d₆) δ 158.50, 156.01, 143.72, 142.96, 140.72, 134.91, 132.40, 128.11, 113.93, 83.78, 83.71, 55.41, 47.78, 46.24, 46.21, 39.47, 25.21, 25.03, 24.88, 24.84, 23.44, 20.84 ppm. ¹¹B NMR (128 MHz, Acetone-d₆): δ 32.77 ppm. HRMS (ESI-TOF): calc'd for C₃₃H₄₈B₂N₂O₇S [M+H]⁺: 639.3441, found: 639.3447. TLC: R_{f}=0.30 (3:1 hexanes:ethyl acetate).

### Step 4: Synthesis of 27

A 100-mL one-necked (24/40 joint) round-bottomed flask, equipped with a Teflon-coated magnetic stir bar, was flame-dried under vacuum, and then cooled to 23° C. under an atmosphere of argon. Then the flask was charged with SI-20 (2.7 g, 4.2 mmol, 1.0 equiv.) and dried cesium carbonate (4.1 g, 12.6 mmol, 3.0 equiv.). (Note: Cesium carbonate was dried at 120° C. under vacuum for 18 hours.) After being evacuated and backfilled with argon from a balloon 3 times, dioxane (40 mL) was added into the flask and the reaction mixture was allowed to stir at 100° C. for 40 minutes. After it was confirmed that the starting material, SI-20, was consumed through TLC analysis, the reaction was cooled to room temperature, filtered through Celite, washed with hexanes (200 mL), and concentrated to remove excess solvents. The crude reaction was purified through flash chromatography (hexanes:ethyl acetate, 20:1) on silica gel to afford the title compound 27, which was further purified through trituration in hexanes at −20° C. affording 1.05 g product (59% yield) with >99% purity as white solids. (Yang et al., 2021b)

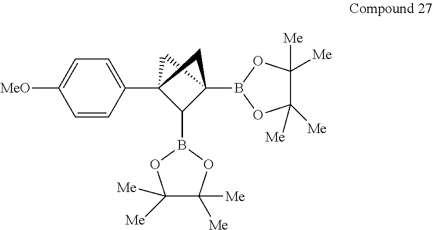 [SMILES: COc1ccc([C@]23C[C@](B4OC(C)(C)C(C)(C)O4)(C2)C3B2OC(C)(C)C(C)(C)O2)cc1]

### 2,2′-(3-(4-methoxyphenyl)bicyclo[1.1.1]pentane-1,2-diyl)bis(4,4,5,5-tetramethyl-1,3,2-dioxaborolane) (27)

Physical State: white solid. m.p.: 89-91° C. ¹H NMR (600 MHz, CDCl₃): δ 7.22-7.17 (m, 2H), 6.85-6.78 (m, 2H), 3.77 (s, 3H), 2.73 (dd, J=9.7, 2.2 Hz, 1H), 2.17 (dd, J=9.7, 1.5 Hz, 1H), 2.15-2.12 (m, 1H), 2.04 (dd, J=8.2, 2.2 Hz, 1H), 1.93 (dd, J=8.2, 0.9 Hz, 1H), 1.25 (d, J=1.3 Hz, 12H), 1.24 (s, 6H), 1.23 (s, 6H) ppm. ¹³C NMR (151 MHz, CDCl₃) δ 158.23, 135.32, 127.21, 113.47, 83.41, 83.05, 56.34, 55.40, 51.87, 49.01, 25.02, 24.92, 24.91, 24.87 ppm. ¹¹B NMR (128 MHz, CDCl₃): δ 32.00 ppm. HRMS (ESI-TOF): calc'd for C₂₄H₃₆B₂O₅ [M+H]⁺: 427.2822, found: 427.2819. TLC: R_{f}=0.43 (5:1 hexanes:ethyl acetate).

### B. X-ray Crystallographic Data for BCP BisBpin Compounds 16, 23-25, 27

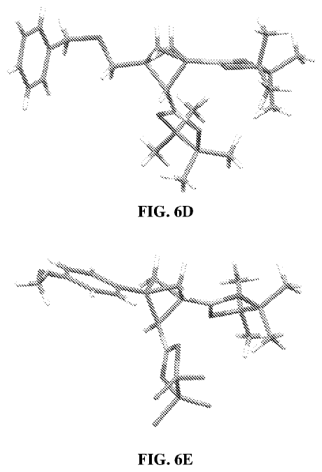

### Compound 16 (See FIG. 6A)

TABLE 1
Crystal data and structure refinement for compound 16.

| CCDC reference number: | 2158998. | |
|---|---|---|
| Empirical formula | C22 H28 B2 N2 O2 | |
| Formula weight | 374.08 | |
| Temperature | 100.01(11) | K |
| Wavelength | 1.54184 | Å |

| Crystal system | monoclinic | | |
|---|---|---|---|
| Space group | P 1 21/c 1 | | |
| Unit cell dimensions a = 9.47573(16) Å | a = 90°. | | |
| | b = 10.73100(19) | Å | b = 99.0998(15)°. |
| | c = 20.9064(3) | Å | g = 90°. |

| Volume | 2099.09(6) | Å3 |
|---|---|---|
| Z | 4 | |
| Density (calculated) | 1.184 | Mg/m3 |
| Absorption coefficient | 0.578 | mm − 1 |
| F(000) | 800 | |
| Crystal size | 0.41 × 0.25 × 0.14 | mm3 |
| Theta range for data collection | 4.283 to 73.370°. | |
| Index ranges | −11 <= h <= 11, −13 <= k <= 13, −25 <= 1 <= 25 | |
| Reflections collected | 11994 | |
| Independent reflections | 4105 [R(int) = 0.0246] | |
| Completeness to theta = 67.684° | 99.6% | |
| Absorption correction | Semi-empirical from equivalents | |
| Max. and min. transmission | 1.00000 and 0.88926 | |
| Refinement method | Full-matrix least-squares on F2 | |
| Data/restraints/parameters | 4105/39/353 | |
| Goodness-of-fit on F2 | 1.099 | |
| Final R indices [I > 2sigma(I)] | R1 = 0.0488, wR2 = 0.1287 | |
| R indices (all data) | R1 = 0.0522, wR2 = 0.1316 | |
| Extinction coefficient | n/a | |
| Largest diff. peak and hole | 0.277 and −0.248 | e · Å − 3 |

TABLE 2
Atomic coordinates (×10⁴) and equivalent isotropic displacement
parameters (Å² × 10³) for 1. U(eq) is defined as one
third of the trace of the orthogonalized U^{ij} tensor.

| | x | y | z | U(eq) |
|---|---|---|---|---|
| N1 | 2334(1) | 6798(1) | 2618(1) | 23(1) |
| N2 | 560(1) | 8336(1) | 2763(1) | 25(1) |
| C1 | 1666(1) | 6538(1) | 1991(1) | 22(1) |
| C2 | 2192(2) | 5657(1) | 1607(1) | 28(1) |
| C3 | 1505(2) | 5457(2) | 968(1) | 32(1) |
| C4 | 311(2) | 6112(2) | 719(1) | 29(1) |
| C5 | −283(2) | 7006(1) | 1099(1) | 25(1) |
| C6 | −1535(2) | 7689(1) | 860(1) | 30(1) |
| C7 | −2060(2) | 8547(2) | 1246(1) | 33(1) |
| C8 | −1374(2) | 8783(1) | 1882(1) | 30(1) |
| C9 | −160(2) | 8134(1) | 2133(1) | 23(1) |
| C10 | 406(1) | 7222(1) | 1746(1) | 22(1) |
| C11 | 2660(1) | 7938(1) | 3721(1) | 23(1) |
| C15 | 3693(2) | 8174(1) | 4573(1) | 27(1) |
| C16 | 4506(2) | 8338(2) | 5246(1) | 41(1) |
| C17 | 6497(2) | 5607(2) | 3277(1) | 37(1) |
| C18 | 7402(2) | 5924(1) | 3944(1) | 29(1) |
| B2 | 1829(2) | 7697(2) | 3025(1) | 23(1) |
| O1 | 5191(9) | 6303(6) | 3308(4) | 26(1) |
| O2 | 6758(2) | 7065(2) | 4149(1) | 30(1) |
| C12 | 2818(3) | 6979(2) | 4288(1) | 30(1) |
| C13 | 2423(3) | 8934(3) | 4240(1) | 32(1) |
| C14 | 4316(2) | 8186(2) | 3929(1) | 27(1) |
| C19 | 7124(8) | 6387(5) | 2732(3) | 65(2) |
| C20 | 6278(6) | 4340(6) | 3089(2) | 47(1) |
| C21 | 8986(3) | 6138(3) | 3970(2) | 50(1) |
| C22 | 7186(3) | 4929(3) | 4438(1) | 40(1) |
| B1 | 5435(3) | 7166(3) | 3798(1) | 27(1) |
| O1A | 5047(16) | 6002(11) | 3356(7) | 44(3) |
| O2A | 6354(3) | 6356(4) | 4335(2) | 40(1) |
| C12A | 3697(4) | 7014(3) | 4173(2) | 18(1) |
| C13A | 3818(4) | 8958(3) | 3920(2) | 22(1) |
| C14A | 2046(4) | 8307(5) | 4353(2) | 26(1) |
| C23 | 8259(7) | 7089(6) | 3832(3) | 61(2) |
| C24 | 8383(7) | 4979(6) | 4307(3) | 62(2) |
| B3 | 5069(4) | 6491(4) | 3947(2) | 18(1) |
| C20A | 6059(13) | 4088(11) | 3318(6) | 75(3) |
| C19A | 7037(9) | 5785(9) | 2692(5) | 62(2) |

TABLE 3
Crystal data and structure refinement for compound
23. CCDC reference number: 2158994.

| Empirical formula | C21 H36 B2 O6 | |
|---|---|---|
| Formula weight | 406.12 | |
| Temperature | 100.04(15) | K |
| Wavelength | 1.54184 | Å |

| Crystal system | monoclinic | | |
|---|---|---|---|
| Space group | C 1 c 1 | | |
| Unit cell dimensions a = 9.8439(9) Å | a = 90°. | | |
| | b = 16.3337(19) | Å | b = 90.304(8)°. |
| | c = 14.8019(9) | Å | g = 90°. |

| Volume | 2379.9(4) Å3 | |
|---|---|---|
| Z | 4 | |
| Density (calculated) | 1.133 | Mg/m3 |
| Absorption coefficient | 0.642 | mm − 1 |
| F(000) | 880 | |
| Crystal size | 0.2 × 0.14 × 0.055 | mm3 |
| Theta range for data collection | 5.246 to 76.734°. | |
| Index ranges | −9 <= h <= 12, −20 <= k <= 20, −18 <= 1 <= 9 | |
| Reflections collected | 6562 | |
| Independent reflections | 2980 [R(int) = 0.0566] | |
| Completeness to theta = 67.684° | 96.7% | |
| Absorption correction | Semi-empirical from equivalents | |
| Max. and min. transmission | 1.000 and 0.60810 | |
| Refinement method | Full-matrix least-squares on F2 | |
| Data/restraints/parameters | 2980/248/340 | |
| Goodness-of-fit on F2 | 1.064 | |
| Final R indices [I > 2sigma(I)] | R1 = 0.0707, wR2 = 0.1960 | |
| R indices (all data) | R1 = 0.0919, wR2 = 0.2156 | |
| Absolute structure parameter | 0.3(3) | |
| Extinction coefficient | n/a | |
| Largest diff. peak and hole | 0.480 and −0.309 | e · Å − 3 |

TABLE 4
Atomic coordinates (×104) and equivalent isotropic displacement
parameters (Å2 × 103) for 1. U(eq) is defined
as one third of the trace of the orthogonalized Uij tensor.

| | x | y | z | U(eq) |
|---|---|---|---|---|
| B1 | 6913(6) | 6690(4) | 3443(4) | 50(1) |
| C1 | 6524(6) | 7115(4) | 2018(4) | 61(2) |
| C2 | 7739(7) | 6534(4) | 2026(4) | 62(2) |
| C3 | 5213(9) | 6730(6) | 1681(6) | 97(3) |
| C4 | 6766(10) | 7921(4) | 1504(6) | 86(2) |
| C5 | 7704(12) | 5842(6) | 1336(6) | 103(3) |
| C6 | 9115(8) | 6955(6) | 2011(7) | 99(3) |
| C7 | 6719(6) | 6572(4) | 4477(4) | 56(1) |
| C11 | 6433(5) | 6374(3) | 5719(4) | 50(1) |
| C12 | 6171(5) | 6190(3) | 6685(4) | 48(1) |
| C13 | 7198(7) | 6177(4) | 8168(4) | 67(2) |
| C14 | 6572(9) | 6857(6) | 8659(6) | 89(2) |
| C15 | 8641(8) | 5995(6) | 8434(5) | 87(2) |
| O1 | 6344(5) | 7309(3) | 2970(3) | 68(1) |
| O2 | 7629(5) | 6158(3) | 2923(3) | 71(1) |
| O3 | 5129(4) | 5897(3) | 6976(3) | 67(1) |
| O4 | 7250(4) | 6377(3) | 7210(2) | 58(1) |
| B2 | 4240(20) | 5903(14) | 4737(11) | 54(4) |
| C8 | 5376(10) | 6519(6) | 4997(7) | 49(2) |
| C9 | 7355(15) | 6990(9) | 5301(10) | 56(3) |
| C10 | 7097(11) | 5697(7) | 5038(7) | 55(2) |
| C16 | 2250(30) | 5565(12) | 4070(20) | 56(4) |
| C17 | 2840(30) | 4793(11) | 4560(20) | 58(4) |
| C18 | 2420(40) | 5536(18) | 3090(30) | 63(5) |
| C19 | 1000(80) | 5720(50) | 4390(50) | 78(7) |
| C20 | 2890(50) | 4010(20) | 4060(30) | 67(6) |
| C21 | 2220(80) | 4640(30) | 5490(60) | 71(6) |
| O5 | 3045(11) | 6221(7) | 4431(8) | 65(3) |
| O6 | 4245(12) | 5090(9) | 4707(8) | 66(3) |
| B2A | 4642(16) | 5523(16) | 4687(9) | 38(3) |
| C8A | 6071(11) | 5852(7) | 4918(8) | 45(2) |
| C9A | 7740(12) | 6654(9) | 5257(9) | 39(3) |
| C10A | 5741(11) | 7120(7) | 5133(7) | 42(2) |
| C16A | 2480(30) | 5367(17) | 4120(30) | 56(4) |
| C17A | 2910(40) | 4562(15) | 4570(30) | 58(4) |
| C18A | 2630(50) | 5330(20) | 3010(40) | 63(5) |
| C19A | 850(100) | 5800(60) | 4290(60) | 78(7) |
| C20A | 2700(60) | 3850(30) | 3950(40) | 67(6) |
| C21A | 2300(100) | 4460(40) | 5510(70) | 71(6) |
| O5A | 3596(16) | 5969(7) | 4450(11) | 58(3) |
| O6A | 4362(12) | 4694(7) | 4703(8) | 51(3) |

### Compound 24 (See FIG. 6C)

TABLE 5
Crystal data and structure refinement for compound
24. CCDC reference number: 2158995.

| Empirical formula | C29 H45 B2 N O6 | |
|---|---|---|
| Formula weight | 525.28 | |
| Temperature | 100.02(12) | K |
| Wavelength | 0.71073 | Å |

| Crystal system | monoclinic | |
|---|---|---|
| Space group | P 1 21 1 | |
| Unit cell dimensions a = 15.4484(4) Å | a = 90°. | |
| | b = 12.6264(2) Å | b = 102.262(2)°. |
| | c = 15.9625(4) Å | g = 90° |

| Volume | 3042.57(11) | Å3 |
|---|---|---|
| Z | 4 | |
| Density (calculated) | 1.147 | Mg/m3 |
| Absorption coefficient | 0.077 | mm − 1 |
| F(000) | 1136 | |
| Crystal size | 0.44 × 0.23 × 0.23 | mm3 |
| Theta range for data collection | 2.319 to 33.170°. | |
| Index ranges | −22 <= h <= 22, −18 <= k <= 18, −22 <= 1 <= 23 | |
| Reflections collected | 64772 | |
| Independent reflections | 19333 [R(int) = 0.0441] | |
| Completeness to theta = 25.242° | 99.9% | |
| Absorption correction | Semi-empirical from equivalents | |
| Max. and min. transmission | 1.000 and 0.65168 | |
| Refinement method | Full-matrix least-squares on F2 | |
| Data/restraints/parameters | 19333/750/1059 | |
| Goodness-of-fit on F2 | 1.046 | |
| Final R indices [I > 2sigma(I)] | R1 = 0.0439, wR2 = 0.1030 | |
| R indices (all data) | R1 = 0.0606, wR2 = 0.1103 | |
| Absolute structure parameter | 0.1(3) | |
| Extinction coefficient | n/a | |
| Largest diff. peak and hole | 0.391 and −0.299 | e · Å − 3 |

TABLE 6
Atomic coordinates (×10⁴) and equivalent isotropic displacement
parameters (Å² × 10³) for 1. U(eq) is defined as one
third of the trace of the orthogonalized U^{ij} tensor.

| | x | y | z | U(eq) |
|---|---|---|---|---|
| O1 | 10352(2) | 2841(2) | 2916(2) | 31(1) |
| O2 | 8946(2) | 2778(1) | 2104(2) | 29(1) |
| O3 | 8091(2) | 4755(2) | 3193(2) | 26(1) |
| O4 | 7492(2) | 6210(3) | 2422(3) | 30(1) |
| O5 | 9517(1) | 8766(1) | 1383(1) | 32(1) |
| O6 | 8949(1) | 7198(1) | 812(1) | 25(1) |
| N1 | 9828(1) | 7222(1) | 2116(1) | 22(1) |
| C1 | 10119(2) | 1714(2) | 2827(2) | 28(1) |
| C2 | 9094(2) | 1758(2) | 2548(2) | 25(1) |
| C3 | 10556(3) | 1272(3) | 2130(3) | 41(1) |
| C4 | 10458(3) | 1172(5) | 3668(5) | 45(1) |
| C5 | 8683(9) | 892(12) | 1949(11) | 32(1) |
| C6 | 8635(3) | 1828(2) | 3299(3) | 42(1) |
| C7 | 7386(4) | 5124(3) | 3598(3) | 23(1) |
| C8 | 6839(2) | 5864(3) | 2905(2) | 32(1) |
| C9 | 6901(4) | 4167(5) | 3853(4) | 38(1) |
| C10 | 7838(2) | 5726(2) | 4408(2) | 33(1) |
| C11 | 6124(2) | 5278(4) | 2271(2) | 61(1) |
| C12 | 6464(2) | 6836(3) | 3263(2) | 52(1) |
| C13 | 9700(1) | 4612(1) | 2292(1) | 24(1) |
| C14 | 8866(1) | 5386(2) | 1996(1) | 21(1) |
| C15 | 10078(2) | 5427(2) | 2985(1) | 23(1) |
| C16 | 10153(2) | 5233(2) | 1665(1) | 23(1) |
| C17 | 9750(1) | 6085(1) | 2170(1) | 19(1) |
| C18 | 10416(1) | 7770(1) | 2811(1) | 25(1) |
| C19 | 9432(1) | 7811(1) | 1425(1) | 22(1) |
| C20 | 8404(1) | 7681(2) | 44(1) | 30(1) |
| C21 | 8004(1) | 6715(2) | −465(1) | 36(1) |
| C22 | 8980(2) | 8302(2) | −449(1) | 42(1) |
| C23 | 7689(2) | 8365(2) | 291(2) | 51(1) |
| C24 | 9984(1) | 8152(1) | 3523(1) | 24(1) |
| C25 | 10527(1) | 8404(1) | 4319(1) | 31(1) |
| C26 | 10164(2) | 8814(2) | 4974(1) | 37(1) |
| C27 | 9267(2) | 8975(2) | 4847(1) | 40(1) |
| C28 | 8720(2) | 8720(2) | 4063(1) | 35(1) |
| C29 | 9080(1) | 8305(1) | 3403(1) | 28(1) |
| B1 | 9670(1) | 3396(1) | 2432(1) | 24(1) |
| B2 | 8150(3) | 5467(2) | 2552(3) | 21(1) |
| O7 | 6380(3) | 7006(4) | 5910(3) | 25(1) |
| O8 | 6978(3) | 7253(4) | 7334(3) | 28(1) |
| O9 | 5077(3) | 5694(3) | 7748(3) | 34(1) |
| O10 | 5784(2) | 4825(2) | 8977(1) | 43(1) |
| O11 | 6814(1) | 1376(1) | 8199(1) | 40(1) |
| O12 | 7517(1) | 2951(1) | 8526(1) | 30(1) |
| N2 | 6553(1) | 2782(1) | 7283(1) | 28(1) |
| C30 | 6583(3) | 8128(5) | 6010(3) | 22(1) |
| C31 | 6700(4) | 8299(6) | 6989(4) | 26(1) |
| C32 | 5854(3) | 8774(3) | 5469(3) | 42(1) |
| C33 | 7446(3) | 8300(2) | 5705(2) | 33(1) |
| C34 | 5849(4) | 8542(3) | 7278(4) | 50(1) |
| C35 | 7411(3) | 9102(3) | 7382(3) | 36(1) |
| C36 | 4460(3) | 5639(3) | 8330(2) | 38(1) |
| C37 | 5052(2) | 5390(3) | 9201(2) | 43(1) |
| C38 | 3824(3) | 4719(4) | 7995(3) | 54(1) |
| C39 | 3952(7) | 6671(8) | 8201(4) | 45(1) |
| C40 | 4636(4) | 4716(4) | 9794(3) | 54(1) |
| C41 | 5422(3) | 6420(4) | 9666(3) | 60(1) |
| C42 | 6707(1) | 5338(1) | 6861(1) | 22(1) |
| C43 | 6628(2) | 4847(2) | 7754(2) | 22(1) |
| C44 | 7401(2) | 4468(2) | 6807(2) | 25(1) |
| C45 | 5983(2) | 4524(2) | 6424(2) | 26(1) |
| C46 | 6651(1) | 3895(1) | 7112(1) | 22(1) |
| C47 | 6951(1) | 2291(1) | 8026(1) | 29(1) |
| C48 | 7930(1) | 2659(2) | 9417(1) | 31(1) |
| C49 | 8447(2) | 3657(2) | 9741(1) | 42(1) |
| C50 | 7226(2) | 2445(2) | 9922(1) | 45(1) |
| C51 | 8560(1) | 1738(2) | 9420(1) | 36(1) |
| C52 | 5951(1) | 2167(1) | 6638(1) | 30(1) |
| C53 | 6327(1) | 1848(1) | 5875(1) | 26(1) |
| C54 | 5756(1) | 1669(1) | 5088(1) | 31(1) |
| C55 | 6078(2) | 1342(2) | 4384(1) | 38(1) |
| C56 | 6980(2) | 1185(2) | 4461(1) | 38(1) |
| C57 | 7553(1) | 1366(2) | 5240(1) | 35(1) |
| C58 | 7230(1) | 1698(1) | 5945(1) | 30(1) |
| B3 | 6705(1) | 6557(1) | 6698(1) | 22(1) |
| B4 | 5819(2) | 5107(2) | 8156(2) | 26(1) |
| C64 | 10622(4) | 5357(5) | 2396(5) | 23(2) |
| C61 | 5883(4) | 4641(5) | 6910(5) | 26(2) |
| C60 | 7017(5) | 4391(5) | 6322(5) | 29(2) |
| C59 | 7219(4) | 4730(4) | 7676(4) | 24(2) |
| C62 | 9419(5) | 5520(5) | 2892(4) | 18(1) |
| C63 | 9339(5) | 5285(5) | 1522(4) | 23(2) |
| O2A | 9275(5) | 2681(4) | 1842(4) | 25(1) |
| O1A | 10109(6) | 2962(5) | 3184(5) | 29(2) |
| C1A | 9845(7) | 1843(6) | 3166(5) | 34(2) |
| C3A | 10690(11) | 1252(17) | 3637(17) | 45(1) |
| C4A | 9122(9) | 1778(8) | 3678(7) | 46(3) |
| C5A | 10258(8) | 1244(9) | 1773(8) | 36(3) |
| C6A | 8730(30) | 910(30) | 1940(30) | 32(1) |
| C2A | 9531(4) | 1629(5) | 2193(4) | 22(2) |
| O13 | 5123(5) | 4232(5) | 8189(6) | 79(3) |
| B5 | 5377(5) | 4937(6) | 7629(6) | 31(2) |
| C66 | 4503(5) | 4784(7) | 8608(6) | 48(2) |
| C65 | 4788(6) | 6000(8) | 8581(5) | 37(2) |
| C67 | 4565(13) | 4263(15) | 9463(10) | 87(5) |
| O17 | 5299(9) | 5962(10) | 7925(9) | 66(3) |
| C68 | 3508(7) | 4529(11) | 8043(9) | 54(1) |
| C70 | 4053(18) | 6760(20) | 8417(13) | 45(1) |
| C69 | 5501(7) | 6219(9) | 9289(7) | 60(1) |
| C34A | 6336(14) | 8615(8) | 7642(10) | 55(4) |
| C31A | 6931(12) | 8373(18) | 7043(10) | 27(4) |
| C35A | 7718(11) | 9116(10) | 7146(11) | 48(4) |
| C30A | 6439(11) | 8265(15) | 6116(10) | 37(5) |
| C32A | 5578(8) | 8855(8) | 5832(12) | 46(3) |
| C33A | 6992(13) | 8346(8) | 5452(8) | 47(3) |
| O4A | 7731(6) | 5977(7) | 2387(8) | 35(2) |
| O3A | 8127(7) | 4883(8) | 3512(6) | 37(2) |
| C7A | 7175(10) | 5105(12) | 3466(9) | 55(6) |
| C9A | 6720(15) | 4097(16) | 3619(13) | 57(5) |
| C10A | 7184(9) | 5937(9) | 4169(8) | 67(3) |
| C8A | 6902(6) | 5538(7) | 2539(7) | 47(2) |
| C12A | 6216(7) | 6372(9) | 2418(11) | 83(4) |
| C11A | 6671(7) | 4632(9) | 1881(7) | 62(3) |
| B6 | 8407(7) | 5464(7) | 2911(8) | 28(2) |
| O15 | 7272(8) | 7271(11) | 7266(10) | 29(2) |
| O14 | 6172(10) | 7084(13) | 6065(10) | 29(2) |

### Compound 25 (See FIG. 6D)

TABLE 7
Crystal data and structure refinement for compound
25. CCDC reference number: 2159016.

| Empirical formula | C25 H38 B2 O5 | |
|---|---|---|
| Formula weight | 440.17 | |
| Temperature | 100.01(11) | K |
| Wavelength | 1.54184 | Å |

| Crystal system | monoclinic | | |
|---|---|---|---|
| Space group | P 1 21/c 1 | | |
| Unit cell dimensions a = 15.7568(3) Å | a = 90°. | | |
| | b = 10.60872(17) | Å | b = 93.4675(14)°. |
| | c = 14.8400(2) | Å | g = 90°. |

| Volume | 2476.11(7) | Å3 |
|---|---|---|
| Z | 4 | |
| Density (calculated) | 1.181 | Mg/m3 |
| Absorption coefficient | 0.626 | mm − 1 |
| F(000) | 952 | |
| Crystal size | 0.392 × 0.202 × 0.111 | mm3 |
| Theta range for data collection | 5.029 to 77.049°. | |
| Index ranges | −16 <= h <= 19, −6 <= k <= 13, −17 <= 1 <= 18 | |
| Reflections collected | 13236 | |
| Independent reflections | 4940 [R(int) = 0.0257] | |
| Completeness to theta = 67.684° | 98.7% | |
| Absorption correction | Gaussian and multi-scan | |
| Max. and min. transmission | 1.000 and 0.625 | |
| Refinement method | Full-matrix least-squares on F2 | |
| Data/restraints/parameters | 4940/849/548 | |
| Goodness-of-fit on F2 | 1.024 | |
| Final R indices [I > 2sigma(I)] | R1 = 0.0501, wR2 = 0.1365 | |
| R indices (all data) | R1 = 0.0551, wR2 = 0.1409 | |
| Extinction coefficient | n/a | |
| Largest diff. peak and hole | 0.351 and −0.277 | e · Å − 3 |

TABLE 8
Atomic coordinates (×10⁴) and equivalent isotropic displacement
parameters (Å² × 10³) for 1. U(eq) is defined as one
third of the trace of the orthogonalized U^{ij} tensor.

| | x | y | z | U(eq) |
|---|---|---|---|---|
| C8 | 2188(1) | 5284(1) | 3754(1) | 27(1) |
| C12 | 2420(1) | 5272(2) | 2512(1) | 34(1) |
| B1 | 1978(1) | 5155(1) | 4761(1) | 27(1) |
| O1 | 1239(4) | 4665(8) | 4995(2) | 33(1) |
| O2 | 2556(3) | 5433(5) | 5462(3) | 28(1) |
| O3 | 3576(1) | 2798(2) | 4147(1) | 36(1) |
| O4 | 4083(1) | 3623(1) | 2869(1) | 35(1) |
| O5 | 2406(1) | 6305(1) | 1080(1) | 31(1) |
| C2 | 2217(4) | 4834(4) | 6262(3) | 27(1) |
| C3 | 1246(4) | 4766(7) | 5980(3) | 31(1) |
| C4 | 2616(5) | 3534(5) | 6371(5) | 36(1) |
| C5 | 2441(6) | 5673(8) | 7067(5) | 30(1) |
| C6 | 768(6) | 3638(9) | 6321(6) | 45(2) |
| C7 | 773(7) | 5981(9) | 6188(8) | 37(2) |
| C9 | 2511(1) | 4124(2) | 3162(1) | 25(1) |
| C10 | 2859(1) | 6099(2) | 3250(1) | 27(1) |
| C11 | 1566(1) | 5580(2) | 2910(1) | 28(1) |
| C14 | 4424(3) | 2248(5) | 4081(5) | 35(1) |
| C15 | 4834(2) | 3159(3) | 3390(2) | 31(1) |
| C16 | 4256(4) | 908(5) | 3692(4) | 43(1) |
| C17 | 4858(2) | 2215(3) | 5018(2) | 50(1) |
| C18 | 5412(2) | 2525(3) | 2760(2) | 41(1) |
| C19 | 5263(2) | 4286(2) | 3842(2) | 43(1) |
| C20 | 2569(1) | 5137(2) | 1516(1) | 31(1) |
| C21 | 2493(2) | 6233(2) | 128(1) | 33(1) |
| C22 | 1768(2) | 5548(2) | −367(2) | 30(1) |
| C23 | 1806(2) | 4249(2) | −521(1) | 30(1) |
| C24 | 1114(2) | 3611(2) | −913(2) | 34(1) |
| C25 | 378(2) | 4266(3) | −1185(2) | 38(1) |
| C26 | 340(3) | 5572(3) | −1068(3) | 41(1) |
| C27 | 1033(2) | 6191(3) | −651(3) | 36(1) |
| B2 | 3405(2) | 3520(3) | 3400(2) | 26(1) |
| O1A | 1139(6) | 4926(8) | 4991(6) | 27(1) |
| O2A | 2502(7) | 5237(11) | 5522(6) | 27(1) |
| O3A | 3455(5) | 2870(9) | 3759(5) | 52(2) |
| O4A | 4470(5) | 4308(6) | 3589(5) | 66(2) |
| O5A | 2064(5) | 5552(8) | 1093(4) | 35(2) |
| C2A | 2031(8) | 4822(11) | 6287(7) | 27(1) |
| C3A | 1099(8) | 4953(11) | 5978(7) | 27(1) |
| C4A | 2341(15) | 3465(14) | 6445(13) | 54(4) |
| C5A | 2284(12) | 5600(20) | 7131(11) | 30(1) |
| C6A | 549(13) | 3840(16) | 6238(15) | 46(4) |
| C7A | 708(17) | 6195(19) | 6228(19) | 37(3) |
| C9A | 3060(5) | 5323(8) | 3446(5) | 42(2) |
| C10A | 1899(6) | 6344(9) | 3126(5) | 49(2) |
| C11A | 1899(6) | 4319(8) | 3037(5) | 47(2) |
| C14A | 4243(13) | 2267(18) | 4090(20) | 35(1) |
| C15A | 4885(9) | 3077(13) | 3672(6) | 31(1) |
| C16A | 4439(16) | 980(30) | 3880(19) | 77(7) |
| C17A | 4269(7) | 2285(11) | 5114(5) | 59(2) |
| C18A | 5050(8) | 2747(12) | 2688(9) | 56(3) |
| C19A | 5724(7) | 3335(15) | 4227(9) | 92(4) |
| C20A | 2786(8) | 5760(14) | 1685(7) | 38(2) |
| C21A | 2206(9) | 5787(14) | 135(9) | 37(3) |
| C22A | 1538(11) | 5224(15) | −399(12) | 32(2) |
| C23A | 1495(11) | 3944(15) | −580(11) | 31(2) |
| C24A | 820(10) | 3414(18) | −1036(12) | 36(2) |
| C25A | 134(12) | 4105(19) | −1321(13) | 36(2) |
| C26A | 197(18) | 5290(20) | −1153(18) | 38(3) |
| C27A | 822(15) | 5952(19) | −712(18) | 33(2) |
| B2A | 3710(6) | 4162(8) | 3592(6) | 40(2) |

### Compound 27 (See FIG. 6E)

TABLE 9
Crystal data and structure refinement for compound
27. CCDC reference number: 2159001.

| Empirical formula | C24 H35.99 B2 O5 | |
|---|---|---|
| Formula weight | 426.08 | |
| Temperature | 100.01(11) | K |
| Wavelength | 1.54184 | Å |

| Crystal system | monoclinic | | |
|---|---|---|---|
| Space group | P 1 n 1 | | |
| Unit cell dimensions a = 12.02588(16) Å | a = 90°. | | |
| | b = 6.61763(11) | Å | b = 93.5949(13)°. |
| | c = 14.9926(2) | Å | g = 90°. |

| Volume | 1190.81(3) Å3 | |
|---|---|---|
| Z | 2 | |
| Density (calculated) | 1.188 | Mg/m3 |
| Absorption coefficient | 0.635 | mm − 1 |
| F(000) | 460 | |
| Crystal size | 0.398 × 0.314 × 0.239 | mm3 |
| Theta range for data collection | 4.576 to 76.923°. | |
| Index ranges | −11 <= h <= 15, −7 <= k <= 8, −18 <= 1 <= 18 | |
| Reflections collected | 11284 | |
| Independent reflections | 3931 [R(int) = 0.0230] | |
| Completeness to theta = 67.684° | 100.0% | |
| Absorption correction | Semi-empirical from equivalents | |
| Max. and min. transmission | 1.00000 and 0.37195 | |
| Refinement method | Full-matrix least-squares on F2 | |
| Data/restraints/parameters | 3931/466/409 | |
| Goodness-of-fit on F2 | 1.031 | |
| Final R indices [I > 2sigma(I)] | R1 = 0.0530, wR2 = 0.1448 | |
| R indices (all data) | R1 = 0.0535, wR2 = 0.1454 | |
| Absolute structure parameter | 0.13(7) | |
| Extinction coefficient | n/a | |
| Largest diff. peak and hole | 0.676 and −0.388 | e · Å − 3 |

TABLE 10
Atomic coordinates (×10⁴) and equivalent isotropic displacement
parameters (Å² × 10³) for 1. U(eq) is defined as one
third of the trace of the orthogonalized U^{ij} tensor.

| | x | y | z | U(eq) |
|---|---|---|---|---|
| O1 | 2501(2) | 5819(4) | 6840(2) | 36(1) |
| O2 | 3006(2) | 2933(4) | 6139(2) | 34(1) |
| O3 | 9312(2) | 11515(4) | 4396(2) | 36(1) |
| C1 | 1577(3) | 4393(5) | 6916(2) | 36(1) |
| C2 | 2142(3) | 2337(5) | 6729(2) | 33(1) |
| C3 | 1150(4) | 4579(7) | 7848(3) | 48(1) |
| C4 | 683(3) | 4972(6) | 6201(3) | 45(1) |
| C5 | 2743(3) | 1414(6) | 7559(2) | 42(1) |
| C6 | 1387(4) | 793(5) | 6250(3) | 41(1) |
| C7 | 4260(3) | 6047(5) | 5964(2) | 31(1) |
| C11 | 5534(3) | 7416(5) | 5559(2) | 29(1) |
| C12 | 6524(3) | 8504(5) | 5252(2) | 28(1) |
| C13 | 7589(3) | 7661(5) | 5318(2) | 32(1) |
| C14 | 8497(3) | 8700(5) | 5037(2) | 33(1) |
| C15 | 8367(3) | 10626(5) | 4672(2) | 28(1) |
| C16 | 7315(3) | 11506(5) | 4607(2) | 32(1) |
| C17 | 6406(3) | 10442(5) | 4894(2) | 32(1) |
| C18 | 9184(3) | 13382(6) | 3924(3) | 40(1) |
| B1 | 3241(3) | 4913(6) | 6309(2) | 30(1) |
| O4 | 3406(6) | 6690(9) | 3540(4) | 44(2) |
| O5 | 3515(5) | 9485(9) | 4407(4) | 42(2) |
| C8 | 4588(4) | 6318(6) | 4971(3) | 29(1) |
| C9 | 5521(4) | 5534(7) | 6195(3) | 34(1) |
| C10 | 4610(4) | 8307(7) | 6124(3) | 34(1) |
| C19 | 2587(7) | 8129(12) | 3120(5) | 30(1) |
| C20 | 3028(6) | 10189(10) | 3514(4) | 18(1) |
| C21 | 2718(12) | 7970(30) | 2107(8) | 52(3) |
| C22 | 1440(8) | 7489(18) | 3365(8) | 43(3) |
| C23 | 3958(7) | 11150(13) | 3033(6) | 38(2) |
| C24 | 2112(10) | 11691(15) | 3745(7) | 46(2) |
| B2 | 3833(13) | 7507(19) | 4261(8) | 25(1) |
| C8A | 4239(14) | 8140(30) | 5396(10) | 32(3) |
| C9A | 5042(15) | 5290(30) | 5227(11) | 29(3) |
| C10A | 5315(15) | 6780(30) | 6509(11) | 29(3) |
| O5A | 4117(8) | 9282(19) | 3806(8) | 52(3) |
| O6A | 2666(7) | 7752(16) | 4302(6) | 42(2) |
| B2A | 3810(18) | 7590(30) | 4307(12) | 25(1) |
| C20A | 3254(14) | 9100(20) | 2950(9) | 68(5) |
| C23A | 3020(20) | 7710(40) | 2147(14) | 52(3) |
| C24A | 3385(15) | 11380(20) | 2607(10) | 35(3) |
| C19A | 2289(11) | 9140(20) | 3578(10) | 64(4) |
| C21A | 1153(12) | 8340(30) | 3186(12) | 39(2) |
| C22A | 2387(15) | 11330(20) | 4047(9) | 46(2) |
| O6B | 2854(8) | 6883(14) | 3975(6) | 32(2) |
| O5B | 3840(9) | 10010(15) | 3979(7) | 47(3) |
| C19B | 2471(8) | 8069(15) | 3218(6) | 30(1) |
| C20B | 2984(10) | 10201(12) | 3285(6) | 18(1) |
| C21B | 1225(8) | 8220(30) | 3182(11) | 39(2) |
| C22B | 2796(15) | 7065(18) | 2376(6) | 52(3) |
| C23B | 3455(15) | 10804(18) | 2421(7) | 35(3) |
| C24B | 2133(15) | 11734(18) | 3523(10) | 46(2) |
| B2B | 3683(9) | 8356(17) | 4575(5) | 25(1) |

### C. General Experimental Procedures and Characterization Data of Substrates in 1^{st} Functionalization of BCP BisBoronates

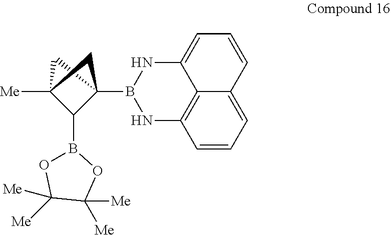 [SMILES: CC1(C)OB(C2[C@]3(C)C[C@@]2(B2Nc4cccc5cccc(c45)N2)C3)OC1(C)C]

2-(3-methyl-2-(4,4,5,5-tetramethyl-1,3,2-dioxaborolan-2-yl)bicyclo[1.1.1]pentan-1-yl)-2,3-dihydro-1H-naphtho[1,8-de][1,3,2]diazaborinine (16)

A flame-dried culture tube was charged with BCP bis-boronate 14 (33.4 mg, 0.1 mmol, 1.0 equiv.) and 1,8-diaminonaphthalene (31.6 mg, 0.2 mmol, 2.0 equiv.). Then the tube was evacuated and backfilled with argon for three times, followed by addition of toluene (1.0 mL, 0.1 M) via a syringe. After stirring for at 100° C. for 12 hours, the reaction mixture was cooled to room temperature. Next, the solvent was removed under high vacuum, and the crude residue was purified by chromatography on silica gel (50:1, hexanes:ethyl acetate) to afford 22.4 mg (60%) of the title compound 16.

Physical State: white solid.

m.p.: 162-164° C.

¹H NMR (600 MHz, CDCl₃): δ 7.08 (dd, J=8.2, 7.3 Hz, 2H), 6.97 (dd, J=8.3, 0.9 Hz, 2H), 6.28-6.23 (m, 4H), 2.07 (dd, J=9.8, 2.5 Hz, 1H), 1.79 (s, 1H), 1.77 (dd, J=9.8, 1.3 Hz, 1H), 1.73 (dd, J=8.8, 2.5 Hz, 1H), 1.55 (d, J=8.7 Hz, 1H), 1.35 (s, 12H), 1.19 (s, 3H) ppm.

¹³C NMR (151 MHz, CDCl₃): δ 141.70, 136.56, 127.65, 119.93, 117.14, 105.36, 83.45, 55.08, 54.21, 44.23, 25.27, 25.05, 20.12 ppm.

¹¹B NMR (128 MHz, CDCl₃): δ 32.50, 29.75 ppm.

TLC: R_{f}=0.40 (10:1 hexanes:ethyl acetate).

### General Procedure A for Hydrazone Coupling of BCP BisBoronates

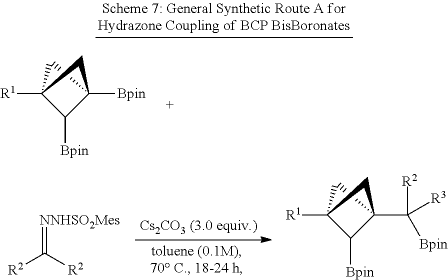

A screw-capped culture tube was charged with cesium carbonate (3.0 equiv.), 2-mesitylsulfonyl hydrazone (2.0 equiv.) and BCP bis-boronate (1.0 equiv.). Then the tube was evacuated and backfilled with argon three times, followed by addition of toluene (0.1 M) via a syringe. After stirring for at 70° C. for 18-48 hours, the reaction mixture was cooled to room temperature. Next, the suspended solution was filtered over Celite and washed with diethyl ether. The solvent was removed under high vacuum, and the crude residue was purified by chromatography on silica gel. (Yang et al., 2021a)

The following sulfonyl hydrazones were prepared through literature procedure (Yang et al., 2021a):

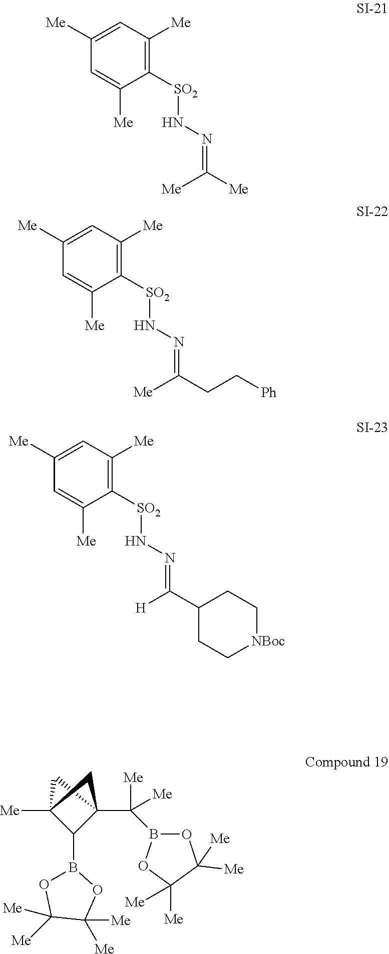

### 4,4,5,5-tetramethyl-2-(2-(3-methyl-2-(4,4,5,5-tetramethyl-1,3,2-dioxaborolan-2-yl)bicyclo[1.1.1]pentan-1-yl)propan-2-yl)-1,3,2-dioxaborolane (19)

Following General Procedure A on 0.1 mmol scale with BCP bisboronate 14 and 2-mesityl sulfonyl hydrazone SI-21 reacting for 48 h. Purification by flash chromatography (hexanes:diethyl ether, 20:1) afforded 16.0 mg (42%) of the title compound 19.

Physical State: colorless oil.

¹H NMR (600 MHz, CDCl₃): δ 2.27 (dd, J=9.7, 1.8 Hz, 1H), 1.52 (dd, J=9.7, 1.1 Hz, 1H), 1.43 (s, 1H), 1.37 (dd, J=8.1, 1.8 Hz, 1H), 1.28 (d, J=8.0 Hz, 1H), 1.22 (s, 12H), 1.21 (s, 12H), 0.86 (s, 3H), 0.85 (s, 3H) ppm.

¹³C NMR (151 MHz, CDCl₃): δ 82.94, 82.54, 54.70, 48.90, 47.59, 37.02, 24.98, 24.94, 24.89, 22.04, 21.85, 18.79 ppm.

¹¹B NMR (128 MHz, CDCl₃): δ 33.30 ppm.

MS (GCMS, EI): m/z=361 (1%), 276 (15%), 261 (13%), 193 (18%), 107 (35%), 83 (100%).

TLC: R_{f}=0.35 (15:1 hexanes:ethyl acetate).

### Preparation of BCP 2-Acid

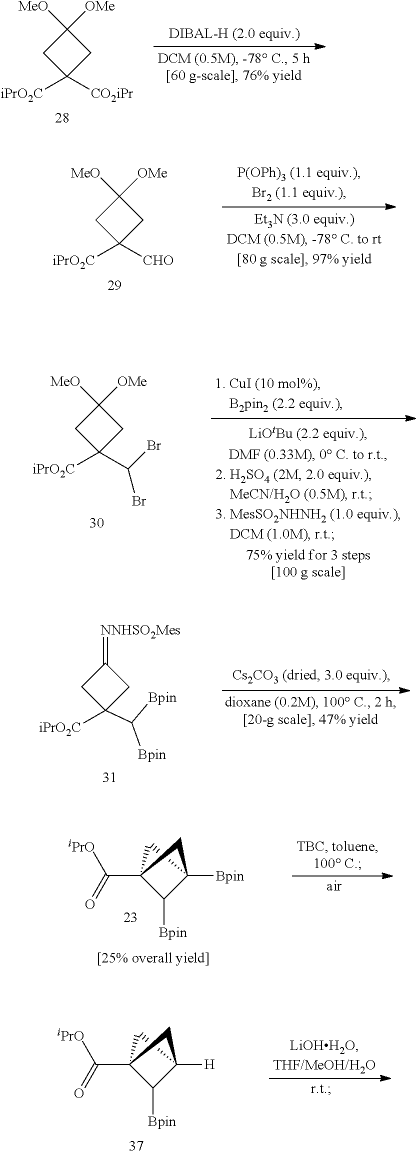

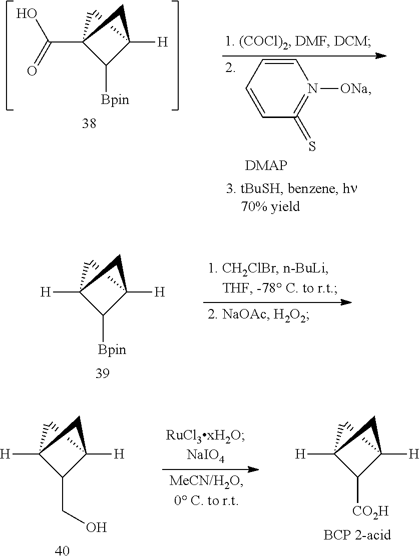

### Step 1: Synthesis of Compound 29

A 2-L three-necked (24/40 joint) round-bottomed flask, equipped with a 6.4 cm Teflon-coated magnetic stir bar, was flame-dried under vacuum, and then cooled to 23° C. under an atmosphere of argon. Then the flask was charged with diisopropyl 3,3-dimethoxycyclobutane-1,1-dicarboxylate, compound 28, (103.8 g, 360 mmol, 1.0 equiv.). Methylene chloride (720 mL) was added into the flask and the mixture was cooled in a dried ice-acetone bath (−78° C.) and stirred for 15 minutes. Next a solution of DIBAL-H (720 mL, 1 M in hexanes, 2.0 equiv., pre-cooled at −78° C.) was added dropwise into the flask through a dropping funnel at −78° C. in 2 hours and the mixture was allowed to stir at −78° C. for another 3 hours. After it was confirmed that the starting material, 28, was consumed through TLC analysis, the reaction was quenched at −78° C. with methanol (24 mL, 720 mmol, 2.0 equiv.). After the reaction was slowly warmed to room temperature, water (29 mL), 20% NaOH (29 mL) and water (72 mL) was slowly added into the reaction mixture in sequence and the mixture was allowed to stir for another 30 minutes. Next, excess Na₂SO₄ was added to dry the reaction mixture and the suspension was filtered through Celite®. Solvents was removed under vacuum and the crude product was purified through flash chromatography (hexanes:ethyl acetate, 5:1) on silica gel to afford 63 g (76%) of the title compound 29.¹

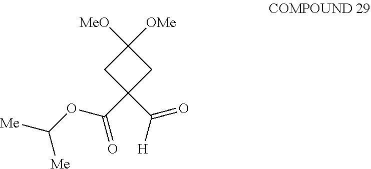 [SMILES: COC1(OC)CC(C=O)(C(=O)OC(C)C)C1]

### isopropyl 1-formyl-3,3-dimethoxycyclobutane-1-carboxylate (29)

Physical State: colorless oil.

¹H NMR (600 MHz, CDCl₃): δ 9.69 (s, 1H), 5.09 (hept, J=6.3 Hz, 1H), 3.16 (s, 3H), 3.13 (s, 3H), 2.65 (d, J=12.1 Hz, 2H), 2.61 (d, J=11.8 Hz, 2H), 1.25 (d, J=6.3 Hz, 6H) ppm.

¹³C NMR (151 MHz, CDCl₃): δ 196.06, 170.25, 98.28, 69.74, 49.73, 48.79, 48.72, 37.30, 21.80 ppm.

HRMS (ESI-TOF): calc'd for C₁₁H₁₈O₅ [M+Na]⁺: 253.1047, found: 253.1035.

TLC: R_{f}=0.31 (5:1 hexanes:ethyl acetate).

### Step 2: Synthesis of Compound 30

A 2-L three-necked (24/40 joint) round-bottomed flask, equipped with a 6.4 cm Teflon-coated magnetic stir bar, was flame-dried under vacuum, and then cooled to 23° C. under an atmosphere of argon. Then the flask was charged with triphenyl phosphite (78 mL, 300 mmol, 1.1 equiv.). Methylene chloride (340 mL) was added into the flask and the mixture was cooled to −78° C. Then bromine (15 mL, 300 mmol, 1.1 equiv.) was added slowly into the flask, followed by addition of triethyl amine (140 mL, 1.0 mol, 3.3 equiv.). (Note: a suspension of the mixture was formed.) Next, the solution of 29 (63 g, 270 mmol, 1.0 equiv.) in 160 mL methylene chloride was added into the mixture and the reaction was warmed up to room temperature. After it was confirmed that the starting material, 29, was consumed through TLC analysis, solvent was removed by rotary evaporator and the crude product was purified through flash chromatography (hexanes:ethyl acetate, 20:1) on silica gel to afford 87 g (97%) of the title compound 30.

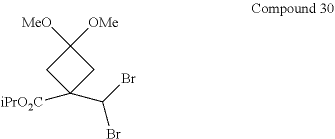

### Isopropyl 1-(dibromomethyl)-3,3-dimethoxycyclobutane-1-carboxylate (30)

Physical state: colorless oil.

¹H NMR (600 MHz, CDCl₃): δ 6.03 (s, 1H), 5.10 (hept, J=6.3 Hz, 1H), 3.16 (s, 3H), 3.15 (s, 3H), 2.72-2.66 (m, 2H), 2.48-2.42 (m, 2H), 1.28 (d, J=6.3 Hz, 6H) ppm.

¹³C NMR (151 MHz, CDCl₃) δ 170.41, 96.85, 69.77, 49.87, 48.79, 48.75, 48.57, 40.13, 21.74. ppm.

HRMS (ESI-TOF): calc'd for C₁₁H₁₈Br₂O₄ [M+Na]⁺: 394.9464, found: 394.9457.

TLC: R_{f}=0.32 (10:1 hexanes:ethyl acetate).

### Step 3: Synthesis of Compound 31

A 2-L one-necked (24/40 joint) round-bottomed flask, equipped with a 6.4 cm Teflon-coated magnetic stir bar, was flame-dried under vacuum, and then cooled to 23° C. under an atmosphere of argon. Then the flask was charged with copper(I) iodide (4.88 g, 25.6 mmol, 0.1 equiv.), B₂pin₂ (140 g, 550 mmol, 2.2 equiv.), and lithium tert-butoxide (44.0 g, 550 mmol, 2.2 equiv.). After being evacuated and backfilled with argon from a balloon 3 times, DMF (500 mL) was added into the flask at 0° C. Then a solution of compound 30 (256 mmol, 95.6 g, 1.0 equiv.) in DMF (250 mL) was added slowly into the mixture at 0° C. in 15 minutes and the reaction mixture was allowed to slowly warm to room temperature and stir for another 1 hour. After it was confirmed that the starting material, 30, was consumed through TLC analysis, the reaction was filtered through Celite®, washed with diethyl ether (200 mL) and quenched at 0° C. with water (500 mL) (Caution: the quenching process is exothermic). The mixture was transferred into a 6-L flask and diluted with water (1.5 L) and diethyl ether (300 mL). After the mixture was stirred for 30 minutes at room temperature, the two-phase solution was transferred into a 3-L separation funnel. The aqueous phase is separated and extracted with two 200-mL portions of diethyl ether. The combined organic layers are washed with the mixture of 200 mL water and 200 mL saturated NaCl solution twice, dried over Na₂SO₄, and filtered through Celite®.

After solvent was removed by rotary evaporator, the crude product was redissolved in 250 mL acetonitrile in a 1-L flask. 2M H₂SO₄ (256 mL, 2.0 equiv.) was added into the mixture at room temperature and the reaction was allowed to stir for another 1.5 hours. After it was confirmed that the ketal intermediate was consumed through TLC analysis, the crude reaction is concentrated to remove excess acetonitrile. Then diethyl ether (400 mL) and saturated brine (150 mL) is added to the reaction mixture and the mixture is transferred to a 1-L separatory funnel. The aqueous layer is separated and further extracted with diethyl ether (3×150 mL). The combined organic layers are dried over Na₂SO₄, filtered through Celite. Excess solvent was removed by rotary evaporator. The crude product was redissolved in 250 mL methylene chloride in a 500 mL-flask and mesitylene sulfonyl hydrazide (54.9 g, 256 mmol, 1.0 equiv.) was added. The mixture was allowed to stir at room temperature for another 2 hours. After it was confirmed that the ketone intermediate was consumed through TLC analysis, the crude reaction is concentrated to remove excess solvent. The crude product was purified through flash chromatography (hexanes:ethyl acetate, 4:1 to 2:1) on silica gel to afford 116 g (73%) of the title compound 31.

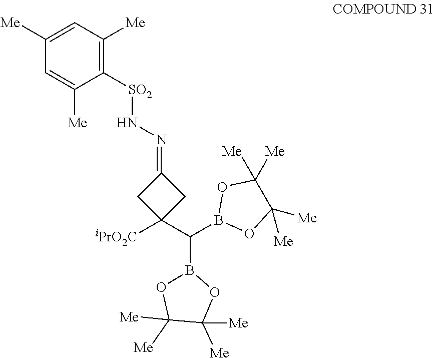

### Isopropyl 1-(bis(4,4,5,5-tetramethyl-1,3,2-dioxaborolan-2-yl)methyl)-3-(2-(mesitylsulfonyl)-hydrazineylidene)cyclobutane-1-carboxylate (31)

Physical State: white solid.

m.p.: 85-87° C.

¹H NMR (600 MHz, Acetone-d₆) δ 9.17 (s, 1H), 7.02 (s, 2H), 4.90 (hept, J=6.2 Hz, 1H), 3.23 (ddd, J=17.6, 3.3, 1.7 Hz, 1H), 3.12 (dt, J=17.0, 2.5 Hz, 1H), 3.05-2.98 (m, 1H), 2.94 (ddd, J=17.1, 3.4, 1.5 Hz, 1H), 2.65 (s, 6H), 2.28 (s, 3H), 1.22 (s, 1H), 1.19 (d, J=6.3 Hz, 3H), 1.18 (d, J=6.6 Hz, 3H), 1.17 (s, 6H), 1.16 (s, 6H), 1.13 (s, 12H) ppm.

¹³C NMR (151 MHz, Acetone-d₆) δ 176.43, 154.40, 143.07, 140.75, 134.85, 132.46, 83.83, 83.78, 68.79, 45.17, 43.93, 40.62, 25.18, 25.06, 24.74, 23.44, 21.80, 21.76, 20.85 ppm.

¹¹B NMR (128 MHz, CDCl₃): δ 32.98 ppm.

HRMS (ESI-TOF): calc'd for C₃₀H₄₈B₂N₂O₈S [M+H]⁺: 619.3390, found: 619.3402.

TLC: R_{f}=0.30 (3:1 hexanes:ethyl acetate).

### Step 4: Synthesis of 23

A 1-L one-necked (24/40 joint) round-bottomed flask, equipped with a 6.4 cm Teflon-coated magnetic stir bar, was flame-dried under vacuum, and then cooled to 23° C. under an atmosphere of argon. Then the flask was charged with 31 (61.8 g, 100 mmol, 1.0 equiv.) and dried cesium carbonate (100 g, 300 mmol, 3.0 equiv.). (Note: Cesium carbonate was dried at 120° C. under vacuum for 18 hours.) After being evacuated and backfilled with argon from a balloon 3 times, dioxane (500 mL) was added into the flask and the reaction mixture was allowed to stir at 100° C. for 40 minutes. After it was confirmed that the starting material, 31, was consumed through TLC analysis, the reaction was cooled to room temperature, filtered through Celite, washed with hexanes (500 mL), and concentrated to remove excess solvents. The crude reaction was purified through flash chromatography (hexanes:ethyl acetate, 10:1) on silica gel to afford the title compound 23, which was further purified through trituration in hexanes at −40° C., affording 19.0 g product (47% yield) with >99% purity as white solids. Trituration procedure: The product (around 21 g) after chromatography was dissolved in hexanes (10 mL) at room temperature and then cooled to −40° C. After the solution of the product was slowly stirred at −40° C. for 1 h, the suspension was filtered and the white solid was washed with cooled hexanes (5 mL) quickly and dried under vacuum for 1 hour.

In the second run, following procedures in step 4 on 87 mmol scale with the rest sulfonyl hydrazone 31. Purification by flash chromatography (hexanes:ethyl acetate, 10:1) and trituration afforded 18.0 g (47%) of the title compound 23.

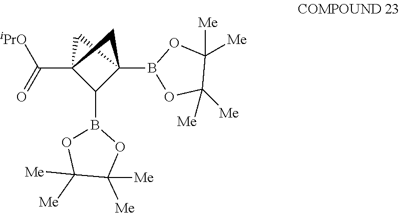 [SMILES: CC(C)OC(=O)[C@]12C[C@](B3OC(C)(C)C(C)(C)O3)(C1)C2B1OC(C)(C)C(C)(C)O1]

### isopropyl 2,3-bis(4,4,5,5-tetramethyl-1,3,2-dioxaborolan-2-yl)bicyclo[1.1.1]pentane-1-carboxylate (23)

Physical State: white solid.

m.p.: 41-43° C.

¹H NMR (600 MHz, CDCl₃): δ 4.93 (hept, J=6.3 Hz, 1H), 2.71 (dd, J=9.4, 2.3 Hz, 1H), 2.14-2.08 (m, 2H), 2.03 (dd, J=8.1, 2.2 Hz, 1H), 1.88 (dd, J=8.2, 0.9 Hz, 1H), 1.22 (s, 12H), 1.21 (s, 6H), 1.20 (s, 6H), 1.19 (d, J=2.9 Hz, 3H), 1.18 (d, J=3.0 Hz, 3H) ppm.

¹³C NMR (151 MHz, CDCl₃) δ 169.49, 83.55, 83.10, 67.44, 55.81, 50.75, 44.87, 24.89, 24.87, 24.84, 24.79, 21.93 ppm.

¹¹B NMR (128 MHz, CDCl₃): δ 31.18 ppm.

HRMS (ESI-TOF): calc'd for C₂₁H₃₆B₂O₆ [M+H]⁺: 407.2771, found: 407.2778.

TLC: R_{f}=0.32 (5:1 hexanes:ethyl acetate).

### Step 5: Synthesis of 37

A screw-capped 13×100 mm Pyrex culture tube or a flame-dried 250-mL Pyrex flask was charged with BCP bisboronate 23 (10 mmol, 4.06 g, 1.0 equiv.) and tert-butyl catechol (4.15 g, 25 mmol, 2.5 equiv.). Then the tube or the flask was evacuated and backfilled with air for three times, followed by addition of toluene (100 mL, 0.1 M) via a syringe. After stirring for at 100° C. for 2.5 hours when it is confirmed that the starting material was consumed totally, the reaction mixture was cooled to room temperature. Next, the solvent was removed under high vacuum, and the crude residue was purified by chromatography on silica gel.

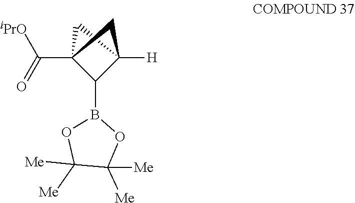 [SMILES: CC(C)OC(=O)[C@]12C[C@H](C1)C2B1OC(C)(C)C(C)(C)O1]

### isopropyl 2-(4,4,5,5-tetramethyl-1,3,2-dioxaborolan-2-yl)bicyclo[1.1.1]pentane-1-carboxylate (37)

Physical State: colorless oil.

¹H NMR (600 MHz, CDCl₃): δ 4.97 (hept, J=6.3 Hz, 1H), 2.58 (dd, J=9.5, 2.2 Hz, 1H), 2.55 (s, 1H), 2.10-2.04 (m, 2H), 2.02 (dd, J=8.2, 2.3 Hz, 1H), 1.89 (dd, J=8.2, 1.0 Hz, 1H), 1.25 (s, 12H), 1.22 (d, J=3.9 Hz, 3H), 1.20 (d, J=3.9 Hz, 3H) ppm.

¹³C NMR (151 MHz, CDCl₃): δ 169.38, 83.32, 67.59, 55.03, 50.46, 44.96, 29.72, 25.01, 24.88, 21.96, 21.95 ppm.

¹¹B NMR (128 MHz, CDCl₃): δ 31.65 ppm.

HRMS (ESI-TOF): calc'd for C₁₅H₂₅BO₄ [M+H]⁺: 289.1919, found: 289.1933.

TLC: R_{f}=0.36 (10:1 hexanes:ethyl acetate).

### Step 6: Synthesis of 39 (Bcp 2-Bpin)

To a stirred solution of the ester 37 (1.0 equiv.) in THF/MeOH/H₂O (2:1:1, 0.2 M) was added LiOH·H₂O (1.5 equiv.) at room temperature and the reaction was stirred for 12 h by which time TLC analysis showed complete conversion. The excess solvent was removed, and reaction mixture was acidified by 3M HCl and the aqueous phase was extracted with CH₂Cl₂ (3 times). The combined organic phase was dried over Na₂SO₄ and evaporated to dryness. The acid residue was directly used without further purification.

The carboxylic acid (1.0 equiv.) was dissolved in methylene chloride (0.65 M) at 0° C., to which DMF (0.1 equiv.) was added followed by slow addition of oxalyl chloride (1.5 equiv.) under argon atmosphere. The reaction temperature was allowed to warm to ambient temperature and was stirred for additional 5 h (or until bubbling ceased).

The reaction was cooled to 0° C., wrapped in aluminum foil, and shielded from light. DMAP (0.1 equiv.) was added followed by portion-wise addition of 2-mercaptopyridine N-oxide (1.5 equiv.) (the reaction color was usually canary yellow or red). The reaction temperature was allowed to warm to ambient temperature and was stirred for 2 h. Upon completion of the reaction, the reaction flask was cooled to 0° C. and water was added. The layers were separated (in a separatory funnel that was wrapped in aluminum foil) and the organics were filtered through a pad of Celite® while washing with methylene chloride (using a fritted funnel and round bottom flask that were covered with aluminum foil). The organics were concentrated under reduced pressure in a water bath no higher than 25° C. while shielded from light (the bath was covered aluminum foil). The flask was wrapped in aluminum foil and placed under high vacuum to remove any residual methylene chloride.

The yellow (or red) residue was dissolved in benzene (0.3 M) and tert-butyl thiol (2.5 equiv.) was added. The flask was fitted with a reflux condenser and the reaction was irradiated with a 600 W halogen lamp until consumption of the Barton ester. Upon completion of the reaction, the reaction mixtures were concentrated under reduced pressure. The crude material was purified by silica gel flash column chromatography to yield the pure compound. Note: The compound is volatile at high vacuum (˜0.1 mbar). Do not dry it under high vacuum of pump.

### Step 7: Synthesis of Alcohol 40

BCP boronate 39 (1.0 equiv.) and bromoiodomethane (2.0 eq.) were dissolved in anhydrous THF (0.1 M) and cooled to −78° C. n-BuLi (2.0 equiv.) was added dropwise, and the solution was stirred 10 minutes at −78° C., and then warmed up to room temperature and stir overnight. The reaction mixture was quenched with saturated NH₄Cl solution and dissolved in ethyl acetate. The aqueous phase was extracted with ethyl acetate twice. The combined organic phase was washed with brine, dried over Na₂SO₄ and evaporated to afford the crude residue, which was used directed without further purification.

To a solution of BCP boronate crude and NaOAc (3.0 equiv.) in THE (0.1 M) at 0° C. was added H₂O₂ (35 wt. % in water, ˜10.0 equiv., 1.0 mL/mmol) dropwise. The resulting mixture was stirred at 0° C. for 1.5 hours. Na₂S₂O₃ was added and the mixture was stirred at 0° C. for 10 min. Diethyl ether was added, the layers were separated, and the aqueous phase was extracted with diethyl ether. The combined organic layers were washed with water and brine, dried over anhydrous MgSO₄, concentrated, and purified by column chromatography on silica gel to obtain the alcohol 40.

### Step 8: Synthesis of Bcp 2-Acid

To a solution of BCP alcohol 40 (1.0 equiv.) in water/MeCN (1:1, 0.1 M) was added ruthenium trichloride hydrate (0.02 equiv.) at 0° C., followed by portion-wise addition of sodium periodate (3.0 equiv.). The reaction was allowed to stir until the starting material is totally consumed. Upon completion of the reaction, excess solvent was removed, and the reaction was extracted with diethyl ether. The layers were separated, and the organics were dried over Na₂SO₄ and concentrated under reduced pressure. The crude material was purified by silica gel flash column chromatography to yield the pure compound.

Alternatively, the BCP 2-acid can also be prepared using the steps below and as described in Wiberg et al., 1993.

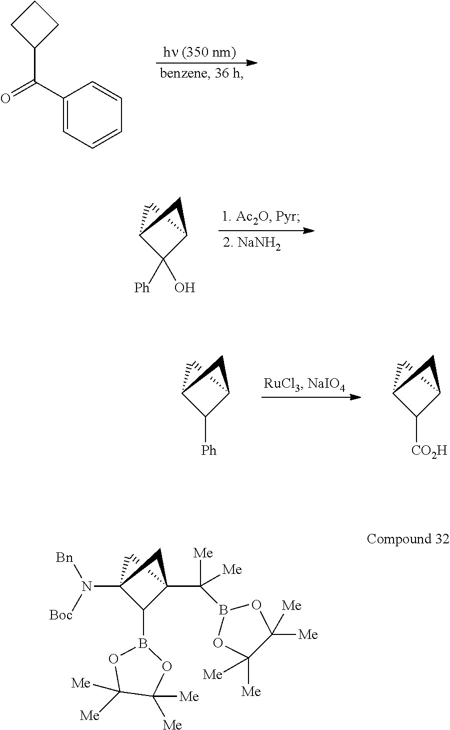 [SMILES: O=C(c1ccccc1)C1CCC1 ; OC1(c2ccccc2)[C@H]2C[C@@H]1C2 ; c1ccc(C2[C@H]3C[C@@H]2C3)cc1 ; O=C(O)C1[C@H]2C[C@@H]1C2 ; CC(C)(C)OC(=O)N(Cc1ccccc1)[C@]12C[C@](C(C)(C)B3OC(C)(C)C(C)(C)O3)(C1)C2B1OC(C)(C)C(C)(C)O1]

### tert-butyl benzyl(2-(4,4,5,5-tetramethyl-1,3,2-dioxaborolan-2-yl)-3-(2-(4,4,5,5-tetra methyl-1,3,2-dioxaborolan-2-yl)propan-2-yl)bicyclo[1.1.1]pentan-1-yl)carbamate (32)

Following General Procedure A on 0.05 mmol scale with BCP bisboronate 24 and 2-mesityl sulfonyl hydrazone SI-21 reacting for 24 h. Purification by flash chromatography (hexanes:ethyl acetate, 4:1) afforded 17.5 mg (62%) of the title compound 32.

Physical State: colorless oil.

¹H NMR (600 MHz, CDCl₃): δ 7.22-7.14 (m, 4H), 7.11 (t, J=7.0 Hz, 1H), 4.46-4.24 (m, 2H), 2.58 (s, 1H), 1.85 (d, J=9.5 Hz, 1H), 1.78 (d, J=7.9 Hz, 1H), 1.67 (s, 1H), 1.66 (s, 1H), 1.38 (s, 9H), 1.139 (s, 6H), 1.136 (s, 6H) 1.11 (s, 12H), 0.80 (s, 3H), 0.79 (s, 3H) ppm.

¹³C NMR (151 MHz, CDCl₃): δ 140.28, 128.22, 126.85, 126.47, 83.06, 82.80, 49.14, 48.76, 45.90, 28.61, 25.07, 24.92, 24.90, 22.40, 22.16 ppm. Note: NC(O), NC, NCH₂, Me₃C and BC were not observed.

¹¹B NMR (128 MHz, CDCl₃): δ 32.08 ppm.

HRMS (ESI-TOF): calc'd for C₃₂H₅₁BNO₆ [M+H]⁺: 568.3975, found: 568.3975.

TLC: R_{f}=0.56 (5:1 hexanes:ethyl acetate).

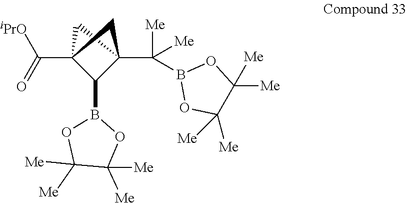 [SMILES: CC(C)OC(=O)[C@]12C[C@](C(C)(C)B3OC(C)(C)C(C)(C)O3)(C1)[C@H]2B1OC(C)(C)C(C)(C)O1]

### isopropyl 2-(4,4,5,5-tetramethyl-1,3,2-dioxaborolan-2-yl)-3-(2-(4,4,5,5-tetramethyl-1,3,2-dioxa borolan-2-yl)propan-2-yl)bicyclo[1.1.1]pentane-1-carboxylate (33)

Following General Procedure A on 0.1 mmol scale with BCP bisboronate 23 and 2-mesityl sulfonyl hydrazone SI-21 reacting for 18 h. Purification by flash chromatography (hexanes:ethyl acetate, 4:1) afforded 27.7 mg (62%) of the title compound 33.

Physical State: white solid.

m.p.: 74-76° C.

¹H NMR (600 MHz, CDCl₃): δ 4.97 (hept, J=6.3 Hz, 1H), 2.69 (dd, J=9.5, 1.8 Hz, 1H), 1.89-1.85 (m, 2H), 1.81 (dd, J=7.9, 1.8 Hz, 1H), 1.66 (d, J=7.8 Hz, 1H), 1.23 (s, 6H), 1.22 (s, 6H), 1.20 (s, 12H), 1.195 (d, J=7.0 Hz, 6H), 0.88 (s, 3H), 0.87 (s, 3H) ppm.

¹³C NMR (151 MHz, CDCl₃): δ 170.85, 83.14, 82.91, 67.44, 54.10, 49.29, 47.75, 38.82, 24.96, 24.94, 24.92, 24.86, 22.00, 21.80, 21.66 ppm.

¹¹B NMR (128 MHz, CDCl₃): δ 33.04 ppm.

MS (GCMS, EI): m/z=433 (0.8%), 348 (0.5%), 262 (15%), 205 (10%), 136 (38%), 83 (100%).

TLC: R_{f}=0.54 (5:1 hexanes:ethyl acetate).

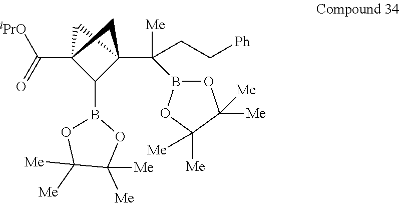 [SMILES: CC(C)OC(=O)[C@]12C[C@](C(C)(CCc3ccccc3)B3OC(C)(C)C(C)(C)O3)(C1)C2B1OC(C)(C)C(C)(C)O1]

### isopropyl 3-(4-phenyl-2-(4,4,5,5-tetramethyl-1,3,2-dioxaborolan-2-yl)butan-2-yl)-2-(4,4,5,5-tetramethyl-1,3,2-dioxaborolan-2-yl)bicyclo[1.1.1]pentane-1-carboxylate (34)

Following General Procedure A on 0.1 mmol scale with BCP bisboronate 23 and 2-mesityl sulfonyl hydrazone SI-22 reacting for 18 h. Purification by flash chromatography (hexanes:ethyl acetate, 4:1) and afforded 30.6 mg (57%) of the title compound 34. Note: two diastereoisomers (1/1) were observed. NMR characterization for the mixture was given.

Physical State: pale yellow solid.

m.p.: 53-55° C.

¹H NMR (600 MHz, CDCl₃): δ 7.27-7.09 (m, 5H), 4.96 (hept, J=6.3 Hz, 1H), 2.75 (dd, J=9.6, 1.9 Hz, 1H), 2.56 (tdd, J=12.9, 5.1, 2.7 Hz, 1H), 2.49-2.38 (m, 1H), 1.92 (ddd, J=5.6, 4.3, 1.4 Hz, 1H), 1.89-1.78 (m, 3H), 1.67 (dd, J=7.8, 4.4 Hz, 1H), 1.26 (s, 6H), 1.26 (s, 6H), 1.21-1.19 (m, 7H), 1.18 (s, 3H), 1.17 (s, 3H), 1.12 (s, 3H), 1.11 (s, 3H), 0.97 (s, 1.5H), 0.96 (s, 1.5H) ppm.

¹³C NMR (151 MHz, CDCl₃): δ 170.70, 170.69, 143.66, 143.62, 128.54, 128.52, 128.30, 128.28, 125.60, 83.44, 82.93, 67.51, 67.50, 54.19, 54.13, 49.17, 49.03, 48.18, 48.12, 39.23, 39.15, 39.07, 38.61, 33.54, 33.49, 25.37, 25.33, 25.07, 25.03, 24.90, 24.86, 24.78, 24.75, 21.99, 18.35, 18.31 ppm.

¹¹B NMR (128 MHz, CDCl₃): δ 32.84 ppm.

HRMS (ESI-TOF): calc'd for C₃₁H₄₈B₂O₆ [M+H]⁺: 539.3710, found: 539.3705.

TLC: R_{f}=0.52 (5:1 hexanes:ethyl acetate).

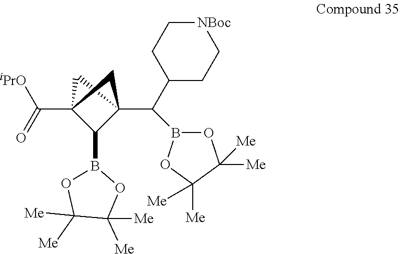 [SMILES: CC(C)OC(=O)[C@]12C[C@](C(B3OC(C)(C)C(C)(C)O3)C3CCN(C(=O)OC(C)(C)C)CC3)(C1)[C@H]2B1OC(C)(C)C(C)(C)O1]

### tert-butyl 4-((3-(isopropoxycarbonyl)-2-(4,4,5,5-tetramethyl-1,3,2-dioxaborolan-2-yl)bicyclo[1.1.1]pentan-1-yl)(4,4,5,5-tetramethyl-1,3,2-dioxaborolan-2-yl)methyl)piperidine-1-carboxylate (35)

Following General Procedure A on 0.1 mmol scale with BCP bisboronate 23 and 2-mesityl sulfonyl hydrazone SI-23 reacting for 24 h. Purification by flash chromatography (hexanes:ethyl acetate, 4:1) afforded 45.1 mg (75%) of the title compound 35. Note: two diastereoisomers (1/1) were observed. NMR characterization for the mixture was given.

Physical State: colorless oil.

¹H NMR (600 MHz, CDCl₃): δ 4.96 (hept, J=6.3, 1.1 Hz, 1H), 4.03 (br., 2H), 2.69-2.56 (m, 3H), 2.06-1.93 (m, 3H), 1.90-1.83 (m, 1H), 1.72 (d, J=8.0 Hz, 1H), 1.69-1.58 (m, 3H), 1.46-1.42 (m, 11H), 1.24 (s, 3H), 1.23 (s, 3H), 1.23 (s, 6H), 1.22 (s, 12H), 1.21-1.18 (m, 6H) ppm.

¹³C NMR (151 MHz, CDCl₃): δ 170.09, 155.06, 155.04, 83.31, 83.24, 83.10, 83.08, 79.20, 67.56, 56.10, 51.94, 42.97, 42.84, 40.75, 40.72, 36.60, 36.47, 28.60, 25.28, 25.24, 25.16, 25.10, 25.08, 24.84, 24.83, 21.99, 21.97 ppm.

¹¹B NMR (128 MHz, CDCl₃): δ 32.78 ppm.

HRMS (ESI-TOF): calc'd for C₃₂H₅₅B₂NO₈ [M+H]⁺: 604.4187, found: 604.4194.

TLC: R_{f}=0.32 (5:1 hexanes:ethyl acetate).

### General Procedure B for Protodeborylation of BCP Bisboronates

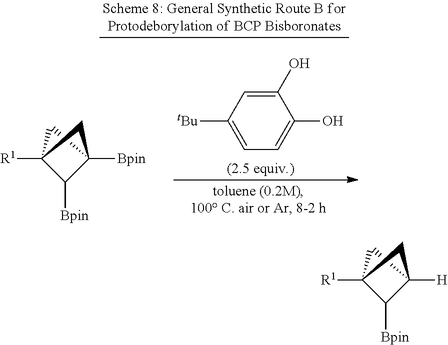

A screw-capped culture tube or a flame-dried flask was charged with BCP bisboronate (1.0 equiv.) and tert-butyl catechol (2.5 equiv.). The tube or the flask was then evacuated and backfilled with argon or air (according to details shown below) three times, followed by addition of toluene (0.1 M) via a syringe. After stirring for at 100° C. for 2-12 hours, and after confirmation that the starting material was consumed totally, the reaction mixture was cooled to room temperature. Next, the solvent was removed under high vacuum, and the crude residue was purified by chromatography on silica gel. (André-Joyaux et al., 2020)

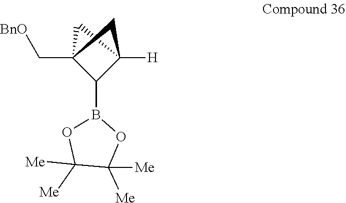 [SMILES: CC1(C)OB(C2[C@H]3C[C@]2(COCc2ccccc2)C3)OC1(C)C]

### 2-(1-((benzyloxy)methyl)bicyclo[1.1.1]pentan-2-yl)-4,4,5,5-tetramethyl-1,3,2-dioxaborolane (36)

Following General Procedure B on 0.1 mmol scale with BCP bisboronate 25 under argon atmosphere heating for 12 hours. Purification by flash chromatography (hexanes:ethyl acetate, 20:1) afforded 22.0 mg (70%) of the title compound 36.

Following General Procedure B on 2.0 mmol scale with BCP bisboronate 25 under argon atmosphere heating for 5 hours. Purification by flash chromatography (hexanes:ethyl acetate, 20:1) and afforded 528 mg (84%) of the title compound 36.

Physical State: colorless oil.

¹H NMR (600 MHz, CDCl₃): δ 7.37-7.30 (m, 4H), 7.28-7.24 (m, 1H), 4.54 (s, 2H), 3.45 (s, 2H), 2.69 (s, 1H), 2.22 (dd, J=9.8, 2.2 Hz, 1H), 1.82 (d, J=9.0 Hz, 2H), 1.78 (dd, J=8.3, 2.2 Hz, 1H), 1.61 (d, J=8.3 Hz, 1H), 1.225 (s, 6H), 1.222 (s, 6H) ppm.

¹³C NMR (151 MHz, CDCl₃): δ 139.04, 128.37, 127.60, 127.45, 83.06, 72.96, 70.74, 53.55, 48.90, 46.48, 30.49, 24.94 ppm.

¹¹B NMR (128 MHz, CDCl₃): δ 32.21 ppm.

MS (GCMS, EI): m/z=299 (0.2%), 244 (0.2%), 219 (0.5%), 151 (5%), 91 (100%).

TLC: R_{f}=0.46 (10:1 hexanes:ethyl acetate).

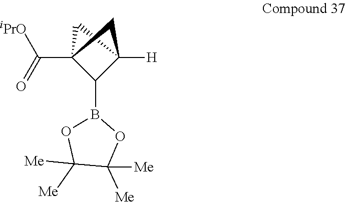 [SMILES: CC(C)OC(=O)[C@]12C[C@H](C1)C2B1OC(C)(C)C(C)(C)O1]

### isopropyl 2-(4,4,5,5-tetramethyl-1,3,2-dioxaborolan-2-yl)bicyclo[1.1.1]pentane-1-carboxylate (37)

Following General Procedure B on 0.1 mmol scale with BCP bisboronate 23 under air atmosphere heating for 3 h. Purification by flash chromatography (hexanes:ethyl acetate, 10:1) afforded 20.2 mg (72%) of the title compound 37.

Following General Procedure B on 3.0 mmol scale with BCP bisboronate 23 under air atmosphere heating for 2 h 20 minutes. Purification by flash chromatography (hexanes:ethyl acetate, 10:1) afforded 630.7 mg (75%) of the title compound 37.

Following General Procedure B on 10.0 mmol scale with BCP bisboronate 23 under air atmosphere heating for 2.5 h. Purification by flash chromatography (hexanes:ethyl acetate, 10:1) afforded 2.09 g (75%) of the title compound 37.

Physical State: colorless oil.

¹H NMR (600 MHz, CDCl₃): δ 4.97 (hept, J=6.3 Hz, 1H), 2.58 (dd, J=9.5, 2.2 Hz, 1H), 2.55 (s, 1H), 2.10-2.04 (m, 2H), 2.02 (dd, J=8.2, 2.3 Hz, 1H), 1.89 (dd, J=8.2, 1.0 Hz, 1H), 1.25 (s, 12H), 1.22 (d, J=3.9 Hz, 3H), 1.20 (d, J=3.9 Hz, 3H) ppm.

¹³C NMR (151 MHz, CDCl₃): δ 169.38, 83.32, 67.59, 55.03, 50.46, 44.96, 29.72, 25.01, 24.88, 21.96, 21.95 ppm.

¹¹B NMR (128 MHz, CDCl₃): δ 31.65 ppm.

MS (GCMS, EI): m/z=265 (1.5%), 222 (10%), 149 (12%), 138 (70%), 94 (100%).

TLC: R_{f}=0.36 (10:1 hexanes:ethyl acetate).

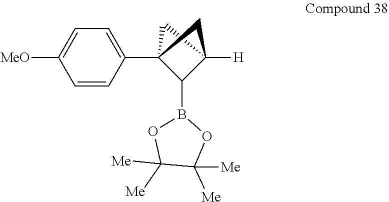 [SMILES: COc1ccc([C@]23C[C@H](C2)C3B2OC(C)(C)C(C)(C)O2)cc1]

### 2-(1-(4-methoxyphenyl)bicyclo[1.1.1]pentan-2-yl)-4,4,5,5-tetramethyl-1,3,2-dioxaborolane (38)

General Procedure B was followed on a 0.1 mmol scale with BCP bisboronate 27 under argon atmosphere heating for 6 h. Purification by flash chromatography (hexanes:ethyl acetate, 4:1) afforded 19.6 mg (65%) of the title compound 38.

Physical State: colorless oil.

¹H NMR (600 MHz, CDCl₃): δ 7.21 (d, J=8.3 Hz, 2H), 6.81 (d, J=8.4 Hz, 2H), 3.78 (s, 3H), 2.68 (s, 1H), 2.61 (dd, J=9.7, 2.1 Hz, 1H), 2.08 (d, J=9.6 Hz, 1H), 2.05 (s, 1H), 2.00 (dd, J=8.2, 2.1 Hz, 1H), 1.89 (d, J=8.2 Hz, 1H), 1.25 (s, 6H), 1.24 (s, 6H) ppm.

¹³C NMR (151 MHz, CDCl₃): δ 158.23, 134.47, 127.43, 113.45, 83.15, 55.65, 55.39, 51.39, 49.27, 28.71, 24.99, 24.96 ppm.

¹¹B NMR (128 MHz, CDCl₃): δ 32.18 ppm.

MS (GCMS, EI): m/z=300 (14%), 200 (18%), 172 (90%), 133 (100%), 84 (54%).

TLC: R_{f}=0.50 (10:1 hexanes:ethyl acetate).

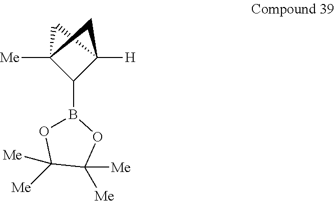 [SMILES: CC1(C)OB(C2[C@H]3C[C@]2(C)C3)OC1(C)C]

### 4,4,5,5-tetramethyl-2-((1s,3s)-1-methylbicyclo[1.1.1]pentan-2-yl)-1,3,2-dioxaborolane (39)

General Procedure B was followed on a 0.1 mmol scale with BCP bisboronate 14 under argon atmosphere heating for 5 hours. Purification by flash chromatography (hexanes:ethyl acetate, 40:1) afforded 12.6 mg (61%) of the title compound 39. Note: The compound is volatile.

Physical State: colorless oil.

¹H NMR (600 MHz, CDCl₃): δ 2.59 (s, 1H), 2.07 (dd, J=9.7, 2.2 Hz, 1H), 1.71 (dd, J=9.7, 1.4 Hz, 1H), 1.69 (s, 1H), 1.64 (dd, J=8.4, 2.2 Hz, 1H), 1.49 (dd, J=8.4, 1.1 Hz, 1H), 1.258 (s, 6H), 1.256 (s, 6H), 1.17 (s, 3H) ppm.

¹³C NMR (151 MHz, CDCl₃): δ 82.96, 55.95, 51.30, 44.81, 29.44, 25.04, 24.95, 19.39 ppm.

¹¹B NMR (128 MHz, CDCl₃): δ 32.16 ppm.

MS (GCMS, EI): m/z=193 (7%), 151 (8%), 135 (7%), 108 (100%), 67 (62%).

TLC: R_{f}=0.50 (20:1 hexanes:ethyl acetate).

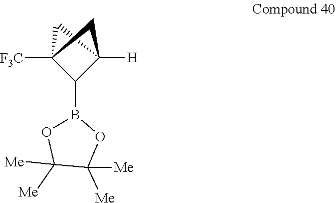 [SMILES: CC1(C)OB(C2[C@H]3C[C@]2(C(F)(F)F)C3)OC1(C)C]

### 4,4,5,5-tetramethyl-2-(1-(trifluoromethyl)bicyclo[1.1.1]pentan-2-yl)-1,3,2-dioxaborolane (40)

General Procedure B was followed on a 0.1 mmol scale with BCP bisboronate 26 under argon atmosphere in benzene solution heating at 100° C. for 12 hours. Purification by flash chromatography (hexanes:ethyl acetate, 40:1) afforded 17.4 mg (66%) of the title compound 40.

Physical State: colorless oil.

¹H NMR (600 MHz, CDCl₃): δ 2.67 (s, 1H), 2.58 (dd, J=9.5, 2.3 Hz, 1H), 2.03-1.98 (m, 2H), 1.96 (dd, J=8.2, 2.3 Hz, 1H), 1.84 (d, J=8.2 Hz, 1H), 1.254 (s, 6H), 1.252 (s, 6H) ppm.

¹³C NMR (151 MHz, CDCl₃): δ 122.03 (q, J=277.2 Hz), 83.46, 52.13, 47.33, 43.36 (q, J=37.5 Hz), 29.72, 24.70, 24.69 ppm.

¹¹B NMR (128 MHz, CDCl₃): δ 31.45 ppm.

¹⁹F NMR (565 MHz, CDCl₃): δ −73.45 ppm.

MS (GCMS, EI): m/z=247 (11%), 153 (9%), 131 (29%), 83 (52%), 59 (100%).

TLC: R_{f}=0.50 (20:1 hexanes:ethyl acetate).

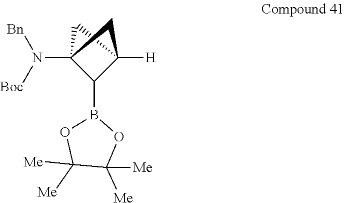 [SMILES: CC(C)(C)OC(=O)N(Cc1ccccc1)[C@]12C[C@H](C1)C2B1OC(C)(C)C(C)(C)O1]

### tert-butyl benzyl(2-(4,4,5,5-tetramethyl-1,3,2-dioxaborolan-2-yl)bicyclo[1.1.1]pentan-1-yl)carbamate (41)

In a 5 mL screw-capped culture tube was added 24 (0.1 mmol), DMAP (30 mol %), MeOBcat (30 mol %) and (Ir[dF(CF₃)ppy]₂(dtbpy))PF₆ (5 mol %). CH₃OH (0.5 mL) and acetone (0.5 mL) was added and the tube was sealed. The reaction was stirred under irradiation by blue LED for 2 hours when TLC analysis showed the consume of the starting material. The solvent was concentrated and the residue was purified by flash chromatography (hexanes:ethyl acetate, 10:1), which afforded 20.5 mg (53%) of the title compound 41. Note: the protodeborylation product of bis-Bpins was observed as the reaction time is extended.

Physical State: colorless oil.

¹H NMR (600 MHz, CDCl₃): δ 7.30-7.26 (m, 2H), 7.24-7.21 (m, 2H), 7.19 (td, J=7.1, 1.4 Hz, 1H), 4.57-4.33 (m, 2H), 2.80-2.28 (m, 2H), 2.04 (dd, J=9.6, 1.3 Hz, 1H), 2.00-1.91 (m, 3H), 1.45 (br., 9H), 1.23 (s, 12H) ppm.

¹³C NMR (151 MHz, CDCl₃): δ 140.09, 128.29, 126.76, 126.57, 83.16, 52.11, 48.88, 28.58, 25.79, 25.00 ppm. Note: NC(O), NC, NCH2, Me3C and BpinC were not observed.

¹¹B NMR (128 MHz, CDCl₃): δ 31.29 ppm.

HRMS (ESI-TOF): calc'd for C₂₃H₃₄BNO₄ [M+H]⁺: 400.2653, found: 400.2655.

TLC: R_{f}=0.39 (10:1 hexanes:ethyl acetate).

### General Procedures C for Cyanation of BCP Bisboronates

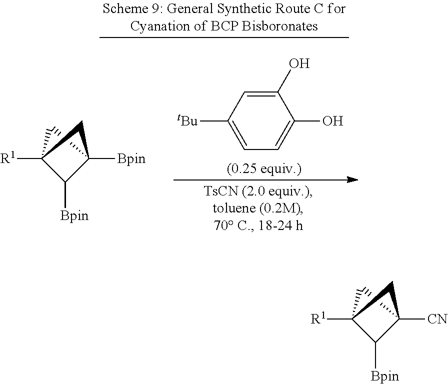

A flame-dried screw-capped culture tube was charged with BCP bisboronate (1.0 equiv.), p-toluenesulfonyl cyanide (2.0 equiv.) and tert-butyl catechol (0.25 equiv.). Then the tube or the flask was evacuated and backfilled with argon three times, followed by addition of toluene (0.2 M) via a syringe. After stirring for at 70° C. for 18-24 hours, and upon confirmation that the starting material was consumed totally, the reaction mixture was cooled to room temperature. Next, the solvent was removed under high vacuum, and the crude residue was purified by chromatography on silica gel. (Andrd-Joyaux et al., 2020)

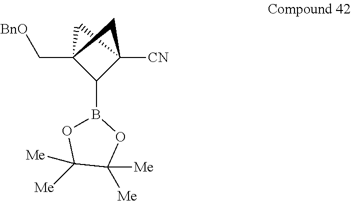 [SMILES: CC1(C)OB(C2[C@]3(C#N)C[C@@]2(COCc2ccccc2)C3)OC1(C)C]

### 3-((benzyloxy)methyl)-2-(4,4,5,5-tetramethyl-1,3,2-dioxaborolan-2-yl)bicyclo[1.1.1]pentane-1-carbonitrile (42)

General Procedure C was followed on a 0.1 mmol scale with BCP bisboronate 25, p-toluenesulfonyl cyanide and guaiacol (1.0 equiv.) as additive. Purification by flash chromatography (hexanes:ethyl acetate, 20:1) afforded 19.5 mg (57%) of the title compound 42.

Physical State: colorless oil.

¹H NMR (600 MHz, CDCl₃): δ 7.30-7.24 (m, 4H), 7.24-7.21 (m, 1H), 4.45 (s, 2H), 3.39 (s, 2H), 2.69 (dd, J=9.9, 2.3 Hz, 1H), 2.19-2.14 (m, 2H), 2.10 (dd, J=8.2, 2.3 Hz, 1H), 1.98 (d, J=8.2 Hz, 1H), 1.19 (s, 6H), 1.18 (s, 6H) ppm.

¹³C NMR (151 MHz, CDCl₃): δ 138.26, 128.44, 127.71, 127.61, 118.00, 83.85, 73.17, 68.93, 57.33, 52.55, 45.48, 26.01, 24.87, 24.84 ppm.

¹¹B NMR (128 MHz, CDCl₃): δ 31.02 ppm.

MS (GCMS, EI): m/z=324 (0.2%), 238 (1%), 190 (4%), 176 (6%), 133 (5%), 91 (100%).

TLC: R_{f}=0.28 (10:1 hexanes:ethyl acetate).

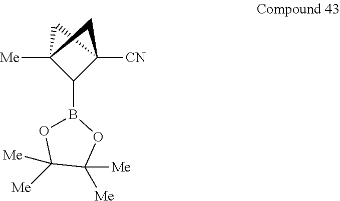 [SMILES: CC1(C)OB(C2[C@]3(C)C[C@@]2(C#N)C3)OC1(C)C]

### 3-methyl-2-(4,4,5,5-tetramethyl-1,3,2-dioxaborolan-2-yl)bicyclo[1.1.1]pentane-1-carbonitrile (43)

General Procedure C was followed on a 0.2 mmol scale with BCP bisboronate 14, and p-toluenesulfonyl cyanide. Purification by flash chromatography (hexanes:ethyl acetate, 50:1) afforded 23.0 mg (50%) of the title compound 43.

Physical State: white solid.

m.p.: 44-46° C.

¹H NMR (600 MHz, CDCl₃): δ 2.56 (dd, J=9.7, 2.3 Hz, 1H), 2.14-2.11 (m, 2H), 2.05 (dd, J=8.4, 2.4 Hz, 1H), 1.92 (d, J=8.3 Hz, 1H), 1.26 (s, 12H), 1.19 (s, 3H) ppm.

¹³C NMR (151 MHz, CDCl₃): δ 118.13, 83.79, 59.60, 54.83, 43.87, 25.19, 24.96, 24.93, 17.82 ppm.

¹¹B NMR (128 MHz, CDCl₃): δ 31.12 ppm.

MS (GCMS, EI): m/z=218 (23%), 176 (20%), 160 (23%), 133 (80%), 55 (100%).

TLC: R_{f}=0.28 (10:1 hexanes:ethyl acetate).

### General Procedures D for C—S & C—N Formation of BCP Bisboronates

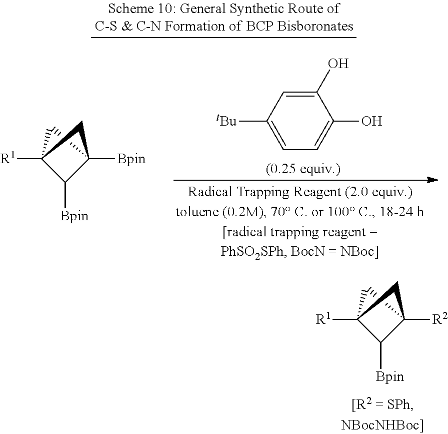

A flame-dried screw-capped culture tube was charged with BCP bisboronate (1.0 equiv.), radical trapping reagent (2.0 equiv., PhSO₂SPh or DBAD) and tert-butyl catechol (0.25 equiv.). Then the tube or the flask was evacuated and backfilled with argon three times, followed by addition of toluene (0.2 M) via a syringe. The reaction mixture was stirred at 70° C. or 100° C. (according to details provided below) for 18-24 hours. After confirmation that the starting material was consumed totally, the reaction mixture was cooled to room temperature. Next, the solvent was removed under high vacuum, and the crude residue was purified by chromatography on silica gel.

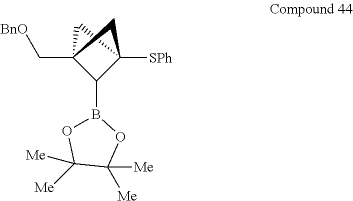

### 2-(1-((benzyloxy)methyl)-3-(phenylthio)bicyclo[1.1.1]pentan-2-yl)-4,4,5,5-tetramethyl-1,3,2-dioxaborolane (44)

General Procedure D was followed on a 0.1 mmol scale. BCP bisboronate 25, and PhSO₂SPh were reacted at 100° C. for 24 h. Purification by flash chromatography (hexanes:ethyl acetate, 20:1) afforded 29.6 mg (64%) of the title compound 44.

Physical State: colorless oil.

¹H NMR (600 MHz, CDCl₃): δ 7.46-7.41 (m, 2H), 7.32-7.16 (m, 8H), 4.46 (s, 2H), 3.44 (s, 2H), 2.54 (dd, J=9.5, 1.9 Hz, 1H), 1.87 (dd, J=8.1, 1.9 Hz, 1H), 1.85-1.81 (m, 2H), 1.67 (d, J=8.0 Hz, 1H), 1.142 (s, 6H), 1.138 (s, 6H) ppm.

¹³C NMR (151 MHz, CDCl₃): δ 138.67, 134.17, 134.12, 128.78, 128.40, 127.60, 127.57, 127.55, 83.22, 72.96, 69.71, 57.80, 52.05, 45.30, 42.19, 24.92, 24.87 ppm.

¹¹B NMR (128 MHz, CDCl₃): δ 31.13 ppm.

MS (GCMS, EI): m/z=422 (0.1%), 331 (2%), 239 (10%), 187 (12%), 91 (100%).

TLC: R_{f}=0.48 (10:1 hexanes:ethyl acetate).

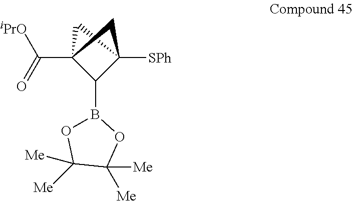

### isopropyl 3-(phenylthio)-2-(4,4,5,5-tetramethyl-1,3,2-dioxaborolan-2-yl)bicyclo[1.1.1]pentane-1-carboxylate (45)

General Procedure D was followed on a 0.1 mmol scale. BCP bisboronate 23, and PhSO₂SPh were reacted at 70° C. for 24 h. Purification by flash chromatography (hexanes:ethyl acetate, 20:1) afforded 13.0 mg (35%) of the title compound 45.

Physical State: colorless oil.

¹H NMR (600 MHz, CDCl₃): δ 7.48-7.43 (m, 2H), 7.31-7.27 (m, 3H), 4.95 (hept, J=6.3 Hz, 1H), 2.90 (dd, J=9.4, 1.9 Hz, 1H), 2.20-2.13 (m, 1H), 2.12 (s, 1H), 2.12-2.07 (m, 1H), 2.01-1.92 (m, 1H), 1.22 (s, 6H), 1.21 (s, 6H), 1.18 (d, J=6.3 Hz, 6H) ppm.

¹³C NMR (151 MHz, CDCl₃): δ 168.60, 134.51, 133.16, 128.95, 128.04, 83.50, 68.10, 59.22, 53.67, 45.08, 41.21, 25.02, 25.01, 24.82, 21.90 ppm.

¹¹B NMR (128 MHz, CDCl₃): δ 31.01 ppm.

MS (GCMS, EI): m/z=388 (1.2%), 345 (33%), 269 (10%), 237 (20%), 125 (44%), 83 (100%).

TLC: R_{f}=0.45 (10:1 hexanes:ethyl acetate).

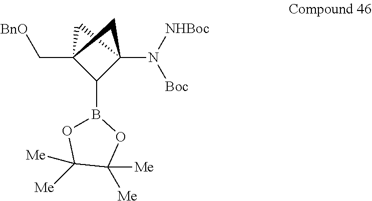 [SMILES: CC(C)(C)OC(=O)NN(C(=O)OC(C)(C)C)[C@]12C[C@](COCc3ccccc3)(C1)C2B1OC(C)(C)C(C)(C)O1]

### di-tert-butyl 1-(3-((benzyloxy)methyl)-2-(4,4,5,5-tetramethyl-1,3,2-dioxaborolan-2-yl)bicyclo[1.1.1]pentan-1-yl)hydrazine-1,2-dicarboxylate (46)

General Procedure D was followed on a 0.1 mmol scale. BCP bisboronate 25, and di-tert-butyl azodicarboxylate (DBAD) were reacted at 100° C. for 24 h. Purification by flash chromatography (hexanes:ethyl acetate, 20:1) afforded 27.2 mg (50%) of the title compound 46.

Physical State: red oil.

¹H NMR (600 MHz, CDCl₃): δ 7.36-7.23 (m, 5H), 6.66 (s, 0.5H), 6.15 (s, 0.5H), 4.54 (s, 2H), 3.61 (s, 2H), 2.57-1.68 (m, 5H), 1.46 (s, 9H), 1.45 (s, 9H), 1.21 (s, 12H) ppm.

¹³C NMR (151 MHz, CDCl₃): δ 138.82, 128.40, 127.61, 127.52, 83.37, 72.97, 69.05, 28.45, 28.34, 24.95, 24.90 ppm. Note: Me₃C, C(O) and all the carbon of BCP skeleton were not observed.

¹¹B NMR (128 MHz, CDCl₃): δ 30.76 ppm.

HRMS (ESI-TOF): calc. for C₂₉H₄₅BN₂O₇[M+H]⁺: 545.3393, found: 545.3374.

TLC: R_{f}=0.59 (2:1 hexanes:ethyl acetate).

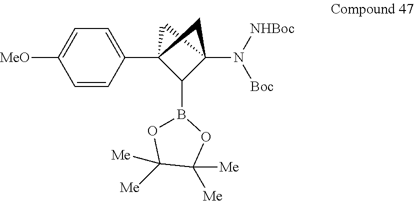 [SMILES: COc1ccc([C@]23C[C@](N(NC(=O)OC(C)(C)C)C(=O)OC(C)(C)C)(C2)C3B2OC(C)(C)C(C)(C)O2)cc1]

### di-tert-butyl 1-(3-(4-methoxyphenyl)-2-(4,4,5,5-tetramethyl-1,3,2-dioxaborolan-2-yl)bicyclo [1.1.1]pentan-1-yl)hydrazine-1,2-dicarboxylate (47)

General Procedure D was followed on a 0.1 mmol scale. BCP bisboronate 27, and di-tert-butyl azodicarboxylate (DBAD) were reacted at 100° C. for 24 h. Purification by flash chromatography (hexanes:ethyl acetate, 20:1) afforded 23.9 mg (45%) of the title compound 47.

Physical State: light yellow foam.

¹H NMR (600 MHz, CDCl₃): δ 7.21 (d, J=8.1 Hz, 2H), 6.82 (d, J=8.6 Hz, 2H), 6.65 (br., 0.5H), 6.16 (br., 0.5H), 3.78 (s, 3H), 2.98-2.60 (m, 1H), 2.52-2.25 (m, 2H), 2.20-1.97 (m, 2H), 1.54-1.44 (m, 18H), 1.24 (s, 12H) ppm.

¹³C NMR (151 MHz, CDCl₃): δ 158.44, 131.80, 127.93, 113.59, 83.45, 55.41, 28.46, 28.34, 25.03, 24.92 ppm. Note: Me₃C, C(O) and all the carbon of BCP skeleton were not observed.

¹¹B NMR (128 MHz, CDCl₃): δ 31.11 ppm.

HRMS (ESI-TOF): calc. for C₂₈H₄₃BN₂O₇[M+H]⁺: 531.3236, found: 531.3235.

TLC: R_{f}=0.59 (2:1 hexanes:ethyl acetate).

### General Procedure E for Giese-Type-Reaction of BCP BisBoronates

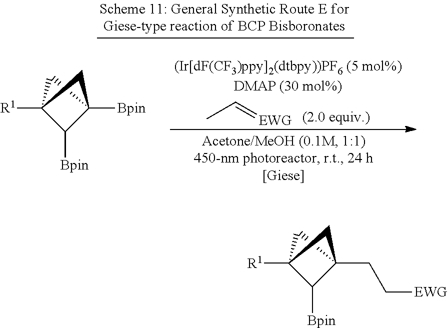

A screw-capped culture tube was charged with (Ir[dF(CF₃)ppy]₂(dtbpy))PF₆ (5 mol %), DMAP (30 mol %), BCP bisboronate (1.0 equiv.) and Michael acceptor (2.0 equiv.). Then the tube or the flask was evacuated and backfilled with argon three times, followed by addition of methanol/acetone (0.1 M, 1:1) solvent via a syringe. The headspace of the tube was then purged with a gentle stream of argon for approximately 10 seconds. After stirring in a 450-nm photoreactor for 24 hours, it was confirmed that the starting material was totally consumed and the reaction mixture was concentrated under high vacuum. The crude residue was then purified by chromatography on silica gel (Lima et al., 2017).

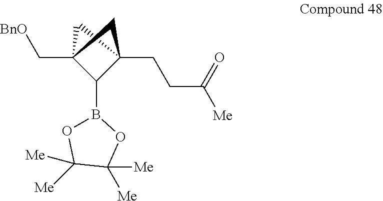 [SMILES: CC(=O)CC[C@]12C[C@](COCc3ccccc3)(C1)C2B1OC(C)(C)C(C)(C)O1]

### 4-(3-((benzyloxy)methyl)-2-(4,4,5,5-tetramethyl-1,3,2-dioxaborolan-2-yl)bicyclo[1.1.1]pentan-1-yl)butan-2-one (48)

General Procedure E was followed on a 0.05 mmol scale with BCP bisboronate 25 and methyl vinyl ketone. Purification by flash chromatography (hexanes:ethyl acetate, 20:1) afforded 13.5 mg (70%) of the title compound 48.

Physical State: colorless oil.

¹H NMR (600 MHz, CDCl₃): δ 7.35-7.29 (m, 4H), 7.27-7.23 (m, 1H), 4.53 (s, 2H), 3.47 (s, 2H), 2.42 (dd, J=8.6, 6.9 Hz, 2H), 2.14 (s, 3H), 2.11 (dd, J=9.9, 2.0 Hz, 1H), 1.79 (t, J=7.7 Hz, 2H), 1.61-1.58 (m, 2H), 1.55 (dd, J=8.2, 2.0 Hz, 1H), 1.44-1.38 (m, 1H), 1.21 (s, 12H) ppm.

¹³C NMR (151 MHz, CDCl₃): δ 209.17, 139.00, 128.36, 127.57, 127.44, 82.96, 72.93, 70.40, 53.49, 48.17, 42.45, 41.01, 40.72, 29.93, 26.48, 24.96, 24.95 ppm.

¹¹B NMR (128 MHz, CDCl₃): δ 31.69 ppm.

MS (GCMS, EI): m/z=369 (0.1%), 326 (0.2%), 275 (0.2%), 149 (10%), 91 (100%).

TLC: R_{f}=0.32 (4:1 hexanes:ethyl acetate).

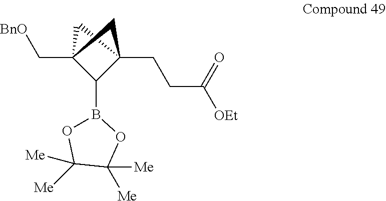 [SMILES: CCOC(=O)CC[C@]12C[C@](COCc3ccccc3)(C1)C2B1OC(C)(C)C(C)(C)O1]

### ethyl 3-(3-((benzyloxy)methyl)-2-(4,4,5,5-tetramethyl-1,3,2-dioxaborolan-2-yl)bicyclo[1.1.1]pentan-1-yl)propanoate (49)

General Procedure E was followed on a 0.1 mmol scale with BCP bisboronate 25 and ethyl acrylate. Purification by flash chromatography (hexanes:ethyl acetate, 20:1) afforded 15.7 mg (38%) of the title compound 49.

Physical State: colorless oil.

¹H NMR (600 MHz, CDCl₃): δ 7.36-7.30 (m, 4H), 7.29-7.23 (m, 1H), 4.53 (s, 2H), 4.11 (q, J=7.2 Hz, 2H), 3.48 (s, 2H), 2.29 (td, J=7.5, 1.8 Hz, 2H), 2.12 (dd, J=9.8, 2.0 Hz, 1H), 1.85 (t, J=7.8 Hz, 2H), 1.63-1.59 (m, 2H), 1.57 (dd, J=8.3, 2.0 Hz, 1H), 1.42 (d, J=8.2 Hz, 1H), 1.25 (t, J=7.2 Hz, 3H), 1.21 (s, 12H) ppm.

¹³C NMR (151 MHz, CDCl₃): δ 173.95, 139.01, 128.36, 127.58, 127.44, 82.96, 72.94, 70.41, 60.34, 53.40, 48.12, 42.46, 40.69, 31.71, 27.58, 24.95, 24.93, 14.35 ppm.

¹¹B NMR (128 MHz, CDCl₃): δ 31.62 ppm.

MS (GCMS, EI): m/z=399 (0.1%), 369 (0.1%), 323 (0.2%), 179 (10%), 91 (100%).

TLC: R_{f}=0.54 (4:1 hexanes:eth acetate).

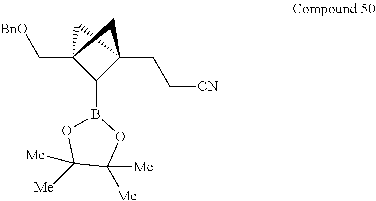 [SMILES: CC1(C)OB(C2[C@]3(CCC#N)C[C@@]2(COCc2ccccc2)C3)OC1(C)C]

### 3-(3-((benzyloxy)methyl)-2-(4,4,5,5-tetramethyl-1,3,2-dioxaborolan-2-yl)bicyclo[1.1.1]pentan-1-yl)propanenitrile (50)

General Procedure E was followed on a 0.1 mmol scale with BCP bisboronate 25 and acrylonitrile. Purification by flash chromatography (hexanes:ethyl acetate, 20:1) afforded 20.0 mg (55%) of the title compound 50.

Physical State: colorless oil.

¹H NMR (600 MHz, CDCl₃): δ 7.35-7.30 (m, 4H), 7.30-7.23 (m, 1H), 4.53 (s, 2H), 3.50 (s, 2H). 2.34 (t. J=7.5 Hz, 2H), 2.13 (dd, J=10.0, 2.2 Hz, 1H), 1.89 (t, J=7.5 Hz, 2H), 1.73-1.69 (m, 2H), 1.66 (dd, J=8.3, 2.1 Hz, 1H), 1.47 (d, J=8.2 Hz, 1H), 1.213 (s, 6H), 1.208 (s, 6H) ppm.

¹³C NMR (151 MHz, CDCl₃): δ 138.88, 128.37, 127.57, 127.49, 120.28, 83.19, 72.99, 70.07, 53.51, 48.42, 41.61, 40.95, 28.16, 24.95, 14.52 ppm.

¹¹B NMR (128 MHz, CDCl₃): δ 31.66 ppm.

MS (GCMS, EI): m/z=352 (0.1%), 338 (0.1%), 324 (0.1%), 161 (5%), 132 (10%), 91 (100%).

TLC: R_{f}=0.39 (4:1 hexanes:ethyl acetate).

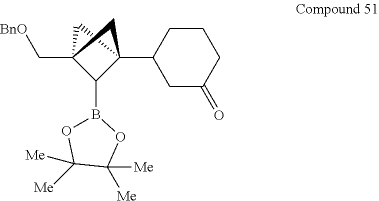 [SMILES: CC1(C)OB(C2[C@]3(COCc4ccccc4)C[C@@]2(C2CCCC(=O)C2)C3)OC1(C)C]

### 3-(3-((benzyloxy)methyl)-2-(4,4,5,5-tetramethyl-1,3,2-dioxaborolan-2-yl)bicyclo[1.1.1]pentan-1-yl)cyclohexan-1-one (51)

General Procedure E was followed on a 0.1 mmol scale with BCP bisboronate 25 and cyclohexenone. Purification by flash chromatography (hexanes:ethyl acetate, 20:1) afforded 22.8 mg (56%) of the title compound 51. Note: two diastereoisomers (1/1) were observed.

NMR spectroscopy of the mixture was given.

Physical State: colorless oil.

¹H NMR (600 MHz, CDCl₃): δ 7.35-7.28 (m, 4H), 7.29-7.21 (m, 1H), 4.53 (s, 2H), 3.49 (s, 2H), 2.36-2.28 (m, 2H), 2.24-2.15 (m, 2H), 2.10-1.98 (m, 2H), 1.90 (tt, J=12.3, 3.7 Hz, 1H), 1.86-1.79 (m, 1H), 1.66-1.51 (m, 4H), 1.41 (dd, J=11.1, 8.1 Hz, 1H), 1.34-1.27 (m, 1H), 1.20 (s, 6H), 1.19 (s, 6H) ppm.

¹³C NMR (151 MHz, CDCl₃): δ 212.61, 138.90, 128.37, 127.58, 127.47, 83.02, 83.00, 72.98, 70.37, 70.35, 51.37, 51.24, 46.22, 46.20, 46.09, 46.07, 44.87, 44.85, 41.38, 41.34, 40.57, 40.50, 39.97, 39.95, 28.08, 28.00, 25.59, 25.48, 24.91, 24.87 ppm.

¹¹B NMR (128 MHz, CDCl₃): δ 32.00 ppm.

MS (GCMS, EI): m/z=395 (0.1%), 352 (0.2%), 301 (0.2%), 219 (3%), 175 (6%), 91 (100%).

TLC: R_{f}=0.36 (4:1 hexanes:ethyl acetate).

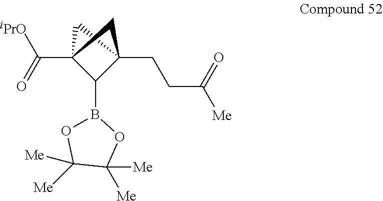 [SMILES: CC(=O)CC[C@]12C[C@](C(=O)OC(C)C)(C1)C2B1OC(C)(C)C(C)(C)O1]

### isopropyl 3-(3-oxobutyl)-2-(4,4,5,5-tetramethyl-1,3,2-dioxaborolan-2-yl)bicyclo[1.1.1]pentane-1-carboxylate (52)

General Procedure E was followed on a 0.1 mmol scale with BCP bisboronate 23 and methyl vinyl ketone. Purification by flash chromatography (hexanes:ethyl acetate, 20:1) afforded 12.9 mg (38%) of the title compound 52.

Physical State: colorless oil.

¹H NMR (600 MHz, CDCl₃): δ 4.97 (hept, J=6.3 Hz, 1H), 2.47 (dd, J=9.9, 2.1 Hz, 1H), 2.44-2.38 (m, 2H), 2.13 (s, 3H), 1.87-1.83 (m, 2H), 1.82 (dd, J=8.1, 2.1 Hz, 1H), 1.78 (ddd, J=11.2, 6.7, 3.4 Hz, 2H), 1.67 (d, J=8.1 Hz, 1H), 1.241 (s, 6H), 1.238 (s, 6H), 1.21 (d, J=2.9 Hz, 3H), 1.20 (d, J=2.9 Hz, 3H) ppm. ¹³C NMR (151 MHz, CDCl₃): δ 208.53, 169.90, 83.26, 67.64, 55.18, 50.05, 41.72, 40.64, 39.95, 29.98, 25.85, 25.01, 24.89, 21.96, 21.95 ppm.

¹¹B NMR (128 MHz, CDCl₃): δ 31.62 ppm.

MS (GCMS, EI): m/z=335 (0.8%), 292 (5%), 208 (10%), 190 (20%), 121 (80%), 55 (100%).

TLC: R_{f}=0.29 (4:1 hexanes:ethyl acetate).

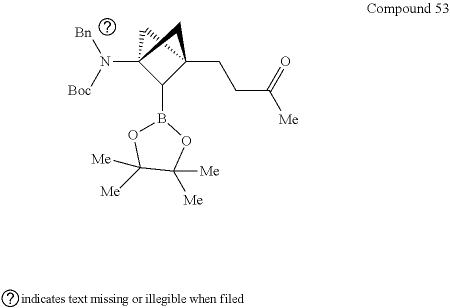 [SMILES: CC(=O)CC[C@]12C[C@](N(Cc3ccccc3)C(=O)OC(C)(C)C)(C1)C2B1OC(C)(C)C(C)(C)O1]

### tert-butyl benzyl(3-(3-oxobutyl)-2-(4,4,5,5-tetramethyl-1,3,2-dioxaborolan-2-yl)bicyclo[1.1.1]pentan-1-yl)carbamate (53)

General Procedure E was followed on a 0.1 mmol scale with BCP bisboronate 24 and methyl vinyl ketone. Purification by flash chromatography (hexanes:ethyl acetate, 20:1) afforded 13.6 mg (29%) of the title compound 53.

Physical State: colorless oil.

¹H NMR (600 MHz, CDCl₃): δ 7.42-7.22 (m, 2H), 7.23-7.16 (m, 3H), 4.52-4.41 (m, 2H), 2.37 (t, J=7.7 Hz, 2H), 2.10 (s, 3H), 1.84 (dd, J=9.6, 1.2 Hz, 1H), 1.82-1.71 (m, 5H), 1.57-1.32 (m, 10H), 1.22 (s, 12H) ppm.

¹³C NMR (151 MHz, CDCl₃): δ 208.73, 140.05, 128.29, 126.73, 126.59, 83.11, 79.83 (br.), 51.62, 49.08 (br.), 41.25, 38.27, 29.93, 28.58, 25.05, 25.00, 24.44 ppm. Note: NC(O), NC, NCH₂ and BpinC were not observed.

¹¹B NMR (128 MHz, CDCl₃): δ 31.06 ppm.

HRMS (ESI-TOF): calc. for C₂₇H₄₀BNO₅ [M+H]⁺: 470.3072, found: 470.3069.

TLC: R_{f}=0.32 (4:1 hexanes:ethyl acetate).

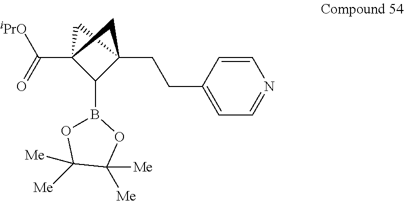 [SMILES: CC(C)OC(=O)[C@]12C[C@](CCc3ccncc3)(C1)C2B1OC(C)(C)C(C)(C)O1]

### isopropyl 3-(2-(pyridin-4-yl)ethyl)-2-(4,4,5,5-tetramethyl-1,3,2-dioxaborolan-2-yl)bicyclo [1.1.1]pentane-1-carboxylate (54)

General Procedure E was followed on a 0.1 mmol scale with BCP bisboronate 23 and 4-vinylpyridine. Purification by flash chromatography (hexanes:ethyl acetate, 2:1) afforded 20.5 mg (53%) of the title compound 54.

Physical State: pale yellow oil.

¹H NMR (600 MHz, CDCl₃): δ 8.49 (br., 2H), 7.14 (br., 2H), 4.97 (hept, J=6.2 Hz, 1H), 2.59 (td, J=7.7, 4.4 Hz, 2H), 2.50 (dd, J=9.9, 2.0 Hz, 1H), 1.90-1.87 (m, 2H), 1.87-1.83 (m, 3H), 1.72 (d, J=8.1 Hz, 1H), 1.240 (s, 6H), 1.238 (s, 6H), 1.21 (d, J=2.8 Hz, 3H), 1.20 (d, J=2.8 Hz, 3H) ppm.

¹³C NMR (151 MHz, CDCl₃): δ 169.84, 151.88, 149.29, 124.15, 83.28, 67.70, 55.28, 50.27, 42.07, 40.04, 32.25, 32.20, 24.99, 24.92, 21.94 ppm.

¹¹B NMR (128 MHz, CDCl₃): δ 31.50 ppm.

HRMS (ESI-TOF): calc'd for C₂₂H₃₂BNO₄ [M+H]⁺: 386.2497, found: 386.2498.

TLC: R_{f}=0.23 (1:1 hexanes:ethyl acetate).

### General Procedure F for Cross-Coupling of BCP Bisboronates

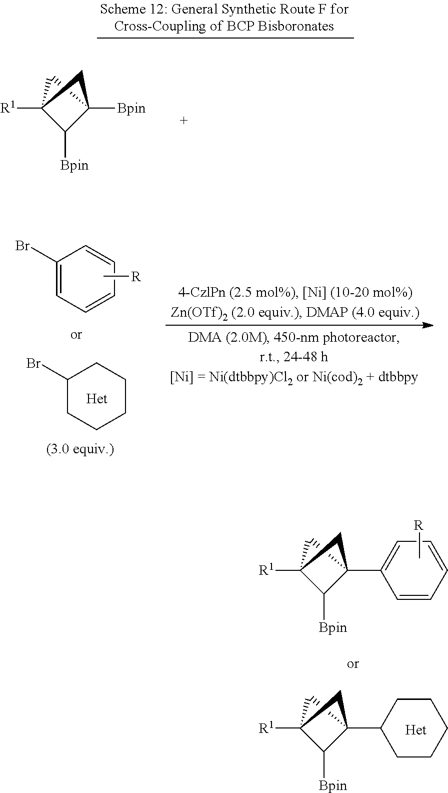

### General Procedure F1:

A flame-dried screw-capped culture tube was charged with BCP bisboronate (1.0 equiv.), aryl bromide (3.0 equiv.), 4-CzlPn (5 mol %), Ni(dtbbpy)Cl₂ (10 mol %), Zn(OTf)₂ (2.0 equiv.) and DMAP (4.0 equiv.). Then the tube was evacuated and backfilled with argon three times, followed by addition of DMA (0.2 M) solvent via a syringe. Next, the headspace of the tube was purged with a gentle stream of argon for approximately 10 seconds and the reaction was allowed to stir in a 450-nm PennPhD integrated photoreactor (M2) for 24-60 hours. After it was confirmed that the starting material was totally consumed, the reaction mixture quenched with water, extracted with ethyl acetate or diethyl ether, washed with brine, dried by Na₂SO₄, and concentrated under high vacuum. The crude residue was purified by chromatography on silica gel.

### General Procedure F2:

Preparation of [Ni] catalyst: A flame-dried screw-capped culture tube was charged with Ni(cod)₂ (0.2 mmol, 55 mg) and dtbbpy (0.24 mmol, 64.4 mg). The tube was then evacuated and backfilled with argon three times, followed by addition of DMA (4.0 mL) solvent via a syringe. Next, the tube was sonicated for 20 minutes to dissolve the catalyst.

A flame-dried screw-capped culture tube was charged with BCP bisboronate (1.0 equiv.), aryl bromide (3.0 equiv.), Zn(OTf)₂ (2.0 equiv.) and DMAP (4.0 equiv.). Then the tube was evacuated and backfilled with argon three times, followed by addition of 4-CzlPn solution (0.02 equiv., 0.02 M) in DMA and [Ni] catalyst solution (0.2 equiv., 0.05 M) in DMA via a syringe. Next, the headspace of the tube was purged with a gentle stream of argon for approximately 10 seconds and the reaction was allowed to stir in a 450-nm PennPhD integrated photoreactor (M2) for 24-60 hours. After it was confirmed that the starting material was totally consumed, the reaction mixture was quenched with water, extracted with ethyl acetate or diethyl ether, washed with brine, dried by Na₂SO₄, and concentrated under high vacuum. The crude residue was purified by chromatography on silica gel.

### Scale-Up of Cross-Coupling of BCP Boronate 14 & 23:

Preparation of [Ni] catalyst: A flame-dried screw-capped culture tube was charged with Ni(cod)₂ (0.4 mmol, 110 mg) and dtbbpy (0.48 mmol, 128.8 mg). Then the tube was evacuated and backfilled with argon three times, followed by addition of DMA (8.0 mL) solvent via a syringe. Next, the tube was sonicated for 20 minutes to form a dark purple solution of Ni catalyst.

Scale-up preparation of BCP boronate 65: A flame-dried screw-capped culture tube was charged with BCP bisboronate 14 (668 mg, 2.0 mmol, 1.0 equiv.), Zn(OTf)₂ (1.46 mg, 4.0 mmol, 2.0 equiv.) and DMAP (977.6 mg, 8.0 mmol, 4.0 equiv.). Then the tube was evacuated and backfilled with argon three times, followed by addition of phenyl bromide (0.62 mL, 6.0 mmol, 3.0 equiv.), 4-CzlPn solution (1.0 mL, 0.05 equiv., 0.05 M) in DMA and [Ni] catalyst solution (8.0 mL, 0.2 equiv., 0.05 M) in DMA via a syringe. Next, the headspace of the tube was purged with a gentle stream of argon for approximately 10 seconds. The reaction tube was sealed and then irradiated under a 40 W Kessil blue LED lamp (468 nm) for 60 hours with a fan running to cool the reaction down. After it was confirmed that the starting material was totally consumed, the reaction mixture was quenched with water (30 mL), extracted with ethyl acetate (10 mL×2) and diethyl ether (10 mL×2), washed with brine (10 mL×2), dried by Na₂SO₄, and concentrated under high vacuum. The crude residue was purified by chromatography on silica gel which afforded 209.6 mg (37%) product as colorless oil.

Scale-up preparation of BCP boronate 55: A flame-dried screw-capped culture tube was charged with BCP bisboronate 23 (406 mg, 1.0 mmol, 1.0 equiv.), 4-bromophenyl methyl sulfone (705 mg, 3.0 mmol, 3.0 equiv.), Zn(OTf)₂ (732 mg, 2.0 mmol, 2.0 equiv.) and DMAP (488.8 mg, 4.0 mmol, 4.0 equiv.). Then the tube was evacuated and backfilled with argon for three times, followed by addition of 4-CzlPn solution (1.0 mL, 0.02 equiv., 0.02 M) in DMA and [Ni] catalyst solution (4.0 mL, 0.2 equiv., 0.05 M) in DMA via a syringe. Next, the headspace of the tube was purged with a gentle stream of argon for approximately 10 seconds and the reaction was sealed and then irradiated under a 40 W Kessil blue LED lamp (468 nm) for 48 hours with a fan running to cool the reaction down. After it is confirmed that the starting material was consumed totally, the reaction mixture quenched with water (30 mL), extracted with ethyl acetate (10 mL×2) and diethyl ether (10 mL×2), washed with brine (10 mL×2), dried by Na₂SO₄, and concentrated under high vacuum. The crude residue was purified by chromatography on silica gel and that afforded 200.0 mg (46%) product as colorless oil.

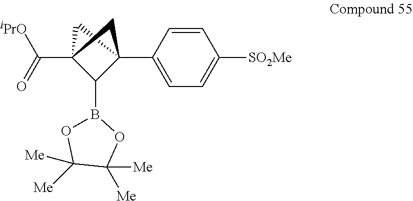 [SMILES: CC(C)OC(=O)[C@]12C[C@](c3ccc(S(C)(=O)=O)cc3)(C1)C2B1OC(C)(C)C(C)(C)O1]

### isopropyl 3-(4-(methylsulfonyl)phenyl)-2-(4,4,5,5-tetramethyl-1,3,2-dioxaborolan-2-yl)bicyclo[1.1.1]pentane-1-carboxylate (55)

General Procedure F2 was followed on a 0.1 mmol scale. BCP bisboronate 23 and 4-bromophenyl methyl sulfone were reacted for 60 hours. Purification by flash chromatography (methylene chloride:ethyl acetate, 50:1 to 20:1) afforded 22.4 mg (52%) of the title compound 55.

Scale-up of preparation of BCP boronate 55 was followed on a 1.0 mmol scale. BCP bisboronate 23 and 4-bromophenyl methyl sulfone were reacted accordingly for 48 hours. Purification by flash chromatography (methylene chloride:ethyl acetate, 50:1 to 20:1) afforded 200.0 mg (46%) of the title compound 55.

Physical State: white solid.

m.p.: 114-116° C.

¹H NMR (600 MHz, CDCl₃): δ 7.88-7.84 (m, 2H), 7.49-7.45 (m, 2H), 5.04 (hept, J=6.3 Hz, 1H), 3.05 (dd, J=10.0, 1.9 Hz, 1H), 3.03 (s, 3H), 2.37-2.32 (m, 2H), 2.27 (dd, J=8.1, 2.0 Hz, 1H), 2.15 (d, J=8.0 Hz, 1H), 1.26 (d, J=2.5 Hz, 3H), 1.25-1.24 (m, 15H) ppm.

¹³C NMR (151 MHz, CDCl₃): δ 169.58, 146.67, 138.89, 127.54, 127.45, 83.68, 68.13, 56.72, 52.42, 44.72, 43.53, 39.60, 24.96, 24.91, 21.98 ppm.

¹¹B NMR (128 MHz, CDCl₃): δ 30.90 ppm.

HRMS (ESI-TOF): calc'd for C₂₂H₃₁BO₆S [M+H]⁺: 435.2007, found: 435.2000.

TLC: R_{f}=0.20 (2:1 hexanes:ethyl acetate).

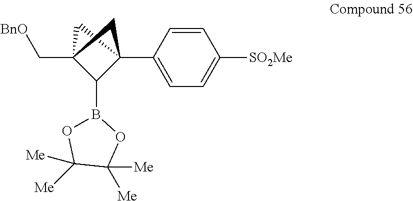 [SMILES: CC1(C)OB(C2[C@]3(COCc4ccccc4)C[C@@]2(c2ccc(S(C)(=O)=O)cc2)C3)OC1(C)C]

### 2-(1-((benzyloxy)methyl)-3-(4-(methylsulfonyl)phenyl)bicyclo[1.1.1]pentan-2-yl)-4,4,5,5-tetra methyl-1,3,2-dioxaborolane (56)

General Procedure F1 was followed on a 0.1 mmol scale. BCP bisboronate 25 and 4-bromophenyl methyl sulfone were reacted accordingly for 48 hours. Purification by flash chromatography (methylene chloride:ethyl acetate, 50:1 to 20:1) afforded 19.8 mg (42%) of the title compound 56.

Physical State: pale yellow oil.

¹H NMR (600 MHz, CDCl₃): δ 7.84 (dd, J=8.2, 1.3 Hz, 2H), 7.51-7.46 (m, 2H), 7.40-7.31 (m, 4H), 7.30-7.27 (m, 1H), 4.58 (s, 2H), 3.58 (s, 2H), 3.03 (s, 3H), 2.74-2.69 (m, 1H), 2.09 (d, J=8.9 Hz, 2H), 2.00 (dd, J=8.0, 1.7 Hz, 1H), 1.87 (d, J=8.1 Hz, 1H), 1.20 (s, 12H) ppm.

¹³C NMR (151 MHz, CDCl₃): δ 147.83, 138.77, 138.35, 128.43, 127.64, 127.59, 127.52, 127.30, 83.37, 73.14, 70.06, 55.30, 50.64, 44.75, 44.42, 40.55, 24.93, 24.91 ppm.

¹¹B NMR (128 MHz, CDCl₃): δ 31.32 ppm.

HRMS (ESI-TOF): calc'd for C₂₆H₃₃BO₅S [M+H]⁺: 469.2215, found: 469.2222.

TLC: R_{f}=0.25 (2:1 hexanes:ethyl acetate).

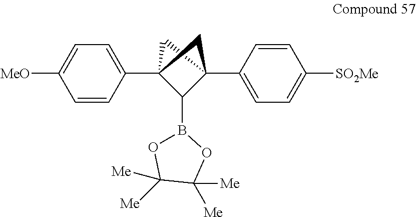 [SMILES: COc1ccc([C@]23C[C@](c4ccc(S(C)(=O)=O)cc4)(C2)C3B2OC(C)(C)C(C)(C)O2)cc1]

### 2-(1-(4-methoxyphenyl)-3-(4-(methylsulfonyl)phenyl)bicyclo[1.1.1]pentan-2-yl)-4,4,5,5-tetra methyl-1,3,2-dioxaborolane (57)

General Procedure F2 was followed on a 0.1 mmol scale. BCP bisboronate 27 and 4-bromophenyl methyl sulfone were reacted accordingly for 48 hours. Purification by flash chromatography (methylene chloride:ethyl acetate, 50:1) afforded 22.2 mg (31%) of the title compound 57.

Physical State: white solid.

m.p.: 155-157° C.

¹H NMR (600 MHz, CDCl₃): δ 7.90-7.85 (m, 2H), 7.56-7.51 (m, 2H), 7.29-7.24 (m, 2H), 6.88-6.83 (m, 2H), 3.80 (s, 3H), 3.11 (dd, J=9.6, 1.9 Hz, 1H), 3.04 (s, 3H), 2.37 (dd, J=9.6, 1.2 Hz, 1H), 2.32 (s, 1H), 2.24 (dd, J=8.1, 1.9 Hz, 1H), 2.16 (d, J=7.9 Hz, 1H), 1.22 (s, 6H), 1.21 (s, 6H) ppm.

¹³C NMR (151 MHz, CDCl₃): δ 158.57, 147.87, 138.42, 133.02, 127.57 (2C), 127.35, 113.65, 83.49, 57.64, 55.43, 52.84, 44.77, 43.36, 42.82, 25.00, 24.92 ppm.

¹¹B NMR (128 MHz, CDCl₃): δ 31.22 ppm.

HRMS (ESI-TOF): calc'd for C₂₅H₃₁BO₅S [M+H]⁺: 455.2058, found: 455.2058.

TLC: R_{f}=0.28 (2:1 hexanes:ethyl acetate).

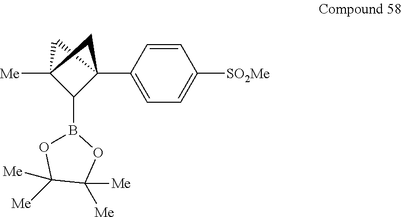 [SMILES: CC1(C)OB(C2[C@]3(C)C[C@@]2(c2ccc(S(C)(=O)=O)cc2)C3)OC1(C)C]

### 4,4,5,5-tetramethyl-2-(1-methyl-3-(4-(methylsulfonyl)phenyl)bicyclo[1.1.1]pentan-2-yl)-1,3,2-dioxaborolane (58)

General Procedure F2 was followed on a 0.1 mmol scale. BCP bisboronate 14 and 4-bromophenyl methyl sulfone were reacted accordingly for 48 hours. Purification by flash chromatography (hexanes:methylene chloride, 1:1) afforded 15.7 mg (43%) of the title compound 58.

Physical State: white solid.

m.p.: 88-90° C. 1H NMR (600 MHz, CDCl₃): δ 7.85-7.80 (m, 2H), 7.49-7.44 (m, 2H), 3.02 (s, 3H), 2.55 (dd, J=9.7, 2.0 Hz, 1H), 2.01-1.96 (m, 2H), 1.89 (dd, J=8.3, 2.0 Hz, 1H), 1.77 (d, J=8.3 Hz, 1H), 1.29 (s, 3H), 1.24 (s, 12H) ppm.

¹³C NMR (151 MHz, CDCl₃): δ 148.14, 138.10, 127.53, 127.24, 83.28, 57.75, 53.02, 44.77, 43.56, 38.54, 25.01, 24.97, 18.36 ppm.

¹¹B NMR (128 MHz, CDCl₃): δ 31.95 ppm.

MS (GCMS, EI): m/z=347 (3%), 262 (14%), 234 (60%), 141 (40%), 84 (100%).

TLC: R_{f}=0.38 (2:1 hexanes:ethyl acetate).

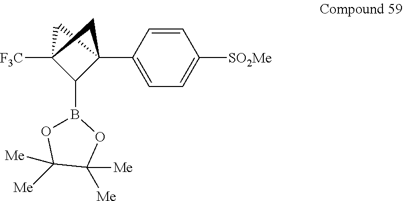 [SMILES: CC1(C)OB(C2[C@]3(c4ccc(S(C)(=O)=O)cc4)C[C@@]2(C(F)(F)F)C3)OC1(C)C]

### 4,4,5,5-tetramethyl-2-(1-(4-(methylsulfonyl)phenyl)-3-(trifluoromethyl)bicyclo[1.1.1]pentan-2-yl)-1,3,2-dioxaborolane (59)

General Procedure F2 was followed on a 0.1 mmol scale. BCP bisboronate 26 and 4-bromophenyl methyl sulfone were reacted accordingly for 48 hours. Purification by flash chromatography (hexanes:methylene chloride, 1:1) afforded 13.0 mg (31%) of the title compound 59.

Physical State: white solid.

m.p.: 95-97° C.

¹H NMR (600 MHz, CDCl₃): δ 7.92-7.85 (m, 2H), 7.51-7.44 (m, 2H), 3.08 (dd, J=9.6, 2.1 Hz, 1H), 3.04 (s, 3H), 2.30 (dd, J=9.6, 1.5 Hz, 1H), 2.27 (s, 1H), 2.21 (dd, J=8.1, 2.1 Hz, 1H), 2.11 (d, J=8.1 Hz, 1H), 1.24 (s, 12H) ppm.

¹³C NMR (151 MHz, CDCl₃): δ 145.53, 139.28, 127.56, 127.54, 123.04 (q, J=276.4 Hz), 83.97, 54.16, 49.22, 44.69, 43.31, 38.91 (q, J=38.5 Hz), 24.83, 24.78 ppm.

¹⁹F NMR (376 MHz, CDCl₃): δ −72.73 ppm.

¹¹B NMR (128 MHz, CDCl₃): δ 31.29 ppm.

HRMS (ESI-TOF): calc'd for C₁₉H₂₄BF₃O₄S [M+H]⁺: 417.1513, found: 417.1510.

TLC: R_{f}=0.35 (2:1 hexanes:ethyl acetate).

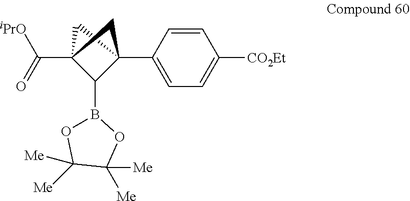 [SMILES: CCOC(=O)c1ccc([C@]23C[C@](C(=O)OC(C)C)(C2)C3B2OC(C)(C)C(C)(C)O2)cc1]

### isopropyl 3-(4-(ethoxycarbonyl)phenyl)-2-(4,4,5,5-tetramethyl-1,3,2-dioxaborolan-2-yl)bicyclo [1.1.1]pentane-1-carboxylate (60)

General Procedure F2 was followed on a 0.1 mmol scale. BCP bisboronate 23 and ethyl 4-bromo-benzoate were reacted accordingly for 48 hours. Purification by flash chromatography (hexanes:ethyl acetate, 20:1) afforded 15.0 mg (35%) of the title compound 60.

Physical State: white solid.

m.p.: 54-56° C.

¹H NMR (600 MHz, CDCl₃): δ 7.98-7.94 (m, 2H), 7.35-7.30 (m, 2H), 5.03 (hept, J=6.3 Hz, 1H), 4.36 (q, J=7.1 Hz, 2H), 3.06 (dd, J=9.9, 2.0 Hz, 1H), 2.32 (d, J=8.8 Hz, 2H), 2.26 (dd, J=8.1, 1.9 Hz, 1H), 2.13 (d, J=7.9 Hz, 1H), 1.38 (t, J=7.1 Hz, 3H), 1.25 (d, J=2.2 Hz, 3H), 1.24 (d, J=2.2 Hz, 3H), 1.24 (s, 6H), 1.23 (s, 6H) ppm.

¹³C NMR (151 MHz, CDCl₃): δ 169.90, 166.73, 145.44, 129.56, 128.98, 126.47, 83.52, 67.98, 61.01, 56.83, 52.29, 43.87, 39.54, 24.96, 24.89, 22.00, 14.49 ppm.

¹¹B NMR (128 MHz, CDCl₃): δ 31.40 ppm.

MS (GCMS, EI): m/z=413 (4%), 386 (4%), 371 (7%), 286 (30%), 242 (55%), 169 (100%).

TLC: R_{f}=0.66 (3:1 hexanes:ethyl acetate).

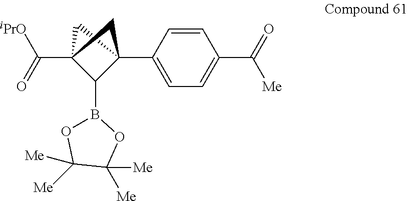 [SMILES: CC(=O)c1ccc([C@]23C[C@](C(=O)OC(C)C)(C2)C3B2OC(C)(C)C(C)(C)O2)cc1]

### isopropyl 3-(4-acetylphenyl)-2-(4,4,5,5-tetramethyl-1,3,2-dioxaborolan-2-yl)bicyclo[1.1.1]pentane-1-carboxylate (61)

General Procedure F2 was followed on a 0.1 mmol scale. BCP bisboronate 23 and 4′-Bromoacetophenone were reacted accordingly for 48 hours. Purification by flash chromatography (hexanes:ethyl acetate, 20:1) and afforded 12.9 mg (38%) of the title compound 61.

Physical State: white solid.

m.p.: 39-41° C.

¹H NMR (600 MHz, CDCl₃): δ 7.91-7.86 (m, 2H), 7.38-7.33 (m, 2H), 5.03 (hept, J=6.3 Hz, 1H), 3.06 (dd, J=9.8, 2.0 Hz, 1H), 2.58 (s, 3H), 2.33 (d, J=9.0 Hz, 2H), 2.27 (dd, J=8.1, 2.0 Hz, 1H), 2.13 (d, J=8.0 Hz, 1H), 1.26 (d, J=2.3 Hz, 3H), 1.25-1.23 (m, 15H) ppm.

¹³C NMR (151 MHz, CDCl₃): δ 198.00, 169.84, 145.82, 135.75, 128.43, 126.72, 83.55, 68.01, 56.81, 52.32, 43.83, 39.57, 26.79, 24.97, 24.89, 21.99 ppm.

¹¹B NMR (128 MHz, CDCl₃): δ 31.88 ppm.

HRMS (ESI-TOF): calc'd for C₂₃H₃₁B₀₅ [M+H]⁺: 399.2337, found: 399.2342.

TLC: R_{f}=0.50 (3:1 hexanes:ethyl acetate).

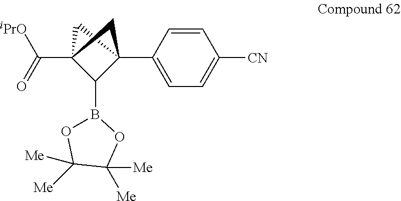 [SMILES: CC(C)OC(=O)[C@]12C[C@](c3ccc(C#N)cc3)(C1)C2B1OC(C)(C)C(C)(C)O1]

### isopropyl 3-(4-cyanophenyl)-2-(4,4,5,5-tetramethyl-1,3,2-dioxaborolan-2-yl)bicyclo[1.1.1]pentane-1-carboxylate (62)

General Procedure F2 was followed on a 0.1 mmol scale with BCP bisboronate 23 and 4-bromobenzonitrile were reacted accordingly for 48 hours. Purification by flash chromatography (hexanes:ethyl acetate, 20:1) afforded 14.7 mg (39%) of the title compound 62.

Physical State: white solid.

m.p.: 57-59° C.

¹H NMR (600 MHz, CDCl₃): δ 7.58 (d, J=8.3 Hz, 2H), 7.39-7.36 (m, 2H), 5.03 (hept, J=6.3 Hz, 1H), 3.02 (dd, J=9.8, 2.0 Hz, 1H), 2.34-2.30 (m, 2H), 2.25 (dd, J=8.1, 2.0 Hz, 1H), 2.13 (d, J=8.0 Hz, 1H), 1.25 (d, J=2.5 Hz, 3H), 1.24 (d, J=2.6 Hz, 3H), 1.24 (s, 6H) 1.23 (s, 6H) ppm.

¹³C NMR (151 MHz, CDCl₃): δ 169.58, 145.66, 132.13, 127.33, 119.17, 110.60, 83.65, 68.11, 56.72, 52.24, 43.64, 39.56, 24.95, 24.88, 21.98, 21.97 ppm.

¹¹B NMR (128 MHz, CDCl₃): δ 31.54 ppm.

MS (GCMS, EI): m/z=381 (6%), 365 (2%), 341 (4%), 283 (5%), 239 (14%), 195 (100%).

TLC: R_{f}=0.56 (3:1 hexanes:ethyl acetate).

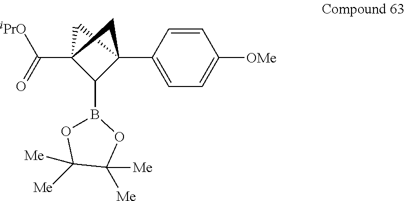 [SMILES: COc1ccc([C@]23C[C@](C(=O)OC(C)C)(C2)C3B2OC(C)(C)C(C)(C)O2)cc1]

### isopropyl 3-(4-methoxyphenyl)-2-(4,4,5,5-tetramethyl-1,3,2-dioxaborolan-2-yl)bicyclo[1.1.1]pentane-1-carboxylate (63)

General Procedure F2 was followed on a 0.1 mmol scale. BCP bisboronate 23 and 4-bromo-anisole were reacted accordingly for 48 hours. Purification by flash chromatography (hexanes:ethyl acetate, 20:1) afforded 12.8 mg (33%) of the title compound 63.

Physical State: white solid.

m.p.: 38-40° C.

¹H NMR (600 MHz, CDCl₃): δ 7.22-7.17 (m, 2H), 6.85-6.80 (m, 2H), 5.07-4.98 (hept, J=6.3 Hz, 1H), 3.78 (s, 3H), 3.01 (dd, J=9.5, 1.9 Hz, 1H), 2.29-2.24 (m, 2H), 2.20 (dd, J=8.1, 1.9 Hz, 1H), 2.07 (d, J=7.9 Hz, 1H), 1.27-1.19 (m, 18H) ppm.

¹³C NMR (151 MHz, CDCl₃): δ 170.28, 158.61, 132.83, 127.57, 113.63, 83.36, 67.80, 56.76, 55.42, 52.38, 43.67, 39.28, 24.99, 24.89, 22.01 ppm.

¹¹B NMR (128 MHz, CDCl₃): δ 31.64 ppm.

MS (GCMS, EI): m/z=386 (5%), 343 (5%), 299 (19%), 244 (20%), 199 (100%), 172 (77%).

TLC: R_{f}=0.63 (3:1 hexanes:ethyl acetate).

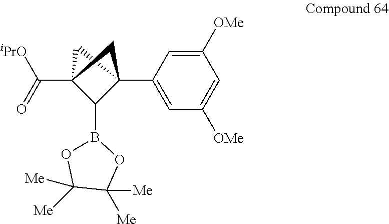 [SMILES: COc1cc(OC)cc([C@]23C[C@](C(=O)OC(C)C)(C2)C3B2OC(C)(C)C(C)(C)O2)c1]

### isopropyl 3-(3,5-dimethoxyphenyl)-2-(4,4,5,5-tetramethyl-1,3,2-dioxaborolan-2-yl)bicyclo [1.1.1]pentane-1-carboxylate (64)

General Procedure F2 was followed on a 0.1 mmol scale. BCP bisboronate 23 and 3,5-dimethoxylbromobenzene were reacted accordingly for 48 hours. Purification by flash chromatography (hexanes:ethyl acetate, 20:1) afforded 14.2 mg (34%) of the title compound 64.

Physical State: colorless oil.

¹H NMR (600 MHz, CDCl₃): δ 6.46 (d, J=2.3 Hz, 2H), 6.33 (t, J=2.3 Hz, 1H), 5.03 (hept, J=6.3 Hz, 1H), 3.78 (s, 6H), 3.00 (dd, J=9.5, 1.9 Hz, 1H), 2.28 (s, 1H), 2.26 (dd, J=9.5, 1.4 Hz, 1H), 2.20 (dd, J=8.1, 1.9 Hz, 1H), 2.07 (d, J=7.6 Hz, 1H), 1.28-1.23 (m, 18H) ppm.

¹³C NMR (151 MHz, CDCl₃): δ 170.10, 160.83, 142.92, 104.43, 99.22, 83.41, 67.86, 56.41, 55.42, 52.61, 44.10, 39.22, 25.06, 24.93, 22.01, 21.99 ppm.

¹¹B NMR (128 MHz, CDCl₃): δ 31.75 ppm.

MS (GCMS, EI): m/z=416 (5%), 358 (6%), 328 (4%), 273 (26%), 229 (100%), 202 (32%).

TLC: R_{f}=0.56 (3:1 hexanes:ethyl acetate).

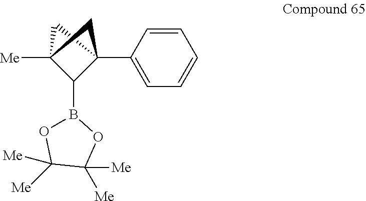 [SMILES: CC1(C)OB(C2[C@]3(C)C[C@@]2(c2ccccc2)C3)OC1(C)C]

### 4,4,5,5-tetramethyl-2-(1-methyl-3-phenylbicyclo[1.1.1]pentan-2-yl)-1,3,2-dioxaborolane (65)

General Procedure F2 was followed on a 0.1 mmol scale. BCP bisboronate 14 and bromobenzene were reacted accordingly for 48 hours. Purification by flash chromatography (hexanes:ethyl acetate, 20:1) afforded 12.0 mg (42%) of the title compound 65.

Scale-up of preparation of BCP boronate 65 was followed on a 2.0 mmol scale with BCP bisboronate 14 and bromobenzene were reacted accordingly for 60 hours. Purification by flash chromatography (hexanes:ethyl acetate, 20:1) afforded 209.6 mg (37%) of the title compound 65. [Note: The protodeborylated side-product (R³═H) was removed by high vacuum.]

Physical State: colorless oil.

¹H NMR (600 MHz, CDCl₃): δ 7.30-7.22 (m, 4H), 7.16 (tt, J=6.6, 1.9 Hz, 1H), 2.56 (dd, J=9.9, 1.9 Hz, 1H), 1.93 (d, J=9.3 Hz, 2H), 1.83 (dd, J=8.2, 1.9 Hz, 1H), 1.72 (d, J=8.2 Hz, 1H), 1.26 (s, 3H), 1.230 (s, 6H), 1.225 (s, 6H) ppm.

¹³C NMR (151 MHz, CDCl₃): δ 141.89, 128.01, 126.45, 126.12, 83.01, 57.73, 52.75, 44.02, 38.05, 25.00, 24.98, 18.55 ppm.

¹¹B NMR (128 MHz, CDCl₃): δ 32.18 ppm.

MS (GCMS, EI): m/z=284 (0.4%), 269 (4%), 225 (3%), 156 (100%), 84 (76%).

TLC: R_{f}=0.38 (15:1 hexanes:ethyl acetate).

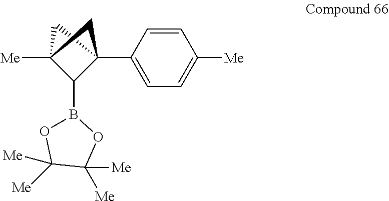 [SMILES: Cc1ccc([C@]23C[C@](C)(C2)C3B2OC(C)(C)C(C)(C)O2)cc1]

### 4,4,5,5-tetramethyl-2-(1-methyl-3-(p-tolyl)bicyclo[1.1.1]pentan-2-yl)-1,3,2-dioxaborolane (66)

General Procedure F2 was followed on a 0.1 mmol scale. BCP bisboronate 14 and 4-bromo-toluene were reacted accordingly for 48 hours. Purification by flash chromatography (hexanes:ethyl acetate, 20:1) afforded 11.2 mg (37%) of the title compound 66. [Note: The deborylated side-product (R³═H) was removed by high vacuum]

Physical State: colorless oil.

¹H NMR (600 MHz, CDCl₃): δ 7.20-7.15 (m, 2H), 7.08 (d, J=7.8 Hz, 2H), 2.55 (dd, J=10.0, 1.9 Hz, 1H), 2.31 (s, 3H), 1.94-1.90 (m, 2H), 1.82 (dd, J=8.2, 1.9 Hz, 1H), 1.71 (d, J=8.1 Hz, 1H), 1.27 (s, 3H), 1.244 (s, 6H), 1.240 (s, 6H) ppm.

¹³C NMR (151 MHz, CDCl₃): δ 138.96, 135.59, 128.71, 126.36, 82.97, 57.75, 52.79, 43.81, 37.99, 25.01, 24.98, 21.25, 18.56 ppm.

¹¹B NMR (128 MHz, CDCl₃): δ 32.23 ppm.

MS (GCMS, EI): m/z=298 (2.5%), 283 (6%), 239 (5%), 197 (10%), 183 (32%), 170 (100%).

TLC: R_{f}=0.38 (15:1 hexanes:ethyl acetate).

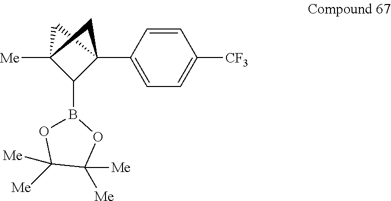 [SMILES: CC1(C)OB(C2[C@]3(C)C[C@@]2(c2ccc(C(F)(F)F)cc2)C3)OC1(C)C]

### 4,4,5,5-tetramethyl-2-(1-methyl-3-(4-(trifluoromethyl)phenyl)bicyclo[0.1.1]pentan-2-yl)-1,3,2-dioxaborolane (67)

General Procedure F2 was followed on 0.1 mmol scale, wherein BCP bisboronate 14 and 4-bromo-trifluorotoluene were reacted for 48 hours. Purification by flash chromatography (hexanes:ethyl acetate, 20:1) and afforded 13.7 mg (39%) of the title compound 67. [Note: The deborylated side-product (R³═H) was removed by high vacuum]

Physical State: colorless crystal.

m.p.: 31-33° C.

¹H NMR (600 MHz, CDCl₃): δ 7.51 (d, J=8.0 Hz, 2H), 7.38 (d, J=7.9 Hz, 2H), 2.56 (dd, J=9.6, 1.9 Hz, 1H), 2.01-1.94 (m, 2H), 1.87 (dd, J=8.2, 1.9 Hz, 1H), 1.76 (d, J=8.3 Hz, 1H), 1.29 (s, 3H), 1.243 (s, 6H), 1.241 (s, 6H) ppm.

¹³C NMR (151 MHz, CDCl₃): δ 145.76, 128.32 (q, J=32.4 Hz), 127.65, 126.84, 124.98 (q, J=3.9 Hz). 83.18, 57.75, 52.87, 43.60, 38.36, 25.00, 24.98, 18.42 ppm.

¹⁹F NMR (376 MHz, CDCl₃) δ −62.28 ppm.

¹¹B NMR (128 MHz, CDCl₃): δ 32.01 ppm.

MS (GCMS, EI): m/z=337 (1%), 284 (1%), 252 (7%), 224 (33%), 84 (100%).

TLC: R_{f}=0.38 (15:1 hexanes:ethyl acetate).

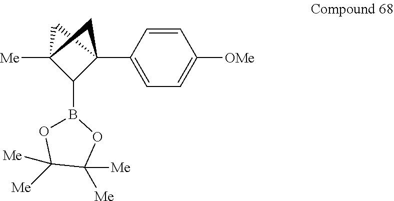 [SMILES: COc1ccc([C@]23C[C@](C)(C2)C3B2OC(C)(C)C(C)(C)O2)cc1]

### 2-(1-(4-methoxyphenyl)-3-methylbicyclo[1.1.1]pentan-2-yl)-4,4,5,5-tetramethyl-1,3,2-dioxa borolane (68)

General Procedure F2 was followed on a 0.1 mmol scale, wherein BCP bisboronate 14 and 4-bromo-anisole were reacted for 48 hours. Purification by flash chromatography (hexanes:ethyl acetate, 20:1) and afforded 7.6 mg (24%) of the title compound 68. [Note: The deborylated side-product (R³═H) was removed by high vacuum]

Physical State: colorless oil.

¹H NMR (600 MHz, CDCl₃): δ 7.23-7.18 (m, 2H), 6.83-6.78 (m, 2H), 3.78 (s, 3H), 2.53 (dd, J=9.7, 1.9 Hz, 1H), 1.94-1.89 (m, 2H), 1.81 (dd, J=8.2, 1.9 Hz, 1H), 1.70 (d, J=8.2 Hz, 1H), 1.26 (s, 3H), 1.243 (3, 6H), 1.238 (3, 6H) ppm.

¹³C NMR (151 MHz, CDCl₃): δ 158.11, 134.36, 127.53, 113.45, 82.98, 57.76, 55.40, 52.83, 43.57, 37.91, 25.01, 24.99, 18.53 ppm.

¹¹B NMR (128 MHz, CDCl₃): δ 32.15 ppm.

MS (GCMS, EI): m/z=314 (6%), 299 (11%), 199 (35%), 186 (98%), 133 (100%).

TLC: R_{f}=0.31 (15:1 hexanes:ethyl acetate).

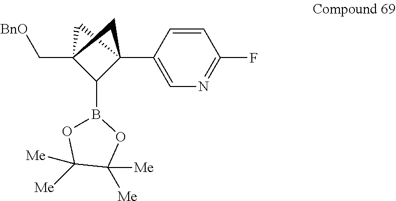 [SMILES: CC1(C)OB(C2[C@]3(COCc4ccccc4)C[C@@]2(c2ccc(F)nc2)C3)OC1(C)C]

### 5-3-((benzyloxy)methyl)-2-(4,4,5,5-tetramethyl-1,3,2-dioxaborolan-2-yl)bicyclo[1.1.1]pentan-1-yl)-2-fluoropyridine (69)

General Procedure F1 was followed on a 0.1 mmol scale, wherein BCP bisboronate 25 and 3-bromo-6-fluoropyridine were reacted for 48 hours. Purification by flash chromatography (hexanes:ethyl acetate, 5:1) afforded 9.0 mg (22%) of the title compound 69.

Physical State: colorless oil.

¹H NMR (600 MHz, CDCl₃): δ 8.12 (d, J=2.5 Hz, 1H), 7.72 (td, J=8.1, 2.5 Hz, 1H), 7.35 (d, J=7.0 Hz, 4H), 7.31-7.24 (m, 1H), 6.83 (dd, J=8.4, 2.8 Hz, 1H), 4.57 (s, 2H), 3.57 (s, 2H), 2.66 (dd, J=9.7, 2.0 Hz, 1H), 2.10-2.06 (m, 2H), 1.98 (dd, J=8.2, 2.1 Hz, 1H), 1.85 (d, J=8.1 Hz, 1H), 1.20 (s, 12H) ppm.

¹³C NMR (151 MHz, CDCl₃): δ 162.61 (d, J=237.1 Hz), 145.89 (d, J=14.5 Hz), 139.60 (d, J=7.7 Hz), 138.80, 134.58, 128.43, 127.64, 127.58, 108.73 (d, J=37.4 Hz), 83.37, 73.12, 70.03, 55.14, 50.74, 41.98, 40.88, 24.94, 24.91 ppm.

¹¹B NMR (128 MHz, CDCl₃): δ 31.62 ppm.

¹⁹F NMR (376 MHz, CDCl₃): δ −71.46 ppm.

MS (GCMS, EI): m/z=394 (0.4%), 356 (0.3%), 303 (4%), 218 (6%), 174 (10%), 91(100%).

TLC: R_{f}=0.59 (3:1 hexanes:ethyl acetate).

### General Procedure G for Minisci Reaction of BCP Bisboronates

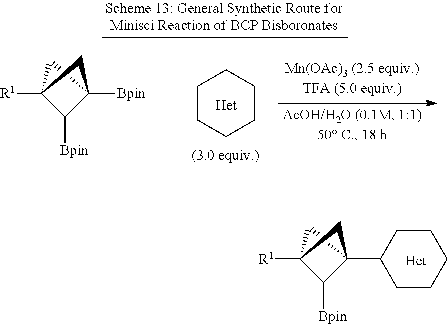

A screw-capped culture tube was charged with BCP bisboronate (1.0 equiv.), heteroarene (3.0 equiv.) and Mn(OAc)₃ (2.5 equiv.). Then the tube was evacuated and backfilled with argon three times, followed by addition of acetic acid/water (0.1 M, 1:1) solvent via a syringe. Next, trifluoroacetic acid (5.0 equiv.) was added into the reaction. Then, the headspace of the tube was purged with a gentle stream of argon for approximately 10 seconds and the reaction was stirred at 50° C. for 18 hours. After it was confirmed that the starting material was consumed totally, the reaction mixture was concentrated under high vacuum to remove excess acetic acid, quenched with Na₂CO₃ solution, extracted with ethyl acetate, dried with Na₂SO₄, and concentrated under high vacuum. The crude residue was purified by chromatography on silica gel. (Molander et al., 2011)

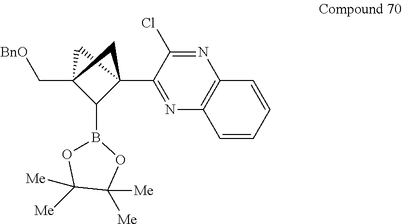 [SMILES: CC1(C)OB(C2[C@]3(COCc4ccccc4)C[C@@]2(c2nc4ccccc4nc2Cl)C3)OC1(C)C]

### 2-(3-((benzyloxy)methyl)-2-(4,4,5,5-tetramethyl-1,3,2-dioxaborolan-2-yl)bicyclo[1.1.1]pentan-1-yl)-3-chloroquinoxaline (70)

General Procedure G was followed on a 0.1 mmol scale with BCP bisboronate 25 and 2-chloroquinoxaline. Purification by flash chromatography (hexanes:ethyl acetate, 20:1) afforded 23.2 mg (49%) of the title compound 70.

Physical State: colorless oil.

¹H NMR (600 MHz, CDCl₃): δ 8.06-8.00 (m, 1H), 7.99-7.94 (m, 1H), 7.74-7.68 (m, 2H), 7.41-7.33 (m, 4H), 7.30-7.27 (m, 1H), 4.61 (s, 2H), 3.62 (s, 2H), 2.94 (dd, J=9.5, 1.9 Hz, 1H), 2.56 (s, 1H), 2.53 (dd, J=8.0, 1.9 Hz, 1H), 2.28 (dd, J=9.5, 1.3 Hz, 1H), 2.17 (d, J=7.9 Hz, 1H), 1.22 (s, 6H), 1.18 (s, 6H) ppm.

¹³C NMR (151 MHz, CDCl₃): δ 152.16, 146.94, 141.17, 141.10, 138.80, 130.21, 129.94, 128.97, 128.44, 128.11, 127.64, 127.56, 83.11, 73.09, 70.19, 56.77, 50.50, 45.40, 42.03, 24.88, 24.81 ppm.

¹¹B NMR (128 MHz, CDCl₃): δ 32.52 ppm.

MS (GCMS, EI): m/z=476 (0.3%), 394 (0.2%), 355 (0.5%), 315 (2%), 229 (20%), 91 (100%).

TLC: R_{f}=0.25 (10:1 hexanes:ethyl acetate).

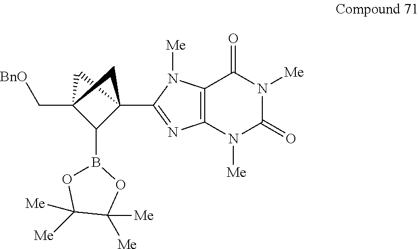 [SMILES: Cn1c(=O)c2c(nc([C@]34C[C@](COCc5ccccc5)(C3)C4B3OC(C)(C)C(C)(C)O3)n2C)n(C)c1=O]

### 8-(3-((benzyloxy)methyl)-2-(4,4,5,5-tetramethyl-1,3,2-dioxaborolan-2-yl)bicyclo[1.1.1]pentan-1-yl)-1,3,7-trimethyl-3,7-dihydro-1H-purine-2,6-dione (71)

General Procedure G was followed on a 0.1 mmol scale with BCP bisboronate 25 and caffeine. Purification by flash chromatography (hexanes:ethyl acetate, 2:1) afforded 27.7 mg (55%) of the title compound 71.

Physical State: white solid.

m.p.: 124-126° C.

¹H NMR (600 MHz, CDCl₃): δ 7.34 (d, J=4.4 Hz, 4H), 7.30-7.26 (m, 1H), 4.56 (s, 2H), 4.01 (s, 3H), 3.55 (s, 3H), 3.55 (s, 2H), 3.38 (s, 3H), 2.90 (dd, J=9.6, 2.1 Hz, 1H), 2.33 (dd, J=9.6, 1.5 Hz, 1H), 2.29-2.24 (m, 2H), 2.12 (d, J=8.1 Hz, 1H), 1.200 (s, 6H), 1.196 (s, 6H) ppm.

¹³C NMR (151 MHz, CDCl₃): δ 155.53, 151.82, 151.10, 147.59, 138.56, 128.45, 127.66, 127.64, 107.55, 83.55, 73.17, 69.63, 56.53, 50.85, 43.43, 38.06, 32.60, 30.03, 28.00, 24.89, 24.85 ppm.

¹¹B NMR (128 MHz, CDCl₃): δ 31.53 ppm.

HRMS (ESI-TOF): calc'd for C₂₇H₃₅BN₄O₅ [M+H]⁺: 507.2773, found: 507.2778.

TLC: R_{f}=0.30 (1:1 hexanes:ethyl acetate).

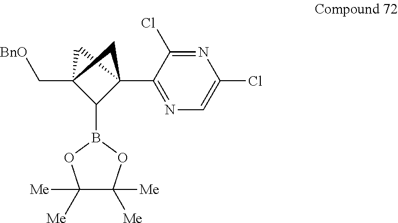 [SMILES: CC1(C)OB(C2[C@]3(COCc4ccccc4)C[C@@]2(c2ncc(Cl)nc2Cl)C3)OC1(C)C]

### 2-(3-((benzyloxy)methyl)-2-(4,4,5,5-tetramethyl-1,3,2-dioxaborolan-2-yl)bicyclo[1.1.1]pentan-1-yl)-3,5-dichloropyrazine (72)

General Procedure G was followed on a 0.1 mmol scale with BCP bisboronate 25 and 2,6-dichloropyrazine. Purification by flash chromatography (hexanes:ethyl acetate, 20:1) afforded 28.3 mg (61%) of the title compound 72.

Physical State: colorless oil.

¹H NMR (600 MHz, CDCl₃): δ 8.39 (s, 1H), 7.38-7.31 (m, 4H), 7.29-7.26 (m, 1H), 4.57 (s, 2H), 3.58 (s, 2H), 2.81 (dd, J=9.6, 2.0 Hz, 1H), 2.38-2.33 (m, 2H), 2.25 (dd, J=9.5, 1.4 Hz, 1H), 2.09 (d, J=8.0 Hz, 1H), 1.19 (s, 6H), 1.17 (s, 6H) ppm.

¹³C NMR (151 MHz, CDCl₃): δ 150.83, 146.22, 144.99, 141.56, 138.72, 128.43, 127.64, 127.58, 83.23, 73.11, 69.96, 56.33, 50.17, 43.96, 42.12, 24.84, 24.79 ppm.

¹¹B NMR (128 MHz, CDCl₃): δ 31.26 ppm.

HRMS (ESI-TOF): calc'd for C₂₃H₂₇BCl₂N₂O₃ [M+H]⁺: 461.1565, found: 461.1558.

TLC: R_{f}=0.32 (10:1 hexanes:ethyl acetate).

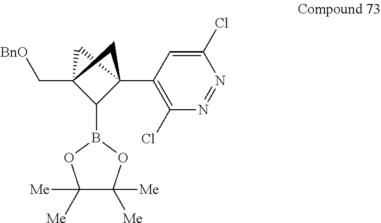 [SMILES: CC1(C)OB(C2[C@]3(COCc4ccccc4)C[C@@]2(c2cc(Cl)nnc2Cl)C3)OC1(C)C]

### 4-(3-((benzyloxy)methyl)-2-(4,4,5,5-tetramethyl-1,3,2-dioxaborolan-2-yl)bicyclo[1.1.1]pentan-1-yl)-3,6-dichloropyridazine (73)

General Procedure G was followed on a 0.1 mmol scale with BCP bisboronate 25 and 3,6-dichloropyridazine. Purification by flash chromatography (hexanes:ethyl acetate, 20:1) afforded 21.6 mg (47%) of the title compound 73.

Physical State: colorless oil.

¹H NMR (600 MHz, CDCl₃): δ 7.44 (s, 1H), 7.35 (d, J=4.4 Hz, 4H), 7.28 (ddd, J=8.0, 4.9, 3.9 Hz, 1H), 4.58 (d, J=12.0 Hz, 1H), 4.55 (d, J=12.0 Hz, 1H), 3.58 (s, 2H), 2.57 (dd, J=9.6, 2.1 Hz, 1H), 2.39 (t, J=1.2 Hz, 1H), 2.36 (dd, J=8.2, 2.1 Hz, 1H), 2.24 (dd, J=9.5, 1.5 Hz, 1H), 2.07 (dd, J=8.3, 0.9 Hz, 1H), 1.192 (s, 6H), 1.185 (s, 6H) ppm.

¹³C NMR (151 MHz, CDCl₃): δ 156.06, 155.69, 141.72, 138.54, 129.21, 128.48, 127.70, 127.65, 83.73, 73.22, 69.46, 56.27, 50.19, 42.35 (2C), 24.91, 24.88 ppm.

¹¹B NMR (128 MHz, CDCl₃): δ 31.58 ppm.

HRMS (ESI-TOF): calc'd for C₂₃H₂₇BCl₂N₂O₃ [M+H]⁺: 461.1565, found: 461.1560.

TLC: R_{f}=0.18 (10:1 hexanes:ethyl acetate).

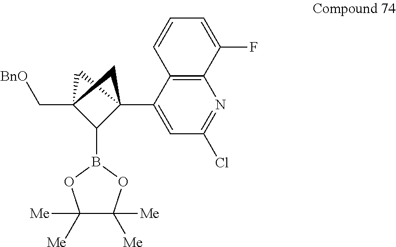 [SMILES: CC1(C)OB(C2[C@]3(COCc4ccccc4)C[C@@]2(c2cc(Cl)nc4c(F)cccc42)C3)OC1(C)C]

### 4-(3-((benzyloxy)methyl)-2-(4,4,5,5-tetramethyl-1,3,2-dioxaborolan-2-yl)bicyclo[1.1.1]pentan-1-yl)-2-chloro-8-fluoroquinoline (74)

General Procedure G was followed on a 0.1 mmol scale with BCP bisboronate 25 and 2,6-dichloropyrazine. Purification by flash chromatography (hexanes:ethyl acetate, 20:1) afforded 18.6 mg (38%) of the title compound 74.

Physical State: red oil.

¹H NMR (600 MHz, CDCl₃): δ 8.07 (d, J=8.4 Hz, 1H), 7.46 (td, J=8.1, 5.2 Hz, 1H), 7.42-7.39 (m, 1H), 7.39-7.33 (m, 4H), 7.31 (s, 1H), 7.30-7.28 (m, 1H), 4.60 (s, 2H), 3.63 (s, 2H), 2.91 (dd, J=9.6, 2.2 Hz, 1H), 2.45-2.42 (m, 1H), 2.40 (dd, J=8.2, 2.2 Hz, 1H), 2.36 (dd, J=9.5, 1.6 Hz, 1H), 2.17 (d, J=8.1 Hz, 1H), 1.18 (s, 12H) ppm.

¹³C NMR (151 MHz, CDCl₃): δ 158.42, 156.72, 151.32, 149.76 (d, J=2.5 Hz), 138.65, 138.43 (d, J=11.5 Hz), 128.49, 128.15, 127.68, 126.21 (d, J=8.1 Hz), 122.77, 121.03, 114.32 (d, J=18.7 Hz), 83.55, 73.23, 69.79, 57.86, 51.30, 44.56, 41.97, 24.91, 24.83 ppm.

¹¹B NMR (128 MHz, CDCl₃): δ 31.32 ppm.

¹⁹F NMR (376 MHz, CDCl₃): δ −123.05 ppm.

HRMS (ESI-TOF): calc'd for C₂₈H₃₀BClFNO₃ [M+H]⁺: 494.2064, found: 494.2063.

TLC: R_{f}=0.36 (5:1 hexanes:ethyl acetate).

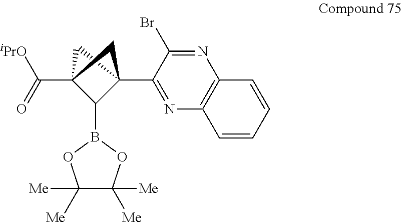 [SMILES: CC(C)OC(=O)[C@]12C[C@](c3nc4ccccc4nc3Br)(C1)C2B1OC(C)(C)C(C)(C)O1]

### isopropyl 3-(3-bromoquinoxalin-2-yl)-2-(4,4,5,5-tetramethyl-1,3,2-dioxaborolan-2-yl)bicyclo [1.1.1]pentane-1-carboxylate (75)

General Procedure G was followed on a 0.1 mmol scale with BCP bisboronate 23 and 2-bromoquinoxaline. Purification by flash chromatography (hexanes:ethyl acetate, 20:1) afforded 22.5 mg (46%) of the title compound 75.

Physical State: pale red solid.

m.p.: 102-103° C.

¹H NMR (600 MHz, CDCl₃): δ 8.02-7.97 (m, 2H), 7.76-7.69 (m, 2H), 5.05 (hept, J=6.3 Hz, 1H), 3.24 (dd, J=9.4, 1.9 Hz, 1H), 2.95 (d, J=1.2 Hz, 1H), 2.89 (dd, J=8.0, 1.9 Hz, 1H), 2.51 (dd, J=9.4, 1.4 Hz, 1H), 2.42 (d, J=8.0 Hz, 1H), 1.29-1.26 (m, 9H), 1.26 (d, J=4.0 Hz, 3H), 1.23 (s, 6H) ppm.

¹³C NMR (151 MHz, CDCl₃): δ 169.74, 152.38, 142.10, 140.93, 138.58, 130.53, 130.31, 129.05, 128.25, 83.36, 68.12, 58.13, 52.77, 45.26, 40.91, 24.94, 24.81, 22.03, 22.01 ppm.

¹¹B NMR (128 MHz, CDCl₃): δ 31.05 ppm.

HRMS (ESI-TOF): calc'd for C₂₃H₂₈BBrN₂O₄[M+H]⁺: 487.1398, found: 487.1399.

TLC: R_{f}=0.36 (5:1 hexanes:ethyl acetate).

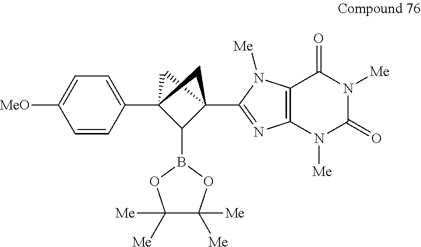 [SMILES: COc1ccc([C@]23C[C@](c4nc5c(c(=O)n(C)c(=O)n5C)n4C)(C2)C3B2OC(C)(C)C(C)(C)O2)cc1]

### 8-(3-(4-methoxyphenyl)-2-(4,4,5,5-tetramethyl-1,3,2-dioxaborolan-2-yl)bicyclo[1.1.1]pentan-1-yl)-1,3,7-trimethyl-3,7-dihydro-1H-purine-2,6-dione (76)

General Procedure G was followed on a 0.1 mmol scale with BCP bisboronate 27 and caffeine Purification by flash chromatography (hexanes:ethyl acetate, 20:1) afforded 17.1 mg (35%) of the title compound 76.

Physical State: yellow solid.

m.p.: >200° C.

¹H NMR (600 MHz, CDCl₃): δ 7.25-7.21 (m, 2H), 6.88-6.83 (m, 2H), 4.06 (s, 3H), 3.80 (s, 3H), 3.57 (s, 3H), 3.40 (s, 3H), 3.26 (dd, J=9.7, 2.0 Hz, 1H), 2.60 (dd, J=9.5, 1.4 Hz, 1H), 2.53-2.52 (m, 1H), 2.51 (dd, J=8.1, 2.0 Hz, 1H), 2.39 (d, J=8.0 Hz, 1H), 1.23 (s, 6H), 1.22 (s, 6H) ppm.

¹³C NMR (151 MHz, CDCl₃): δ 158.78, 155.54, 151.84, 151.33, 147.66, 132.17, 127.49, 113.73, 107.65, 83.66, 58.63, 55.43, 53.25, 46.17, 36.62, 32.69, 30.04, 28.02, 24.92 ppm.

¹¹B NMR (128 MHz, CDCl₃): δ 30.50 ppm.

HRMS (ESI-TOF): calc'd for C₂₆H₃₃BN₄O₅[M+H]⁺: 493.2617, found: 493.2597.

TLC: R_{f}=0.40 (1:1 hexanes:ethyl acetate).

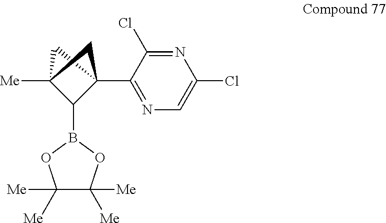 [SMILES: CC1(C)OB(C2[C@]3(C)C[C@@]2(c2ncc(Cl)nc2Cl)C3)OC1(C)C]

### 3,5-dichloro-2-(3-methyl-2-(4,4,5,5-tetramethyl-1,3,2-dioxaborolan-2-yl)bicyclo[1.1.1]pentan-1-yl)pyrazine (77)

General Procedure G was followed on a 0.1 mmol scale with BCP bisboronate 14 and 2,6-dichloropyrazine. Purification by flash chromatography (hexanes:ethyl acetate, 20:1) afforded 26.1 mg (74%) of the title compound 77.

General Procedure G was followed on 2.0 mmol scale with BCP bisboronate 14 and 2,6-dichloropyrazine. Purification by flash chromatography (hexanes:ethyl acetate, 20:1) afforded 465.7 mg (65%) of the title compound 77.

Physical State: white solid.

m.p.: 32-33° C.

¹H NMR (600 MHz, CDCl₃): δ 8.38 (s, 1H), 2.66 (dd, J=9.6, 2.1 Hz, 1H), 2.25-2.20 (m, 2H), 2.17 (dd, J=9.6, 1.2 Hz, 1H), 2.01 (dd, J=8.1, 1.0 Hz, 1H), 1.29 (s, 3H), 1.22 (s, 6H), 1.21 (s, 6H) ppm.

¹³C NMR (151 MHz, CDCl₃): δ 151.11, 146.19, 144.73, 141.51, 83.17, 58.64, 52.33, 43.13, 40.18, 24.92, 24.87, 18.35 ppm.

¹¹B NMR (128 MHz, CDCl₃): δ 31.87 ppm.

MS (GCMS, EI): m/z=355 (4%), 354 (5%), 341 (5%), 319 (7%), 213 (27%), 84 (100%).

TLC: R_{f}=0.46 (10:1 hexanes:ethyl acetate).

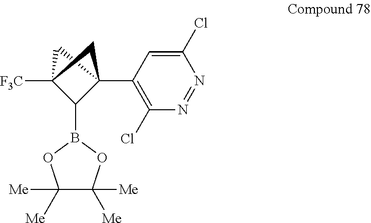 [SMILES: CC1(C)OB(C2[C@]3(c4cc(Cl)nnc4Cl)C[C@@]2(C(F)(F)F)C3)OC1(C)C]

### 3,6-dichloro-4-(2-(4,4,5,5-tetramethyl-1,3,2-dioxaborolan-2-yl)-3-(trifluoromethyl)bicyclo [1.1.1]pentan-1-yl)pyridazine (73)

General Procedure G was followed on a 0.1 mmol scale with BCP bisboronate 20 and 2,6-dichloropyrazine. Purification by flash chromatography (hexanes:ethyl acetate, 20:1) afforded 13.6 mg (33%) of the title compound 73.

Physical State: white solid.

m.p.: 77-79° C.

¹H NMR (600 MHz, CDCl₃): δ 7.41 (s, 1H), 2.94 (dd, J=9.6, 2.2 Hz, 1H), 2.61-2.59 (m, 1H), 2.57 (dd, J=8.2, 2.2 Hz, 1H), 2.47 (dd, J=9.6, 1.7 Hz, 1H), 2.33 (d, J=8.1 Hz, 1H), 1.24 (s, 6H), 1.23 (s, 6H) ppm.

¹³C NMR (151 MHz, CDCl₃): δ 156.15, 155.34, 139.82, 129.17, 122.48 (q, J=276.1 Hz), 84.39, 55.23, 49.07, 41.20, 40.38 (q, J=39.1 Hz). 24.80, 24.76 ppm.

¹⁹F NMR (376 MHz, CDCl₃): δ −72.73 ppm.

¹¹B NMR (128 MHz, CDCl₃): δ 30.91 ppm.

MS (GCMS, EI): m/z=410 (1%), 408 (1.5%), 393 (2%), 350 (8%), 315 (16%), 59 (100%).

TLC: R_{f}=0.30 (10:1 hexanes:ethyl acetate).

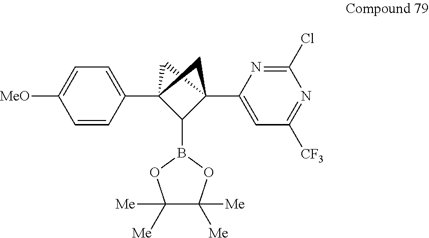 [SMILES: COc1ccc([C@]23C[C@](c4cc(C(F)(F)F)nc(Cl)n4)(C2)C3B2OC(C)(C)C(C)(C)O2)cc1]

### 2-chloro-4-(3-(4-methoxyphenyl)-2-(4,4,5,5-tetramethyl-1,3,2-dioxaborolan-2-yl)bicyclo[1.1.1]pentan-1-yl)-6-(trifluoromethyl)pyrimidine (79)

General Procedure G was followed on a 0.1 mmol scale with BCP bisboronate 27 and 2-chloro-4-(trifluoromethyl)pyrimidine. Purification by flash chromatography (hexanes:ethyl acetate, 10:1) afforded 17.6 mg (37%) of the title compound 79.

Physical State: yellow oil.

¹H NMR (600 MHz, CDCl₃): δ 7.73 (s, 1H), 7.29-7.24 (m, 2H), 6.90-6.84 (m, 2H), 3.81 (s, 3H), 3.12 (dd, J=9.6, 1.9 Hz, 1H), 2.50 (d, J=1.3 Hz, 1H), 2.48-2.43 (m, 1H), 2.37 (dd, J=8.2, 1.9 Hz, 1H), 2.25-2.21 (m, 1H), 1.27 (s, 6H), 1.26 (s, 6H) ppm.

¹³C NMR (151 MHz, CDCl₃): δ 174.79, 161.98, 158.83, 157.62 (q, J=37.0 Hz), 132.13, 127.64, 120.06 (q, J=275.3 Hz), 113.76, 113.40 (q, J=2.8 Hz), 83.87, 56.61, 55.45, 54.22, 44.16, 43.12, 25.03, 24.87 ppm.

¹⁹F NMR (565 MHz, CDCl₃): δ −69.81 ppm.

¹¹B NMR (128 MHz, CDCl₃): δ 31.28 ppm.

MS (GCMS, EI): m/z=480 (15%), 465 (8%), 352 (32%), 302 (15%), 133 (60%), 84 (100%).

TLC: R_{f}=0.36 (10:1 hexanes:ethyl acetate).

### D. Experimental Procedures and Characterization Data of Substrates in 2^{Nd} Functionalization of BCP Bisboronates

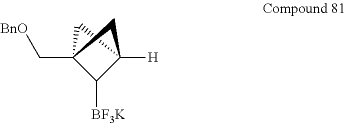

### (1-benzyloxy)methy)bicyclo[1.1.1]pentan-2-yl)trifuoro-λ⁴-borane, potassium salt (81)

BCP boronate 36 (1.1 g, 3.3 mmol) was suspended in methanol (6.6 mL), and a saturated aqueous solution of KHF₂ (5 mL, 25 mmol) was added dropwise. The suspended solution was stirred at room temperature for 2 hours and then concentrated to dryness. (Note: removing the pinacol by azeotrope with methanol and water under high vacuum 5 times facilitate the subsequent crystallization). The residue was extracted with hot acetone (3×30 mL), and the combined filtered extracts were concentrated to approximately 5 mL. Diethyl ether was added, and the resultant precipitate was collected and dried to afford the 750 mg (73%) of the potassium trifluoroborate 81.

Physical State: white solid.

m.p.: 88-90° C.

¹H NMR (600 MHz, acetone-d⁶): δ 7.34 (d, J=7.1 Hz, 2H), 7.31 (t, J=7.6 Hz, 2H), 7.26-7.20 (m, 1H), 4.51 (d, J=12.3 Hz, 1H), 4.47 (d, J=12.3 Hz, 1H), 3.48 (d, J=10.7 Hz, 1H), 3.39 (d, J=10.7 Hz, 1H), 2.49 (d, J=9.4 Hz, 1H), 2.36 (s, 1H), 1.70 (s, 1H), 1.54 (d, J=8.0 Hz, 1H), 1.52 (d, J=9.4 Hz, 1H), 1.23-1.15 (m, 1H) ppm.

¹³C NMR (151 MHz, acetone-d⁶): δ 140.80, 128.88, 128.09, 127.75, 72.91, 72.33, 54.06, 47.92, 46.61, 31.15 (q, J=3.3 Hz) ppm.

¹⁹F NMR (376 MHz, acetone-d⁶): δ −136.15 ppm.

¹¹B NMR (128 MHz, Acetone-d⁶): δ 3.77 (q, J=75.1 Hz) ppm.

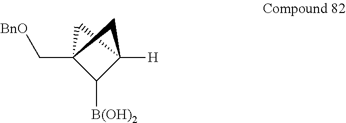 [SMILES: OB(O)C1[C@H]2C[C@]1(COCc1ccccc1)C2]

### (1-((benzyloxy)methyl)bicyclo[1.1.1]pentan-2-yl)boronic acid (82)

A screw-capped culture tube was charged with 81 (294 mg, 1.0 mmol) and water (5.0 mL), followed by addition of silica gel (500 mg) under argon atmosphere. The mixture was stirred at room temperature for 1 hour. Ethyl ether (10 mL) was added, and the suspended solution was filtered by Celite. The organic phase was separated, and the water phase was extracted with diethyl ether (3×5 mL). The combined organic solvent was washed with brine and dried by anhydrous MgSO₄. The solvent was removed under vacuum to afford the desire boronic acid 82 (230 mg, 99%) without further purification.

A screw-capped culture tube was charged with 36 (314 mg, 1.0 mmol, 1.0 equiv.) and Na₅IO₆ (855.6 mg, 4.0 mmol, 4.0 equiv.), followed by addition of THF/H₂O (5 mL, 1:1). Then 12 M HCl (0.17 mL, 2.0 mmol, 2.0 equiv.) was added to reaction tube at 0° C. The reaction mixture was allowed to stir at 0° C. for 3 hours. After it was confirmed by TLC analysis that 36 was totally consumed, the suspended reaction mixture was filtered via Celite to remove excess Na₅IO₆, and the organic phase was separated, and the water phase was extracted with diethyl ether (3×5 mL). The combined organic solvent was washed with brine and dried by anhydrous Na₂SO₄. The solvent was removed under vacuum to afford the desire boronic acid 82 (157.8 mg, 68%) without further purification.

Physical State: white solid.

m.p.: 64-66° C.

¹H NMR (600 MHz, CDCl₃): δ 7.39-7.35 (m, 2H), 7.34-7.30 (m, 3H), 6.05 (br., 2H), 4.57 (d, J=12.0 Hz, 1H), 4.56 (d, J=12.0 Hz, 1H), 3.52 (dd, J=9.9, 1.5 Hz, 1H), 3.48 (dd, J=9.7, 1.2 Hz, 1H), 2.71 (s, 1H), 2.12 (dd, J=9.8, 2.5 Hz, 1H), 1.76-1.71 (m, 3H), 1.68 (d, J=8.7 Hz, 1H) ppm.

¹³C NMR (151 MHz, CDCl₃): δ 136.97, 128.75, 128.31, 128.12, 73.79, 71.83, 52.42, 49.98, 44.48, 31.14 ppm.

¹¹B NMR (128 MHz, CDCl₃) δ 31.19 ppm.

HRMS (ESI-TOF): calc'd for C₁₃H₁₇BO₃ [M+H]⁺: 233.1344, found: 233.1350.

TLC: R_{f}=0.68 (2:1 hexanes:ethyl acetate).

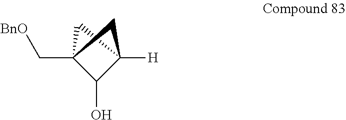 [SMILES: OC1[C@H]2C[C@]1(COCc1ccccc1)C2]

### 1-((benzyloxy)methyl)bicyclo[1.1.1]pentan-2-ol (83)

To a solution of BCP boronate 36 (314.2 mg, 1.0 mmol) and NaOAc (164 mg, 2.0 mmol) in THE (10 mL) at 0° C. was added H₂O₂ (35 wt. % in water, 1.0 mL) dropwise. The resulting mixture was stirred at 0° C. for 1.5 hours. Na₂S₂O₃ was added and the mixture was stirred at 0° C. for 10 min. Diethyl ether was added, the layers were separated, and the aqueous phase was extracted with diethyl ether. The combined organic layers were washed with water and brine, dried over anhydrous MgSO₄, concentrated, and purified by column chromatography (hexanes:ethyl acetate, 2:1) on silica gel to obtain 150 mg (75%) of the alcohol 83.

Physical State: colorless oil.

¹H NMR (600 MHz, CDCl₃): δ 7.37-7.31 (m, 4H). 7.30-7.27 (m, 1H), 4.51 (s, 2H), 4.08 (d, J=6.2 Hz, 1H), 3.46 (d, J=12.0 Hz, 1H), 3.44 (d, J=12.0 Hz, 1H), 2.65 (dd, J=9.7, 2.6 Hz, 1H), 2.55 (s, 1H), 2.22 (br., 1H), 1.76 (dd, J=6.2, 2.5 Hz, 1H), 1.62 (d, J=2.9 Hz, 1H), 1.25 (dd, J=9.7, 2.9 Hz, 1H) ppm.

¹³C NMR (151 MHz, CDCl₃): δ 138.52, 128.54, 127.74, 127.66, 82.73, 73.29, 68.76, 49.09, 43.46, 39.48, 35.23 ppm.

HRMS (ESI-TOF): calc'd for C₁₃H₁₆₀₂ [M+H]⁺: 205.1223, found: 205.1220.

TLC: R_{f}=0.41 (2:1 hexanes:ethyl acetate).

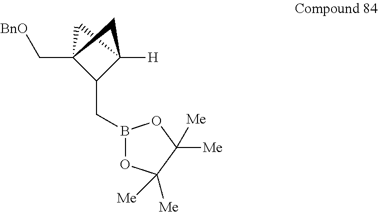 [SMILES: CC1(C)OB(CC2[C@H]3C[C@]2(COCc2ccccc2)C3)OC1(C)C]

### 2-((1-((benzyloxy)methyl)bicyclo[1.1.1]pentan-2-yl)methyl)-4,4,5,5-tetramethyl-1,3,2-dioxa borolane (84)

BCP boronate 36 (31.4 mg, 0.1 mmol, 1.0 equiv.) and bromoiodomethane (15 μL, 0.2 mmol, 2.0 eq.) were dissolved in anhydrous THF (1.0 mL) and cooled to −78° C. n-BuLi (2.5 M in n-hexane, 0.08 mL, 0.2 mmol, 2.0 equiv.) was added dropwise and the solution was stirred 10 minutes at −78° C., and then warmed up to room temperature and stirred overnight. The reaction mixture was quenched with saturated NH₄Cl solution and dissolved in ethyl acetate. The aqueous phase was extracted with ethyl acetate twice. The combined organic phase was washed with brine, dried over Na₂SO₄ and evaporated to afford the crude residue, which was purified by flash chromatography (hexane:ethyl acetate, 20:1) on silica gel to give 28.0 mg (85%) of the desired product 84. (Kondo et al., 2020)

Physical State: colorless oil.

¹H NMR (600 MHz, CDCl₃): δ 7.35-7.30 (m, 4H), 7.29-7.24 (m, 1H), 4.52-4.46 (m, 2H), 3.34 (s, 2H), 2.36 (s, 1H), 2.32-2.24 (m, 2H), 1.79 (d, J=1.7 Hz, 1H), 1.73 (dd, J=6.3, 2.9 Hz, 1H), 1.60 (dd, J=9.8, 1.7 Hz, 1H), 1.22 (s, 12H), 1.09-10.6 (m, 2H) ppm.

¹³C NMR (151 MHz, CDCl₃): δ 138.95, 128.39, 127.48, 127.46, 83.04, 72.99, 69.35, 55.93, 49.10, 46.79, 45.04, 32.56, 24.95, 24.94 ppm.

¹¹B NMR (128 MHz, CDCl₃): δ 33.77 ppm.

MS (GCMS, EI): m/z=328 (0.1%), 313 (0.1%), 219 (1%), 179 (5%), 137 (4%), 91 (100%).

TLC: R_{f}=0.50 (10:1 hexanes:ethyl acetate).

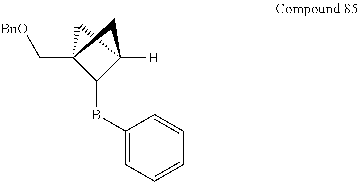

### (1-((benzyloxy)methyl)bicyclo[1.1.1]pentan-2-yl)(phenyl)sulfane (85)

A flame-dried screw-capped culture tube was charged with BCP boronate 36 (31.4 mg, 0.1 mmol, 1.0 equiv.), PhSO₂SPh (50 mg, 0.2 mmol, 2.0 equiv.), and tert-butyl catechol (4.8 mg, 0.03 mmol, 0.3 equiv.), MeOBcat (6.0 mg, 0.04 mmol, 0.4 equiv.). Then the tube was evacuated and backfilled with argon three times, followed by addition of toluene (0.5 mL, 0.2 M) solvent via a syringe. Next, the headspace of the tube was purged with a gentle stream of argon for approximately 10 seconds and the reaction was allowed to stir at 100° C. for 36 hours. After it was confirmed that the starting material was consumed totally, the reaction mixture was concentrated under high vacuum and the crude residue was purified by chromatography on silica gel to give 15.8 mg (53%) of the desired product 85. (Andrd-Joyaux et al., 2020)

Physical State: colorless oil.

¹H NMR (600 MHz, CDCl₃): δ 7.40-7.37 (m, 2H), 7.37-7.31 (m, 4H), 7.30-7.27 (m, 1H), 7.23 (dd, J=8.5, 7.0 Hz, 2H), 7.18-7.12 (m, 1H), 4.51 (d, J=12.2 Hz, 1H), 4.48 (d, J=12.2 Hz, 1H), 3.72-3.67 (m, 1H), 3.46 (d, J=10.8 Hz, 1H), 3.42 (d, J=10.7 Hz, 1H), 2.76 (s, 1H), 2.63 (dd, J=10.0, 3.0 Hz, 1H), 2.03 (d, J=2.5 Hz, 1H), 1.89-1.82 (m, 2H) ppm.

¹³C NMR (151 MHz, CDCl₃): δ 138.51, 137.52, 129.10, 128.92, 128.48, 127.66, 127.61, 125.69, 73.23, 68.36, 64.74, 49.32, 47.80, 47.04, 34.68 ppm.

MS (GCMS, EI): m/z=296 (2.5%), 252 (2.5%), 207 (4%), 147 (10%), 91 (100%).

TLC: R_{f}=0.57 (10:1 hexanes:ethyl acetate).

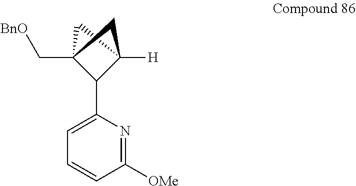 [SMILES: COc1cccc(C2[C@H]3C[C@]2(COCc2ccccc2)C3)n1]

### 2-(1-((benzyloxy)methyl)bicyclo[1.1.1]pentan-2-yl)-6-methoxypyridine (86)

A solution of 2-bromo-6-methoxypyridine (17 μL, 0.14 mmol, 1.4 equiv.) in THF:diethyl ether:pentane (4:1:1, 0.3 M) was cooled to −78° C. and treated with n-BuLi (0.06 mL, 0.14 mmol, 1.3 eq., 2.32 M in hexanes) and the mixture was stirred at this temperature for 30 min. BCP boronate 36 (31.4 mg, 0.1 mmol, 1.0 equiv.) was added dropwise as a solution in THE (0.5 mL). The mixture was stirred at −78° C. for 30 min. The mixture was warmed to room temperature. and the solvents were removed under high vacuum at room temperature. The crude reaction mixture was redissolved in MeOH (1.0 mL) and the mixture was cooled to 0° C. A solution of 1,3-dibromo-5,5-dimethylhydantoin (56 mg, 0.2 mmol, 2.0 eq.) in MeOH (1.5 ml) was added dropwise. After 1 hour at 0° C. saturated aqueous solution of Na₂S₂O₃ was added and the reaction mixture was allowed to warm to room temperature. The reaction mixture was diluted with ethyl acetate (15 mL) and water (15 mL). The layers were separated, and the aqueous layer was extracted with ethyl acetate twice. The combined organic layers were dried over anhydrous MgSO₄, filtered and concentrated under vacuum. The crude material was adsorbed on silica and purified by flash column chromatography (hexanes:ethyl acetate, 20:1) on silica gel to give 15.6 mg (53%) of the desired product 81. (Odachowski et al., 2016)

Physical State: colorless oil.

¹H NMR (600 MHz, CDCl₃): δ 7.49 (t, J=7.7 Hz, 1H), 7.37-7.30 (m, 4H), 7.29-7.25 (m, 1H), 6.75 (d, J=7.3 Hz, 1H), 6.57 (d, J=8.2 Hz, 1H), 4.61 (d, J=12.2 Hz, 1H), 4.58 (d, J=12.2 Hz, 1H), 3.83 (s, 3H), 3.72 (d, J=10.9 Hz, 1H), 3.67 (d, J=10.8 Hz, 1H), 3.40 (d, J=6.9 Hz, 1H), 2.91 (s, 1H), 2.14 (dd, J=9.5, 2.6 Hz, 1H), 1.91-1.84 (m, 2H), 1.83 (dd, J=6.9, 2.6 Hz, 1H) ppm.

¹³C NMR (151 MHz, CDCl₃): δ 163.37, 157.95, 138.87, 138.70 (br.), 128.43, 127.68, 127.58, 115.95, 107.76, 73.21, 69.46, 63.87 (br.), 53.45, 47.68, 47.49, 46.78, 32.06 ppm.

MS (GCMS, EI): m/z=295 (1%), 240 (1%), 204 (11%), 186 (16%), 174 (18%), 91 (100%).

TLC: R_{f}=0.54 (10:1 hexanes:ethyl acetate).

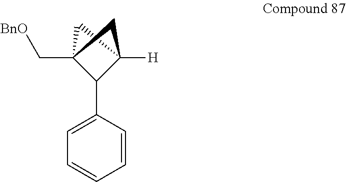 [SMILES: c1ccc(COC[C@]23C[C@H](C2)C3c2ccccc2)cc1]

### 1-((benzyloxy)methyl)-2-phenylbicyclo[1.1.1]pentane (87)

On the benchtop, BCP BF₃K 81 (14.7 mg, 0.05 mmol, 1.0 equiv.), (Ir[dF(CF₃)ppy]₂(dtbbpy))PF₆ (2.8 mg, 0.0025 mmol, 0.05 equiv.), Ni(dtbbpy)Cl₂ (4.0 mg, 0.01 mmol, 0.20 equiv.) and Cs₂CO₃ (100 mg, 0.3 mmol, 6.0 equiv.) were added to a flame-dried test tube equipped with a stir bar. The test tube was evacuated and backfilled with argon three times. Then PhBr (26 mL, 0.25 mmol, 5.0 equiv.), and distilled dioxane (0.5 mL) were added into the tube. The tube was purged with a gentle stream of argon for 10 seconds, then sealed and stirred at room temperature in 450-nm photoreactor for 24 hours. Next, the reaction mixture was quenched with water (1.0 mL) and extracted with diethyl ether (1.0 mL) three times. The combined organic layers were dried over Na₂SO₄, filtered through Celite, concentrated under reduced pressure, and purified by pTLC (hexanes:diethyl ether, 10:1) on silica gel to obtain 5.3 mg (40%) of the desired coupling product 87. (Primer et al., 2016)

Physical State: colorless oil.

¹H NMR (600 MHz, CDCl₃): δ 7.38-7.33 (m, 4H), 7.32-7.26 (m, 3H), 7.22-7.18 (m, 1H), 7.16 (dt, J=8.1, 1.1 Hz, 2H), 4.60 (d, J=12.1 Hz, 1H), 4.53 (d, J=12.2 Hz, 1H), 3.53 (d, J=10.7 Hz, 1H), 3.47-3.41 (m, 2H), 2.89 (s, 1H), 2.10 (dd, J=10.1, 2.6 Hz, 1H), 1.86 (dq, J=4.0, 1.9 Hz, 2H), 1.78 (dd, J=6.8, 2.6 Hz, 1H) ppm.

¹³C NMR (151 MHz, CDCl₃): δ 139.99, 138.66, 128.94, 128.49, 128.09, 127.83, 127.70, 125.94, 73.24, 69.05, 62.79, 47.59, 47.00, 46.50, 31.13 ppm.

MS (GCMS, EI): m/z=264 (0.2%), 173 (2%), 155 (16%), 115 (30%), 91 (100%).

TLC: R_{f}=0.54 (10:1 hexanes:ethyl acetate).

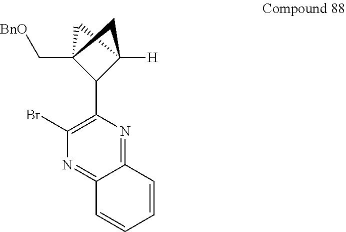 [SMILES: Brc1nc2ccccc2nc1C1[C@H]2C[C@]1(COCc1ccccc1)C2]

### 2-(1-((benzyloxy)methyl)bicyclo[1.1.1]pentan-2-yl)-3-bromoquinoxaline (88)

A screw-capped culture tube was charged with BCP BF₃K 81 (29.4 mg, 0.1 mmol, 1.0 equiv.), 2-bromoquinoxaline (62.4 mg, 0.3 mmol, 3.0 equiv.) and Mn(OAc)₃·2H₂O (80.4 mg, 0.3 mmol, 3.0 equiv.). Then the tube or the flask was evacuated and backfilled with argon three times, followed by addition of acetic acid/water (1.0 mL, 0.1 M, 1:1) solvent via a syringe. Next, trifluoroacetic acid (23 mL, 0.5 mmol, 5.0 equiv.) was added into the reaction. Then the headspace of the tube was purged with a gentle stream of argon for approximately 10 seconds and the reaction was stirred at 50° C. for 18 hours. After it was confirmed that the starting material was consumed totally, the reaction mixture was concentrated under high vacuum to remove excess acetic acid, quenched with K₂CO₃ solution, extracted with ethyl acetate, dried with Na₂SO₄, and concentrated under high vacuum. The crude residue was purified by pTLC (hexanes:diethyl ether, 5:1) on silica gel to obtain 12.1 mg (31%) of the desired coupling product 88. (Molander et al., 2011)

Physical State: red oil.

¹H NMR (600 MHz, CDCl₃): δ 8.00 (dd, J=7.7, 2.0 Hz, 2H), 7.78-7.70 (m, 2H), 7.29-7.27 (m, 4H), 7.23 (dq, J=7.8, 2.6 Hz, 1H), 4.59 (d, J=12.2 Hz, 1H), 4.53 (d, J=12.2 Hz, 1H), 3.93 (d, J=10.6 Hz, 1H), 3.82 (d, J=10.6 Hz, 1H), 3.72 (d, J=6.2 Hz, 1H), 3.16 (s, 1H), 2.38 (dd, J=9.8, 2.9 Hz, 1H), 2.05-1.98 (m, 1H), 1.92 (d, J=1.9 Hz, 1H), 1.87 (dd, J=6.2, 2.9 Hz, 1H) ppm.

¹³C NMR (151 MHz, CDCl₃): δ 154.97, 141.81, 141.52, 138.75, 130.21, 130.10, 129.27, 128.39, 128.28, 127.82, 127.64, 127.54, 73.19, 69.30, 63.69, 48.32, 48.09, 46.13, 33.54 ppm.

HRMS (ESI-TOF): calc'd for C₂₁H₁₉BrN₂O [M+H]⁺: 395.0754, found: 395.0750.

TLC: R_{f}=0.43 (10:1 hexanes:ethyl acetate).

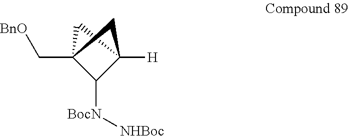 [SMILES: CC(C)(C)OC(=O)NN(C(=O)OC(C)(C)C)C1[C@H]2C[C@]1(COCc1ccccc1)C2]

### di-tert-butyl 1-(2-((benzyloxy)methyl)cyclobutyl)hydrazine-1,2-dicarboxylate (89)

To a screw-capped culture tube was added boronic acid 82 (116 mg, 0.5 mmol), TBC (30 mol %), DBAD (1.0 mmol) and toluene (2.5 mL). The headspace of the tube was purged with a gentle stream of argon for approximately 10 seconds and the reaction was allowed to stir at 70° C. for 2 h. The solvent was concentrated, and the residue was directly purified by flash column chromatography (hexanes:ethyl acetate, 10:1) on silica gel to give 199 mg (95%) of the desired product 89. (Andrd-Joyaux, et al., 2011)

Physical State: colorless oil.

¹H NMR (600 MHz, CDCl₃): δ 7.35-7.26 (m, 5H), 6.99 (br., 0.5H), 6.51 (br., 0.5H), 4.50 (s, 2H), 3.82 (br., 1H), 3.43 (br., 2H), 2.97-2.60 (m, 1H), 2.39-2.29 (m, 1H), 1.90-1.68 (m, 2H), 1.54-1.38 (m, 19H) ppm.

¹³C NMR (151 MHz, CDCl₃): δ 138.21, 128.51, 127.92, 127.77, 81.16 (br.), 73.48 (br.), 73.08 (br.), 69.32 (br.), 44.87, 28.40, 28.37 ppm. Note: bridge-head CH and C, bridge NCH and CH₂ and two NC(O) were not observed.

HRMS (ESI-TOF): calc'd for C₂₃H₃₄N₂O₅ [M+H]⁺: 419.2541, found: 419.2541.

TLC: R_{f}=0.39 (2:1 hexanes:ethyl acetate).

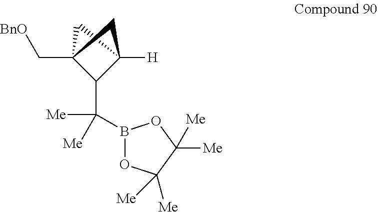 [SMILES: CC(C)(B1OC(C)(C)C(C)(C)O1)C1[C@H]2C[C@]1(COCc1ccccc1)C2]

### 2-(2-(1-((benzyloxy)methyl)bicyclo[1.1.1]pentan-2-yl)propan-2-yl)-4,4,5,5-tetramethyl-1,3,2-dioxaborolane (90)

A flame-dried screw-capped culture tube was charged with BCP boronic acid 82 (23.2 mg, 0.1 mmol, 1.0 equiv.) and sulfonyl hydrazone SI-21 (30.5 mg, 0.12 mmol, 1.0 equiv.), and cesium carbonate (97.5 mg, 0.3 mmol, 3.0 equiv.) Then the tube was evacuated and backfilled with argon three times, followed by addition of chlorobenzene (1.0 mL) via a syringe. After stirring for at 100° C. for 2 hours, the reaction mixture was cooled to room temperature. Next, pinacol (118 mg, 1.0 mmol, 5.0 equiv.) was added, and the reaction was stirred at 100° C. for another 1 hour. The suspended solution was then filtered over Celite and washed with diethyl ether. The solvent was removed under high vacuum, and the crude residue was purified by chromatography (hexanes:ethyl acetate, 15:1) on silica gel to afford 22.1 mg (62%) of the desired product 90. (Yang, et al., 2021a)

Physical State: white solid.

m.p.: 27-29° C.

¹H NMR (600 MHz, CDCl₃): δ 7.37-7.31 (m, 4H), 7.29-7.24 (m, 1H), 4.52 (s, 2H), 3.56 (d, J=10.6 Hz, 1H), 3.52 (d, J=10.6 Hz, 1H), 2.51 (s, 1H), 2.07 (dd, J=9.9, 3.3 Hz, 1H), 1.86 (d, J=7.1 Hz, 1H), 1.76 (dd, J=7.2, 3.2 Hz, 1H), 1.71 (d, J=1.6 Hz, 1H), 1.46 (dd, J=9.9, 1.7 Hz, 1H), 1.21 (s, 6H), 1.20 (s, 6H), 0.97 (s, 3H), 0.95 (s, 3H) ppm.

¹³C NMR (151 MHz, CDCl₃): δ 139.12, 128.39, 127.60, 127.44, 82.96, 73.20, 73.07, 69.87, 48.13, 47.65, 47.08, 31.84, 27.12, 26.43, 24.86, 24.84 ppm.

¹¹B NMR (128 MHz, CDCl₃): δ 34.77 ppm.

MS (GCMS, EI): m/z=355 (0.1%), 341 (0.1%), 294 (0.1%), 207 (3%), 107 (25%), 91 (100%).

TLC: R_{f}=0.50 (10:1 hexanes:ethyl acetate).

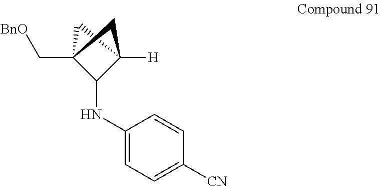 [SMILES: N#Cc1ccc(NC2[C@H]3C[C@]2(COCc2ccccc2)C3)cc1]

### 4-((1-((benzyloxy)methyl)bicyclo[1.1.1]pentan-2-yl)amino)benzonitrile (91)

A flame dried screw-capped culture tube was charged with boronic acid 82 (23.2 mg, 0.1 mmol), 4-nitrobenzonitrile (14.8 mg, 0.1 mmol) and 1,2,2,3,4,4 hexamethylphosphetane 1-oxide (15 mol %) under argon atmosphere, followed by addition of m-xylene (0.2 mL) and PhSiH₃ (0.2 mmol). The reaction mixture was stirred at 120° C. for 8 hours. The mixture was directly purified by flash column chromatography (hexanes:ethyl acetate, 10:1) on silica gel to give 20.0 mg (66%) of the desired product 91. (Nykaza et al., 2018)

Physical State: colorless oil.

¹H NMR (600 MHz, CDCl₃): δ 7.40-7.35 (m, 4H), 7.32 (td, J=6.7, 6.3, 1.7 Hz, 3H), 6.59-6.54 (m, 2H), 5.29 (br., 1H), 4.50 (s, 2H), 3.60 (d, J=6.3 Hz, 1H), 3.51 (d, J=10.3 Hz, 1H), 3.47 (d, J=10.3 Hz, 1H), 2.77 (s, 1H), 2.56 (dd, J=9.8, 2.9 Hz, 1H), 1.83-1.78 (m, 2H), 1.61 (dd, J=9.7, 2.7 Hz, 1H) ppm.

¹³C NMR (151 MHz, CDCl₃): δ 151.62, 138.21, 133.76, 128.64, 127.96, 127.64, 120.78, 112.25, 98.53, 73.50, 70.09, 68.50, 47.23, 44.82, 43.47, 33.23 ppm.

HRMS (ESI-TOF): calc'd for C₂₀H₂₀N₂O [M+H]⁺: 305.1648, found: 305.1684.

TLC: R_{f}=0.46 (10:1 hexanes:ethyl acetate).

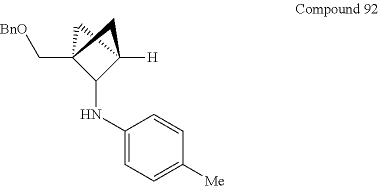 [SMILES: Cc1ccc(NC2[C@H]3C[C@]2(COCc2ccccc2)C3)cc1]

### 1-((benzyloxy)methyl)-N-(p-tolyl)bicyclo[1.1.1]pentan-2-amine (92)

A flame dried screw-capped culture tube was charged with boronic acid 82 (23.2 mg, 0.1 mmol), 4-nitrotoluene (13.7 mg, 0.1 mmol) and 1,2,2,3,4,4 hexamethylphosphetane 1-oxide (15 mol %) under argon atmosphere, followed by addition of m-xylene (0.2 mL) and PhSiH₃ (0.2 mmol). The reaction mixture was stirred at 120° C. for 8 hours. The mixture was directly purified by flash column chromatography (hexanes:ethyl acetate, 10:1) on silica gel to give 18.0 mg (61%) of the desired product 92. (Nykaza et al., 2018)

Physical State: red oil.

¹H NMR (600 MHz, CDCl₃): δ 7.42-7.28 (m, 5H), 7.01-6.96 (m, 2H), 6.59-6.54 (m, 2H), 4.53 (d, J=12.1 Hz, 1H), 4.50 (d, J=12.1 Hz, 1H), 3.60 (d, J=6.2 Hz, 1H), 3.48 (s, 2H), 2.72 (s, 1H), 2.61 (dd, J=9.7, 2.6 Hz, 1H), 2.25 (s, 3H), 1.79 (dd, J=6.3, 2.6 Hz, 1H), 1.76 (d, J=2.5 Hz, 1H), 1.58 (dd, J=9.7, 2.5 Hz, 1H) ppm.

¹³C NMR (151 MHz, CDCl₃): δ 146.16, 138.55, 129.94, 129.81, 128.55, 127.73, 127.61, 126.22, 112.66, 73.32, 69.83, 69.76, 47.46, 44.80, 43.54, 33.29, 20.53 ppm.

HRMS (ESI-TOF): calc'd for C₂₀H₂₃NO [M+H]⁺: 294.1852, found: 294.1856.

TLC: R_{f}=0.68 (5:1 hexanes:ethyl acetate).

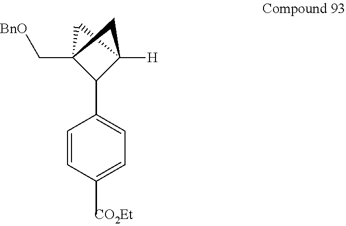 [SMILES: Cc1ccc(C2[C@H]3C[C@]2(COCc2ccccc2)C3)cc1]

### ethyl 4-(1-((benzyloxy)methyl)bicyclo[1.1.1]pentan-2-yl)benzoate (93)

A flame-dried screw-capped culture tube was charged with BCP boronate 36 (31.4 mg, 0.1 mmol, 1.0 equiv.). Then the tube was evacuated and backfilled with argon three times, followed by addition of THF (0.5 mL, 0.2 M) solvent via a syringe. Next, PhLi (68 mL, 1.75 M in hexanes, 0.12 mmol, 1.2 equiv.) was added into the reaction mixture at −78° C. and the reaction was allowed to stir at −78° C. for 30 minutes. Then the mixture was allowed to warm up to room temperature and stir for another 30 minutes. A solution of 4-CzlPn (3.9 mg, 0.005 mmol, 0.05 equiv.), Ni(dtbbpy)Cl₂ (8.0 mg, 0.02 mmol, 0.2 equiv.) and ethyl 4-bromobenzoate (49 mL, 0.3 mmol, 3.0 equiv.) in DMA (0.5 mL) was added into the reaction mixture. Next, the headspace of the tube was purged with a gentle stream of argon for approximately 10 seconds and the reaction was allowed to stir in a 450-nm photoreactor for 12 hours. After it was confirmed that the starting material was consumed totally, the reaction mixture was quenched with water, extracted with diethyl ether, washed by saturated brine, dried with Na₂SO₄ and concentrated under high vacuum and the crude residue was purified by chromatography on silica gel to give 21.2 mg (63%) of the desired product 88.

Physical State: colorless oil.

¹H NMR (600 MHz, CDCl₃): δ 7.95 (d, J=8.3 Hz, 2H), 7.39-7.34 (m, 4H), 7.31 (ddd, J=8.6, 5.5, 2.4 Hz, 1H), 7.23 (d, J=7.9 Hz, 2H), 4.59 (d, J=12.1 Hz, 1H), 4.53 (d, J=12.2 Hz, 1H), 4.37 (q, J=7.1 Hz, 2H), 3.50 (d, J=10.7 Hz, 1H), 3.47-3.42 (m, 2H), 2.92 (s, 1H), 2.07-2.02 (m, 1H), 1.88 (dd, J=9.7, 1.9 Hz, 1H), 1.86 (d, J=1.8 Hz, 1H), 1.78 (dd, J=6.9, 2.7 Hz, 1H), 1.39 (t, J=7.1 Hz, 3H) ppm.

¹³C NMR (151 MHz, CDCl₃): δ 166.88, 145.42, 138.48, 129.35, 128.92, 128.52, 128.23, 127.85, 127.79, 73.28, 68.86, 62.78, 60.93, 47.61, 47.34, 46.51, 31.22, 14.50 ppm.

MS (GCMS, EI): m/z=336 (0.2%), 291 (1%), 230 (6%), 199 (9%), 155 (19%), 91 (100%).

TLC: R_{f}=0.46 (10:1 hexanes:ethyl acetate).

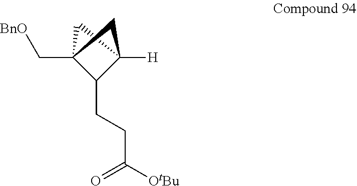 [SMILES: CC(C)(C)OC(=O)CCC1[C@H]2C[C@]1(COCc1ccccc1)C2]

### tert-butyl 3-(1-((benzyloxy)methyl)bicyclo[1.1.1]pentan-2-yl)propanoate (94)

A flame-dried screw-capped culture tube was charged with BCP boronate 36 (31.4 mg, 0.1 mmol, 1.0 equiv.). Then the tube was evacuated and backfilled with argon three times, followed by addition of THF (0.2 mL, 0.5 M) solvent via a syringe. Next, PhLi (68 mL, 1.75 M in hexanes, 0.12 mmol, 1.2 equiv.) was added into the reaction mixture at −78° C. and the reaction was allowed to stir at −78° C. for 30 minutes. Then the mixture was allowed to warm up to room temperature and was stirred for another 30 minutes. A solution of 4-CzlPn (3.9 mg, 0.005 mmol, 0.05 equiv.), tert-butylacrylate (29 mL, 0.2 mmol, 2.0 equiv.) and tert-butanol (28 mL, 0.3 mmol, 3.0 equiv.) in acetonitrile (1.0 mL) was added into the reaction mixture. Next, the headspace of the tube was purged with a gentle stream of argon for approximately 10 seconds and the reaction was allowed to stir in a 450-nm photoreactor for 12 hours. The reaction mixture was concentrated under high vacuum and the crude residue was purified by chromatography on silica gel to give 28.8 mg (91%) of the desired product 94.

Physical State: colorless oil.

¹H NMR (400 MHz, CDCl₃): δ 7.31-7.16 (m, 5H), 4.42 (s, 2H), 3.27 (s, 2H), 2.32 (s, 1H), 2.23 (dd, J=9.8, 2.9 Hz, 1H), 2.16 (ddd, J=8.4, 6.9, 5.2 Hz, 2H), 2.01 (dt, J=7.8, 6.2 Hz, 1H), 1.87-1.70 (m, 2H), 1.69-1.64 (m, 2H), 1.48 (dd, J=9.8, 1.7 Hz, 1H), 1.37 (s, 9H) ppm.

¹³C NMR (101 MHz, CDCl₃): δ 173.38, 138.79, 134.87, 128.45, 127.57, 80.10, 73.12, 69.51, 60.31, 48.89, 46.38, 45.36, 34.94, 31.12, 28.26, 21.25 ppm.

HRMS (ESI-TOF): calc'd for C₂₀H₂₈O₃[M+H]⁺: 317.2111, found: 317.2113.

TLC: R_{f}=0.54 (10:1 hexanes:ethyl acetate).

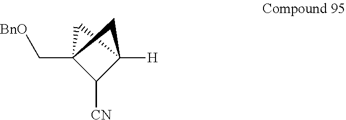 [SMILES: N#CC1[C@H]2C[C@]1(COCc1ccccc1)C2]

### 1-((benzyloxy)methyl)bicyclo[1.1.1]pentane-2-carbonitrile (95)

A flame-dried screw-capped culture tube was charged with BCP boronate 36 (31.4 mg, 0.1 mmol, 1.0 equiv.). Then the tube was evacuated and backfilled with argon three times, followed by addition of THE (0.2 mL, 0.5 M) solvent via a syringe. Next, PhLi (68 mL, 1.75 M in hexanes, 0.12 mmol, 1.2 equiv.) was added into the reaction mixture at −78° C. and the reaction was allowed to stir at −78° C. for 30 minutes. Then the mixture was allowed to warm up to room temperature and stir for another 30 minutes. A solution of 4-CzlPn (3.9 mg, 0.005 mmol, 0.05 equiv.) and TsCN (36 mg, 0.2 mmol, 2.0 equiv.) in acetonitrile (1.0 mL) was added into the reaction mixture. Next, the headspace of the tube was purged with a gentle stream of argon for approximately 10 seconds and the reaction was allowed to stir in a 450-nm photoreactor for 12 hours. The reaction mixture was concentrated under high vacuum and the crude residue was purified by chromatography on silica gel to give 14 mg (66%) of the desired product 95.

Physical State: colorless oil.

¹H NMR (400 MHz, CDCl₃): δ 7.42-7.26 (m, 5H), 4.55 (d, J=12.4 Hz, 1H), 4.51 (d, J=12.4 Hz, 1H), 3.50 (d, J=11.0 Hz, 1H), 3.45 (d, J=11.0 Hz, 1H), 2.91 (s, 1H), 2.76 (d, J=7.6 Hz, 1H), 2.53 (dd, J=9.9, 3.4 Hz, 1H), 1.94 (dd, J=7.6, 3.4 Hz, 1H), 1.87 (dd, J=9.9, 2.7 Hz, 1H), 1.81 (d, J=2.7 Hz, 1H) ppm.

¹³C NMR (101 MHz, CDCl₃): δ 138.11, 128.58, 127.86, 127.63, 119.43, 73.40, 68.17, 48.49, 48.32, 47.87, 45.90, 33.10 ppm.

MS (GCMS, EI): m/z=213 (3%), 107 (10%), 91 (100%), 65 (35%).

TLC: R_{f}=0.63 (2:1 hexanes:ethyl acetate).

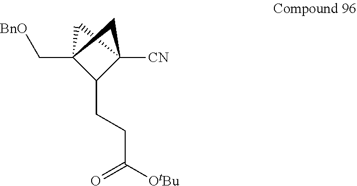 [SMILES: CC(C)(C)OC(=O)CCC1[C@]2(C#N)C[C@@]1(COCc1ccccc1)C2]

### tert-butyl 3-(1-((benzyloxy)methyl)-3-cyanobicyclo[1.1.1]pentan-2-yl)propanoate (96)

A flame-dried screw-capped culture tube was charged with BCP boronate 42 (33.9 mg, 0.1 mmol, 1.0 equiv.). Then the tube was evacuated and backfilled with argon three times, followed by addition of THF (0.2 mL, 0.5 M) solvent via a syringe. Next, PhLi (68 mL, 1.75 M in hexanes, 0.12 mmol, 1.2 equiv.) was added into the reaction mixture at −78° C. and the reaction was allowed to stir at −78° C. for 30 minutes. Then the mixture was allowed to warm up to room temperature and was stirred for another 30 minutes. A solution of 4-CzlPn (3.9 mg, 0.005 mmol, 0.05 equiv.), tert-butylacrylate (29 mL, 0.2 mmol, 2.0 equiv.) and tert-butanol (28 mL, 0.3 mmol, 3.0 equiv.) in acetonitrile (1.0 mL) was added into the reaction mixture. Next, the headspace of the tube was purged with a gentle stream of argon for approximately 10 seconds and the reaction was allowed to stir in a 450-nm photoreactor for 12 hours. The reaction mixture was concentrated under high vacuum and the crude residue was purified by chromatography on silica gel to give 15 mg (44%) of the desired product 96.

Physical State: colorless oil.

¹H NMR (600 MHz, CDCl₃): δ 7.38-7.32 (m, 2H), 7.32-7.26 (m, 3H), 4.47 (d, J=12.2 Hz, 1H), 4.45 (d, J=12.2 Hz, 1H), 3.39-3.34 (m, 2H), 2.70 (dd, J=9.7, 3.1 Hz, 1H), 2.48 (q, J=6.7 Hz, 1H), 2.43-2.27 (m, 2H), 2.18-2.15 (m, 2H), 2.07-1.83 (m, 3H), 1.45 (s, 9H) ppm.

¹³C NMR (151 MHz, CDCl₃): δ 172.44, 138.04, 128.58, 127.90, 127.67, 117.47, 80.67, 73.39, 67.76, 64.28, 53.00, 49.28, 45.51, 33.53, 28.25, 26.98, 20.43 ppm.

HRMS (ESI-TOF): calc'd for C₂₁H₂₇NO₃ [M+H]⁺: 342.2064, found: 342.2061.

TLC: R_{f}=0.29 (10:1 hexanes:ethyl acetate).

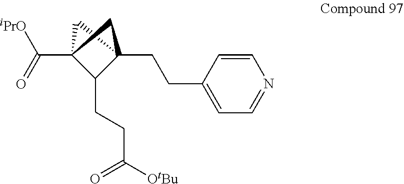

### isopropyl 2-(3-(tert-butoxy)-3-oxopropyl)-3-(2-(pyridin-4-yl)ethyl)bicyclo[1.1.1]pentane-1-carboxylate (97)

A flame-dried screw-capped culture tube was charged with BCP boronate 54 (41.9 mg, 0.1 mmol, 1.0 equiv.). Then the tube was evacuated and backfilled with argon three times, followed by addition of THF (0.2 mL, 0.5 M) solvent via a syringe. Next, PhLi (68 mL, 1.75 M in hexanes, 0.12 mmol, 1.2 equiv.) was added into the reaction mixture at −78° C. and the reaction was allowed to stir at −78° C. for 30 minutes. Then the mixture was allowed to warm up to room temperature and was stirred for another 30 minutes. A solution of 4-CzlPn (3.9 mg, 0.005 mmol, 0.05 equiv.), tert-butylacrylate (29 mL, 0.2 mmol, 2.0 equiv.) and tert-butanol (28 mL, 0.3 mmol, 3.0 equiv.) in acetonitrile (1.0 mL) was added into the reaction mixture. Next, the headspace of the tube was purged with a gentle stream of argon for approximately 10 seconds and the reaction was allowed to stir in a 450-nm photoreactor for 12 hours. The reaction mixture was concentrated under high vacuum and the crude residue was purified by chromatography on silica gel to give 36 mg (85%) of the desired product 97.

Physical State: colorless oil.

¹H NMR (400 MHz, CDCl₃): δ 8.49-8.43 (m, 2H), 7.13-7.06 (m, 2H), 4.95 (hept, J=6.3 Hz, 1H), 2.56-2.47 (m, 2H), 2.41-2.13 (m, 4H), 1.98-1.77 (m, 4H), 1.75 (ddd, J=8.0, 6.9, 2.5 Hz, 2H), 1.67 (dd, J=9.7, 1.7 Hz, 1H), 1.43 (s, 9H), 1.20 (d, J=6.2 Hz, 6H) ppm.

¹³C NMR (151 MHz, CDCl₃): δ 172.93, 169.43, 151.09, 149.73, 123.85, 80.34, 67.77, 62.08, 51.21, 46.61, 42.50, 41.04, 34.23, 31.90, 30.07, 28.22, 21.90, 20.40 ppm.

MS (GCMS, EI): m/z=387 (1%), 373 (1%), 342 (5%), 298 (5%), 207 (11%), 93 (100%).

TLC: R_{f}=0.17 (2:1 hexanes:ethyl acetate).

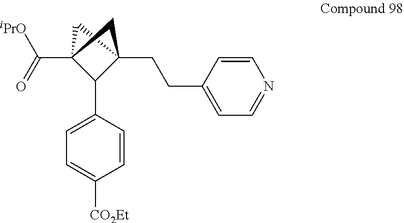 [SMILES: CCOC(=O)c1ccc(C2[C@]3(CCc4ccncc4)C[C@@]2(C(=O)OC(C)C)C3)cc1]

### ethyl 4-(1-((benzyloxy)methyl)bicyclo[1.1.1]pentan-2-yl)benzoate (98)

A flame-dried screw-capped culture tube was charged with BCP boronate 54 (31.4 mg, 0.1 mmol, 1.0 equiv.). Then the tube was evacuated and backfilled with argon three times, followed by addition of THF (0.5 mL, 0.2 M) solvent via a syringe. Next, PhLi (68 mL, 1.75 M in hexanes, 0.12 mmol, 1.2 equiv.) was added into the reaction mixture at −78° C. and the reaction was allowed to stir at −78° C. for 30 minutes. Then the mixture was allowed to warm up to room temperature and stir for another 30 minutes. A solution of 4-CzlPn (3.9 mg, 0.005 mmol, 0.05 equiv.), Ni(dtbbpy)Cl₂ (8.0 mg, 0.02 mmol, 0.2 equiv.) and ethyl 4-bromobenzoate (49 mL, 0.3 mmol, 3.0 equiv.) in DMA (0.5 mL) was added into the reaction mixture. Next, the headspace of the tube was purged with a gentle stream of argon for approximately 10 seconds and the reaction was allowed to stir in a 450-nm photoreactor for 12 hours. After it was confirmed that the starting material was consumed totally, the reaction mixture was quenched with water, extracted with diethyl ether, washed by saturated brine, dried with Na₂SO₄ and concentrated under high vacuum and the crude residue was purified by pTLC on silica gel (hexane:acetone, 3:1) to give 10.2 mg (25%) of the desired product 98.

On the benchtop, BCP BF₃K SI-25 (18.3 mg, 0.05 mmol, 1.0 equiv.), ethyl 4-bromobenzoate (48 mL, 0.3 mmol, 4.0 equiv.), (Ir[dF(CF₃)ppy]₂(dtbbpy))PF₆ (2.8 mg, 0.0025 mmol, 0.05 equiv.), Ni(dtbbpy)Cl₂ (4.0 mg, 0.01 mmol, 0.20 equiv.) and Cs₂CO₃ (100 mg, 0.3 mmol, 6.0 equiv.) were added to a flame-dried test tube equipped with a stir bar. The test tube was evacuated and backfilled with argon three times. Then dried THF (0.5 mL) was added into the tube. Then the tube was purged with a gentle stream of argon for 10 seconds, then sealed and stirred at room temperature in 450-nm photoreactor for 24 hours. Next, the reaction mixture was quenched with water (1.0 mL) and extracted with diethyl ether (1.0 mL) three times. The combined organic layers were dried over Na₂SO₄, filtered through Celite, concentrated under reduced pressure, and purified by pTLC (hexanes:diethyl ether, 1:3) on silica gel to obtain 4.8 mg (24%) of the desired coupling product 98.

Physical State: colorless oil.

¹H NMR (600 MHz, CDCl₃): δ 8.50 (d, J=5.0 Hz, 2H), 7.99 (d, J=8.0 Hz, 2H), 7.28 (d, J=8.1 Hz, 2H), 7.13 (d, J=5.0 Hz, 2H), 5.06 (hept, J=6.2 Hz, 1H), 4.37 (q, J=7.1 Hz, 2H), 3.60 (d, J=6.6 Hz, 1H), 2.63 (qdd, J=14.2, 10.3, 6.1 Hz, 2H), 2.33 (dd, J=9.7, 3.0 Hz, 1H), 2.01-1.94 (m, 3H), 1.94-1.86 (m, 2H), 1.39 (t, J=7.1 Hz, 3H), 1.25 (dd, J=7.7, 6.3 Hz, 6H) ppm.

¹³C NMR (151 MHz, CDCl₃): δ 169.13, 166.65, 151.19, 149.56, 143.16, 129.57, 128.83, 128.68, 123.98, 68.34, 65.00, 61.08, 51.04, 47.02, 43.75, 41.46, 31.91, 30.20, 21.95, 14.49 ppm.

HRMS (ESI-TOF): calc'd for C₂₅H₂₉NO₄ [M+H]⁺: 408.2169, found: 408.2167.

TLC: R_{f}=0.13 (2:1 hexanes:ethyl acetate).

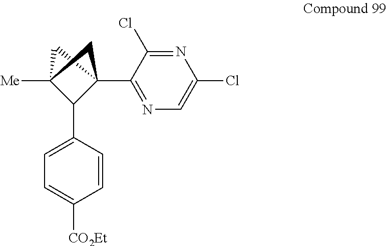 [SMILES: CCOC(=O)c1ccc(C2[C@]3(C)C[C@@]2(c2ncc(Cl)nc2Cl)C3)cc1]

### ethyl 4-(1-(3,5-dichloropyrazin-2-yl)-3-methylbicyclo[1.1.1]pentan-2-yl)benzoate (99)

A flame-dried screw-capped culture tube was charged with BCP boronate 77 (35.5 mg, 0.1 mmol, 1.0 equiv.). Then the tube was evacuated and backfilled with argon three times, followed by addition of THF (0.5 mL, 0.2 M) solvent via a syringe. Next, PhLi (68 mL, 1.75 M in hexanes, 0.12 mmol, 1.2 equiv.) was added into the reaction mixture at −78° C. and the reaction was allowed to stir at −78° C. for 30 minutes. Then the mixture was allowed to warm up to room temperature and was stirred for another 30 minutes. A solution of 4-CzlPn (3.9 mg, 0.005 mmol, 0.05 equiv.), Ni(dtbbpy)Cl₂ (8.0 mg, 0.02 mmol, 0.2 equiv.) and ethyl 4-bromobenzoate (49 mL, 0.3 mmol, 3.0 equiv.) in DMA (0.5 mL) was added into the reaction mixture. Next, the headspace of the tube was purged with a gentle stream of argon for approximately 10 seconds and the reaction was allowed to stir in a 450-nm photoreactor for 12 hours. After it was confirmed that the starting material was consumed totally, the reaction mixture was quenched with water, extracted with diethyl ether, washed by saturated brine, dried with Na₂SO₄ and concentrated under high vacuum and the crude residue was purified by chromatography on silica gel to give 8.2 mg (22%) of the desired product 99.

Physical State: red oil.

¹H NMR (600 MHz, CDCl₃): δ 8.46 (s, 1H), 7.92 (d, J=8.3 Hz, 2H), 7.08 (d, J=8.1 Hz, 2H), 4.35 (q, J=7.1 Hz, 2H), 3.95 (d, J=6.7 Hz, 1H), 2.59 (dd, J=9.8, 3.0 Hz, 1H), 2.36 (dd, J=9.8, 1.7 Hz, 1H), 2.24 (dt, J=7.4, 3.7 Hz, 1H), 2.14 (d, J=1.6 Hz, 1H), 1.42-1.32 (m, 6H) ppm.

¹³C NMR (151 MHz, CDCl₃): δ 166.68, 149.87, 146.46, 145.42, 143.96, 141.99, 129.47, 128.59, 128.52, 66.18, 60.99, 54.18, 48.84, 44.58, 41.70, 16.40, 14.47 ppm.

MS (GCMS, EI): m/z=378 (5%), 376 (8%), 341 (20%), 269 (15%), 213 (35%), 115 (100%).

TLC: R_{f}=0.46 (10:1 hexanes:ethyl acetate).

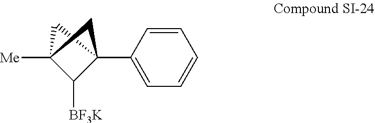

### trifluoro(1-methyl-3-phenylbicyclo[1.1.1]pentan-2-yl)-λ⁴-borane, potassium salt (SI-24)

BCP boronate 65 (284 mg, 1.0 mmol) was suspended in methanol (5 mL), and a saturated aqueous solution of KHF₂ (1 mL, 4 mmol) was added dropwise. The suspended solution was stirred at room temperature for 2 hours and then concentrated to dryness. The residue was extracted with hot acetone (3×20 mL), and the combined filtered extracts were concentrated. Methylene chloride was added, and the resultant precipitate was collected and dried to afford the 201 mg (76%) of the potassium trifluoroborate SI-24.

Physical State: white solid.

m.p.: 191-193° C.

¹H NMR (600 MHz, Acetone-d⁶): δ 7.34-7.29 (m, 2H), 7.14 (dd, J=8.5, 6.9 Hz, 2H), 7.06-7.00 (m, 1H), 2.74 (d, J=9.5 Hz, 1H), 1.78 (s, 1H), 1.63 (d, J=9.4 Hz, 1H), 1.57 (d, J=8.0 Hz, 1H), 1.27 (dd, J=7.7, 5.7 Hz, 1H), 1.18 (s, 3H) ppm.

¹³C NMR (151 MHz, Acetone-d⁶): δ 145.49, 128.03, 127.66, 125.51, 58.94, 52.08, 44.22 (d, J=2.8 Hz), 37.47 (q, J=2.9 Hz), 18.95 ppm.

¹⁹F NMR (376 MHz, Acetone-d⁶): δ −134.94 ppm.

¹¹B NMR (128 MHz, Acetone-d₆): δ 4.01 (q, J=65.8 Hz) ppm.

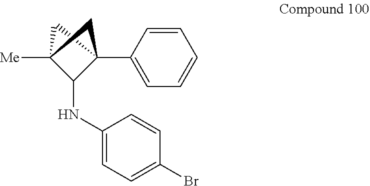 [SMILES: C[C@]12C[C@](c3ccccc3)(C1)C2Nc1ccc(Br)cc1]

### N-(4-bromophenyl)-1-methyl-3-phenylbicyclo[1.1.1]pentan-2-amine (100)

A screw-capped culture tube was charged with SI-24 (132 mg, 0.5 mmol) and water (2.5 mL), followed by addition of silica gel (250 mg) under argon atmosphere. The mixture was stirred at room temperature for 1 hour. Ethyl ether (5 mL) was added, and the suspended solution was filtered by Celite. The organic phase was separated, and the water phase was extracted with diethyl ether (3×2 mL). The combined organic solvent was washed with brine and dried by anhydrous MgSO₄. The solvent was removed under vacuum to afford the desired boronic acid without further purification.

A flame dried screw-capped culture tube was charged with boronic acid (20.2 mg, 0.1 mmol), 1-bromo-4-nitrobenzene (20.2 mg, 0.1 mmol) and 1,2,2,3,4,4-hexamethylphosphetane-1-oxide (15 mol %) under argon atmosphere, followed by addition of m-xylene (0.2 mL) and PhSiH₃ (0.2 mmol) were added. The reaction mixture was stirred at 120° C. for 8 hours. The mixture was directly purified by flash column chromatography (hexanes:ethyl acetate, 10:1) on silica gel to give 14.1 mg (43%) of the desired product 100. (Nykaza et al., 2018)

Physical State: red oil.

¹H NMR (600 MHz, CDCl₃): δ 7.28 (dd, J=8.1, 6.8 Hz, 2H), 7.25-7.19 (m, 1H), 7.16 (ddd, J=10.2, 7.5, 1.8 Hz, 4H), 6.45-6.40 (m, 2H), 3.64 (d, J=6.3 Hz, 1H), 2.65 (dd, J=9.8, 2.7 Hz, 1H), 1.91 (dd, J=6.3, 2.7 Hz, 1H), 1.89 (d, J=2.4 Hz, 1H), 1.84 (dd, J=9.8, 2.5 Hz, 1H), 1.25 (s, 3H) ppm.

¹³C NMR (151 MHz, CDCl₃): δ 147.23, 138.46, 131.88, 128.48, 126.93, 126.54, 114.47, 108.89, 72.32, 49.00, 47.00, 46.95, 40.85, 15.98 ppm.

HRMS (ESI-TOF): calc'd for C₁₈H₁₈BrN [M+H]⁺: 328.0695, found: 328.0694.

TLC: R_{f}=0.27 (5:1 hexanes:ethyl acetate).

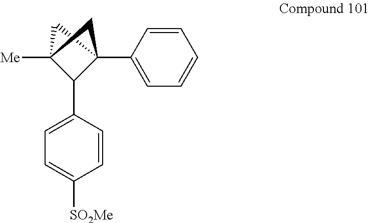 [SMILES: CS(=O)(=O)c1ccc(C2[C@]3(C)C[C@@]2(c2ccccc2)C3)cc1]

### 1-methyl-2-(4-(methylsulfonyl)phenyl)-3-phenylbicyclo[1.1.1]pentane (101)

On the benchtop, BCP BF₃K SI-24 (14.7 mg, 0.05 mmol, 1.0 equiv.), 4-bromophenyl methyl sulfone (47 mg, 0.2 mmol, 4.0 equiv.), (Ir[dF(CF₃)ppy]₂(dtbbpy))PF₆ (2.8 mg, 0.0025 mmol, 0.05 equiv.), Ni(dtbbpy)Cl₂ (4.0 mg, 0.01 mmol, 0.20 equiv.) and Cs₂CO₃ (100 mg, 0.3 mmol, 6.0 equiv.) were added to a flame-dried test tube equipped with a stir bar. The test tube was evacuated and backfilled with argon three times. Then dried dioxane (0.5 mL) was added into the tube. Then the tube was purged with a gentle stream of argon for 10 seconds, then sealed and stirred at room temperature in 450-nm photoreactor for 24 hours. Next, the reaction mixture was quenched with water (1.0 mL) and extracted with diethyl ether (1.0 mL) three times. The combined organic layers were dried over Na₂SO₄, filtered through Celite, concentrated under reduced pressure, and purified by pTLC (hexanes:diethyl ether, 10:1) on silica gel to obtain 8.1 mg (52%) of the desired coupling product 96. (Primer et al., 2016)

Physical State: colorless oil.

¹H NMR (600 MHz, CDCl₃): δ 7.81-7.77 (m, 2H), 7.35-7.29 (m, 2H), 7.29-7.23 (m, 3H), 7.21-7.16 (m, 2H), 3.52 (d, J=6.7 Hz, 1H), 3.02 (s, 3H), 2.35 (dd, J=9.8, 2.8 Hz, 1H), 2.05 (dd, J=9.8, 1.8 Hz, 1H), 2.02 (dd, J=6.8, 2.8 Hz, 1H), 2.00-1.94 (m, 1H), 1.37 (s, 3H) ppm.

¹³C NMR (151 MHz, CDCl₃): δ 146.42, 139.35, 138.05, 129.76, 128.53, 127.08, 126.83, 126.59, 65.08, 55.55, 47.75, 45.40, 44.68, 39.71, 16.71 ppm.

HRMS (ESI-TOF): calc'd for C₁₉H₂₀O₂S [M+H]⁺: 313.1257, found: 313.1258.

TLC: R_{f}=0.58 (2:1 hexanes:ethyl acetate).

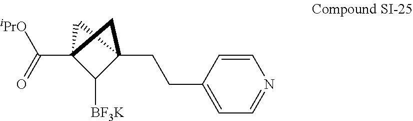

### isopropyl 3-(2-(pyridin-4-yl)ethyl)-2-(trifluoro-24-boraneyl)bicyclo[1.1.1]pentane-1-carboxyl-ate, potassium salt (SI-25)

BCP boronate 54 (385 mg, 1.0 mmol) was suspended in methanol (5 mL), and a saturated aqueous solution of KHF₂ (1 mL, 4 mmol) was added dropwise. The suspended solution was stirred at room temperature for 2 hours and then concentrated to dryness. The residue was extracted with hot acetone (3×40 mL), and the combined filtered extracts were concentrated. Methylene chloride was added, and the resultant precipitate was collected and dried to afford the 274 mg (75%) of the potassium trifluoroborate SI-25.

Physical State: white solid.

m.p.: >200° C.

¹H NMR (600 MHz, DMSO-d₆): δ 8.42-8.38 (m, 2H), 7.20-7.16 (m, 2H), 4.75 (hept, J=6.3 Hz, 1H), 2.54-2.50 (m, 2H), 2.44 (d, J=9.3 Hz, 1H), 1.69 (td, J=7.2, 1.6 Hz, 2H), 1.57 (s, 1H), 1.53 (d, J=9.3 Hz, 1H), 1.44 (d, J=7.9 Hz, 1H), 1.22 (dq, J=10.3, 5.3 Hz, 1H), 1.10 (d, J=6.3 Hz, 6H) ppm.

¹³C NMR (151 MHz, DMSO-d₆): δ 170.87, 151.89, 149.37, 123.89, 65.80, 55.34, 46.90, 40.94, 31.96, 31.65, 21.79, 21.76 ppm.

¹⁹F NMR (376 MHz, DMSO-d₆): δ −133.29 ppm.

¹¹B NMR (128 MHz, DMSO-d₆): δ 2.99 ppm.

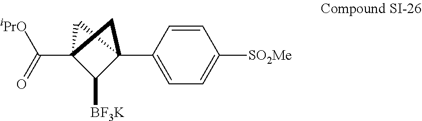

### isopropyl 3-(4-(methylsulfonyl)phenyl)-2-(trifluoro-14-boraneyl)bicyclo[1.1.1]pentane-1-carboxylate, potassium salt (SI-26)

BCP boronate 56 (217 mg, 0.5 mmol) was suspended in methanol (3 mL), and a saturated aqueous solution of KHF₂ (0.7 mL, 2.8 mmol) was added dropwise. The suspended solution was stirred at room temperature for 2 hours and then concentrated to dryness. The residue was extracted with hot acetone (3×10 mL), and the combined filtered extracts were concentrated. Methylene chloride was added, and the resultant precipitate was collected and dried to afford the 147 mg (71%) of the potassium trifluoroborate SI-26.

Physical State: white solid.

m.p.: >200° C.

¹H NMR (600 MHz, DMSO-d₆): δ 7.79-7.75 (m, 2H), 7.50-7.45 (m, 2H), 4.83 (hept, J=6.3 Hz, 1H), 3.14 (s, 3H), 2.91 (d, J=9.2 Hz, 1H), 2.06 (s, 1H), 2.01 (d, J=9.2 Hz, 1H), 1.88 (d, J=7.9 Hz, 1H), 1.64 (dq, J=10.1, 5.2 Hz, 1H), 1.15 (d, J=6.2 Hz, 6H) ppm.

¹³C NMR (151 MHz, DMSO-d₆): δ 170.71, 148.80, 138.11, 127.59, 126.53, 66.17, 56.94, 48.83, 43.84, 42.87, 21.79, 21.76 ppm.

¹⁹F NMR (376 MHz, DMSO-d₆): δ −133.31 ppm.

¹¹B NMR (128 MHz, DMSO-d₆): δ 2.57 ppm.

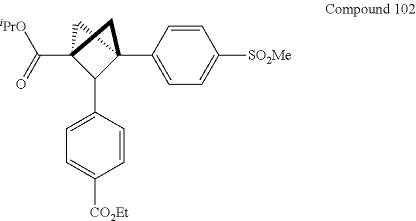

### isopropyl 2-(4-(ethoxycarbonyl)phenyl)-3-(4-(methylsulfonyl)phenyl)bicyclo[1.1.1]pentane-1-carboxylate (102)

On the benchtop, BCP BF₃K SI-26 (20.1 mg, 0.05 mmol, 1.0 equiv.), ethyl 4-bromobenzoate (49 mL, 0.3 mmol, 6.0 equiv.), (Ir[dF(CF₃)ppy]₂(dtbbpy))PF₆ (2.8 mg, 0.0025 mmol, 0.05 equiv.), Ni(dtbbpy)Cl₂ (4.0 mg, 0.01 mmol, 0.20 equiv.) and Cs₂CO₃ (100 mg, 0.3 mmol, 6.0 equiv.) were added to a flame-dried test tube equipped with a stir bar. The test tube was evacuated and backfilled with argon three times. Then dried THF (0.5 mL) was added into the tube. Then the tube was purged with a gentle stream of argon for 10 seconds, then sealed and stirred at room temperature in 450-nm photoreactor for 24 hours. Next, the reaction mixture was quenched with water (1.0 mL) and extracted with diethyl ether (1.0 mL) three times. The combined organic layers were dried over Na₂SO₄, filtered through Celite, concentrated under reduced pressure, and purified by pTLC (hexanes:diethyl ether, 2:1) on silica gel to obtain 4.1 mg (18%) of the desired coupling product 102. (Primer et al., 2016)

Physical State: colorless oil.

¹H NMR (600 MHz, CDCl₃): δ 7.92 (d, J=3.0 Hz, 2H), 7.90 (d, J=2.9 Hz, 2H), 7.35 (d, J=8.3 Hz, 2H), 7.09 (d, J=8.2 Hz, 2H), 5.11 (hept, J=6.3 Hz, 1H), 4.35 (q, J=7.1 Hz, 2H), 4.03 (d, J=6.7 Hz, 1H), 3.07 (s, 3H), 2.76 (dd, J=9.6, 2.9 Hz, 1H), 2.51 (dd, J=9.6, 1.8 Hz, 1H), 2.40 (dd, J=6.8, 2.8 Hz, 1H), 2.35 (d, J=1.8 Hz, 1H), 1.36 (t, J=7.1 Hz, 3H), 1.30 (d, J=4.1 Hz, 3H), 1.29 (d, J=4.0 Hz, 3H) ppm.

¹³C NMR (151 MHz, CDCl₃): δ 168.86, 166.52, 144.42, 142.00, 139.50, 129.51, 129.18, 128.66, 127.84, 127.79, 68.73, 67.51, 61.10, 53.78, 47.12, 45.07, 44.67, 41.09, 21.98, 21.96, 14.45 ppm.

HRMS (ESI-TOF): calc'd for C₂₅H₂₈O₆S [M+H]⁺: 457.1679, found: 457.1677.

TLC: R_{f}=0.35 (2:1 hexanes:ethyl acetate).

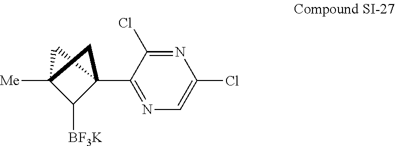

### 3,5-dichloro-2-(3-methyl-2-(trifluoro-24-boraneyl)bicyclo[1.1.1]pentan-1-yl)pyrazine, potassium salt (SI-27)

BCP boronate 77 (355 mg, 1.0 mmol) was suspended in methanol (5 mL), and a saturated aqueous solution of KHF₂ (1 mL, 4 mmol) was added dropwise. The suspended solution was stirred at room temperature for 2 hours and then concentrated to dryness. The residue was extracted with hot acetone (3×20 mL), and the combined filtered extracts were concentrated. Methylene chloride was added, and the resultant precipitate was collected and dried to afford the 245 mg (73%) of the potassium trifluoroborate SI-27.

Physical State: white solid.

m.p.: >200° C.

¹H NMR (600 MHz, Acetone-d⁶): δ 8.52 (s, 1H), 2.82 (d, J=9.5 Hz, 1H), 2.09 (dd, J=9.7, 2.6 Hz, 1H), 1.88 (t, J=6.3 Hz, 2H), 1.80 (dq, J=11.2, 5.8 Hz, 1H), 1.19 (s, 3H) ppm.

¹³C NMR (151 MHz, Acetone-d⁶): δ 154.86, 146.56, 143.79, 142.24, 58.90, 50.70, 43.69 (d, J=3.3 Hz), 39.67 (d, J=2.8 Hz), 18.61 ppm.

¹⁹F NMR (376 MHz, Acetone-d⁶): δ −136.10 ppm.

¹¹B NMR (128 MHz, Acetone-d₆): δ 3.63 ppm.

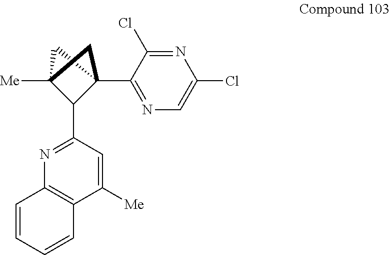

### 2-(1-(3,5-dichloropyrazin-2-yl)-3-methylbicyclo[1.1.1]pentan-2-yl)-4-methylquinoline (103)

A screw-capped culture tube was charged with BCP BF₃K SI-27 (31.9 mg, 0.1 mmol, 1.0 equiv.), lepidine (40 mL, 0.3 mmol, 3.0 equiv.) and Mn(OAc)₃·2H₂O (80.4 mg, 0.3 mmol, 3.0 equiv.). Then the tube was evacuated and backfilled with argon three times, followed by addition of acetic acid/water (1.0 mL, 0.1 M, 1:1) solvent via a syringe. Next, trifluoroacetic acid (23 mL, 0.5 mmol, 5.0 equiv.) was added into the reaction. Then the headspace of the tube was purged with a gentle stream of argon for approximately 10 seconds and the reaction was stirred at 50° C. for 18 hours. Then the reaction mixture was concentrated under high vacuum to remove excess acetic acid, quenched with Na₂CO₃ solution, extracted with ethyl acetate, dried with Na₂SO₄, and concentrated under high vacuum. The crude residue was purified by pTLC (hexanes:diethyl ether, 5:1) on silica gel to obtain 11.0 mg (30%) of the desired coupling product 103. (Molander et al., 2011)

Physical State: pale yellow solid.

m.p.: 49-51° C.

¹H NMR (600 MHz, CDCl₃): δ 8.47 (s, 1H), 7.92 (dd, J=8.4, 1.3 Hz, 1H), 7.85 (d, J=8.5 Hz, 1H), 7.62 (t, J=7.7 Hz, 1H), 7.48 (t, J=7.6 Hz, 1H), 6.95 (s, 1H), 4.08 (d, J=6.8 Hz, 1H), 2.73 (dd, J=9.8, 2.8 Hz, 1H), 2.62 (s, 3H), 2.42 (dd, J=9.8, 1.5 Hz, 1H), 2.26 (dd, J=6.9, 2.8 Hz, 1H), 2.12 (s, 1H), 1.49 (s, 3H) ppm.

¹³C NMR (151 MHz, CDCl₃): δ 158.81, 150.73, 147.81, 146.56, 144.83, 143.60, 141.63, 130.08, 128.97, 126.91, 125.78, 123.64, 121.85, 68.15, 53.90, 49.43, 44.81, 18.98, 16.66 ppm. MS (GCMS, EI): m/z=370 (21%), 368 (32%), 366 (29%), 243 (35%), 205 (75%), 51 (100%).

TLC: R_{f}=0.55 (5:1 hexanes:ethyl acetate).

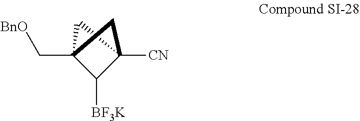

### 3-((benzyloxy)methyl)-2-(trifluoro-2′-boraneyl)bicyclo[1.1.1]pentane-1-carbonitrile, potassium salt (SI-28)

BCP boronate 42 (678 mg, 2.0 mmol) was suspended in methanol (10 mL), and a saturated aqueous solution of KHF₂ (2 mL, 8 mmol) was added dropwise. The suspended solution was stirred at room temperature for 2 hours and then concentrated to dryness. The residue was extracted with hot acetone (3×30 mL), and the combined filtered extracts were concentrated. Methylene chloride was added, and the resultant precipitate was collected and dried to afford the 517 mg (81%) of the potassium trifluoroborate SI-28.

Physical State: white solid.

m.p.: 122-124° C.

¹H NMR (600 MHz, Acetone-d⁶): δ 7.35-7.29 (m, 4H), 7.28-7.21 (m, 1H), 4.49 (d, J=12.2 Hz, 1H), 4.45 (d, J=12.3 Hz, 1H), 3.50 (d, J=10.8 Hz, 1H), 3.42 (d, J=10.9 Hz, 1H), 2.85 (d, J=9.2 Hz, 1H), 2.09 (s, 1H), 1.95 (d, J=8.1 Hz, 1H), 1.91 (d, J=9.3 Hz, 1H), 1.59 (dq, J=10.2, 5.2 Hz, 1H) ppm.

¹³C NMR (151 MHz, Acetone-d⁶): δ 140.18, 128.92, 128.11, 127.92, 120.54, 73.12, 70.53, 57.40, 51.52, 45.32 (q, J=2.2 Hz), 26.47 (q, J=3.4 Hz) ppm.

¹⁹F NMR (376 MHz, Acetone-d⁶): δ −137.30 ppm.

¹¹B NMR (128 MHz, Acetone-d₆): δ 2.94 (q, J=62.8 Hz) ppm.

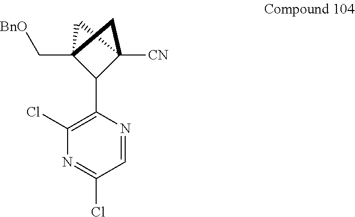

### 3-((benzyloxy)methyl)-2-(3,5-dichloropyrazin-2-yl)bicyclo[1.1.1]pentane-1-carbonitrile (104)

A screw-capped culture tube was charged with BCP BF₃K SI-28 (31.9 mg, 0.1 mmol, 1.0 equiv.), 2,6-dichloropyrazine (44.7 mg, 0.3 mmol, 3.0 equiv.) and Mn(OAc)₃·2H₂O (80.4 mg, 0.3 mmol, 3.0 equiv.). Then the tube was evacuated and backfilled with argon three times, followed by addition of acetic acid/water (1.0 mL, 0.1 M, 1:1) solvent via a syringe. Next, trifluoroacetic acid (23 mL, 0.5 mmol, 5.0 equiv.) was added into the reaction. Then the headspace of the tube was purged with a gentle stream of argon for approximately 10 seconds and the reaction was stirred at 50° C. for 18 hours. Then the reaction mixture was concentrated under high vacuum to remove excess acetic acid, quenched with K₂CO₃ solution, extracted with ethyl acetate, dried with Na₂SO₄, and concentrated under high vacuum. The crude residue was purified by pTLC (hexanes:diethyl ether, 5:1) on silica gel to obtain 9.3 mg (28%) of the desired coupling product 104. (Molander et al., 2011)

Physical State: colorless oil.

¹H NMR (600 MHz, CDCl₃): δ 8.51 (s, 1H), 7.36-7.26 (m, 3H), 7.23-7.18 (m, 2H), 4.48 (d, J=12.0 Hz, 1H), 4.41 (d, J=11.9 Hz, 1H), 3.92 (d, J=6.4 Hz, 1H), 3.63 (d, J=10.7 Hz, 1H), 3.59 (d, J=10.7 Hz, 1H), 2.80 (dd, J=9.7, 3.1 Hz, 1H), 2.33 (dd, J=9.8, 2.3 Hz, 1H), 2.29 (d, J=2.3 Hz, 1H), 2.25 (dd, J=6.5, 3.1 Hz, 1H) ppm.

¹³C NMR (151 MHz, CDCl₃): δ 148.50, 148.32, 146.22, 141.56, 137.80, 128.53, 127.96, 127.77, 116.76, 73.51, 67.83, 64.18, 51.67, 50.03, 48.17, 28.12 ppm.

HRMS (ESI-TOF): calc'd for C₁₈H₁₅C₂N₃O [M+H]⁺: 360.0665, found: 360.0671.

TLC: R_{f}=0.36 (5:1 hexanes:ethyl acetate).

### E. Optimization of Synthesis and Functionalizations of BCP Bisboronates

Scheme 13: Optimization of Synthesis of BCP BisBoronates

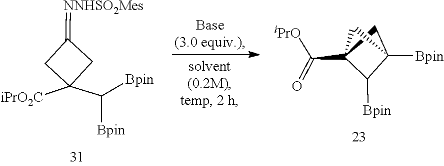

| base | solvent | temp | Yield^{a} |
|---|---|---|---|
| Cs₂CO₃^{b} | dioxane | 100° C. | 66% |
| NaH | benzene | 100° C. | 56% |
| Cs₂CO₃ | toluene | 100° C. | 37% |
| Cs₂CO₃ | benzene | 80° C. | 20% |
| Cs₂CO₃ | dioxane | 80° C. | 28% |
| NaH | toluene | 80° C. | 57% |
| Cs₂CO₃ | toluene | 80° C. | 40% |
| K₂CO₃^{b} | dioxane | 100° C. | 50% |
| Cs₂CO₃ | dioxane | 100° C. | 61% |

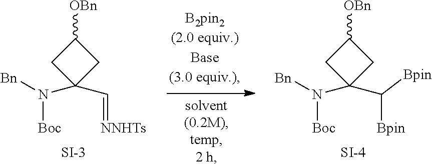

| base | solvent | temp | Yield^{a} |
|---|---|---|---|
| Cs₂CO₃^{b} | dioxane | 100° C. | <10% |
| Cs₂CO₃^{b} | toluene | 100° C. | <10% |
| NaH | toluene | 80° C. | 38% |
| NaH | benzene | 80° C. | <10% |
| K₃PO₄ | dioxane | 80° C. | <10% |
| K₂CO₃ | dioxane | 80° C. | <10% |
| NaH | toluene | 70° C. | 40% |
| NaH | toluene | 75° C. | 50% |
| NaH | toluene | 90° C. | 19% |

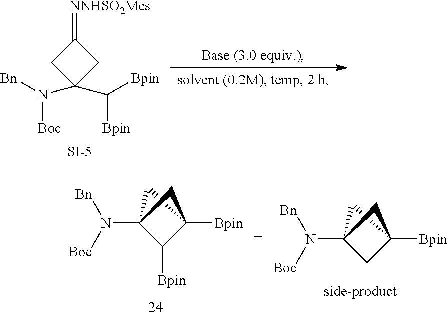

| base | solvent | temp | yield of 24^{a} | side-product^{a} |
|---|---|---|---|---|
| Cs₂CO₃^{b} | dioxane | 100° C. | 30% | 29% |
| Cs₂CO₃^{b} | toluene | 100° C. | 26% | 56% |
| NaH | toluene | 100° C. | 41% | 28% |
| Cs₂CO₃^{b} | benzene | 100° C. | 19% | 63% |
| NaH | dioxane | 80° C. | 46% | 25% |
| K₂CO₃ | dioxane | 100° C. | 35% | 20% |
| Cs₂CO₃^{c} | dioxane | 100° C. | 22% | 57% |
| K₂CO₃^{b} | dioxane | 100° C. | 65% | trace |

Note:
^{a}Yield determined by ¹H NMR analysis with trimethoxybenzene as an internal standard;
^{b}The base was dried at 120° C. for 18 hours;
^{c}99.995% from Sigma-aldrich.

TABLE S4
Optimization of cyanation of BCP 25

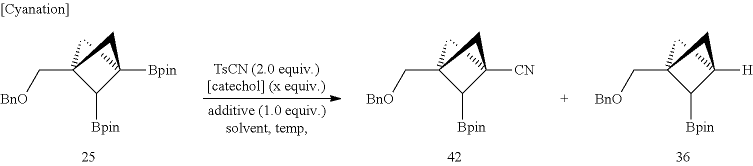

| Entry | [catechol] | x | additive | solvent | temp | 42^{a} | 36^{a} |
|---|---|---|---|---|---|---|---|
| 1 | TBC | 0.5 | none | toluene | 100° C. | 45% | 23% |
| 2 | catechol | 0.5 | none | toluene | 100° C. | 36% | 12% |
| 3 | 4-Cl catechol | 0.5 | none | toluene | 100° C. | 37% | 35% |
| 4 | TBC | 0.5 | DMPU | toluene | 100° C. | 36% | 21% |
| 5 | TBC | 0.5 | MeOH | toluene | 100° C. | 30% | 16% |
| 6 | TBC | 0.5 | MeOD | toluene | 100° C. | 33% | 10% |
| 7 | TBC | 0.5 | H₂O | toluene | 100° C. | 33% | 12% |
| 8 | TBC | 0.5 | none | toluene | r.t. | 33% | 17% |
| 9 | TBC | 0.5 | none | toluene | 40° C. | 39% | 29% |
| 10 | TBC | 0.5 | none | toluene | 70° C. | 48% | 29% |
| 11 | TBC | 0.5 | none | toluene | 120° C. | 38% | 15% |
| 12 | TBC | 1.0 | none | toluene | 100° C. | 26% | 20% |
| 13 | TBC | 2.0 | none | toluene | 100° C. | 16% | 25% |
| 14 | TBC | 0.2 | none | toluene | 100° C. | 49% | 7% |
| 15 | TBC | 0.01 | none | toluene | 70° C. | 23% | 3% |
| 16 | TBC | 0.05 | none | toluene | 70° C. | 43% | 5% |
| 17 | TBC | 0.1 | none | toluene | 70° C. | 43% | 10% |
| 18 | TBC | 0.2 | none | toluene | 70° C. | 60% | 6% |
| 19 | TBC | 0.2 | none | benzene | 70° C. | 50% | 13% |
| 20 | TBC | 0.2 | none | DCE | 70° C. | 34% | <5% |
| 21 | TBC | 0.2 | none | dioxane | 70° C. | 0% | 0% |
| 22 | TBC | 0.2 | none | THF | 70° C. | 0% | 0% |
| 23 | TBC | 0.2 | pyrogallol | toluene | 70° C. | 32% | 23% |
| 24 | TBC | 0.2 | guaiacol | toluene | 70° C. | 70% | 6% |
| 25 | TBC | 0.2 | 1,2-naphthoquinone | toluene | 70° C. | 43% | 9% |
| 26 | TBC | 0.2 | 1,4-naphthoquinone | toluene | 70° C. | 36% | 10% |
| 27 | TBC | 0.2 | B(OMe)₃^{b} | toluene | 70° C. | 41% | 7% |
| 28 | TBC | 0.2 | B(OMe)₃^{c} | toluene | 70° C. | 29% | 10% |
| 29 | TBC | 0.2 | MeOBcat | toluene | 70° C. | 60% | 3% |
| 30 | TBC | 0.2 | TMSOTf | toluene | 70° C. | 50% | 3% |

Note:
^{a}Yield determined by 1H NMR analysis with trimethoxybenzene as an internal standard; ^{b}B(OMe)₃ (0.1 equiv.); ^{c}B(OMe)₃ (0.5 equiv).

Scheme 14: Optimization of 1^{st} functionalization of BCP BisBoronates

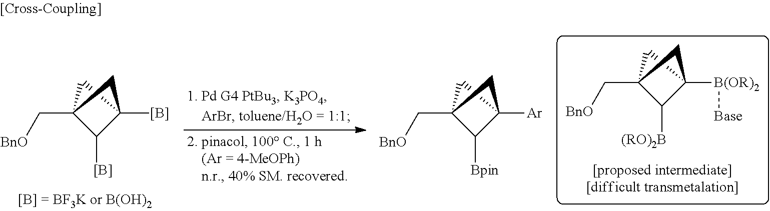

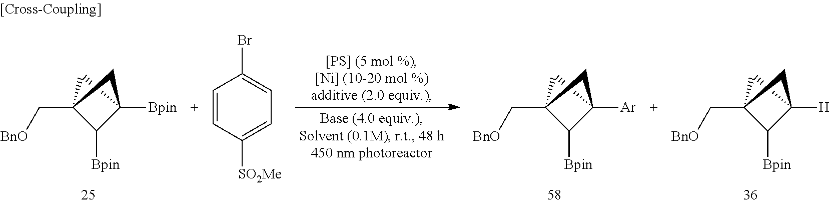

| Entry | [PS] | [Ni] | additive | Base | solvent | 58^{a} | 36^{a} | 25^{a} |
|---|---|---|---|---|---|---|---|---|
| 1 | [Ir] | Ni(dtbbpy)Cl₂ | none | DMAP | DMA | 0% | 0% | main |
| 2 | [Ir] | Ni(dtbbpy)Cl₂ | ZnBr₂ | DMAP | DMA | 25% | 6% | 10% |
| 3 | [Ir] | Ni(dtbbpy)Cl₂ | ZnBr₂ | DMAP | DMSO | 0% | 0% | 0% |
| 4 | [Ir] | Ni(dtbbpy)Cl₂ | ZnBr₂ | DMAP | DMF | trace | 0% | 0% |
| 5 | [Ir] | Ni(dtbbpy)Cl₂ | ZnBr₂ | DMAP | dioxane | 0% | 0% | main |
| 6 | [Ir] | Ni(dtbbpy)Cl₂ | ZnBr₂ | DMAP | acetone | 0% | 10% | main |
| 7^{b} | [Ir] | Ni(dtbbpy)Cl₂ | ZnBr₂ | DMAP | DMA | 2% | 0% | 0% |
| 8 | [Ir] | NiBr₂.glyme + dtbbpy | ZnBr₂ | DMAP | DMA | 10% | 20% | trace |
| 9 | [Ir] | NiBr₂.glyme + dtbbpy^{c} | ZnBr₂ | DMAP | DMA | 14% | 23% | trace |
| 10 | [Ir] | NiBr₂.glyme + L₁ | ZnBr₂ | DMAP | DMA | 10% | 29% | trace |
| 11 | [Ir] | NiBr₂.glyme + L₂ | ZnBr₂ | DMAP | DMA | 10% | 15% | trace |
| 12 | [Ir] | NiBr₂.glyme + L₃ | ZnBr₂ | DMAP | DMA | 5% | 20% | trace |
| 13 | [Ir] | NiBr₂.glyme + L₄ | ZnBr₂ | DMAP | DMA | trace | 25% | trace |
| 14 | [Ir] | Ni(TMHD)₂ | ZnBr₂ | DMAP | DMA | 0% | 0% | trace% |
| 15 | [Ir] | Ni(dtbbpy)Cl₂ | ZnBr₂ | CsF | DMA | 17% | 24% | 10% |
| 16 | [Ir] | Ni(dtbbpy)Cl₂ | ZnBr₂ | PhONa | DMA | 22% | 13% | 7% |
| 17 | [Ir] | Ni(dtbbpy)Cl₂ | Zn(OTf)₂ | DMAP | DMA | 40% | 18% | 10% |
| 18 | [Ir] | Ni(dtbbpy)Cl₂ | Zn(ClO)₄.6H₂O | DMAP | DMA | 25% | 20% | 10% |
| 19 | [Ir] | Ni(dtbbpy)Cl₂ | In(OTf)₃ | DMAP | DMA | 23% | 13% | 38% |
| 20 | [Ir] | Ni(cod)₂ + dtbbpy | Zn(OTf)₂ | DMAP | DMA | 39% | 20% | trace |
| 21 | 4-CzlPn | Ni(dtbbpy)Cl₂ | Zn(OTf)₂ | DMAP | DMA | 50% | 22% | trace |
| 22 | Acr-Mes | Ni(dtbbpy)Cl₂ | Zn(OTf)₂ | DMAP | DMA | trace | 0% | 0% |

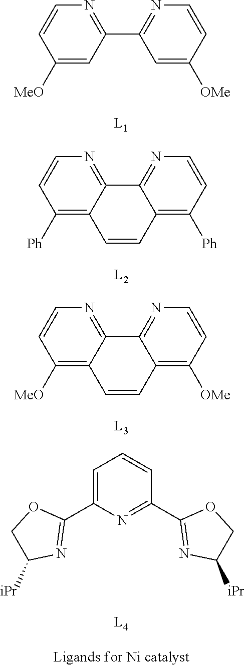 [SMILES: COc1ccnc(-c2cc(OC)ccn2)c1 ; c1ccc(-c2ccnc3c2ccc2c(-c4ccccc4)ccnc23)cc1 ; COc1ccnc2c1ccc1c(OC)ccnc12 ; CC(C)[C@@H]1COC(c2cccc(C3=N[C@H](C(C)C)CO3)n2)=N1]

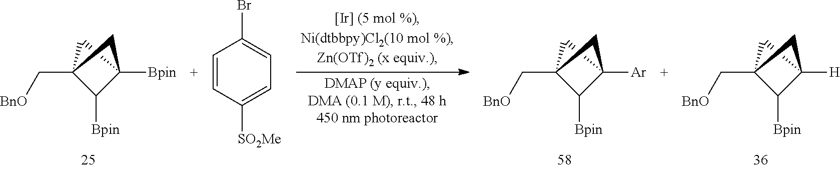

| x | y | 58^{a} | 36^{a} | 25^{a} |
|---|---|---|---|---|
| 0.5 | 4.0 | 7% | 11% | 56% |
| 1 | 4.0 | 25% | 13% | 20% |
| 4.0 | 4.0 | 22% | 21% | 20% |
| 2.0 | 2.0 | 21% | 20% | 13% |
| 2.0 | 3.0 | 33% | 19% | 16% |
| 2.0 | 4.0 | 50% | 22% | trace |

Note:
^{a}Yield determined by 1H NMR analysis with trimethoxybenzene as an internal standard;
^{b}The reaction was runned under light from 468-nm blue LED;
^{c}NiBr₂.glyme:dtbbpy = 1:2
^{d}[Ir] = [Ir(dF(CF₃)ppy)₂(dtbpy)]PF₆; dtbbpy = 4,4′-Di-tert-butyl-2,2′-dipyridyl.

Scheme 15: Optimization of 2^{nd} functionalization of BCP BisBoronates

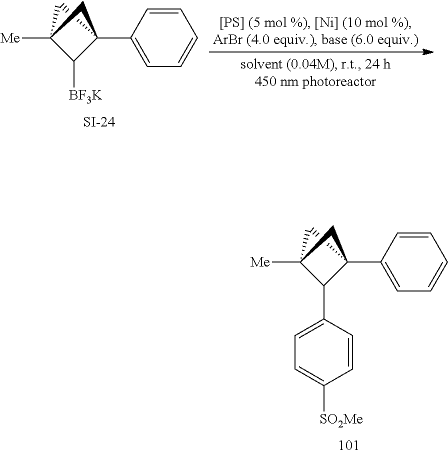

| Entry | [PS] | [Ni] | Base | solvent | Result^{a} |
|---|---|---|---|---|---|
| 1 | [Ir] | Ni(dtbbpy)Cl₂ | Cs₂CO₃ | Dioxane/DMA (4:1) | trace |
| 2 | [Ir] | Ni(TMHD)₂ | CS₂CO₃ | Dioxane/DMA (4:1) | n.d. |
| 3 | 4-CzIPn | Ni(dtbbpy)Cl₂ | Cs₂CO₃ | Dioxane/DMA (4:1) | n.d. |
| 4 | [Ir] | Ni(dtbbpy)Cl₂ | K₃PO₄ | Dioxane/DMA (4:1) | 40% yield |
| 5 | [Ir] | Ni(dtbbpy)Cl₂ | Cs₂CO₃ | Dioxane | 50% yield |
| 6 | [Ir] | Ni(dtbbpy)Cl₂ | Cs₂CO₃ | DMA | 23% yield |
| 7 | 4-CzIPn | Ni(TMHD)₂ | Cs₂CO₃ | Dioxane/DMA (4:1) | n.d. |

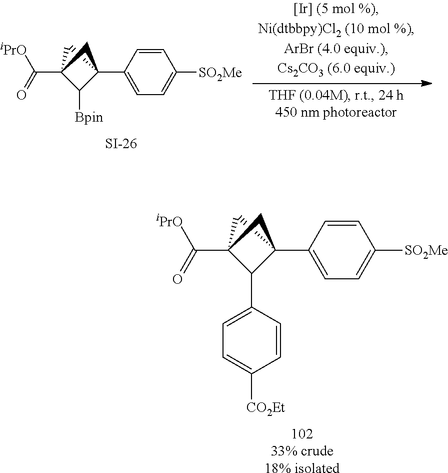

| Derivation from above | Result |
|---|---|
| dioxane in place of THF | 11% pdt + 23% deborylation |
| dioxane/DMA (5:1) in place of THF | 12% pdt + 20% deborylation |
| DMA in place of THF | n.d. |
| K₃PO₄ in place of Cs₂CO₃ | 0% pdt + 23% deborylation |
| K₂CO₃ in place of Cs₂CO₃ | n.d. |
| MeONa in place of Cs₂CO₃ | n.d. |
| Zn(OTf)₂ as additive | n.d. |
| ZnBr₂ as additive | n.d. |
| 4-CzIPn in place of [Ir] | n.d. |

Note:
^{a}Yield determined by ¹H NMR analysis with trimethoxybenzene as an internal standard;
^{b}[Ir] = [Ir(dF(CF₃)ppy)₂(dtbpy)]PF₆; dtbbpy = 4,4′-Di-tert-butyl-2,2′-dipyridyl.

Scheme 16: Optimization of C2 control of 1^{st} Functionalization of BCP Boronates

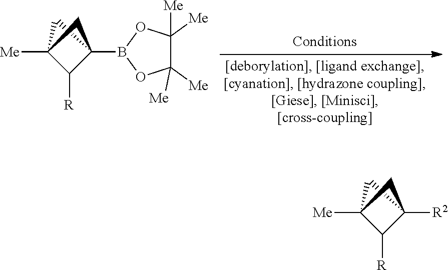

| Conditions | R | pdt/% | SM/% |
|---|---|---|---|
| TBC, C₆D₆, | R = cPent | 17 | 63 |
| 100° C., 5 h | Bpin | 63 | 23 |
| [deborylation] | | | |
| 1,8-diamino- | R = cPent | 7 | 85 |
| naphthalene, | Bpin | 60 | 28 |
| toluene, 100° C., 12 h | | | |
| [ligand exchange] | | | |
| sulfonyl hydrazone | R = cPent | 14 | 80 |
| Cs₂CO₃, toluene, | Bpin | 42 | 23 |
| 70° C., 48 h | | | |
| [hydrazone coupling] | | | |
| TsCN, TBC, | R = cPent | 0 | 78 |
| toluene, 70° C., 16 h | Bpin | 50 | 30 |
| [cyanation] | | | |
| [Ir], DMAP, MVK, | R = cPent | 0 | 54 |
| acetone/MeOH, 450 nm hv | Bpin | 26 | 44 |
| [Giese] | | | |
| 2,6-diClpyrazine | R = cPent | 52 | 0 |
| Mn(OAc)₃, TFA, | Bpin | 52 | 0 |
| AcOH/H₂O, 50° C., 18 h | | | |
| [Minisci] | | | |
| [Ir], [Ni], 4-CF₃PhBr | R = cPent | 20 | 40 |
| Zn(OTf)₂, DMAP, | Bpin | 40 | 0 |
| DMA, 450 nm hv, 24 h | | | |
| [cross-coupling] | | | |

### REFERENCES

The following references to the extent that they provide exemplary procedural or other details supplementary to those set forth herein, are specifically incorporated herein by reference.
WO 2010/085528A1
Anderson, Practical Process Research & Development—A Guide for Organic Chemists, 2^{nd} ed., Academic Press, New York, 2012.
André-Joyaux et al., Angew. Chem. Int. Ed., 59:13859-64, 2020.
Denisenko et al., Angew. Chem. Int. Ed., 59:20515-21, 2020.
Fawcett, A. et al., Angew. Chem., Int. Ed., 55:14663-67, 2016.
Gutierrez et al., J. Am. Chem. Soc., 137:4896-99, 2015.
Handbook of Pharmaceutical Salts: Properties, and Use, Stahl and Wermuth Eds., Verlag Helvetica Chimica Acta, 2002.
Hazrati & Oestreich, Org. Lett., 20:5367-69, 2018.
Jarret et al., Tetrahedron Lett., 31:171-74, 1990.
Joseph et al., Angew. Chem. Int. Ed., 60:24754-69, 2021.
JosienJohn et al., WO2010085528A1, 2010.
Kaiser et al., J. Am. Chem. Soc., 141:14104-09, 2019.
Katayev et al., Org. Lett., 17:5898-01, 2015.
Kim et al., Angew. Chem. Int. Ed., 59:8225-31, 2020.
Kondo et al., Angew. Chem. Int. Ed., 59:1970-74, 2020.
Li et al., Angew. Chem. Int. Ed., 51:2943-46, 2012.
Lima et al., Angew. Chem. Int. Ed., 56:15136-40, 2017.
Lima et al., Angew. Chem. Int. Ed., 55:14085-89, 2016.
Lima et al., Chem. Commun., 54:5606-09, 2018.
Ma et al., Org. Lett., 22:9133-38, 2020.
Mlynarski et al., Nature, 505:386-90, 2014.
Molander et al., Org. Lett., 13:1852-55, 2011.
Mousseau et al., ACS Catal., 12:600-06, 2022.
Nóvoa et al., Angew. Chem., Int. Ed., 60:11763-68, 2021.
Nykaza et al., J. Am. Chem. Soc., 140:15200-05, 2018.
Odachowski et al., J. Am. Chem. Soc., 138:9521-32, 2016.
Pozzi et al., J. Am. Chem. Soc., 127:14204-05, 2005.
Primer et al., J. Am. Chem. Soc., 139:9847-50, 2017.
Renaud et al., Angew. Chem. Int. Ed., 59:13859-64, 2020.
Sadhu & Matteson, Organometallics, 4:1687-89, 1985.
Tellis et al., Science, 345:433-36, 2014.
Wiberg & Williams, J. Org. Chem., 35:369-73, 1970.
Wiberg et al., J. Org. Chem., 58(6):1372-1376, 1993.
Yang et al. J. Am. Soc. Chem, 143:471-80, 2021a.
Yang et al., Angew. Chem., Int. Ed., 50:3904-07, 2011.
Yang, Y.; et al. Nat. Chem., 13:950-55, 2021b.
Yuan et al., J. Am. Chem. Soc., 142:7225-34, 2020.
Zhao et al., Proc. Natl. Acad. Sci., USA 118:e2108881118, 2021.

What is claimed is:

1. A method of preparing a compound comprising reacting a compound of the formula: 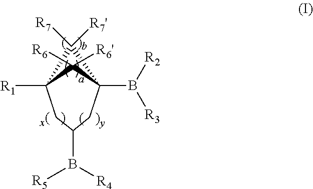
wherein:
a and b are each independently selected from 0, 1, 2, or 3;
x and y are each independently selected from 0, 1, 2, or 3;
R₁ is an organic moiety;
R₂, R₃, R₄, and R₅ are each hydroxy or R₂ and R₃ are taken together to form a B-containing heterocycloalkyl_{(C<12)} or substituted B-containing heterocycloalkyl_{(C≤12)}; and
R₆, R₆′, R₇, and R₇′ are each independently hydrogen, alkyl_{(C≤12)}, or substituted alkyl_{(C≤12)};
with a reactive compound to form a monoboronated compound of the formula: 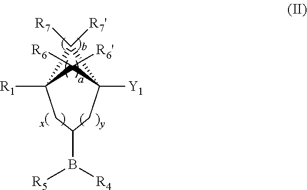
wherein:
a and b are each independently selected from 0, 1, 2, or 3;
x and y are each independently selected from 0, 1, 2, or 3;
R₁ is an organic moiety;
R₂, R₃, R₄, and R₅ are each hydroxy or R₂ and R₃ are taken together to form a B-containing heterocycloalkyl_{(C≤12)} or substituted B-containing heterocycloalkyl_{(C≤12)};
R₆, R₆′, R₇, and R₇′ are each independently hydrogen, alkyl_{(C≤12)}, or substituted alkyl_{(C≤12)}; and
Y₁ is hydrogen or an organic moiety.

2. The method of claim 1, further comprising reacting the monoboronated compound of formula II with a second reactive compound to form a compound of the formula: 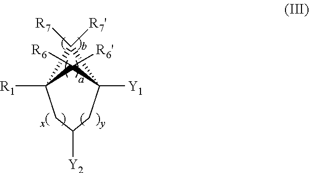
wherein:
a and b are each independently selected from 0, 1, 2, or 3;
x and y are each independently selected from 0, 1, 2, or 3;
R₁ is an organic moiety;
R₂, R₃, R₄, and R₅ are each hydroxy or R₂ and R₃ are taken together to form a B-containing heterocycloalkyl_{(C≤12)} or substituted B-containing heterocycloalkyl_{(C≤12)};
R₆, R₆′, R₇, and R₇′ are each independently hydrogen, alkyl_{(C≤12)}, or substituted alkyl_{(C≤12)}; and
Y₁ and Y₂ are each independently hydrogen or an organic moiety.

3. The method of either claim 1 or claim 2, wherein the reactive compound is a catechol.

4. The method of claim 3, wherein the catechol is tert-butylcatechol.

5. The method of either claim 3 or claim 4, wherein Y₁ is hydrogen.

6. The method according to any one of claims 1-4, wherein the method further comprises a coupling partner.

7. The method of claim 6, wherein the coupling partner is a cyanide source.

8. The method of claim 7, wherein the cyanide source is tosyl cyanide.

9. The method of claim 6, wherein the coupling partner is a sulfur source.

10. The method of claim 9, wherein the sulfur source comprises a S—S bond.

11. The method of either claim 9 or claim 10, wherein the sulfur source is a sulfonothioic acid.

12. The method of claim 11, wherein the sulfur source is an S-phenyl ester of benzenesulfonothioic acid.

13. The method of claim 6, wherein the coupling partner is a nitrogen source.

14. The method of claim 13, wherein the nitrogen source comprises an azodicarboxylate group.

15. The method of claim 14, wherein the nitrogen source is di-tert-butyl azodicarboxylate or di-isopropyl azodicarboxylate.

16. The method of either claim 1 or claim 2, wherein the reactive compound is a hydrazone.

17. The method of claim 16, wherein the hydrazone further comprises an alkylsulfonyl_{(C≤12)}, arylsulfonyl_{(C≤12)}, or a substituted version of either group.

18. The method of either claim 16 or claim 17, wherein the hydrazone further comprises a group of the formula:
CRₐRₐ′═
wherein:
Rₐ and Rₐ′ are each hydrogen, alkyl_{(C<12)}, cycloalkyl_{(C<12)}, alkenyl_{(C<12)}, cycloalkenyl_{(C≤12)}, alkynyl_{(C≤12)}, cycloalkynyl_{(C≤12)}, aryl_{(C≤12)}, heteroaryl_{(C≤12)}, heterocycloalkyl_{(C≤12)}, alkoxy_{(C≤12)}, aryloxy_{(C≤12)}, aralkoxy_{(C≤12)}, acyl_{(C≤12)}, alkylamino_{(C≤12)}, dialkylamino_{(C≤12)}, alkylsulfonyl_{(C≤12)}, arylsulfonyl_{(C≤12)}, or a substituted version of any of these groups.

19. The method according to any one of claims 16-18, wherein the hydrazone is further defined as: 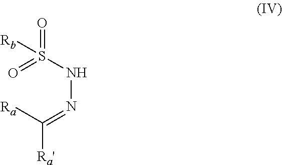
wherein:
Rₐ and Rₐ′ are each hydrogen, alkyl_{(C≤12)}, cycloalkyl_{(C≤12)}, alkenyl_{(C≤12)}, cycloalkenyl_{(C≤12)}, alkynyl_{(C≤12)}, cycloalkynyl_{(C≤12)}, aryl_{(C≤12)}, heteroaryl_{(C≤12)}, heterocycloalkyl_{(C≤12)}, alkoxy_{(C≤12)}, aryloxy_{(C≤12)}, aralkoxy_{(C≤12)}, acyl_{(C≤12)}, alkylamino_{(C≤12)}, dialkylamino_{(C≤12)}, alkylsulfonyl_{(C≤12)}, arylsulfonyl_{(C≤12)}, or a substituted version of any of these groups; and
R_{b} is alkyl_{(C≤12)}, aryl_{(C≤12)}, or a substituted version thereof.

20. The method of either claim 1 or claim 2, wherein the reactive compound is a Michael acceptor.

21. The method of claim 20, wherein the Michael acceptor comprises a double bond.

22. The method of claim 21, wherein the double bond is attached to an electron withdrawing group.

23. The method according to any one of claims 20-22, wherein the electron withdrawing group is an oxo group, an ester group, an amide group, or a cyano group.

24. The method according to any one of claims 20-23, wherein the method further comprises a metal catalyst.

25. The method of claim 24, wherein the metal catalyst is iridium catalyst.

26. The method according to any one of claims 20-25, wherein the method further comprises exposing the compound to an energy source.

27. The method of claim 26, wherein the energy source is a radiation source.

28. The method of claim 27, wherein the radiation source is UV light.

29. The method of either claim 1 or claim 2, wherein reactive compound is an organic halide.

30. The method of claim 29, wherein the organic halide is an organic bromide.

31. The method of claim 30, wherein the organic halide is an aromatic bromide.

32. The method of claim 31, wherein the aromatic bromide is further defined as: R_{d}Br, wherein: aryl_{(C≤18)}, heteroaryl_{(C≤18)}, or a substituted version of either group.

33. The method of claim 30, wherein the organic bromide is an aliphatic bromide.

34. The method of claim 33, wherein the aliphatic bromide is further defined as: R_{d}Br, wherein: alkyl_{(C≤18)}, alkenyl_{(C≤18)}, alkynyl_{(C≤18)}, or a substituted version of any of these group.

35. The method according to any one of claims 1, 2, or 29-34, wherein the method further comprises a metal catalyst.

36. The method of claim 35, wherein the metal catalyst is a nickel metal catalyst.

37. The method according to any one of claims 1, 2, or 29-36, wherein the method further comprises a Lewis acid.

38. The method of claim 37, wherein the Lewis acid is a metal salt.

39. The method of claim 38, wherein the metal salt is a zinc salt.

40. The method of claim 39, wherein the zinc salt is zinc triflate.

41. The method according to any one of claims 1, 2, or 29-40, wherein the method further comprises a photocatalyst.

42. The method of claim 41, wherein the photocatalyst is capable of generating a radical.

43. The method of either claim 41 or claim 42, wherein the photocatalyst is an organic compound.

44. The method according to any one of claims 41-43, wherein the photocatalyst is a photoredox catalyst.

45. The method of claim 44, wherein the photoredox catalyst is an isophthalonitrile.

46. The method of claim 45, wherein the isophthalonitrile is 2,4,5,6-tetra(9H-carbazol-9-yl)isophthalonitrile.

47. The method according to any one of claims 1, 2, or 29-46, wherein the method further comprises exposing the compound to an energy source.

48. The method of claim 47, wherein the energy source is a radiation source.

49. The method of claim 48, wherein the radiation source is ultraviolet radiation.

50. The method of either claim 1 or claim 2, wherein reactive compound is a heteroarene_{(C≤18)} or a substituted heteroarene_{(C≤18)}.

51. The method according to any one of claims 1, 2, or 50, wherein the method further comprises a metal salt.

52. The method of claim 51, wherein the metal salt is a manganese salt.

53. The method of either claim 51 or claim 52, wherein the metal salt is a manganese(III) salt.

54. The method of claim 53, wherein the manganese(III) salt is Mn(OAc)₃.

55. The method according to any one of claims 1, 2, and 50-54, wherein the method further comprises an acid.

56. The method of claim 55, wherein the acid has a pKₐ of less than 5.

57. The method of claim 56, wherein the acid has a pKₐ of less than 0.

58. The method according to any one of claims 55-57, wherein the acid is an alkylcarboxylate_{(C≤8)} or a substituted alkylcarboxylate_{(C≤8)}.

59. The method of claim 58, wherein the acid is a substituted alkylcarboxylate_{(C≤8)}.

60. The method of claim 59, wherein the acid is trifluoroacetic acid.

61. The method according to any one of claims 2-60, wherein the second reactive compound is a peroxide.

62. The method according to any one of claims 2-60, wherein the second reactive compound is a base.

63. The method of claim 62, wherein the base is an organolithium compound.

64. The method of claim 63, wherein the organolithium compound is an alkyl lithium.

65. The method of claim 64, wherein the organolithium compound is nbutyllithium.

66. The method of claim 63, wherein the organolithium compound is an aromatic lithium.

67. The method of claim 66, wherein the aromatic lithium is an aryl lithium or a heteroaryl lithium.

68. The method of claim 67, wherein the aromatic lithium is phenyl lithium.

69. The method according to any one of claims 2-60 and 62, wherein the base is a metal carbonate.

70. The method of claim 69, wherein the base is an alkali metal carbonate.

71. The method of claim 70, wherein the base is CsCO₃.

72. The method according to any one of claims 2-60 and 62-71, wherein the second reactive compound is a carbon atom source.

73. The method of claim 72, wherein the carbon source is a dihaloalkane_{(C≤12)} or a substituted dihaloalkane_{(C≤12)}.

74. The method of claim 73, wherein the halogen atoms in the dihaloalkane_{(C≤12)} or the substituted dihaloalkane_{(C≤12)} are different.

75. The method of either claim 73 or claim 74, wherein the dihaloalkane_{(C≤12)} is bromoiodomethane.

76. The method according to any one of claims 2-60 and 62-71, wherein the second reactive compound is a cyanide source.

77. The method of claim 76, wherein the cyanide source is tosyl cyanide.

78. The method according to any one of claims 2-60 and 62-71, wherein the second reactive compound is a Michael acceptor.

79. The method of claim 78, wherein the Michael acceptor comprises a double bond.

80. The method of claim 79, wherein the double bond is attached to an electron withdrawing group.

81. The method according to any one of claims 78-80, wherein the electron withdrawing group is an oxo group, an ester group, an amide group, or a cyano group.

82. The method according to any one of claims 2-60 and 62-71, wherein the second reactive compound is a hydrazone.

83. The method of claim 82, wherein the hydrazone further comprises an alkylsulfonyl_{(C≤12)}, arylsulfonyl_{(C≤12)}, or a substituted version of either group.

84. The method of either claim 82 or claim 83, wherein the hydrazone further comprises a group of the formula:
CRₐRₐ′═
wherein:
Rₐ and Rₐ′ are each hydrogen, alkyl_{(C≤12)}, cycloalkyl_{(C≤12)}, alkenyl_{(C≤12)}, cycloalkenyl_{(C≤12)}, alkynyl_{(C≤12)}, cycloalkynyl_{(C≤12)}, aryl_{(C≤12)}, heteroaryl_{(C≤12)}, heterocycloalkyl_{(C≤12)}, alkoxy_{(C≤12)}, aryloxy_{(C≤12)}, aralkoxy_{(C≤12)}, acyl_{(C≤12)}, alkylamino_{(C≤12)}, dialkylamino_{(C≤12)}, alkylsulfonyl_{(C≤12)}, arylsulfonyl_{(C≤12)}, or a substituted version of any of these groups.

85. The method according to any one of claims 82-84, wherein the hydrazone is further defined as: 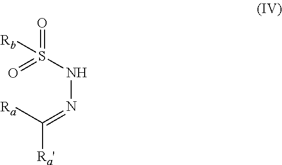
wherein:
Rₐ and Rₐ′ are each hydrogen, alkyl_{(C≤12)}, cycloalkyl_{(C≤12)}, alkenyl_{(C≤12)}, cycloalkenyl_{(C≤12)}, alkynyl_{(C≤12)}, cycloalkynyl_{(C≤12)}, aryl_{(C≤12)}, heteroaryl_{(C≤12)}, heterocycloalkyl_{(C≤12)}, alkoxy_{(C≤12)}, aryloxy_{(C≤12)}, aralkoxy_{(C≤12)}, acyl_{(C≤12)}, alkylamino_{(C≤12)}, dialkylamino_{(C≤12)}, alkylsulfonyl_{(C≤12)}, arylsulfonyl_{(C≤12)}, or a substituted version of any of these groups; and
R_{b} is alkyl_{(C≤12)}, aryl_{(C≤12)}, or a substituted version thereof.

86. The method according to any one of claims 2-60 and 62-71, wherein the second reactive compound is a nitroaromatic compound.

87. The method of claim 86, wherein the nitroaromatic compound is RₑNO₂, wherein Rₑ is aryl_{(C≤18)}, heteroaryl_{(C≤18)}, or a substituted version thereof.

88. The method according to any one of claims 2-60 and 62-71, wherein the second reactive compound is a nitrogen source.

89. The method of claim 88, wherein the nitrogen source comprises an azodicarboxylate group.

90. The method of claim 89, wherein the nitrogen source is di-tert-butyl azodicarboxylate or di-isopropyl azodicarboxylate.

91. The method according to any one of claims 2-60 and 62-71, wherein the second reactive compound is a heteroarene_{(C≤18)} or a substituted heteroarene_{(C≤18)}.

92. The method according to any one of claims 2-60 and 62-71, wherein the second reactive compound is an organic halide.

93. The method of claim 92, wherein the organic halide is an organic bromide.

94. The method of claim 93, wherein the organic halide is an aromatic bromide.

95. The method of claim 94, wherein the aromatic bromide is further defined as: R_{d}Br, wherein: aryl_{(C≤18)}, heteroaryl_{(C≤8)}, or a substituted version of either group.

96. The method of claim 93, wherein the organic bromide is an aliphatic bromide.

97. The method of claim 96, wherein the aliphatic bromide is further defined as: R_{d}Br, wherein: alkyl_{(C≤18)}, alkenyl_{(C≤18)}, alkynyl_{(C≤18)}, or a substituted version of any of these group.

98. The method according to any one of claims 2-60 and 62-71, wherein the second reactive compound is a sulfur source.

99. The method of claim 98, wherein the sulfur source comprises a S—S bond.

100. The method of either claim 98 or claim 99, wherein the sulfur source is a sulfonothioic acid.

101. The method of claim 100, wherein the sulfur source is an S-phenyl ester of benzenesulfonothioic acid.

102. The method according to any one of claims 2-101, wherein the method further comprises exposing the monoboronated compound to an energy source.

103. The method of claim 102, wherein the energy source is a radiation source.

104. The method of claim 103, wherein the radiation source is ultraviolet radiation.

105. The method according to any one of claims 2-104, wherein the method further comprises a diol.

106. The method of claim 105, wherein the diol is pinacol.

107. The method of claim 105, wherein the diol is a catechol.

108. The method of claim 107, wherein the catechol is tert-butylcatechol.

109. The method according to any one of claims 2-108, wherein the method further comprises a phosphorus catalyst.

110. The method of claim 109, wherein the phosphorus catalyst is a phosphorus oxide compound.

111. The method according to any one of claims 2-110, wherein the method further comprises a metal catalyst.

112. The method of claim 111, wherein the metal catalyst is an iridium catalyst.

113. The method of claim 111, wherein the metal catalyst is a nickel catalyst.

114. The method of claim 111, wherein the metal salt is a manganese salt.

115. The method of either claim 111 or claim 114, wherein the metal salt is a manganese(III) salt.

116. The method of claim 115, wherein the manganese(III) salt is Mn(OAc)₃.

117. The method according to any one of claims 2-116, wherein the method further comprises an energy source.

118. The method of claim 117, wherein the energy source is a radiation source.

119. The method of claim 118, wherein the radiation source is ultraviolet radiation.

120. The method according to any one of claims 2-119, wherein the method further comprises a redox catalyst.

121. The method of claim 120, wherein the redox catalyst is a dimethylhydantoin.

122. The method of claim 121, wherein the redox catalyst is a dibromodimethylhydantoin.

123. The method of claim 120, wherein the redox catalyst is a boron compound.

124. The method of claim 123, wherein the redox catalyst is MeOB(catechol).

125. The method according to any one of claims 1-124, wherein R₁ is hydrogen, alkyl_{(C≤24)}, cycloalkyl_{(C≤24)}, alkenyl_{(C≤24)}, cycloalkenyl_{(C≤24)}, alkynyl_{(C≤24)}, cycloalkynyl_{(C≤24)}, aryl_{(C≤24)}, heteroaryl_{(C≤24)}, heterocycloalkyl_{(C≤24)}, alkoxy_{(C≤24)}, aryloxy_{(C≤24)}, aralkoxy_{(C≤24)}, acyl_{(C≤24)}, alkylamino_{(C≤24)}, dialkylamino_{(C≤24)}, alkylthio_{(C≤24)}, arylthio_{(C≤24)}, alkylsulfonyl_{(C≤24)}, arylsulfonyl_{(C≤24)}, or a substituted version of any of these groups; or a group of the formula: —C(O)R₈, wherein R₈ is alkoxy_{(C≤12)}, alkylamino_{(C≤12)}, dialkylamino_{(C≤12)}, or a substituted version of any of these groups; a monovalent protected amine group, a divalent protected amine group, a protected hydroxy group, or a protected thio group; or —X₁—R₉, wherein X₁ is substituted alkanediyl_{(C≤12)}, cycloalkanediyl_{(C≤12)}, alkenediyl_{(C≤12)}, arenediyl_{(C≤12)}, heteroarenediyl_{(C≤12)}, heterocycloalkanediyl_{(C≤12)}, or a substituted version thereof; and R₉ is alkyl_{(C≤24)}, cycloalkyl_{(C≤24)}, alkenyl_{(C≤24)}, cycloalkenyl_{(C≤24)}, alkynyl_{(C≤24)}, cycloalkynyl_{(C≤24)}, aryl_{(C≤24)}, heteroaryl_{(C≤24)}, heterocycloalkyl_{(C≤24)}, alkoxy_{(C≤24)}, aryloxy_{(C≤24)}, aralkoxy_{(C≤24)}, acyl_{(C≤24)}, alkylamino_{(C≤24)}, dialkylamino_{(C≤24)}, alkylthio_{(C≤24)}, arylthio_{(C≤24)}, alkylsulfonyl_{(C≤24)}, arylsulfonyl_{(C≤24)}, or a substituted version of any of these groups; or a group of the formula: —C(O)R₈, wherein R₈ is alkoxy_{(C≤12)}, alkylamino_{(C≤12)}, dialkylamino_{(C≤12)}, or a substituted version of any of these groups; a monovalent protected amine group, a divalent protected amine group, a protected hydroxy group, or a protected thio group.

126. The method of claim 125, wherein R₁ is hydrogen, alkyl_{(C≤24)}, cycloalkyl_{(C≤24)}, alkenyl_{(C≤24)}, cycloalkenyl_{(C≤24)}, alkynyl_{(C≤24)}, cycloalkynyl_{(C≤24)}, aryl_{(C≤24)}, heteroaryl_{(C≤24)}, heterocycloalkyl_{(C≤24)}, alkoxy_{(C≤24)}, aryloxy_{(C≤24)}, aralkoxy_{(C≤24)}, acyl_{(C≤24)}, alkylamino_{(C≤24)}, dialkylamino_{(C≤24)}, alkylthio_{(C≤24)}, arylthio_{(C≤24)}, alkylsulfonyl_{(C≤24)}, arylsulfonyl_{(C≤24)}, or a substituted version of any of these groups.

127. The method of claim 125, wherein R₁ is or a group of the formula: —C(O)R₈, wherein R₈ is alkoxy_{(C≤12)}, alkylamino_{(C≤12)}, dialkylamino_{(C≤12)}, or a substituted version of any of these groups.

128. The method of claim 125, wherein R₁ is a monovalent protected amine group, a divalent protected amine group, a protected hydroxy group, or a protected thio group.

129. The method of claim 125, wherein R₁ is —X₁—R₉, wherein X₁ is substituted alkanediyl_{(C≤12)}, cycloalkanediyl_{(C≤12)}, alkenediyl_{(C≤12)}, arenediyl_{(C≤12)}, heteroarenediyl_{(C≤12)}, heterocycloalkanediyl_{(C≤12)}, or a substituted version thereof; and R₉ is alkyl_{(C≤24)}, cycloalkyl_{(C≤24)}, alkenyl_{(C≤24)}, cycloalkenyl_{(C≤24)}, alkynyl_{(C≤24)}, cycloalkynyl_{(C≤24)}, aryl_{(C≤24)}, heteroaryl_{(C≤24)}, heterocycloalkyl_{(C≤24)}, alkoxy_{(C≤24)}, aryloxy_{(C≤24)}, aralkoxy_{(C≤24)}, acyl_{(C≤24)}, alkylamino_{(C≤24)}, dialkylamino_{(C≤24)}, alkylthio_{(C≤24)}, arylthio_{(C≤24)}, alkylsulfonyl_{(C≤24)}, arylsulfonyl_{(C≤24)}, or a substituted version of any of these groups; or a group of the formula: —C(O)R₈, wherein R₈ is alkoxy_{(C≤12)}, alkylamino_{(C≤12)}, dialkylamino_{(C≤12)}, or a substituted version of any of these groups; a monovalent protected amine group, a divalent protected amine group, a protected hydroxy group, or a protected thio group.

130. The method according to any one of claims 125-129, wherein R₁ is alkyl_{(C≤24)}, cycloalkyl_{(C≤24)}, aryl_{(C≤24)}, heteroaryl_{(C≤24)}, heterocycloalkyl_{(C≤24)}, a group of the formula: —C(O)R₈, wherein R₈ is alkoxy_{(C≤12)}, a monovalent protected amine group, a divalent protected amine group, a protected hydroxy group, a protected thio group, R₁ is —X₁—R₉, wherein X₁ is substituted alkanediyl_{(C≤12)} or a substituted version thereof; and R₉ is cycloalkyl_{(C≤24)}, aryl_{(C≤24)}, heteroaryl_{(C≤24)}, heterocycloalkyl_{(C≤24)}, alkoxy_{(C≤24)}, aryloxy_{(C≤24)}, aralkoxy_{(C≤24)}, acyl_{(C≤24)}, alkylamino_{(C≤24)}, dialkylamino_{(C≤24)}, alkylthio_{(C≤24)}, arylthio_{(C≤24)}, alkylsulfonyl_{(C≤24)}, arylsulfonyl_{(C≤24)}, or a substituted version of any of these groups; or a group of the formula: —C(O)R₈, wherein R₈ is alkoxy_{(C≤12)}, alkylamino_{(C≤12)}, dialkylamino_{(C≤12)}, or a substituted version of any of these groups; a monovalent protected amine group, a divalent protected amine group, a protected hydroxy group, or a protected thio group.

131. A compound of the formula: 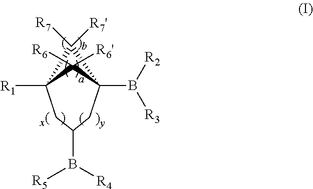
wherein:
a and b are each independently selected from 0, 1, 2, or 3;
x and y are each independently selected from 0, 1, 2, or 3;
R₁ is an organic moiety;
R₂, R₃, R₄, and R₅ are each hydroxy or R₂ and R₃ are taken together to form a B-containing heterocycloalkyl_{(C≤12)} or substituted B-containing heterocycloalkyl_{(C≤12)}; and
R₆, R₆′, R₇, and R₇′ are each independently hydrogen, alkyl_{(C≤12)}, or substituted alkyl_{(C≤12)}.

132. The compound of claim 131, wherein the compound is not a compound of the formula:

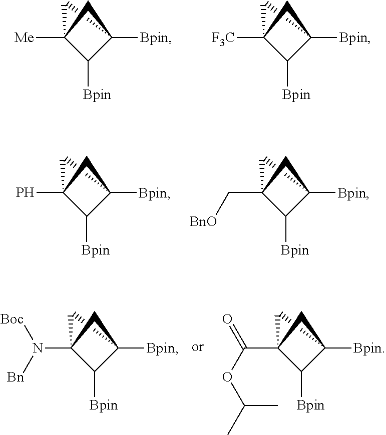

133. The compound of claim 131 or claim 132, wherein R₁ is aralkoxy_{(C≤24)}, acyl_{(C≤24)}, alkylamino_{(C≤24)}, dialkylamino_{(C≤24)}, alkylthio_{(C≤24)}, arylthio_{(C≤24)}, alkylsulfonyl_{(C≤24)}, arylsulfonyl_{(C≤24)}, or a substituted version of any of these groups; or a group of the formula: —C(O)R₈, wherein R₈ is alkoxy_{(C≤12)}, alkylamino_{(C≤12)}, dialkylamino_{(C≤12)}, or a substituted version of any of these groups; a monovalent protected amine group, a divalent protected amine group, a protected hydroxy group, or a protected thio group; or —X₁—R₉, wherein X₁ is substituted alkanediyl_{(C≤12)}, cycloalkanediyl_{(C≤12)}, alkenediyl_{(C≤12)}, arenediyl_{(C≤12)}, heteroarenediyl_{(C≤12)}, heterocycloalkanediyl_{(C≤12)}, or a substituted version thereof; and R₉ is alkyl_{(C≤24)}, cycloalkyl_{(C≤24)}, alkenyl_{(C≤24)}, cycloalkenyl_{(C≤24)}, alkynyl_{(C≤24)}, cycloalkynyl_{(C≤24)}, aryl_{(C≤24)}, heteroaryl_{(C≤24)}, heterocycloalkyl_{(C≤24)}, alkoxy_{(C≤24)}, aryloxy_{(C≤24)}, aralkoxy_{(C≤24)}, acyl_{(C≤24)}, alkylamino_{(C≤24)}, dialkylamino_{(C≤24)}, alkylthio_{(C≤24)}, arylthio_{(C≤24)}, alkylsulfonyl_{(C≤24)}, arylsulfonyl_{(C≤24)}, or a substituted version of any of these groups; or a group of the formula: —C(O)R₈, wherein R₈ is alkoxy_{(C≤12)}, alkylamino_{(C≤12)}, dialkylamino_{(C≤12)}, or a substituted version of any of these groups; a monovalent protected amine group, a divalent protected amine group, a protected hydroxy group, or a protected thio group.

134. The method of claim 133, wherein R₁ is hydrogen, alkyl_{(C≤24)}, cycloalkyl_{(C≤24)}, alkenyl_{(C≤24)}, cycloalkenyl_{(C≤24)}, alkynyl_{(C≤24)}, cycloalkynyl_{(C≤24)}, aryl_{(C≤24)}, heteroaryl_{(C≤24)}, heterocycloalkyl_{(C≤24)}, alkoxy_{(C≤24)}, aryloxy_{(C≤24)}, aralkoxy_{(C≤24)}, acyl_{(C≤24)}, alkylamino_{(C≤24)}, dialkylamino_{(C≤24)}, alkylthio_{(C≤24)}, arylthio_{(C≤24)}, alkylsulfonyl_{(C≤24)}, arylsulfonyl_{(C≤24)}, or a substituted version of any of these groups.

135. The method of claim 133, wherein R₁ is or a group of the formula: —C(O)R₈, wherein R₈ is alkoxy_{(C≤12)}, alkylamino_{(C≤12)}, dialkylamino_{(C≤12)}, or a substituted version of any of these groups.

136. The method of claim 133, wherein R₁ is a monovalent protected amine group, a divalent protected amine group, a protected hydroxy group, or a protected thio group.

137. The method of claim 133, wherein R₁ is —X₁—R₉, wherein X₁ is substituted alkanediyl_{(C≤12)}, cycloalkanediyl_{(C≤12)}, alkenediyl_{(C≤12)}, arenediyl_{(C≤12)}, heteroarenediyl_{(C≤12)}, heterocycloalkanediyl_{(C≤12)}, or a substituted version thereof; and R₉ is alkyl_{(C≤24)}, cycloalkyl_{(C≤24)}, alkenyl_{(C≤24)}, cycloalkenyl_{(C≤24)}, alkynyl_{(C≤24)}, cycloalkynyl_{(C≤24)}, aryl_{(C≤24)}, heteroaryl_{(C≤24)}, heterocycloalkyl_{(C≤24)}, alkoxy_{(C≤24)}, aryloxy_{(C≤24)}, aralkoxy_{(C≤24)}, acyl_{(C≤24)}, alkylamino_{(C≤24)}, dialkylamino_{(C≤24)}, alkylthio_{(C≤24)}, arylthio_{(C≤24)}, alkylsulfonyl_{(C≤24)}, arylsulfonyl_{(C≤24)}, or a substituted version of any of these groups; or a group of the formula: —C(O)R₈, wherein R₈ is alkoxy_{(C≤12)}, alkylamino_{(C≤12)}, dialkylamino_{(C≤12)}, or a substituted version of any of these groups; a monovalent protected amine group, a divalent protected amine group, a protected hydroxy group, or a protected thio group.

138. The method according to any one of claims 133-137, wherein R₁ is alkyl_{(C≤24)}, cycloalkyl_{(C≤24)}, aryl_{(C≤24)}, heteroaryl_{(C≤24)}, heterocycloalkyl_{(C≤24)}, a group of the formula: —C(O)R₈, wherein R₈ is alkoxy_{(C≤12)}, a monovalent protected amine group, a divalent protected amine group, a protected hydroxy group, a protected thio group, R₁ is —X₁—R₉, wherein X₁ is substituted alkanediyl_{(C≤12)} or a substituted version thereof; and R₉ is cycloalkyl_{(C≤24)}, aryl_{(C≤24)}, heteroaryl_{(C≤24)}, heterocycloalkyl_{(C≤24)}, alkoxy_{(C≤24)}, aryloxy_{(C≤24)}, aralkoxy_{(C≤24)}, acyl_{(C≤24)}, alkylamino_{(C≤24)}, dialkylamino_{(C≤24)}, alkylthio_{(C≤24)}, arylthio_{(C≤24)}, alkylsulfonyl_{(C≤24)}, arylsulfonyl_{(C≤24)}, or a substituted version of any of these groups; or a group of the formula: —C(O)R₈, wherein R₈ is alkoxy_{(C≤12)}, alkylamino_{(C≤12)}, dialkylamino_{(C≤12)}, or a substituted version of any of these groups; a monovalent protected amine group, a divalent protected amine group, a protected hydroxy group, or a protected thio group.

139. The compound according to any one of claims 131-138, wherein R₂ and R₃ are a B-containing heterocycloalkyl_{(C≤12)}.

140. The compound of claim 139, wherein R₂ and R₃ are a pinacol boronic ester.

141. The compound according to any one of claims 131-140, wherein R₄ and R₅ are a B-containing heterocycloalkyl_{(C≤12)}.

142. The compound of claim 141, wherein R₄ and R₅ are a pinacol boronic ester.

143. The compound according to any one of claims 131-142, wherein R₆ is hydrogen.

144. The compound according to any one of claims 131-143, wherein R₆′ is hydrogen.

145. The compound according to any one of claims 131-144, wherein R₇ is hydrogen.

146. The compound according to any one of claims 131-145, wherein R₇′ is hydrogen.

147. The compound according to any one of claims 131-146, wherein the compound is further defined as: [chemical structure]
